(19) United States
(12) Patent Application Publication
(10) Pub. No.: US 2026/0270470 A1
(43) Pub. Date: Sep. 10, 2026

(54) METHOD FOR ENCODING/DECODING IMAGE AND RECORDING MEDIUM FOR STORING BITSTREAM

(71) Applicant: ELECTRONICS AND TELECOMMUNICATIONS RESEARCH INSTITUTE, Daejeon (KR)

(72) Inventors: Jong Ho KIM, Daejeon (KR); Dong Hyun KIM, Daejeon (KR); Sung Chang LIM, Daejeon (KR); Woong LIM, Daejeon (KR); Jin Soo CHOI, Daejeon (KR); Jung Won KANG, Daejeon (KR)

(21) Appl. No.: 19/166,448

(22) PCT Filed: Apr. 12, 2024
(86) PCT No.: PCT/KR2024/004957

§ 371 Date: Sep. 17, 2025

(30) Foreign Application Priority Data
Apr. 14, 2023 (KR) 10-2023-0049569
Apr. 14, 2023 (KR) 10-2023-0049666
Jul. 4, 2023 (KR) 10-2023-0086743

(51) Int. Cl. H04N 19/593; H04N 19/176; H04N 19/70

(52) U.S. Cl. CPC H04N 19/593; H04N 19/176; H04N 19/70

(57) ABSTRACT

A method for decoding an image according to the present disclosure comprises the steps of: setting a search range for template matching for a current block within a current picture; performing template matching for the search range so as to derive a block vector for the current block; and deriving a prediction block for the current block on the basis of the block vector.

### TECHNICAL FIELD

The present disclosure relates to a method, a device and a recording medium for image encoding/decoding.

### BACKGROUND ART

With the continuous development of the information and communication industries, broadcasting services supporting High-Definition (HD) resolution have been popularized all over the world. Through this popularization, a large number of users have become accustomed to high-resolution and high-definition images and/or video.

To satisfy users' demand for high definition, many institutions have accelerated the development of next-generation imaging devices. Users' interest in UHD TVs, having resolution that is more than four times as high as that of Full HD (FHD) TVs, as well as High-Definition TVs (HDTV) and FHD TVs, has increased. As interest therein has increased, image encoding/decoding technology for images having higher resolution and higher definition is currently required.

As image compression technology, there are various technologies, such as inter-prediction technology, intra-prediction technology, transform, quantization technology, filtering technology and entropy coding technology.

Inter-prediction technology is technology for predicting the value of a pixel included in a current picture using a picture previous to and/or a picture subsequent to the current picture. Intra-prediction technology is technology for predicting the value of a pixel included in a current picture using information about pixels in the current picture. Transform and quantization technology may be technology for compressing the energy of a residual signal. The entropy coding technology is technology for assigning a short codeword to a frequently occurring value and assigning a long codeword to a less frequently occurring value.

By utilizing this image compression technology, data about images may be effectively compressed, transmitted, and stored.

### DISCLOSURE

### Technical Problem

The present disclosure is to provide a method for deriving a block vector through template matching.

The present disclosure is to increase the accuracy of a derived block vector by diversifying the number of search ranges and the configuration of a search range for template matching.

The present disclosure is to improve prediction accuracy by adaptively determining the resolution of a block vector.

### Technical Solution

An image decoding method according to an embodiment of the present disclosure includes setting a search range for template matching for a current block within a current picture; performing template matching for the search range to derive a block vector for the current block; and deriving a prediction block for the current block based on the block vector.

An image encoding method according to an embodiment of the present disclosure includes setting a search range for template matching for a current block within a current picture; performing template matching for the search range to derive a block vector for the current block; and deriving a prediction block for the current block based on the block vector.

In an image encoding/decoding method according to an embodiment of the present disclosure, the search range may include a plurality of spatially separated sub-search ranges.

In an image encoding/decoding method according to an embodiment of the present disclosure, the search range may include at least one of a first sub-search range at the top position of the current block, a second sub-search range at a left position or a third sub-search range at a top-left position.

In an image encoding/decoding method according to an embodiment of the present disclosure, whether a sub-search range is available may be determined based on the availability of an adjacent block positioned in a direction toward which the sub-search range faces from the current block.

In an image encoding/decoding method according to an embodiment of the present disclosure, the size of the sub-search ranges may be determined based on the block vector of an adjacent block adjacent to the current block.

In an image encoding/decoding method according to an embodiment of the present disclosure, the size of a sub-search range including a position spaced apart from the position of the current block by the block vector of the adjacent block may be expanded.

In an image encoding/decoding method according to an embodiment of the present disclosure, the size of a residual sub-search range not including the position may be reduced.

In an image encoding/decoding method according to an embodiment of the present disclosure, deriving the block vector may include performing initial template matching at predefined integer positions set according to a predefined pattern within the search range.

In an image encoding/decoding method according to an embodiment of the present disclosure, deriving the block vector may include selecting an integer position having a minimum template matching cost among the predefined integer positions, further performing additional template matching on ½ pixel positions around a selected integer position, selecting a ½ pixel position having a minimum template matching cost among the ½ pixel positions and further performing additional template matching on ¼ pixel positions around a selected ½ pixel position.

In an image encoding/decoding method according to an embodiment of the present disclosure, the sample value of a sub-pixel position may be obtained through interpolation, and an interpolation filter used to derive a sample value at the ½ pixel positions may be different from an interpolation filter used to derive a sample value at the ¼ pixel positions.

In an image encoding/decoding method according to an embodiment of the present disclosure, the prediction block of the current block may be obtained based on a weighted sum operation between a first prediction block derived based on a first block vector and a second prediction block derived based on a second block vector.

In an image encoding/decoding method according to an embodiment of the present disclosure, the first block vector may be derived based on a first template, and the second block vector may be derived based on a second template.

According to the present disclosure, a recording medium storing a bitstream generated by the image encoding method may be provided.

### Technical Effect

According to the present disclosure, there is an effect of reducing information to be encoded/decoded by deriving a block vector through template matching.

According to the present disclosure, there is an effect of increasing the accuracy of a derived block vector by diversifying the number of search ranges and the configuration of a search range for template matching.

According to the present disclosure, there is an effect of improving prediction accuracy by adaptively determining the resolution of a block vector.

### BRIEF DESCRIPTION OF DRAWINGS

FIG. 1 is a block diagram illustrating the configuration of an embodiment of an encoding apparatus to which the present disclosure is applied.

FIG. 2 is a block diagram illustrating the configuration of an embodiment of a decoding apparatus to which the present disclosure is applied.

FIG. 3 is a diagram schematically illustrating the partition structure of an image when the image is encoded and decoded.

FIG. 4 is a diagram illustrating the form of a Prediction Unit (PU) that a Coding Unit (CU) can include.

FIG. 5 is a diagram illustrating the form of a Transform Unit (TU) that can be included in a CU.

FIG. 6 illustrates splitting of a block according to an example.

FIG. 7 is a diagram for explaining an embodiment of an intra-prediction procedure.

FIG. 8 is a diagram illustrating reference samples used in an intra-prediction procedure.

FIG. 9 is a diagram for explaining an embodiment of an inter-prediction procedure.

FIG. 10 illustrates spatial candidates according to an embodiment.

FIG. 11 illustrates the order of addition of motion information of spatial candidates to a merge list according to an embodiment.

FIG. 12 illustrates a transform and quantization process according to an example.

FIG. 13 illustrates diagonal scanning according to an example.

FIG. 14 illustrates horizontal scanning according to an example.

FIG. 15 illustrates vertical scanning according to an example.

FIG. 16 is a configuration diagram of an encoding apparatus according to an embodiment.

FIG. 17 is a configuration diagram of a decoding apparatus according to an embodiment.

FIGS. 18 to 21 are a diagram for describing a template matching prediction method according to an embodiment of the present disclosure.

FIG. 22 shows an example in which a prediction block is derived based on a block vector.

FIG. 23 shows configuration examples of template.

FIG. 24 is a diagram showing a template configuring method when the top boundary of a current block touches a CTU boundary.

FIG. 25 shows an example in which a reference block is determined based on a block vector of a current block.

FIG. 26 is a flowchart of a method for encoding a current block under an intra block copy mode.

FIG. 27 is a flowchart of a method for decoding a current block under an intra block copy mode.

FIG. 28 shows spatial candidates according to an embodiment of the present disclosure.

FIGS. 29 to 31 show a method for configuring a block vector candidate list including spatial block vector candidates.

FIG. 32 shows an example in which the block vector of a block encoded/decoded in an intra block copy mode and the block vector of a block encoded/decoded by template matching are stored in one history block vector buffer.

FIG. 33 shows an example in which a history block vector buffer storing the block vector of a block encoded/decoded in an intra block copy mode and a history block vector buffer storing the block vector of a block encoded/decoded by template matching are individually managed.

FIGS. 34 and 35 show an example in which the block vector candidate list of a current block is configured.

FIG. 36 is to describe an example in which a block vector candidate is improved by applying template matching.

FIGS. 37 and 38 show an example in which block vector candidates are updated.

FIGS. 39 and 40 shows an example in which block vector candidates within a block vector candidate list are reordered.

FIG. 41 shows an example in which a block vector candidate list derived based on an upper block is shared with lower blocks.

FIG. 42 is an example for describing a block vector candidate that is unavailable to a lower block.

FIG. 43 shows a configuration example of a set including integer sample unit candidates.

FIG. 44 illustrates rounding shift values that may be applied to a current block.

FIG. 45 is a diagram for describing an example in which the range of a block vector is restricted.

FIG. 46 is a diagram for describing the position of a reference block.

FIG. 47 is a drawing for describing a reference region buffer.

FIG. 48 shows an example in which a coordinate is set based on the center position of a reference region.

FIG. 49 shows a configuration example of a reference region buffer.

FIGS. 50 to 53 show an aspect in which a reference region buffer is updated as a CTB is encoded/decoded.

FIG. 54 shows an example in which a block vector is derived for each sub-block after a current chroma block is partitioned into a plurality of sub-blocks.

FIG. 55 illustrates a sample at a predefined position.

FIG. 56 is to describe an example in which a reference block indicated by a block vector is set as a prediction block.

FIGS. 57 and 58 are a drawing for describing an embodiment in which the residual block of a current chroma component block is derived.

FIGS. 59 and 60 illustrates a luma block and a chroma block when a ratio between color components is 4:2:0.

FIG. 61 is a diagram for describing an example in which the prediction mode of a chroma component block is derived based on a luma component block.

FIG. 62 is a diagram for describing a prediction process based on a DBVB method.

FIG. 63 illustrates four separated search ranges.

FIG. 64 shows an example in which whether to perform template matching for a search range is determined based on the prediction mode of a current block and the prediction mode of an adjacent block.

FIG. 65 shows the position of pixels where initial template matching is performed.

FIG. 66 is a diagram for describing an example in which template matching is performed by using the block vector of an adjacent block.

FIGS. 67 to 69 show an example in which the size of a search range is expanded.

FIGS. 70 to 74 show an example in which the size of a search range is determined variably.

FIGS. 75 to 77 shows an example in which sub-sampling is performed for a search range.

FIGS. 78 and 79 illustrate a position where template matching is performed.

FIGS. 80 to 82 show an example in which template matching is additionally performed on adjacent or symmetrical sub-pixel positions based on a sub-pixel position having a minimum template cost.

FIG. 83 is an example of a method for determining a pixel position where template matching is performed in a lower resolution unit by inheriting a sub-pixel position determined in a higher resolution (precision) pixel unit.

FIGS. 84 and 85 shows an example of a sub-pixel position where template matching is performed in a ¼ pixel unit based on a template matching cost for each sub-pixel position in a ½ pixel unit.

FIG. 86 shows a sub-pixel position where template matching is performed in a ¼ pixel unit.

FIGS. 87 and 88 show an example of a template in various forms.

FIG. 89 shows an example in which template matching is performed by using one template.

FIG. 90 shows an example in which template matching is performed by using a plurality of templates.

FIG. 91 shows an example in which a template shape is changed according to a prediction mode.

FIG. 92 shows an example in which a template is partitioned according to the partition shape of a neighboring block.

FIG. 93 shows an example in which a template is partitioned.

FIG. 94 is a flowchart of a method for configuring a MPM list according to an embodiment of the present disclosure.

FIG. 95 shows a prediction mode number (index) and adjacent blocks to be referenced in intra prediction.

FIGS. 96 and 97 show an example in which the value of nbRemovedFirst is determined differently according to the availability of an adjacent block.

### MODE FOR INVENTION

The present invention may be variously changed, and may have various embodiments, and specific embodiments will be described in detail below with reference to the attached drawings. However, it should be understood that those embodiments are not intended to limit the present invention to specific disclosure forms, and that they include all changes, equivalents or modifications included in the spirit and scope of the present invention.

Detailed descriptions of the following exemplary embodiments will be made with reference to the attached drawings illustrating specific embodiments. These embodiments are described so that those having ordinary knowledge in the technical field to which the present disclosure pertains can easily practice the embodiments. It should be noted that the various embodiments are different from each other, but do not need to be mutually exclusive of each other. For example, specific shapes, structures, and characteristics described here may be implemented as other embodiments without departing from the spirit and scope of the embodiments in relation to an embodiment. Further, it should be understood that the locations or arrangement of individual components in each disclosed embodiment can be changed without departing from the spirit and scope of the embodiments. Therefore, the accompanying detailed description is not intended to restrict the scope of the disclosure, and the scope of the exemplary embodiments is limited only by the accompanying claims, along with equivalents thereof, as long as they are appropriately described.

In the drawings, similar reference numerals are used to designate the same or similar functions in various aspects. The shapes, sizes, etc. of components in the drawings may be exaggerated to make the description clear.

Terms such as “first” and “second” may be used to describe various components, but the components are not restricted by the terms. The terms are used only to distinguish one component from another component. For example, a first component may be named a second component without departing from the scope of the present specification. Likewise, a second component may be named a first component. The terms “and/or” may include combinations of a plurality of related described items or any of a plurality of related described items.

It will be understood that when a component is referred to as being “connected” or “coupled” to another component, the two components may be directly connected or coupled to each other, or intervening components may be present between the two components. On the other hand, it will be understood that when a component is referred to as being “directly connected or coupled”, no intervening components are present between the two components.

Also, components described in the embodiments are independently shown in order to indicate different characteristic functions, but this does not mean that each of the components is formed of a separate piece of hardware or software. That is, the components are arranged and included separately for convenience of description. For example, at least two of the components may be integrated into a single component. Conversely, one component may be divided into multiple components. An embodiment into which the components are integrated or an embodiment in which some components are separated is included in the scope of the present specification as long as it does not depart from the essence of the present specification.

The terms used in the embodiment are merely used to describe specific embodiments and are not intended to limit the present invention. A singular expression includes a plural expression unless a description to the contrary is specifically pointed out in context. In the embodiments, it should be understood that the terms such as “include” or “have” are merely intended to indicate that features, numbers, steps, operations, components, parts, or combinations thereof are present, and are not intended to exclude the possibility that one or more other features, numbers, steps, operations, components, parts, or combinations thereof will be present or added. That is, in the embodiments, an expression describing that a component “comprises” a specific component means that additional components may be included within the scope of the practice of the present invention or the technical spirit of the present invention, but does not preclude the presence of components other than the specific component.

In the embodiments, a term “at least one” may mean one of one or more numbers, such as 1, 2, 3, and 4. In the embodiments, a term “a plurality of” may mean one of two or more numbers, such as 2, 3 and 4.

Some components of the embodiments are not essential components for performing essential functions, but may be optional components for improving only performance. The embodiments may be implemented using only essential components for implementing the essence of the embodiments. For example, a structure including only essential components, excluding optional components used only to improve performance, is also included in the scope of the embodiments.

Embodiments will be described in detail below with reference to the accompanying drawings so that those having ordinary knowledge in the technical field to which the embodiments pertain can easily practice the embodiments. In the following description of the embodiments, detailed descriptions of known functions or configurations which are deemed to make the gist of the present specification obscure will be omitted. Further, the same reference numerals are used to designate the same components throughout the drawings, and repeated descriptions of the same components will be omitted.

Hereinafter, “image” may mean a single picture constituting a video, or may mean the video itself. For example, “encoding and/or decoding of an image” may mean “encoding and/or decoding of a video”, and may also mean “encoding and/or decoding of any one of images constituting the video”.

Hereinafter, the terms “video” and “motion picture” may be used to have the same meaning, and may be used interchangeably with each other.

Hereinafter, a target image may be an encoding target image, which is the target to be encoded, and/or a decoding target image, which is the target to be decoded. Further, the target image may be an input image that is input to an encoding apparatus or an input image that is input to a decoding apparatus. And, a target image may be a current image, that is, the target to be currently encoded and/or decoded. For example, the terms “target image” and “current image” may be used to have the same meaning, and may be used interchangeably with each other.

Hereinafter, the terms “image”, “picture”, “frame”, and “screen” may be used to have the same meaning and may be used interchangeably with each other.

Hereinafter, a target block may be an encoding target block, i.e. the target to be encoded and/or a decoding target block, i.e. the target to be decoded. Further, the target block may be a current block, i.e. the target to be currently encoded and/or decoded. Here, the terms “target block” and “current block” may be used to have the same meaning, and may be used interchangeably with each other. A current block may denote an encoding target block, which is the target of encoding, during encoding and/or a decoding target block, which is the target of decoding, during decoding. Also, the current block may be at least one of a coding block, a prediction block, a residual block, and a transform block.

Hereinafter, the terms “block” and “unit” may be used to have the same meaning, and may be used interchangeably with each other. Alternatively, “block” may denote a specific unit.

Hereinafter, the terms “region” and “segment” may be used interchangeably with each other.

In the following embodiments, specific information, data, a flag, an index, an element, and an attribute may have their respective values. A value of “0” corresponding to each of the information, data, flag, index, element, and attribute may indicate a false, a logical false or a first predefined value. In other words, the value of “0”, a false, logical false, and a first predefined value may be used interchangeably with each other. A value of “1” corresponding to each of the information, data, flag, index, element, and attribute may indicate a true, a logical true or a second predefined value. In other words, the value of “1”, true, logical true, and a second predefined value may be used interchangeably with each other.

When a variable such as i or j is used to indicate a row, a column, or an index, the value of i may be an integer of 0 or more or an integer of 1 or more. In other words, in the embodiments, each of a row, a column, and an index may be counted from 0 or may be counted from 1.

In embodiments, the term “one or more” or the term “at least one” may mean the term “plural”. The term “one or more” or the term “at least one” may be used interchangeably with “plural”.

Below, the terms to be used in embodiments will be described.

Encoder: An encoder denotes a device for performing encoding. That is, an encoder may mean an encoding apparatus.

Decoder: A decoder denotes a device for performing decoding. That is, a decoder may mean a decoding apparatus.

Unit: A unit may denote the unit of image encoding and decoding. The terms “unit” and “block” may be used to have the same meaning, and may be used interchangeably with each other.
A unit may be an M×N array of samples. Each of M and N may be a positive integer. A unit may typically mean an array of samples in the form of two-dimensions.
In the encoding and decoding of an image, “unit” may be an area generated by the partitioning of one image. In other words, “unit” may be a region specified in one image. A single image may be partitioned into multiple units. Alternatively, one image may be partitioned into sub-parts, and the unit may denote each partitioned sub-part when encoding or decoding is performed on the partitioned sub-part.
In the encoding and decoding of an image, predefined processing may be performed on each unit depending on the type of the unit.
Depending on functions, the unit types may be classified into a macro unit, a Coding Unit (CU), a Prediction Unit (PU), a residual unit, a Transform Unit (TU), etc. Alternatively, depending on functions, the unit may denote a block, a macroblock, a coding tree unit, a coding tree block, a coding unit, a coding block, a prediction unit, a prediction block, a residual unit, a residual block, a transform unit, a transform block, etc. For example, a target unit, which is the target of encoding and/or decoding, may be at least one of a CU, a PU, a residual unit, and a TU.
The term “unit” may mean information including a luminance (luma) component block, a chrominance (chroma) component block corresponding thereto, and syntax elements for respective blocks so that the unit is designated to be distinguished from a block.
The size and shape of a unit may be variously implemented. Further, a unit may have any of various sizes and shapes. In particular, the shapes of the unit may include not only a square, but also a geometric figure that can be represented in two dimensions (2D), such as a rectangle, a trapezoid, a triangle, and a pentagon.
Further, unit information may include one or more of the type of a unit, the size of a unit, the depth of a unit, the order of encoding of a unit and the order of decoding of a unit, etc. For example, the type of a unit may indicate one of a CU, a PU, a residual unit and a TU.
One unit may be partitioned into sub-units, each having a smaller size than that of the relevant unit.

Depth: A depth may mean an extent to which the unit is partitioned. Further, the depth of the unit may indicate the level at which the corresponding unit is present when unit(s) are represented by a tree structure.
Unit partition information may include a depth indicating the depth of a unit. A depth may indicate the number of times the unit is partitioned and/or the degree to which the unit is partitioned.
In a tree structure, it may be considered that the depth of a root node is the smallest, and the depth of a leaf node is the largest. The root node may be the highest (top) node. The leaf node may be a lowest node.
A single unit may be hierarchically partitioned into multiple sub-units while having depth information based on a tree structure. In other words, the unit and sub-units, generated by partitioning the unit, may correspond to a node and child nodes of the node, respectively. Each of the partitioned sub-units may have a unit depth. Since the depth indicates the number of times the unit is partitioned and/or the degree to which the unit is partitioned, the partition information of the sub-units may include information about the sizes of the sub-units.
In a tree structure, the top node may correspond to the initial node before partitioning. The top node may be referred to as a “root node”. Further, the root node may have a minimum depth value. Here, the top node may have a depth of level ‘0’.
A node having a depth of level ‘1’ may denote a unit generated when the initial unit is partitioned once. A node having a depth of level ‘2’ may denote a unit generated when the initial unit is partitioned twice.
A leaf node having a depth of level ‘n’ may denote a unit generated when the initial unit has been partitioned n times.
The leaf node may be a bottom node, which cannot be partitioned any further. The depth of the leaf node may be the maximum level. For example, a predefined value for the maximum level may be 3.
A QT depth may denote a depth for a quad-partitioning. A BT depth may denote a depth for a binary-partitioning. A TT depth may denote a depth for a ternary-partitioning.

Sample: A sample may be a base unit constituting a block. A sample may be represented by values from 0 to 2Bd−1 depending on the bit depth (Bd).
A sample may be a pixel or a pixel value.
Hereinafter, the terms “pixel” and “sample” may be used to have the same meaning, and may be used interchangeably with each other.

A Coding Tree Unit (CTU): A CTU may be composed of a single luma component (Y) coding tree block and two chroma component (Cb, Cr) coding tree blocks related to the luma component coding tree block. Further, a CTU may mean information including the above blocks and a syntax element for each of the blocks.
Each coding tree unit (CTU) may be partitioned using one or more partitioning methods, such as a quad tree (QT), a binary tree (BT), and a ternary tree (TT) so as to configure sub-units, such as a coding unit, a prediction unit, and a transform unit. A quad tree may mean a quaternary tree. Further, each coding tree unit may be partitioned using a multitype tree (MTT) using one or more partitioning methods.
“CTU” may be used as a term designating a pixel block, which is a processing unit in an image-decoding and encoding process, as in the case of partitioning of an input image.

Coding Tree Block (CTB): “CTB” may be used as a term designating any one of a Y coding tree block, a Cb coding tree block, and a Cr coding tree block.

Neighbor block: A neighbor block (or neighboring block) may mean a block adjacent to a target block. A neighbor block may mean a reconstructed neighbor block.
Hereinafter, the terms “neighbor block” and “adjacent block” may be used to have the same meaning and may be used interchangeably with each other.
A neighbor block may mean a reconstructed neighbor block.

Spatial neighbor block; A spatial neighbor block may a block spatially adjacent to a target block. A neighbor block may include a spatial neighbor block.
The target block and the spatial neighbor block may be included in a target picture.
The spatial neighbor block may mean a block, the boundary of which is in contact with the target block, or a block located within a predetermined distance from the target block.
The spatial neighbor block may mean a block adjacent to the vertex of the target block. Here, the block adjacent to the vertex of the target block may mean a block vertically adjacent to a neighbor block which is horizontally adjacent to the target block or a block horizontally adjacent to a neighbor block which is vertically adjacent to the target block.

Temporal neighbor block: A temporal neighbor block may be a block temporally adjacent to a target block. A neighbor block may include a temporal neighbor block.
The temporal neighbor block may include a co-located block (col block).
The col block may be a block in a previously reconstructed co-located picture (col picture). The location of the col block in the col-picture may correspond to the location of the target block in a target picture. Alternatively, the location of the col block in the col-picture may be equal to the location of the target block in the target picture. The col picture may be a picture included in a reference picture list.
The temporal neighbor block may be a block temporally adjacent to a spatial neighbor block of a target block.

Prediction mode: The prediction mode may be information indicating the mode used for intra prediction, or the mode used for inter prediction.

Prediction unit: A prediction unit may be a base unit for prediction, such as inter prediction, intra prediction, inter compensation, intra compensation, and motion compensation.

A single prediction unit may be divided into multiple partitions having smaller sizes or sub-prediction units. The multiple partitions may also be base units in the performance of prediction or compensation. The partitions generated by dividing the prediction unit may also be prediction units.

Prediction unit partition: A prediction unit partition may be the shape into which a prediction unit is divided.

Reconstructed neighbor unit: A reconstructed neighbor unit may be a unit which has already been decoded and reconstructed neighboring a target unit.
A reconstructed neighbor unit may be a unit that is spatially adjacent to the target unit or that is temporally adjacent to the target unit.
A reconstructed spatial neighbor unit may be a unit which is included in a target picture and which has already been reconstructed through encoding and/or decoding.
A reconstructed temporal neighbor unit may be a unit which is included in a reference image and which has already been reconstructed through encoding and/or decoding. The location of the reconstructed temporal neighbor unit in the reference image may be identical to that of the target unit in the target picture, or may correspond to the location of the target unit in the target picture. Also, a reconstructed temporal neighbor unit may be a block neighboring the corresponding block in a reference image. Here, the location of the corresponding block in the reference image may correspond to the location of the target block in the target image. Here, the fact that the locations of blocks correspond to each other may mean that the locations of the blocks are identical to each other, may mean that one block is included in another block, or may mean that one block occupies a specific location in another block.

Sub-picture: A picture may be divided into one or more sub-pictures. A sub-picture may be composed of one or more tile rows and one or more tile columns.
A sub-picture may be a region having a square shape or a rectangular(i.e., a non-square rectangular) shape in a picture. Further, a sub-picture may include one or more CTUs.
A sub-picture may be a rectangular region of one or more slices in a picture.
One sub-picture may include one or more tiles, one or more bricks, and/or one or more slices.

Tile: A tile may be a region having a square shape or rectangular (i.e., a non-square rectangular) shape in a picture.
A tile may include one or more CTUs.
A tile may be partitioned into one or more bricks.

Brick: A brick may denote one or more CTU rows in a tile.
A tile may be partitioned into one or more bricks. Each brick may include one or more CTU rows.
A tile that is not partitioned into two parts may also denote a brick.

Slice: A slice may include one or more tiles in a picture. Alternatively, a slice may include one or more bricks in a tile.
A sub-picture may contain one or more slices that collectively cover a rectangular region of a picture. Consequently, each sub-picture boundary is also always a slice boundary, and each vertical sub-picture boundary is always also a vertical tile boundary.

Parameter set: A parameter set may correspond to header information in the internal structure of a bitstream.
A parameter set may include at least one of a video parameter set (VPS), a sequence parameter set (SPS), a picture parameter set (PPS), an adaptation parameter set (APS), a decoding parameter set (DPS), etc.

Information signaled through each parameter set may be applied to pictures which refer to the corresponding parameter set. For example, information in a VPS may be applied to pictures which refer to the VPS. Information in an SPS may be applied to pictures which refer to the SPS. Information in a PPS may be applied to pictures which refer to the PPS.

Each parameter set may refer to a higher parameter set. For example, a PPS may refer to an SPS. An SPS may refer to a VPS.
Further, a parameter set may include a tile group, slice header information, and tile header information. The tile group may be a group including multiple tiles. Also, the meaning of “tile group” may be identical to that of “slice”.

Rate-distortion optimization: An encoding apparatus may use rate-distortion optimization so as to provide high coding efficiency by utilizing combinations of the size of a coding unit (CU), a prediction mode, the size of a prediction unit (PU), motion information, and the size of a transform unit (TU).
A rate-distortion optimization scheme may calculate rate-distortion costs of respective combinations so as to select an optimal combination from among the combinations. The rate-distortion costs may be calculated using the equation “D+λ*R”. Generally, a combination enabling the rate-distortion cost to be minimized may be selected as the optimal combination in the rate-distortion optimization scheme.
D may denote distortion. D may be the mean of squares of differences (i.e. mean square error) between original transform coefficients and reconstructed transform coefficients in a transform unit.
R may denote the rate, which may denote a bit rate using related-context information.
λ denotes a Lagrangian multiplier. R may include not only coding parameter information, such as a prediction mode, motion information, and a coded block flag, but also bits generated due to the encoding of transform coefficients.
An encoding apparatus may perform procedures, such as inter prediction and/or intra prediction, transform, quantization, entropy encoding, inverse quantization (dequantization), and/or inverse transform so as to calculate precise D and R. These procedures may greatly increase the complexity of the encoding apparatus.

Bitstream: A bitstream may denote a stream of bits including encoded image information.

Parsing: Parsing may be the decision on the value of a syntax element, made by performing entropy decoding on a bitstream. Alternatively, the term “parsing” may mean such entropy decoding itself.

Symbol: A symbol may be at least one of the syntax element, the coding parameter, and the transform coefficient of an encoding target unit and/or a decoding target unit. Further, a symbol may be the target of entropy encoding or the result of entropy decoding.

Reference picture: A reference picture may be an image referred to by a unit so as to perform inter prediction or motion compensation. Alternatively, a reference picture may be an image including a reference unit referred to by a target unit so as to perform inter prediction or motion compensation.

Hereinafter, the terms “reference picture” and “reference image” may be used to have the same meaning, and may be used interchangeably with each other.

Reference picture list: A reference picture list may be a list including one or more reference images used for inter prediction or motion compensation.

The types of a reference picture list may include List Combined (LC), List 0 (L0), List 1 (L1), List 2 (L2), List 3 (L3), etc.
For inter prediction, one or more reference picture lists may be used.

Inter-prediction indicator: An inter-prediction indicator may indicate the inter-prediction direction for a target unit. Inter prediction may be one of unidirectional prediction and bidirectional prediction. Alternatively, the inter-prediction indicator may denote the number of reference pictures used to generate a prediction unit of a target unit. Alternatively, the inter-prediction indicator may denote the number of prediction blocks used for inter prediction or motion compensation of a target unit.

Prediction list utilization flag: A prediction list utilization flag may indicate whether a prediction unit is generated using at least one reference picture in a specific reference picture list.
An inter-prediction indicator may be derived using the prediction list utilization flag. In contrast, the prediction list utilization flag may be derived using the inter-prediction indicator. For example, the case where the prediction list utilization flag indicates “0”, which is a first value, may indicate that, for a target unit, a prediction block is not generated using a reference picture in a reference picture list. The case where the prediction list utilization flag indicates “1”, which is a second value, may indicate that, for a target unit, a prediction unit is generated using the reference picture list.

Reference picture index: A reference picture index may be an index indicating a specific reference picture in a reference picture list.

Picture Order Count (POC): A POC value for a picture may denote an order in which the corresponding picture is displayed.

Motion vector (MV): A motion vector may be a 2D vector used for inter prediction or motion compensation. A motion vector may mean an offset between a target image and a reference image.
For example, a MV may be represented in a form such as (mvₓ, mv_{y}). mvₓ may indicate a horizontal component, and mv_{y} may indicate a vertical component.

Search range: A search range may be a 2D area in which a search for a MV is performed during inter prediction. For example, the size of the search range may be M×N. M and N may be respective positive integers.

Motion vector candidate: A motion vector candidate may be a block that is a prediction candidate or the motion vector of the block that is a prediction candidate when a motion vector is predicted.
A motion vector candidate may be included in a motion vector candidate list.

Motion vector candidate list: A motion vector candidate list may be a list configured using one or more motion vector candidates.

Motion vector candidate index: A motion vector candidate index may be an indicator for indicating a motion vector candidate in the motion vector candidate list. Alternatively, a motion vector candidate index may be the index of a motion vector predictor.

Motion information: Motion information may be information including at least one of a reference picture list, a reference image, a motion vector candidate, a motion vector candidate index, a merge candidate, and a merge index, as well as a motion vector, a reference picture index, and an inter-prediction indicator.

Merge candidate list: A merge candidate list may be a list configured using one or more merge candidates.

Merge candidate: A merge candidate may be a spatial merge candidate, a temporal merge candidate, a combined merge candidate, a combined bi-prediction merge candidate, a candidate based on a history, a candidate based on an average of two candidates, a zero-merge candidate, etc. A merge candidate may include an inter-prediction indicator, and may include motion information such as prediction type information, a reference picture index for each list, a motion vector, a prediction list utilization flag, and an inter-prediction indicator.

Merge index: A merge index may be an indicator for indicating a merge candidate in a merge candidate list.

A merge index may indicate a reconstructed unit used to derive a merge candidate between a reconstructed unit spatially adjacent to a target unit and a reconstructed unit temporally adjacent to the target unit.
A merge index may indicate at least one of pieces of motion information of a merge candidate.

Transform unit: A transform unit may be the base unit of residual signal encoding and/or residual signal decoding, such as transform, inverse transform, quantization, dequantization, transform coefficient encoding, and transform coefficient decoding. A single transform unit may be partitioned into multiple sub-transform units having a smaller size. Here, a transform may include one or more of a primary transform and a secondary transform, and an inverse transform may include one or more of a primary inverse transform and a secondary inverse transform.

Scaling: Scaling may denote a procedure for multiplying a factor by a transform coefficient level.
As a result of scaling of the transform coefficient level, a transform coefficient may be generated. Scaling may also be referred to as “dequantization”.

Quantization Parameter (QP): A quantization parameter may be a value used to generate a transform coefficient level for a transform coefficient in quantization. Alternatively, a quantization parameter may also be a value used to generate a transform coefficient by scaling the transform coefficient level in dequantization. Alternatively, a quantization parameter may be a value mapped to a quantization step size.

Delta quantization parameter: A delta quantization parameter may mean a difference value between a predicted quantization parameter and the quantization parameter of a target unit.

Scan: Scan may denote a method for aligning the order of coefficients in a unit, a block or a matrix. For example, a method for aligning a 2D array in the form of a one-dimensional (1D) array may be referred to as a “scan”. Alternatively, a method for aligning a 1D array in the form of a 2D array may also be referred to as a “scan” or an “inverse scan”.

Transform coefficient: A transform coefficient may be a coefficient value generated as an encoding apparatus performs a transform. Alternatively, the transform coefficient may be a coefficient value generated as a decoding apparatus performs at least one of entropy decoding and dequantization.

A quantized level or a quantized transform coefficient level generated by applying quantization to a transform coefficient or a residual signal may also be included in the meaning of the term “transform coefficient”.

Quantized level: A quantized level may be a value generated as the encoding apparatus performs quantization on a transform coefficient or a residual signal. Alternatively, the quantized level may be a value that is the target of dequantization as the decoding apparatus performs dequantization.

A quantized transform coefficient level, which is the result of transform and quantization, may also be included in the meaning of a quantized level.

Non-zero transform coefficient: A non-zero transform coefficient may be a transform coefficient having a value other than 0 or a transform coefficient level having a value other than 0. Alternatively, a non-zero transform coefficient may be a transform coefficient, the magnitude of the value of which is not 0, or a transform coefficient level, the magnitude of the value of which is not 0.

Quantization matrix: A quantization matrix may be a matrix used in a quantization procedure or a dequantization procedure so as to improve the subjective image quality or objective image quality of an image. A quantization matrix may also be referred to as a “scaling list”.

Quantization matrix coefficient: A quantization matrix coefficient may be each element in a quantization matrix. A quantization matrix coefficient may also be referred to as a “matrix coefficient”.

Default matrix: A default matrix may be a quantization matrix predefined by the encoding apparatus and the decoding apparatus.

Non-default matrix: A non-default matrix may be a quantization matrix that is not predefined by the encoding apparatus and the decoding apparatus. The non-default matrix may mean a quantization matrix to be signaled from the encoding apparatus to the decoding apparatus by a user.

Most Probable Mode (MPM): An MPM may denote an intra-prediction mode having a high probability of being used for intra prediction for a target block.
An encoding apparatus and a decoding apparatus may determine one or more MPMs based on coding parameters related to the target block and the attributes of entities related to the target block.
The encoding apparatus and the decoding apparatus may determine one or more MPMs based on the intra-prediction mode of a reference block. The reference block may include multiple reference blocks. The multiple reference blocks may include spatial neighbor blocks adjacent to the left of the target block and spatial neighbor blocks adjacent to the top of the target block. In other words, depending on which intra-prediction modes have been used for the reference blocks, one or more different MPMs may be determined.
The one or more MPMs may be determined in the same manner both in the encoding apparatus and in the decoding apparatus. That is, the encoding apparatus and the decoding apparatus may share the same MPM list including one or more MPMs.

MPM list: An MPM list may be a list including one or more MPMs. The number of the one or more MPMs in the MPM list may be defined in advance.

MPM indicator: An MPM indicator may indicate an MPM to be used for intra prediction for a target block among one or more MPMs in the MPM list. For example, the MPM indicator may be an index for the MPM list.
Since the MPM list is determined in the same manner both in the encoding apparatus and in the decoding apparatus, there may be no need to transmit the MPM list itself from the encoding apparatus to the decoding apparatus.
The MPM indicator may be signaled from the encoding apparatus to the decoding apparatus. As the MPM indicator is signaled, the decoding apparatus may determine the MPM to be used for intra prediction for the target block among the MPMs in the MPM list.

MPM use indicator: An MPM use indicator may indicate whether an MPM usage mode is to be used for prediction for a target block. The MPM usage mode may be a mode in which the MPM to be used for intra prediction for the target block is determined using the MPM list.
The MPM use indicator may be signaled from the encoding apparatus to the decoding apparatus.

Signaling: “signaling” may denote that information is transferred from an encoding apparatus to a decoding apparatus. Alternatively, “signaling” may mean information is included in in a bitstream or a recoding medium by an encoding apparatus. Information signaled by an encoding apparatus may be used by a decoding apparatus.
The encoding apparatus may generate encoded information by performing encoding on information to be signaled. The encoded information may be transmitted from the encoding apparatus to the decoding apparatus. The decoding apparatus may obtain information by decoding the transmitted encoded information. Here, the encoding may be entropy encoding, and the decoding may be entropy decoding.

Selective Signaling: Information may be signaled selectively. A selective signaling FOR information may mean that an encoding apparatus selectively includes information (according to a specific condition) in a bitstream or a recording medium. Selective signaling for information may mean that a decoding apparatus selectively extracts information from a bitstream (according to a specific condition).

Omission of signaling: Signaling for information may be omitted. Omission of signaling for information on information may mean that an encoding apparatus does not include information (according to a specific condition) in a bitstream or a recording medium. Omission of signaling for information may mean that a decoding apparatus does not extract information from a bitstream (according to a specific condition).

Statistic value: A variable, a coding parameter, a constant, etc. may have values that can be calculated. The statistic value may be a value generated by performing calculations (operations) on the values of specified targets. For example, the statistic value may indicate one or more of the average, weighted average, weighted sum, minimum value, maximum value, mode, median value, and interpolated value of the values of a specific variable, a specific coding parameter, a specific constant, or the like.

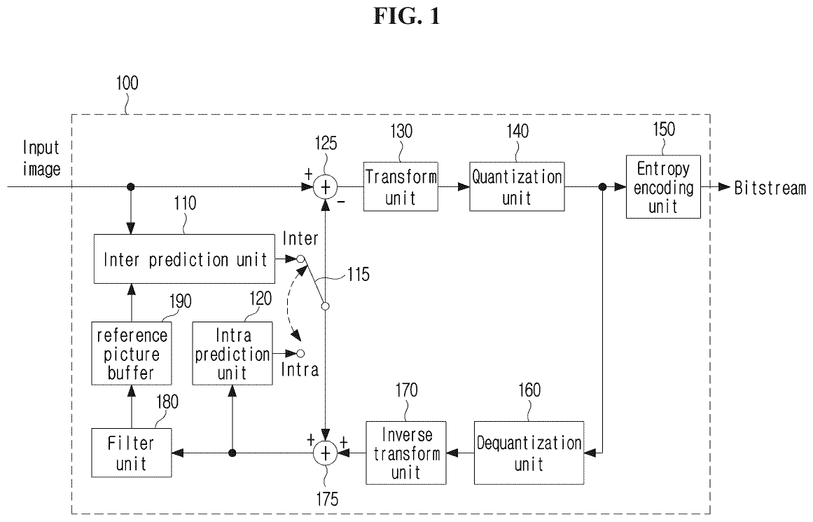

FIG. 1 is a block diagram illustrating the configuration of an embodiment of an encoding apparatus to which the present disclosure is applied.

An encoding apparatus 100 may be an encoder, a video encoding apparatus or an image encoding apparatus. A video may include one or more images. The encoding apparatus 100 may sequentially encode one or more images of the video.

Referring to FIG. 1, the encoding apparatus 100 includes an inter-prediction unit 110, an intra-prediction unit 120, a switch 115, a subtractor 125, a transform unit 130, a quantization unit 140, an entropy encoding unit 150, a dequantization unit 160, an inverse transform unit 170, an adder 175, a filter unit 180 and a reference picture buffer 190.

The encoding apparatus 100 may perform encoding on a target image using an intra mode and/or an inter mode. In other words, a prediction mode for a target block may be one of an intra mode and an inter mode.

Hereinafter, the terms “intra mode”, “intra-prediction mode”, “intra-picture mode” and “intra-picture prediction mode” may be used to have the same meaning, and may be used interchangeably with each other.

Hereinafter, the terms “inter mode”, “inter-prediction mode”, “inter-picture mode” and “inter-picture prediction mode” may be used to have the same meaning, and may be used interchangeably with each other.

Hereinafter, the term “image” may indicate only part of an image, or may indicate a block. Also, the processing of an “image” may indicate sequential processing of multiple blocks.

Further, the encoding apparatus 100 may generate a bitstream, including encoded information, via encoding on the target image, and may output and store the generated bitstream. The generated bitstream may be stored in a computer-readable storage medium and may be streamed through a wired and/or wireless transmission medium.

When the intra mode is used as a prediction mode, the switch 115 may switch to the intra mode. When the inter mode is used as a prediction mode, the switch 115 may switch to the inter mode.

The encoding apparatus 100 may generate a prediction block of a target block. Further, after the prediction block has been generated, the encoding apparatus 100 may encode a residual block for the target block using a residual between the target block and the prediction block.

When the prediction mode is the intra mode, the intra-prediction unit 120 may use pixels of previously encoded/decoded neighbor blocks adjacent to the target block as reference samples. The intra-prediction unit 120 may perform spatial prediction on the target block using the reference samples, and may generate prediction samples for the target block via spatial prediction. The prediction samples may mean samples in the prediction block.

The inter-prediction unit 110 may include a motion prediction unit and a motion compensation unit.

When the prediction mode is an inter mode, the motion prediction unit may search a reference image for the area most closely matching the target block in a motion prediction procedure, and may derive a motion vector for the target block and the found area based on the found area. Here, the motion-prediction unit may use a search range as a target area for searching.

The reference image may be stored in the reference picture buffer 190. More specifically, an encoded and/or decoded reference image may be stored in the reference picture buffer 190 when the encoding and/or decoding of the reference image have been processed.

Since a decoded picture is stored, the reference picture buffer 190 may be a Decoded Picture Buffer (DPB).

The motion compensation unit may generate a prediction block for the target block by performing motion compensation using a motion vector. Here, the motion vector may be a two-dimensional (2D) vector used for inter-prediction. Further, the motion vector may indicate an offset between the target image and the reference image.

The motion prediction unit and the motion compensation unit may generate a prediction block by applying an interpolation filter to a partial area of a reference image when the motion vector has a value other than an integer. In order to perform inter prediction or motion compensation, it may be determined which one of a skip mode, a merge mode, an advanced motion vector prediction (AMVP) mode, and a current picture reference mode corresponds to a method for predicting the motion of a PU included in a CU, based on the CU, and compensating for the motion, and inter prediction or motion compensation may be performed depending on the mode.

The subtractor 125 may generate a residual block, which is the differential between the target block and the prediction block. A residual block may also be referred to as a “residual signal”.

The residual signal may be the difference between an original signal and a prediction signal. Alternatively, the residual signal may be a signal generated by transforming or quantizing the difference between an original signal and a prediction signal or by transforming and quantizing the difference. A residual block may be a residual signal for a block unit.

The transform unit 130 may generate a transform coefficient by transforming the residual block, and may output the generated transform coefficient. Here, the transform coefficient may be a coefficient value generated by transforming the residual block.

The transform unit 130 may use one of multiple predefined transform methods when performing a transform.

The multiple predefined transform methods may include a Discrete Cosine Transform (DCT), a Discrete Sine Transform (DST), a Karhunen-Loeve Transform (KLT), etc.

The transform method used to transform a residual block may be determined depending on at least one of coding parameters for a target block and/or a neighbor block. For example, the transform method may be determined based on at least one of an inter-prediction mode for a PU, an intra-prediction mode for a PU, the size of a TU, and the shape of a TU. Alternatively, transformation information indicating the transform method may be signaled from the encoding apparatus 100 to the decoding apparatus 200.

When a transform skip mode is used, the transform unit 130 may omit transforming the residual block.

By applying quantization to the transform coefficient, a quantized transform coefficient level or a quantized level may be generated. Hereinafter, in the embodiments, each of the quantized transform coefficient level and the quantized level may also be referred to as a ‘transform coefficient’.

The quantization unit 140 may generate a quantized transform coefficient level (i.e., a quantized level or a quantized coefficient) by quantizing the transform coefficient depending on quantization parameters. The quantization unit 140 may output the quantized transform coefficient level that is generated. In this case, the quantization unit 140 may quantize the transform coefficient using a quantization matrix.

The entropy encoding unit 150 may generate a bitstream by performing probability distribution-based entropy encoding based on values, calculated by the quantization unit 140, and/or coding parameter values, calculated in the encoding procedure. The entropy encoding unit 150 may output the generated bitstream.

The entropy encoding unit 150 may perform entropy encoding on information about the pixels of the image and information required to decode the image. For example, the information required to decode the image may include syntax elements or the like.

When entropy encoding is applied, fewer bits may be assigned to more frequently occurring symbols, and more bits may be assigned to rarely occurring symbols. As symbols are represented by means of this assignment, the size of a bit string for target symbols to be encoded may be reduced. Therefore, the compression performance of video encoding may be improved through entropy encoding.

Further, for entropy encoding, the entropy encoding unit 150 may use a coding method such as exponential Golomb, Context-Adaptive Variable Length Coding (CAVLC), or Context-Adaptive Binary Arithmetic Coding (CABAC). For example, the entropy encoding unit 150 may perform entropy encoding using a Variable Length Coding/Code (VLC) table. For example, the entropy encoding unit 150 may derive a binarization method for a target symbol. Further, the entropy encoding unit 150 may derive a probability model for a target symbol/bin. The entropy encoding unit 150 may perform arithmetic coding using the derived binarization method, a probability model, and a context model.

The entropy encoding unit 150 may transform the coefficient of the form of a 2D block into the form of a 1D vector through a transform coefficient scanning method so as to encode a quantized transform coefficient level.

The coding parameters may be information required for encoding and/or decoding. The coding parameters may include information encoded by the encoding apparatus 100 and transferred from the encoding apparatus 100 to a decoding apparatus, and may also include information that may be derived in the encoding or decoding procedure. For example, information transferred to the decoding apparatus may include syntax elements.

The coding parameters may include not only information (or a flag or an index), such as a syntax element, which is encoded by the encoding apparatus and is signaled by the encoding apparatus to the decoding apparatus, but also information derived in an encoding or decoding process. Further, the coding parameters may include information required so as to encode or decode images. For example, the coding parameters may include at least one value, combinations or statistics of a size of a unit/block, a shape/form of a unit/block, a depth of a unit/block, partition information of a unit/block, a partition structure of a unit/block, information indicating whether a unit/block is partitioned in a quad-tree structure, information indicating whether a unit/block is partitioned in a binary tree structure, a partitioning direction of a binary tree structure (horizontal direction or vertical direction), a partitioning form of a binary tree structure (symmetrical partitioning or asymmetrical partitioning), information indicating whether a unit/block is partitioned in a ternary tree structure, a partitioning direction of a ternary tree structure (horizontal direction or vertical direction), a partitioning form of a ternary tree structure (symmetrical partitioning or asymmetrical partitioning, etc.), information indicating whether a unit/block is partitioned in a multi-type tree structure, a combination and a direction (horizontal direction or vertical direction, etc.) of a partitioning of the multi-type tree structure, a partitioning form of a multi-type tree structure (symmetrical partitioning or asymmetrical partitioning, etc.), a partitioning tree (a binary tree or a ternary tree) of the multi-type tree form, a type of a prediction (intra prediction or inter prediction), an intra-prediction mode/direction, an intra luma prediction mode/direction, an intra chroma prediction mode/direction, an intra partitioning information, an inter partitioning information, a coding block partitioning flag, a prediction block partitioning flag, a transform block partitioning flag, a reference sample filtering method, a reference sample filter tap, a reference sample filter coefficient, a prediction block filtering method, a prediction block filter tap, a prediction block filter coefficient, a prediction block boundary filtering method, a prediction block boundary filter tap, a prediction block boundary filter coefficient, an inter-prediction mode, motion information, a motion vector, a motion vector difference, a reference picture index, an inter-prediction direction, an inter-prediction indicator, a prediction list utilization flag, a reference picture list, a reference image, a POC, a motion vector predictor, a motion vector prediction index, a motion vector prediction candidate, a motion vector candidate list, information indicating whether a merge mode is used, a merge index, a merge candidate, a merge candidate list, information indicating whether a skip mode is used, a type of an interpolation filter, a tap of an interpolation filter, a filter coefficient of an interpolation filter, a magnitude of a motion vector, accuracy of motion vector representation, a transform type, a transform size, information indicating whether a first transform is used, information indicating whether an additional (secondary) transform is used, first transform selection information (or a first transform index), secondary transform selection information (or a secondary transform index), information indicating a presence or absence of a residual signal, a coded block pattern, a coded block flag, a quantization parameter, a residual quantization parameter, a quantization matrix, information about an intra-loop filter, information indicating whether an intra-loop filter is applied, a coefficient of an intra-loop filter, a tap of an intra-loop filter, a shape/form of an intra-loop filter, information indicating whether a deblocking filter is applied, a coefficient of a deblocking filter, a tap of a deblocking filter, deblocking filter strength, a shape/form of a deblocking filter, information indicating whether an adaptive sample offset is applied, a value of an adaptive sample offset, a category of an adaptive sample offset, a type of an adaptive sample offset, information indicating whether an adaptive in-loop filter is applied, a coefficient of an adaptive in-loop filter, a tap of an adaptive in-loop filter, a shape/form of an adaptive in-loop filter, a binarization/inverse binarization method, a context model, a context model decision method, a context model update method, information indicating whether a regular mode is performed, information whether a bypass mode is performed, a significant coefficient flag, a last significant coefficient flag, a coding flag for a coefficient group, a position of a last significant coefficient, information indicating whether a value of a coefficient is greater than 1, information indicating whether a value of a coefficient is greater than 2, information indicating whether a value of a coefficient is greater than 3, a remaining coefficient value information, a sign information, a reconstructed luma sample, a reconstructed chroma sample, a context bin, a bypass bin, a residual luma sample, a residual chroma sample, a transform coefficient, a luma transform coefficient, a chroma transform coefficient, a quantized level, a luma quantized level, a chroma quantized level, a transform coefficient level, a transform coefficient level scanning method, a size of a motion vector search region on a side of a decoding apparatus, a shape/form of a motion vector search region on a side of a decoding apparatus, the number of a motion vector search on a side of a decoding apparatus, a size of a CTU, a minimum block size, a maximum block size, a maximum block depth, a minimum block depth, an image display/output order, slice identification information, a slice type, slice partition information, tile group identification information, a tile group type, a tile group partitioning information, tile identification information, a tile type, tile partitioning information, a picture type, bit depth, input sample bit depth, reconstructed sample bit depth, residual sample bit depth, transform coefficient bit depth, quantized level bit depth, information about a luma signal, information about a chroma signal, a color space of a target block and a color space of a residual block. Further, the above-described coding parameter-related information may also be included in the coding parameter. Information used to calculate and/or derive the above-described coding parameter may also be included in the coding parameter. Information calculated or derived using the above-described coding parameter may also be included in the coding parameter.

The first transform selection information may indicate a first transform which is applied to a target block.

The second transform selection information may indicate a second transform which is applied to a target block.

The residual signal may denote the difference between the original signal and a prediction signal. Alternatively, the residual signal may be a signal generated by transforming the difference between the original signal and the prediction signal. Alternatively, the residual signal may be a signal generated by transforming and quantizing the difference between the original signal and the prediction signal. A residual block may be the residual signal for a block.

Here, signaling information may mean that the encoding apparatus 100 includes an entropy-encoded information, generated by performing entropy encoding a flag or an index, in a bitstream, and that the decoding apparatus 200 acquires information by performing entropy decoding on the entropy-encoded information, extracted from the bitstream. Here, the information may comprise a flag, an index, etc.

A signal may mean information to be signaled. Hereinafter, information for an image and a block may be referred to as a signal. Further, hereinafter, the terms “information” and “signal” may be used to have the same meaning and may be used interchangeably with each other. For example, a specific signal may be a signal representing a specific block. An original signal may be a signal representing a target block. A prediction signal may be a signal representing a prediction block. A residual signal may be a signal representing a residual block.

A bitstream may include information based on a specific syntax. The encoding apparatus 100 may generate a bitstream including information depending on a specific syntax. The decoding apparatus 200 may acquire information from the bitstream depending on a specific syntax.

Since the encoding apparatus 100 performs encoding via inter prediction, the encoded target image may be used as a reference image for additional image(s) to be subsequently processed. Therefore, the encoding apparatus 100 may reconstruct or decode the encoded target image and store the reconstructed or decoded image as a reference image in the reference picture buffer 190. For decoding, dequantization and inverse transform on the encoded target image may be processed.

The quantized level may be inversely quantized by the dequantization unit 160, and may be inversely transformed by the inverse transform unit 170. The dequantization unit 160 may generate an inversely quantized coefficient by performing inverse transform for the quantized level. The inverse transform unit 170 may generate a inversely quantized and inversely transformed coefficient by performing inverse transform for the inversely quantized coefficient.

The inversely quantized and inversely transformed coefficient may be added to the prediction block by the adder 175. The inversely quantized and inversely transformed coefficient and the prediction block are added, and then a reconstructed block may be generated. Here, the inversely quantized and/or inversely transformed coefficient may denote a coefficient on which one or more of dequantization and inverse transform are performed, and may also denote a reconstructed residual block. Here, the reconstructed block may mean a recovered block or a decoded block.

The reconstructed block may be subjected to filtering through the filter unit 180. The filter unit 180 may apply one or more of a deblocking filter, a Sample Adaptive Offset (SAO) filter, an Adaptive Loop Filter (ALF), and a Non Local Filter (NLF) to a reconstructed sample, the reconstructed block or a reconstructed picture. The filter unit 180 may also be referred to as an “in-loop filter”.

The deblocking filter may eliminate block distortion occurring at the boundaries between blocks in a reconstructed picture. In order to determine whether to apply the deblocking filter, the number of columns or rows which are included in a block and which include pixel(s) based on which it is determined whether to apply the deblocking filter to a target block may be decided on.

When the deblocking filter is applied to the target block, the applied filter may differ depending on the strength of the required deblocking filtering. In other words, among different filters, a filter decided on in consideration of the strength of deblocking filtering may be applied to the target block. When a deblocking filter is applied to a target block, one or more filters of a long-tap filter, a strong filter, a weak filter and Gaussian filter may be applied to the target block depending on the strength of required deblocking filtering.

Also, when vertical filtering and horizontal filtering are performed on the target block, the horizontal filtering and the vertical filtering may be processed in parallel.

The SAO may add a suitable offset to the values of pixels to compensate for coding error. The SAO may perform, for the image to which deblocking is applied, correction that uses an offset in the difference between an original image and the image to which deblocking is applied, on a pixel basis. To perform an offset correction for an image, a method for dividing the pixels included in the image into a certain number of regions, determining a region to which an offset is to be applied, among the divided regions, and applying an offset to the determined region may be used, and a method for applying an offset in consideration of edge information of each pixel may also be used.

The ALF may perform filtering based on a value obtained by comparing a reconstructed image with an original image. After pixels included in an image have been divided into a predetermined number of groups, filters to be applied to each group may be determined, and filtering may be differentially performed for respective groups. information related to whether to apply an adaptive loop filter may be signaled for each CU. Such information may be signaled for a luma signal. The shapes and filter coefficients of ALFs to be applied to respective blocks may differ for respective blocks. Alternatively, regardless of the features of a block, an ALF having a fixed form may be applied to the block.

A non-local filter may perform filtering based on reconstructed blocks, similar to a target block. A region similar to the target block may be selected from a reconstructed picture, and filtering of the target block may be performed using the statistical properties of the selected similar region. Information about whether to apply a non-local filter may be signaled for a Coding Unit (CU). Also, the shapes and filter coefficients of the non-local filter to be applied to blocks may differ depending on the blocks.

The reconstructed block or the reconstructed image subjected to filtering through the filter unit 180 may be stored in the reference picture buffer 190 as a reference picture. The reconstructed block subjected to filtering through the filter unit 180 may be a part of a reference picture. In other words, the reference picture may be a reconstructed picture composed of reconstructed blocks subjected to filtering through the filter unit 180. The stored reference picture may be subsequently used for inter prediction or a motion compensation.

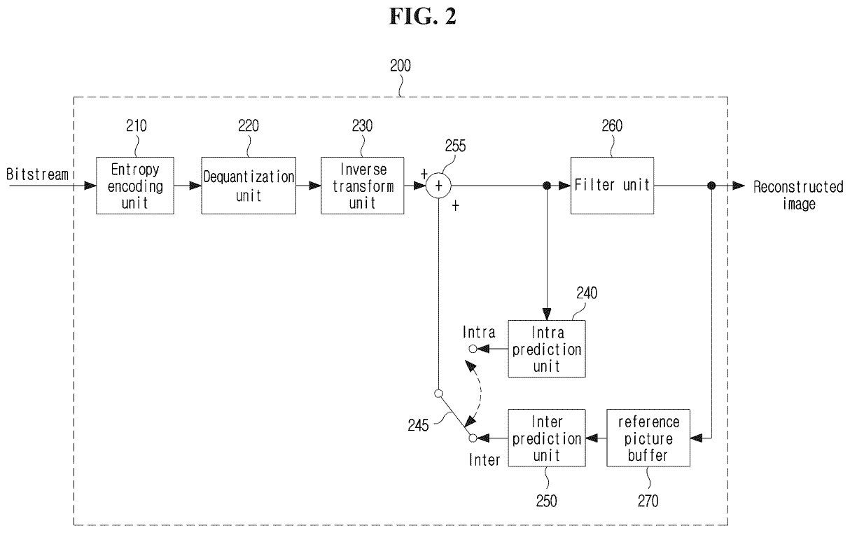

FIG. 2 is a block diagram illustrating the configuration of an embodiment of a decoding apparatus to which the present disclosure is applied.

A decoding apparatus 200 may be a decoder, a video decoding apparatus or an image decoding apparatus.

Referring to FIG. 2, the decoding apparatus 200 may include an entropy decoding unit 210, a dequantization (inverse quantization) unit 220, an inverse transform unit 230, an intra-prediction unit 240, an inter-prediction unit 250, a switch 245 an adder 255, a filter unit 260, and a reference picture buffer 270.

The decoding apparatus 200 may receive a bitstream output from the encoding apparatus 100. The decoding apparatus 200 may receive a bitstream stored in a computer-readable storage medium, and may receive a bitstream that is streamed through a wired/wireless transmission medium.

The decoding apparatus 200 may perform decoding on the bitstream in an intra mode and/or an inter mode. Further, the decoding apparatus 200 may generate a reconstructed image or a decoded image via decoding, and may output the reconstructed image or decoded image.

For example, switching to an intra mode or an inter mode based on the prediction mode used for decoding may be performed by the switch 245. When the prediction mode used for decoding is an intra mode, the switch 245 may be operated to switch to the intra mode. When the prediction mode used for decoding is an inter mode, the switch 245 may be operated to switch to the inter mode.

The decoding apparatus 200 may acquire a reconstructed residual block by decoding the input bitstream, and may generate a prediction block. When the reconstructed residual block and the prediction block are acquired, the decoding apparatus 200 may generate a reconstructed block, which is the target to be decoded, by adding the reconstructed residual block and the prediction block.

The entropy decoding unit 210 may generate symbols by performing entropy decoding on the bitstream based on the probability distribution of a bitstream. The generated symbols may include symbols in a form of a quantized transform coefficient level (i.e., a quantized level or a quantized coefficient). Here, the entropy decoding method may be similar to the above-described entropy encoding method. That is, the entropy decoding method may be the reverse procedure of the above-described entropy encoding method.

The entropy decoding unit 210 may change a coefficient having a one-dimensional (1D) vector form to a 2D block shape through a transform coefficient scanning method in order to decode a quantized transform coefficient level.

For example, the coefficients of the block may be changed to 2D block shapes by scanning the block coefficients using up-right diagonal scanning. Alternatively, which one of up-right diagonal scanning, vertical scanning, and horizontal scanning is to be used may be determined depending on the size and/or the intra-prediction mode of the corresponding block.

The quantized coefficient may be inversely quantized by the dequantization unit 220. The dequantization unit 220 may generate an inversely quantized coefficient by performing dequantization on the quantized coefficient. Further, the inversely quantized coefficient may be inversely transformed by the inverse transform unit 230. The inverse transform unit 230 may generate a reconstructed residual block by performing an inverse transform on the inversely quantized coefficient. As a result of performing dequantization and the inverse transform on the quantized coefficient, the reconstructed residual block may be generated. Here, the dequantization unit 220 may apply a quantization matrix to the quantized coefficient when generating the reconstructed residual block.

When the intra mode is used, the intra-prediction unit 240 may generate a prediction block by performing spatial prediction that uses the pixel values of previously decoded neighbor blocks adjacent to a target block for the target block.

The inter-prediction unit 250 may include a motion compensation unit. Alternatively, the inter-prediction unit 250 may be designated as a “motion compensation unit”.

When the inter mode is used, the motion compensation unit may generate a prediction block by performing motion compensation that uses a motion vector and a reference image stored in the reference picture buffer 270 for the target block.

The motion compensation unit may apply an interpolation filter to a partial area of the reference image when the motion vector has a value other than an integer, and may generate a prediction block using the reference image to which the interpolation filter is applied. In order to perform motion compensation, the motion compensation unit may determine which one of a skip mode, a merge mode, an Advanced Motion Vector Prediction (AMVP) mode, and a current picture reference mode corresponds to the motion compensation method used for a PU included in a CU, based on the CU, and may perform motion compensation depending on the determined mode.

The reconstructed residual block and the prediction block may be added to each other by the adder 255. The adder 255 may generate a reconstructed block by adding the reconstructed residual block to the prediction block.

The reconstructed block may be subjected to filtering through the filter unit 260. The filter unit 260 may apply at least one of a deblocking filter, an SAO filter, an ALF, and a NLF to the reconstructed block or the reconstructed image. The reconstructed image may be a picture including the reconstructed block.

The filter unit may output the reconstructed image.

The reconstructed image and/or the reconstructed block subjected to filtering through the filter unit 260 may be stored as a reference picture in the reference picture buffer 270. The reconstructed block subjected to filtering through the filter unit 260 may be a part of the reference picture. In other words, the reference picture may be an image composed of reconstructed blocks subjected to filtering through the filter unit 260. The stored reference picture may be subsequently used for inter prediction or a motion compensation.

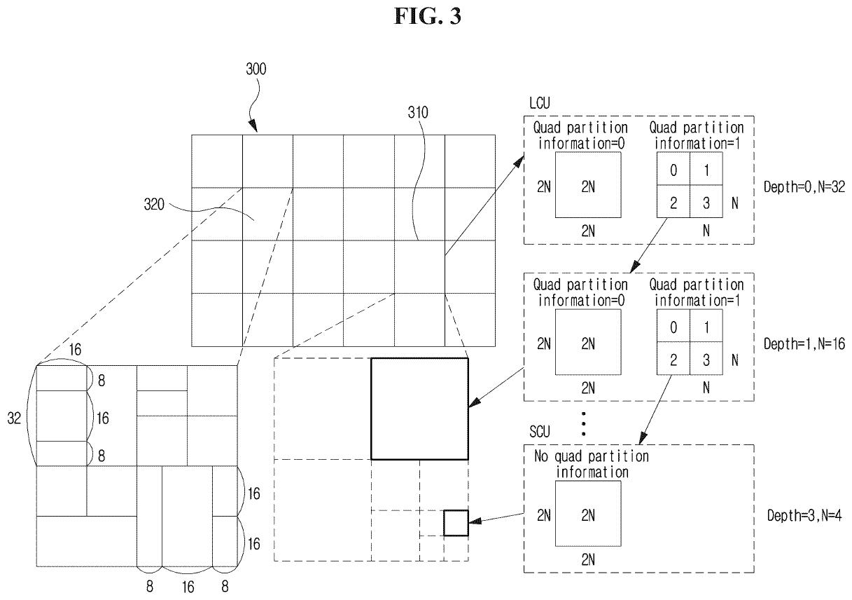

FIG. 3 is a diagram schematically illustrating the partition structure of an image when the image is encoded and decoded.

FIG. 3 may schematically illustrate an example in which a single unit is partitioned into multiple sub-units.

In order to efficiently partition the image, a Coding Unit (CU) may be used in encoding and decoding. The term “unit” may be used to collectively designate 1) a block including image samples and 2) a syntax element. For example, the “partitioning of a unit” may mean the “partitioning of a block corresponding to a unit”.

A CU may be used as a base unit for image encoding/decoding. A CU may be used as a unit to which one mode selected from an intra mode and an inter mode in image encoding/decoding is applied. In other words, in image encoding/decoding, which one of an intra mode and an inter mode is to be applied to each CU may be determined.

Further, a CU may be a base unit in prediction, transform, quantization, inverse transform, dequantization, and encoding/decoding of transform coefficients.

Referring to FIG. 3, an image 300 may be sequentially partitioned into units corresponding to a Largest Coding Unit (LCU), and a partition structure may be determined for each LCU. Here, the LCU may be used to have the same meaning as a Coding Tree Unit (CTU).

The partitioning of a unit may mean the partitioning of a block corresponding to the unit. Block partition information may include depth information about the depth of a unit. The depth information may indicate the number of times the unit is partitioned and/or the degree to which the unit is partitioned. A single unit may be hierarchically partitioned into a plurality of sub-units while having depth information based on a tree structure.

Each of partitioned sub-units may have depth information. The depth information may be information indicating the size of a CU. The depth information may be stored for each CU.

Each CU may have depth information. When the CU is partitioned, CUs resulting from partitioning may have a depth increased from the depth of the partitioned CU by 1.

The partition structure may mean the distribution of Coding Units (CUs) to efficiently encode the image in an LCU 310. Such a distribution may be determined depending on whether a single CU is to be partitioned into multiple CUs. The number of CUs generated by partitioning may be a positive integer of 2 or more, including 2, 3, 4, 8, 16, etc.

The horizontal size and the vertical size of each of CUs generated by the partitioning may be less than the horizontal size and the vertical size of a CU before being partitioned, depending on the number of CUs generated by partitioning. For example, the horizontal size and the vertical size of each of CUs generated by the partitioning may be half of the horizontal size and the vertical size of a CU before being partitioned.

Each partitioned CU may be recursively partitioned into four CUs in the same way. Via the recursive partitioning, at least one of the horizontal size and the vertical size of each partitioned CU may be reduced compared to at least one of the horizontal size and the vertical size of the CU before being partitioned.

The partitioning of a CU may be recursively performed up to a predefined depth or a predefined size.

For example, the depth of a CU may have a value ranging from 0 to 3. The size of the CU may range from a size of 64×64 to a size of 8×8 depending on the depth of the CU.

For example, the depth of an LCU 310 may be 0, and the depth of a Smallest Coding Unit (SCU) may be a predefined maximum depth. Here, as described above, the LCU may be the CU having the maximum coding unit size, and the SCU may be the CU having the minimum coding unit size.

Partitioning may start at the LCU 310, and the depth of a CU may be increased by 1 whenever the horizontal and/or vertical sizes of the CU are reduced by partitioning.

For example, for respective depths, a CU that is not partitioned may have a size of 2N×2N. Further, in the case of a CU that is partitioned, a CU having a size of 2N×2N may be partitioned into four CUs, each having a size of N×N. The value of N may be halved whenever the depth is increased by 1.

Referring to FIG. 3, an LCU having a depth of 0 may have 64×64 pixels or 64×64 blocks. 0 may be a minimum depth. An SCU having a depth of 3 may have 8×8 pixels or 8×8 blocks. 3 may be a maximum depth. Here, a CU having 64×64 blocks, which is the LCU, may be represented by a depth of 0. A CU having 32×32 blocks may be represented by a depth of 1. A CU having 16×16 blocks may be represented by a depth of 2. A CU having 8×8 blocks, which is the SCU, may be represented by a depth of 3.

Information about whether the corresponding CU is partitioned may be represented by the partition information of the CU. The partition information may be 1-bit information. All CUs except the SCU may include partition information. For example, the value of the partition information of a CU that is not partitioned may be a first value. The value of the partition information of a CU that is partitioned may be a second value. When the partition information indicates whether a CU is partitioned or not, the first value may be “0” and the second value may be “1”.

For example, when a single CU is partitioned into four CUs, the horizontal size and vertical size of each of four CUs generated by partitioning may be half the horizontal size and the vertical size of the CU before being partitioned. When a CU having a 32×32 size is partitioned into four CUs, the size of each of four partitioned CUs may be 16×16. When a single CU is partitioned into four CUs, it may be considered that the CU has been partitioned in a quad-tree structure. In other words, it may be considered that a quad-tree partition has been applied to a CU.

For example, when a single CU is partitioned into two CUs, the horizontal size or the vertical size of each of two CUs generated by partitioning may be half the horizontal size or the vertical size of the CU before being partitioned. When a CU having a 32×32 size is vertically partitioned into two CUs, the size of each of two partitioned CUs may be 16×32. When a CU having a 32×32 size is horizontally partitioned into two CUs, the size of each of two partitioned CUs may be 32×16. When a single CU is partitioned into two CUs, it may be considered that the CU has been partitioned in a binary-tree structure. In other words, it may be considered that a binary-tree partition has been applied to a CU.

For example, when a single CU is partitioned (or split) into three CUs, the original CU before being partitioned is partitioned so that the horizontal size or vertical size thereof is divided at a ratio of 1:2:1, thus enabling three sub-CUs to be generated. For example, when a CU having a 16×32 size is horizontally partitioned into three sub-CUs, the three sub-CUs resulting from the partitioning may have sizes of 16×8, 16×16, and 16×8, respectively, in a direction from the top to the bottom. For example, when a CU having a 32×32 size is vertically partitioned into three sub-CUs, the three sub-CUs resulting from the partitioning may have sizes of 8×32, 16×32, and 8×32, respectively, in a direction from the left to the right. When a single CU is partitioned into three CUs, it may be considered that the CU is partitioned in a ternary-tree form. In other words, it may be considered that a ternary-tree partition has been applied to the CU.

Both of quad-tree partitioning and binary-tree partitioning are applied to the LCU 310 of FIG. 3.

In the encoding apparatus 100, a Coding Tree Unit (CTU) having a size of 64×64 may be partitioned into multiple smaller CUs by a recursive quad-tree structure. A single CU may be partitioned into four CUs having the same size. Each CU may be recursively partitioned, and may have a quad-tree structure.

By the recursive partitioning of a CU, an optimal partitioning method that incurs a minimum rate-distortion cost may be selected.

The Coding Tree Unit (CTU) 320 in FIG. 3 is an example of a CTU to which all of a quad-tree partition, a binary-tree partition, and a ternary-tree partition are applied.

As described above, in order to partition a CTU, at least one of a quad-tree partition, a binary-tree partition, and a ternary-tree partition may be applied to the CTU. Partitions may be applied based on specific priority.

For example, a quad-tree partition may be preferentially applied to the CTU. A CU that cannot be partitioned in a quad-tree form any further may correspond to a leaf node of a quad-tree. A CU corresponding to the leaf node of the quad-tree may be a root node of a binary tree and/or a ternary tree. That is, the CU corresponding to the leaf node of the quad-tree may be partitioned in a binary-tree form or a ternary-tree form, or may not be partitioned any further. In this case, each CU, which is generated by applying a binary-tree partition or a ternary-tree partition to the CU corresponding to the leaf node of a quad-tree, is prevented from being subjected again to quad-tree partitioning, thus effectively performing partitioning of a block and/or signaling of block partition information.

The partition of a CU corresponding to each node of a quad-tree may be signaled using quad-partition information. Quad-partition information having a first value (e.g., “1”) may indicate that the corresponding CU is partitioned in a quad-tree form. Quad-partition information having a second value (e.g., “0”) may indicate that the corresponding CU is not partitioned in a quad-tree form. The quad-partition information may be a flag having a specific length (e.g., 1 bit).

Priority may not exist between a binary-tree partition and a ternary-tree partition. That is, a CU corresponding to the leaf node of a quad-tree may be partitioned in a binary-tree form or a ternary-tree form. Also, the CU generated through a binary-tree partition or a ternary-tree partition may be further partitioned in a binary-tree form or a ternary-tree form, or may not be partitioned any further.

Partitioning performed when priority does not exist between a binary-tree partition and a ternary-tree partition may be referred to as a “multi-type tree partition”. That is, a CU corresponding to the leaf node of a quad-tree may be the root node of a multi-type tree. Partitioning of a CU corresponding to each node of the multi-type tree may be signaled using at least one of information indicating whether the CU is partitioned in a multi-type tree, partition direction information, and partition tree information. For partitioning of a CU corresponding to each node of a multi-type tree, information indicating whether partitioning in the multi-type tree is performed, partition direction information, and partition tree information may be sequentially signaled.

For example, information indicating whether a CU is partitioned in a multi-type tree and having a first value (e.g., “1”) may indicate that the corresponding CU is partitioned in a multi-type tree form. Information indicating whether a CU is partitioned in a multi-type tree and having a second value (e.g., “0”) may indicate that the corresponding CU is not partitioned in a multi-type tree form.

When a CU corresponding to each node of a multi-type tree is partitioned in a multi-type tree form, the corresponding CU may further include partition direction information.

The partition direction information may indicate the partition direction of the multi-type tree partition. Partition direction information having a first value (e.g., “1”) may indicate that the corresponding CU is partitioned in a vertical direction. Partition direction information having a second value (e.g., “0”) may indicate that the corresponding CU is partitioned in a horizontal direction.

When a CU corresponding to each node of a multi-type tree is partitioned in a multi-type tree form, the corresponding CU may further include partition-tree information. The partition-tree information may indicate the tree that is used for a multi-type tree partition.

For example, partition-tree information having a first value (e.g., “1”) may indicate that the corresponding CU is partitioned in a binary-tree form. Partition-tree information having a second value (e.g., “0”) may indicate that the corresponding CU is partitioned in a ternary-tree form.

Here, each of the above-described information indicating whether partitioning in the multi-type tree is performed, partition-tree information, and partition direction information may be a flag having a specific length (e.g., 1 bit).

At least one of the above-described quad-partition information, information indicating whether partitioning in the multi-type tree is performed, partition direction information, and partition-tree information may be entropy-encoded and/or entropy-decoded. In order to perform entropy encoding/decoding of such information, information of a neighbor CU adjacent to a target CU may be used.

For example, it may be considered that there is a high probability that the partition form of a left CU and/or an above CU (i.e., partitioning/non-partitioning, a partition tree and/or a partition direction) and the partition form of a target CU will be similar to each other. Therefore, based on the information of a neighbor CU, context information for entropy encoding and/or entropy decoding of the information of the target CU may be derived. Here, the information of the neighbor CU may include at least one of 1) quad-partition information of the neighbor CU, 2) information indicating whether the neighbor CU is partitioned in a multi-type tree, 3) partition direction information of the neighbor CU, and 4) partition-tree information of the neighbor CU.

In another embodiment, of a binary-tree partition and a ternary-tree partition, the binary-tree partition may be preferentially performed. That is, the binary-tree partition may be first applied, and then a CU corresponding to the leaf node of a binary tree may be set to the root node of a ternary tree. In this case, a quad-tree partition or a binary-tree partition may not be performed on the CU corresponding to the node of the ternary tree.

A CU, which is not partitioned any further through a quad-tree partition, a binary-tree partition, and/or a ternary-tree partition, may be the unit of encoding, prediction and/or transform. That is, the CU may not be partitioned any further for prediction and/or transform. Therefore, a partition structure for partitioning the CU into Prediction Units (PUs) and/or Transform Units (TUs), partition information thereof, etc. may not be present in a bitstream.

However, when the size of a CU, which is the unit of partitioning, is greater than the size of a maximum transform block, the CU may be recursively partitioned until the size of the CU becomes less than or equal to the size of the maximum transform block. For example, when the size of a CU is 64×64 and the size of the maximum transform block is 32×32, the CU may be partitioned into four 32×32 blocks so as to perform a transform. For example, when the size of a CU is 32×64 and the size of the maximum transform block is 32×32, the CU may be partitioned into two 32×32 blocks.

In this case, information indicating whether a CU is partitioned for a transform may not be separately signaled. Without signaling, whether a CU is partitioned may be determined via a comparison between the horizontal size (and/or vertical size) of the CU and the horizontal size (and/or vertical size) of the maximum transform block. For example, when the horizontal size of the CU is greater than the horizontal size of the maximum transform block, the CU may be vertically bisected. Further, when the vertical size of the CU is greater than the vertical size of the maximum transform block, the CU may be horizontally bisected.

Information about the maximum size and/or minimum size of a CU and information about the maximum size and/or minimum size of a transform block may be signaled or determined at a level higher than that of the CU. For example, the higher level may be a sequence level, a picture level, a tile level, a tile group level or a slice level. For example, the minimum size of the CU may be set to 4×4. For example, the maximum size of the transform block may be set to 64×64. For example, the maximum size of the transform block may be set to 4×4.

Information about the minimum size of a CU corresponding to the leaf node of a quad-tree (i.e., the minimum size of the quad-tree) and/or information about the maximum depth of a path from the root node to the leaf node of a multi-type tree (i.e., the maximum depth of a multi-type tree) may be signaled or determined at a level higher than that of the CU. For example, the higher level may be a sequence level, a picture level, a slice level, a tile group level or a tile level. Information about the minimum size of a quad-tree and/or information about the maximum depth of a multi-type tree may be separately signaled or determined at each of an intra-slice level and an inter-slice level.

Information about the difference between the size of a CTU and the maximum size of a transform block may be signaled or determined at a level higher than that of a CU. For example, the higher level may be a sequence level, a picture level, a slice level, a tile group level or a tile level. Information about the maximum size of a CU corresponding to each node of a binary tree (i.e., the maximum size of the binary tree) may be determined based on the size and the difference information of a CTU. The maximum size of a CU corresponding to each node of a ternary tree (i.e., the maximum size of the ternary tree) may have different values depending on the type of slice. For example, the maximum size of the ternary tree at an intra-slice level may be 32×32. For example, the maximum size of the ternary tree at an inter-slice level may be 128×128. For example, the minimum size of a CU corresponding to each node of a binary tree (i.e., the minimum size of the binary tree) and/or the minimum size of a CU corresponding to each node of a ternary tree (i.e., the minimum size of the ternary tree) may be set to the minimum size of a CU.

In a further example, the maximum size of a binary tree and/or the maximum size of a ternary tree may be signaled or determined at a slice level. Also, the minimum size of a binary tree and/or the minimum size of a ternary tree may be signaled or determined at a slice level.

Based on the above-described various block sizes and depths, quad-partition information, information indicating whether partitioning in a multi-type tree is performed, partition tree information and/or partition direction information may or may not be present in a bitstream.

For example, when the size of a CU is not greater than the minimum size of a quad-tree, the CU may not include quad-partition information, and quad-partition information of the CU may be inferred as a second value.

For example, when the size of a CU corresponding to each node of a multi-type tree (horizontal size and vertical size) is greater than the maximum size of a binary tree (horizontal size and vertical size) and/or the maximum size of a ternary tree (horizontal size and vertical size), the CU may not be partitioned in a binary-tree form and/or a ternary-tree form. By means of this determination manner, information indicating whether partitioning in a multi-type tree is performed may not be signaled, but may be inferred as a second value.

Alternatively, when the size of a CU corresponding to each node of a multi-type tree (horizontal size and vertical size) is equal to the minimum size of a binary tree (horizontal size and vertical size), or when the size of a CU (horizontal size and vertical size) is equal to twice the minimum size of a ternary tree (horizontal size and vertical size), the CU may not be partitioned in a binary tree form and/or a ternary tree form. By means of this determination manner, information indicating whether partitioning in a multi-type tree is performed may not be signaled, but may be inferred as a second value. The reason for this is that, when a CU is partitioned in a binary tree form and/or a ternary tree form, a CU smaller than the minimum size of the binary tree and/or the minimum size of the ternary tree is generated.

Alternatively, a binary-tree partition or a ternary-tree partition may be limited based on the size of a virtual pipeline data unit (i.e., the size of a pipeline buffer). For example, when a CU is partitioned into sub-CUs unsuitable for the size of a pipeline buffer through a binary-tree partition or a ternary-tree partition, a binary-tree partition or a ternary-tree partition may be limited. The size of the pipeline buffer may be equal to the maximum size of a transform block (e.g., 64×64).

For example, when the size of the pipeline buffer is 64×64, the following partitions may be limited.
Ternary-tree partition for N×M CU (where N and/or M are 128)
Horizontal binary-tree partition for 128×N CU (where N<=64)
Vertical binary-tree partition for N×128 CU (where N<=64)

Alternatively, when the depth of a CU corresponding to each node of a multi-type tree is equal to the maximum depth of the multi-type tree, the CU may not be partitioned in a binary-tree form and/or a ternary-tree form. By means of this determination manner, information indicating whether partitioning in a multi-type tree is performed may not be signaled, but may be inferred as a second value.

Alternatively, information indicating whether partitioning in a multi-type tree is performed may be signaled only when at least one of a vertical binary-tree partition, a horizontal binary-tree partition, a vertical ternary-tree partition, and a horizontal ternary-tree partition is possible for a CU corresponding to each node of a multi-type tree. Otherwise, the CU may not be partitioned in a binary-tree form and/or a ternary-tree form. By means of this determination manner, information indicating whether partitioning in a multi-type tree is performed may not be signaled, but may be inferred as a second value.

Alternatively, partition direction information may be signaled only when both a vertical binary-tree partition and a horizontal binary-tree partition are possible or only when both a vertical ternary-tree partition and a horizontal ternary-tree partition are possible, for a CU corresponding to each node of a multi-type tree. Otherwise, the partition direction information may not be signaled, but may be inferred as a value indicating the direction in which the CU can be partitioned.

Alternatively, partition tree information may be signaled only when both a vertical binary-tree partition and a vertical ternary-tree partition are possible or only when both a horizontal binary-tree partition and a horizontal ternary-tree partition are possible, for a CU corresponding to each node of a multi-type tree. Otherwise, the partition tree information may not be signaled, but may be inferred as a value indicating a tree that can be applied to the partition of the CU.

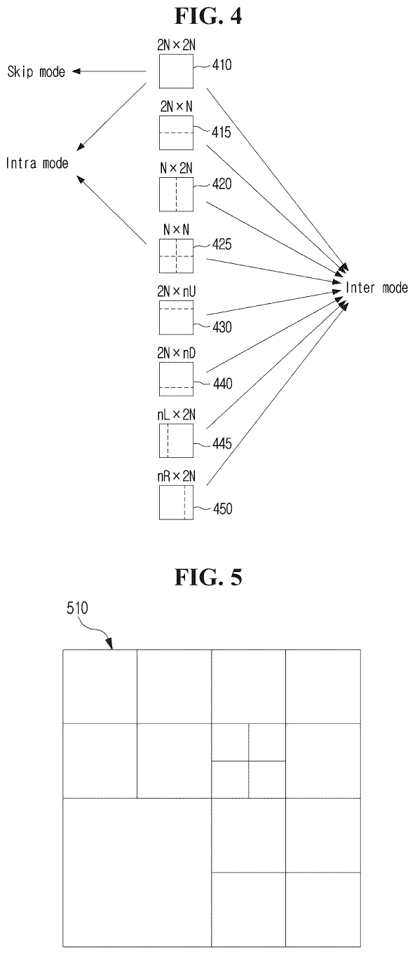

FIG. 4 is a diagram illustrating the form of a Prediction Unit that a Coding Unit can include.

Among CUs partitioned from a LCU, a CU, which is not partitioned any further, may be divided into one or more Prediction Units (PUs).

A PU may be a base unit for prediction. A PU may be encoded and decoded in any one of a skip mode, an inter mode, and an intra mode. A PU may be partitioned into various shapes depending on respective modes. For example, the target block, described above with reference to FIG. 1, and the target block, described above with reference to FIG. 2, may each be a PU.

A CU may not be split into PUs. When the CU is not split into PUs, the size of the CU and the size of a PU may be equal to each other.

In a skip mode, partitioning may not be present in a CU. In the skip mode, a 2N×2N mode 410, in which the sizes of a PU and a CU are identical to each other, may be supported without partitioning.

In an inter mode, 8 types of partition shapes may be present in a CU. For example, in the inter mode, the 2N×2N mode 410, a 2N×N mode 415, an N×2N mode 420, an N×N mode 425, a 2N×nU mode 430, a 2N×nD mode 435, an nL×2N mode 440, and an nR×2N mode 445 may be supported.

In an intra mode, the 2N×2N mode 410 and the N×N mode 425 may be supported.

In the 2N×2N mode 410, a PU having a size of 2N×2N may be encoded. The PU having a size of 2N×2N may mean a PU having a size identical to that of the CU. For example, the PU having a size of 2N×2N may have a size of 64×64, 32×32, 16×16 or 8×8.

In the N×N mode 425, a PU having a size of N×N may be encoded.

For example, in intra prediction, when the size of a PU is 8×8, four partitioned PUs may be encoded. The size of each partitioned PU may be 4×4.

When a PU is encoded in an intra mode, the PU may be encoded using any one of multiple intra-prediction modes. For example, HEVC technology may provide 35 intra-prediction modes, and the PU may be encoded in any one of the 35 intra-prediction modes.

Which one of the 2N×2N mode 410 and the N×N mode 425 is to be used to encode the PU may be determined based on rate-distortion cost.

The encoding apparatus 100 may perform an encoding operation on a PU having a size of 2N×2N. Here, the encoding operation may be the operation of encoding the PU in each of multiple intra-prediction modes that can be used by the encoding apparatus 100. Through the encoding operation, the optimal intra-prediction mode for a PU having a size of 2N×2N may be derived. The optimal intra-prediction mode may be an intra-prediction mode in which a minimum rate-distortion cost occurs upon encoding the PU having a size of 2N×2N, among multiple intra-prediction modes that can be used by the encoding apparatus 100.

Further, the encoding apparatus 100 may sequentially perform an encoding operation on respective PUs obtained from N×N partitioning. Here, the encoding operation may be the operation of encoding a PU in each of multiple intra-prediction modes that can be used by the encoding apparatus 100. By means of the encoding operation, the optimal intra-prediction mode for the PU having a size of N×N may be derived. The optimal intra-prediction mode may be an intra-prediction mode in which a minimum rate-distortion cost occurs upon encoding the PU having a size of N×N, among multiple intra-prediction modes that can be used by the encoding apparatus 100.

The encoding apparatus 100 may determine which of a PU having a size of 2N×2N and PUs having sizes of N×N to be encoded based on a comparison of a rate-distortion cost of the PU having a size of 2N×2N and a rate-distortion costs of the PUs having sizes of N×N.

A single CU may be partitioned into one or more PUs, and a PU may be partitioned into multiple PUs.

For example, when a single PU is partitioned into four PUs, the horizontal size and vertical size of each of four PUs generated by partitioning may be half the horizontal size and the vertical size of the PU before being partitioned. When a PU having a 32×32 size is partitioned into four PUs, the size of each of four partitioned PUs may be 16×16. When a single PU is partitioned into four PUs, it may be considered that the PU has been partitioned in a quad-tree structure.

For example, when a single PU is partitioned into two PUs, the horizontal size or the vertical size of each of two PUs generated by partitioning may be half the horizontal size or the vertical size of the PU before being partitioned. When a PU having a 32×32 size is vertically partitioned into two PUs, the size of each of two partitioned PUs may be 16×32. When a PU having a 32×32 size is horizontally partitioned into two PUs, the size of each of two partitioned PUs may be 32×16. When a single PU is partitioned into two PUs, it may be considered that the PU has been partitioned in a binary-tree structure.

FIG. 5 is a diagram illustrating the form of a Transform Unit that can be included in a Coding Unit.

A Transform Unit (TU) may have a base unit that is used for a procedure, such as transform, quantization, inverse transform, dequantization, entropy encoding, and entropy decoding, in a CU.

A TU may have a square shape or a rectangular shape. A shape of a TU may be determined based on a size and/or a shape of a CU.

Among CUs partitioned from the LCU, a CU which is not partitioned into CUs any further may be partitioned into one or more TUs. Here, the partition structure of a TU may be a quad-tree structure. For example, as shown in FIG. 5, a single CU 510 may be partitioned one or more times depending on the quad-tree structure. By means of this partitioning, the single CU 510 may be composed of TUs having various sizes.

It can be considered that when a single CU is split two or more times, the CU is recursively split. Through splitting, a single CU may be composed of Transform Units (TUs) having various sizes.

Alternatively, a single CU may be split into one or more TUs based on the number of vertical lines and/or horizontal lines that split the CU.

A CU may be split into symmetric TUs or asymmetric TUs. For splitting into asymmetric TUs, information about the size and/or shape of each TU may be signaled from the encoding apparatus 100 to the decoding apparatus 200. Alternatively, the size and/or shape of each TU may be derived from information about the size and/or shape of the CU.

A CU may not be split into TUs. When the CU is not split into TUs, the size of the CU and the size of a TU may be equal to each other.

A single CU may be partitioned into one or more TUs, and a TU may be partitioned into multiple TUs.

For example, when a single TU is partitioned into four TUs, the horizontal size and vertical size of each of four TUs generated by partitioning may be half the horizontal size and the vertical size of the TU before being partitioned. When a TU having a 32×32 size is partitioned into four TUs, the size of each of four partitioned TUs may be 16×16. When a single TU is partitioned into four TUs, it may be considered that the TU has been partitioned in a quad-tree structure.

For example, when a single TU is partitioned into two TUs, the horizontal size or the vertical size of each of two TUs generated by partitioning may be half the horizontal size or the vertical size of the TU before being partitioned. When a TU having a 32×32 size is vertically partitioned into two TUs, the size of each of two partitioned TUs may be 16×32. When a TU having a 32×32 size is horizontally partitioned into two TUs, the size of each of two partitioned TUs may be 32×16. When a single TU is partitioned into two TUs, it may be considered that the TU has been partitioned in a binary-tree structure.

In a way differing from that illustrated in FIG. 5, a CU may be split.

For example, a single CU may be split into three CUs. The horizontal sizes or vertical sizes of the three CUs generated from splitting may be ¼, ½, and ¼, respectively, of the horizontal size or vertical size of the original CU before being split.

For example, when a CU having a 32×32 size is vertically split into three CUs, the sizes of the three CUs generated from the splitting may be 8×32, 16×32, and 8×32, respectively. In this way, when a single CU is split into three CUs, it may be considered that the CU is split in the form of a ternary tree.

One of exemplary splitting forms, that is, quad-tree splitting, binary tree splitting, and ternary tree splitting, may be applied to the splitting of a CU, and multiple splitting schemes may be combined and used together for splitting of a CU. Here, the case where multiple splitting schemes are combined and used together may be referred to as “complex tree-format splitting”.

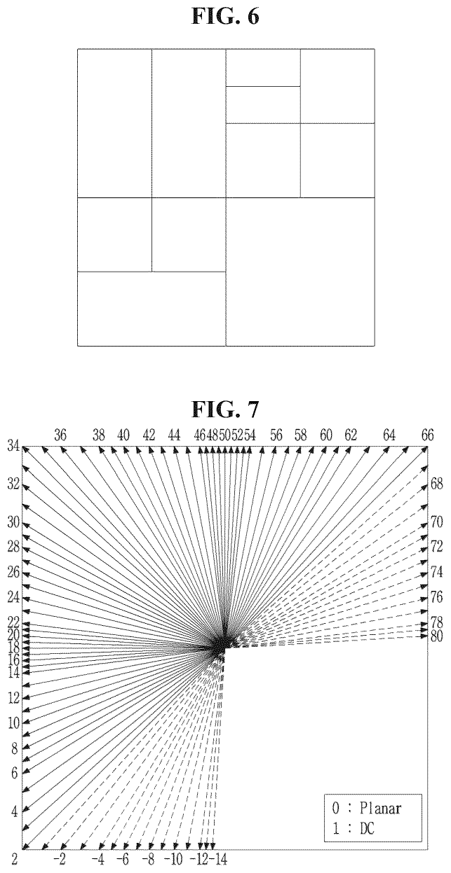

FIG. 6 illustrates the splitting of a block according to an example.

In a video encoding and/or decoding process, a target block may be split, as illustrated in FIG. 6. For example, the target block may be a CU.

For splitting of the target block, an indicator indicating split information may be signaled from the encoding apparatus 100 to the decoding apparatus 200. The split information may be information indicating how the target block is split.

The split information may be one or more of a split flag (hereinafter referred to as “split flag”), a quad-binary flag (hereinafter referred to as “QB_flag”), a quad-tree flag (hereinafter referred to as “quadtree_flag”), a binary tree flag (hereinafter referred to as “binarytree_flag”), and a binary type flag (hereinafter referred to as “Btype_flag”).

“split_flag” may be a flag indicating whether a block is split. For example, a split_flag value of 1 may indicate that the corresponding block is split. A split_flag value of 0 may indicate that the corresponding block is not split.

“QB_flag” may be a flag indicating which one of a quad-tree form and a binary tree form corresponds to the shape in which the block is split. For example, a QB_flag value of 0 may indicate that the block is split in a quad-tree form. A QB_flag value of 1 may indicate that the block is split in a binary tree form. Alternatively, a QB_flag value of 0 may indicate that the block is split in a binary tree form. A QB_flag value of 1 may indicate that the block is split in a quad-tree form.

“quadtree_flag” may be a flag indicating whether a block is split in a quad-tree form. For example, a quadtree_flag value of 1 may indicate that the block is split in a quad-tree form. A quadtree_flag value of 0 may indicate that the block is not split in a quad-tree form.

“binarytree_flag” may be a flag indicating whether a block is split in a binary tree form. For example, a binarytree_flag value of 1 may indicate that the block is split in a binary tree form. A binarytree_flag value of 0 may indicate that the block is not split in a binary tree form.

“Btype_flag” may be a flag indicating which one of a vertical split and a horizontal split corresponds to a split direction when a block is split in a binary tree form. For example, a Btype_flag value of 0 may indicate that the block is split in a horizontal direction. A Btype_flag value of 1 may indicate that a block is split in a vertical direction. Alternatively, a Btype_flag value of 0 may indicate that the block is split in a vertical direction. A Btype_flag value of 1 may indicate that a block is split in a horizontal direction.

For example, the split information of the block in FIG. 6 may be derived by signaling at least one of quadtree_flag, binarytree_flag, and Btype_flag, as shown in the following Table 1.

TABLE 1

| quadtree_flag | binarytree_flag | Btype_flag |
|---|---|---|
| 1 | | |
| 0 | | |
| | 1 | |
| | | 1 |
| | 0 | |
| | 0 | |
| 1 | | |
| 0 | | |
| | 1 | |
| | | 0 |
| | 0 | |
| | 0 | |
| 0 | | |
| | 0 | |
| 0 | | |
| | 0 | |
| 0 | | |
| | 0 | |
| 0 | | |
| | 1 | |
| | | 0 |
| | 1 | |
| | | 1 |
| | 0 | |
| | 0 | |
| | 0 | |
| 0 | | |
| | 0 | |

For example, the split information of the block in FIG. 6 may be derived by signaling at least one of split_flag, QB_flag and Btype_flag, as shown in the following Table 2.

TABLE 2

| split_flag | QB_flag | Btype_flag |
|---|---|---|
| 1 | | |
| | 0 | |
| 1 | | |
| | 1 | |
| | | 1 |
| 0 | | |
| 0 | | |
| 1 | | |
| | 0 | |
| 1 | | |
| | 1 | |
| | | 0 |
| 0 | | |
| 0 | | |
| 0 | | |
| 0 | | |
| 0 | | |
| 1 | | |
| | 1 | |
| | | 0 |
| 1 | | |
| | | 1 |
| 0 | | |
| 0 | | |
| 0 | | |
| 0 | | |

The splitting method may be limited only to a quad-tree or to a binary tree depending on the size and/or shape of the block. When this limitation is applied, split_flag may be a flag indicating whether a block is split in a quad-tree form or a flag indicating whether a block is split in a binary tree form. The size and shape of a block may be derived depending on the depth information of the block, and the depth information may be signaled from the encoding apparatus 100 to the decoding apparatus 200.

When the size of a block falls within a specific range, only splitting in a quad-tree form may be possible. For example, the specific range may be defined by at least one of a maximum block size and a minimum block size at which only splitting in a quad-tree form is possible.

Information indicating the maximum block size and the minimum block size at which only splitting in a quad-tree form is possible may be signaled from the encoding apparatus 100 to the decoding apparatus 200 through a bitstream. Further, this information may be signaled for at least one of units such as a video, a sequence, a picture, a parameter, a tile group, and a slice (or a segment).

Alternatively, the maximum block size and/or the minimum block size may be fixed sizes predefined by the encoding apparatus 100 and the decoding apparatus 200. For example, when the size of a block is above 64×64 and below 256×256, only splitting in a quad-tree form may be possible. In this case, split_flag may be a flag indicating whether splitting in a quad-tree form is performed.

When the size of a block is greater than the maximum size of a transform block, only partitioning in a quad-tree form may be possible. Here, a sub-block resulting from partitioning may be at least one of a CU and a TU.

In this case, split_flag may be a flag indicating whether a CU is partitioned in a quad-tree form.

When the size of a block falls within the specific range, only splitting in a binary tree form or a ternary tree form may be possible. For example, the specific range may be defined by at least one of a maximum block size and a minimum block size at which only splitting in a binary tree form or a ternary tree form is possible.

Information indicating the maximum block size and/or the minimum block size at which only splitting in a binary tree form or splitting in a ternary tree form is possible may be signaled from the encoding apparatus 100 to the decoding apparatus 200 through a bitstream. Further, this information may be signaled for at least one of units such as a sequence, a picture, and a slice (or a segment).

Alternatively, the maximum block size and/or the minimum block size may be fixed sizes predefined by the encoding apparatus 100 and the decoding apparatus 200. For example, when the size of a block is above 8×8 and below 16×16, only splitting in a binary tree form may be possible. In this case, split_flag may be a flag indicating whether splitting in a binary tree form or a ternary tree form is performed.

The above description of partitioning in a quad-tree form may be equally applied to a binary-tree form and/or a ternary-tree form.

The partition of a block may be limited by a previous partition. For example, when a block is partitioned in a specific binary-tree form and then multiple sub-blocks are generated from the partitioning, each sub-block may be additionally partitioned only in a specific tree form. Here, the specific tree form may be at least one of a binary-tree form, a ternary-tree form, and a quad-tree form.

When the horizontal size or vertical size of a partition block is a size that cannot be split further, the above-described indicator may not be signaled.

FIG. 7 is a diagram for explaining an embodiment of an intra-prediction process.

Arrows radially extending from the center of the graph in FIG. 7 indicate the prediction directions of intra-prediction modes. Further, numbers appearing near the arrows indicate examples of mode values assigned to intra-prediction modes or to the prediction directions of the intra-prediction modes.

In FIG. 7, A number 0 may represent a Planar mode which is a non-directional intra prediction mode. A number 1 may represent a DC mode which is a non-directional intra prediction mode.

Intra encoding and/or decoding may be performed using a reference sample of neighbor block of a target block. The neighbor block may be a reconstructed neighbor block. The reference sample may mean a neighbor sample.

For example, intra encoding and/or decoding may be performed using the value of a reference sample which are included in are reconstructed neighbor block or the coding parameters of the reconstructed neighbor block.

The encoding apparatus 100 and/or the decoding apparatus 200 may generate a prediction block by performing intra prediction on a target block based on information about samples in a target image. When intra prediction is performed, the encoding apparatus 100 and/or the decoding apparatus 200 may generate a prediction block for the target block by performing intra prediction based on information about samples in the target image. When intra prediction is performed, the encoding apparatus 100 and/or the decoding apparatus 200 may perform directional prediction and/or non-directional prediction based on at least one reconstructed reference sample.

A prediction block may be a block generated as a result of performing intra prediction. A prediction block may correspond to at least one of a CU, a PU, and a TU.

The unit of a prediction block may have a size corresponding to at least one of a CU, a PU, and a TU. The prediction block may have a square shape having a size of 2N×2N or N×N. The size of N×N may include sizes of 4×4, 8×8, 16×16, 32×32, 64×64, or the like.

Alternatively, a prediction block may a square block having a size of 2×2, 4×4, 8×8, 16×16, 32×32, 64×64 or the like or a rectangular block having a size of 2×8, 4×8, 2×16, 4×16, 8×16, or the like.

Intra prediction may be performed in consideration of the intra-prediction mode for the target block. The number of intra-prediction modes that the target block can have may be a predefined fixed value, and may be a value determined differently depending on the attributes of a prediction block. For example, the attributes of the prediction block may include the size of the prediction block, the type of prediction block, etc. Further, the attribute of a prediction block may indicate a coding parameter for the prediction block.

For example, the number of intra-prediction modes may be fixed at N regardless of the size of a prediction block. Alternatively, the number of intra-prediction modes may be, for example, 3, 5, 9, 17, 34, 35, 36, 65, 67 or 95.

The intra-prediction modes may be non-directional modes or directional modes.

For example, the intra-prediction modes may include two non-directional modes and 65 directional modes corresponding to numbers 0 to 66 illustrated in FIG. 7.

For example, the specified intra-prediction method is used, an intra prediction mode may include two non-directional modes and 93 directional modes corresponding to numbers −14 to 80 illustrated in FIG. 7.

The two non-directional modes may include a DC mode and a planar mode.

A directional mode may be a prediction mode having a specific direction or a specific angle. The directional mode may also be referred to as an “angular mode”.

An intra-prediction mode may be represented by at least one of a mode number, a mode value, a mode angle, and a mode direction. In other words, the terms “(mode) number of the intra-prediction mode”, “(mode) value of the intra-prediction mode”, “(mode) angle of the intra-prediction mode”, and “(mode) direction of the intra-prediction mode” may be used to have the same meaning, and may be used interchangeably with each other.

The number of intra-prediction modes may be M. The value of M may be 1 or more. In other words, the number of intra-prediction modes may be M, which includes the number of non-directional modes and the number of directional modes.

The number of intra-prediction modes may be fixed to M regardless of the size and/or the color component of a block. For example, the number of intra-prediction modes may be fixed at any one of 35 and 67 regardless of the size of a block.

Alternatively, the number of intra-prediction modes may differ depending on the shape, the size and/or the type of the color component of a block.

For example, in FIG. 7, directional prediction modes illustrated as dashed lines may be applied only for a prediction for a non-square block.

For example, the larger the size of the block, the greater the number of intra-prediction modes. Alternatively, the larger the size of the block, the smaller the number of intra-prediction modes. When the size of the block is 4×4 or 8×8, the number of intra-prediction modes may be 67. When the size of the block is 16×16, the number of intra-prediction modes may be 35. When the size of the block is 32×32, the number of intra-prediction modes may be 19. When the size of a block is 64×64, the number of intra-prediction modes may be 7.

For example, the number of intra prediction modes may differ depending on whether a color component is a luma signal or a chroma signal. Alternatively, the number of intra-prediction modes corresponding to a luma component block may be greater than the number of intra-prediction modes corresponding to a chroma component block.

For example, in a vertical mode having a mode value of 50, prediction may be performed in a vertical direction based on the pixel value of a reference sample. For example, in a horizontal mode having a mode value of 18, prediction may be performed in a horizontal direction based on the pixel value of a reference sample.

Even in directional modes other than the above-described mode, the encoding apparatus 100 and the decoding apparatus 200 may perform intra prediction on a target unit using reference samples depending on angles corresponding to the directional modes.

Intra-prediction modes located on a right side with respect to the vertical mode may be referred to as ‘vertical-right modes’. Intra-prediction modes located below the horizontal mode may be referred to as ‘horizontal-below modes’. For example, in FIG. 7, the intra-prediction modes in which a mode value is one of 51, 52, 53, 54, 55, 56, 57, 58, 59, 60, 61, 62, 63, 64, 65, and 66 may be vertical-right modes. Intra-prediction modes in which a mode value is one of 2, 3, 4, 5, 6, 7, 8, 9, 10, 11, 12, 13, 14, 15, 16, and 17 may be horizontal-below modes.

The non-directional mode may include a DC mode and a planar mode. For example, a value of the DC mode may be 1. A value of the planar mode may be 0.

The directional mode may include an angular mode. Among the plurality of the intra prediction modes, remaining modes except for the DC mode and the planar mode may be directional modes.

When the intra-prediction mode is a DC mode, a prediction block may be generated based on the average of pixel values of a plurality of reference pixels. For example, a value of a pixel of a prediction block may be determined based on the average of pixel values of a plurality of reference pixels.

The number of above-described intra-prediction modes and the mode values of respective intra-prediction modes are merely exemplary. The number of above-described intra-prediction modes and the mode values of respective intra-prediction modes may be defined differently depending on the embodiments, implementation and/or requirements.

In order to perform intra prediction on a target block, the step of checking whether samples included in a reconstructed neighbor block can be used as reference samples of a target block may be performed. When a sample that cannot be used as a reference sample of the target block is present among samples in the neighbor block, a value generated via copying and/or interpolation that uses at least one sample value, among the samples included in the reconstructed neighbor block, may replace the sample value of the sample that cannot be used as the reference sample. When the value generated via copying and/or interpolation replaces the sample value of the existing sample, the sample may be used as the reference sample of the target block.

When intra prediction is used, a filter may be applied to at least one of a reference sample and a prediction sample based on at least one of the intra-prediction mode and the size of the target block.

The type of filter to be applied to at least one of a reference sample and a prediction sample may differ depending on at least one of the intra-prediction mode of a target block, the size of the target block, and the shape of the target block. The types of filters may be classified depending on one or more of the length of filter tap, the value of a filter coefficient, and filter strength. The length of filter tap may mean the number of filter taps. Also, the number of filter tap may mean the length of the filter.

When the intra-prediction mode is a planar mode, a sample value of a prediction target block may be generated using a weighted sum of an above reference sample of the target block, a left reference sample of the target block, an above-right reference sample of the target block, and a below-left reference sample of the target block depending on the location of the prediction target sample in the prediction block when the prediction block of the target block is generated.

When the intra-prediction mode is a DC mode, the average of reference samples above the target block and the reference samples to the left of the target block may be used when the prediction block of the target block is generated. Also, filtering using the values of reference samples may be performed on specific rows or specific columns in the target block. The specific rows may be one or more upper rows adjacent to the reference sample. The specific columns may be one or more left columns adjacent to the reference sample.

When the intra-prediction mode is a directional mode, a prediction block may be generated using the above reference samples, left reference samples, above-right reference sample and/or below-left reference sample of the target block.

In order to generate the above-described prediction sample, real-number-based interpolation may be performed.

The intra-prediction mode of the target block may be predicted from intra prediction mode of a neighbor block adjacent to the target block, and the information used for prediction may be entropy-encoded/decoded.

For example, when the intra-prediction modes of the target block and the neighbor block are identical to each other, it may be signaled, using a predefined flag, that the intra-prediction modes of the target block and the neighbor block are identical.

For example, an indicator for indicating an intra-prediction mode identical to that of the target block, among intra-prediction modes of multiple neighbor blocks, may be signaled.

When the intra-prediction modes of the target block and a neighbor block are different from each other, information about the intra-prediction mode of the target block may be encoded and/or decoded using entropy encoding and/or decoding.

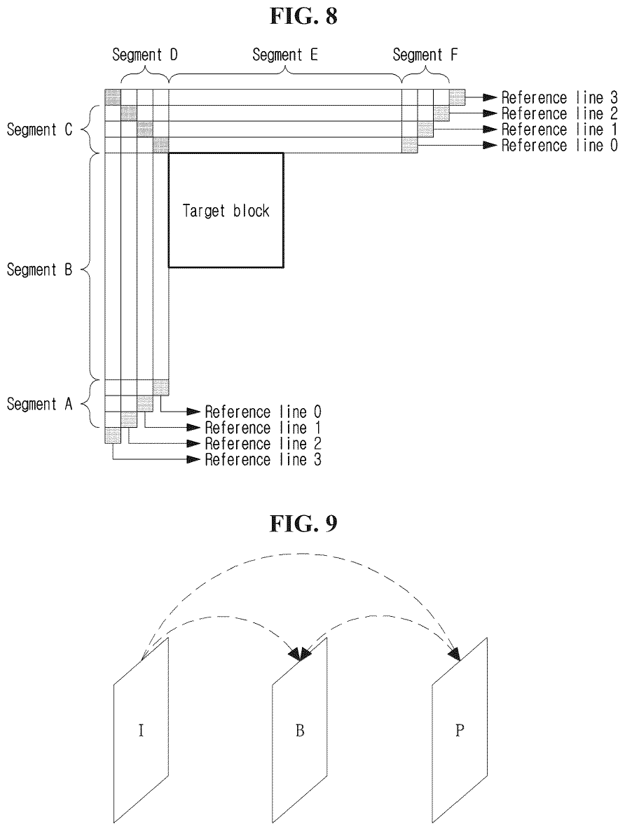

FIG. 8 is a diagram illustrating reference samples used in an intra-prediction procedure.

Reconstructed reference samples used for intra prediction of the target block may include below-left reference samples, left reference samples, an above-left corner reference sample, above reference samples, and above-right reference samples.

For example, the left reference samples may mean reconstructed reference pixels adjacent to the left side of the target block. The above reference samples may mean reconstructed reference pixels adjacent to the top of the target block. The above-left corner reference sample may mean a reconstructed reference pixel located at the above-left corner of the target block. The below-left reference samples may mean reference samples located below a left sample line composed of the left reference samples, among samples located on the same line as the left sample line. The above-right reference samples may mean reference samples located to the right of an above sample line composed of the above reference samples, among samples located on the same line as the above sample line.

When the size of a target block is N×N, the numbers of the below-left reference samples, the left reference samples, the above reference samples, and the above-right reference samples may each be N.

By performing intra prediction on the target block, a prediction block may be generated. The generation of the prediction block may include the determination of the values of pixels in the prediction block. The sizes of the target block and the prediction block may be equal.

The reference samples used for intra prediction of the target block may vary depending on the intra-prediction mode of the target block. The direction of the intra-prediction mode may represent a dependence relationship between the reference samples and the pixels of the prediction block. For example, the value of a specified reference sample may be used as the values of one or more specified pixels in the prediction block. In this case, the specified reference sample and the one or more specified pixels in the prediction block may be the sample and pixels which are positioned in a straight line in the direction of an intra-prediction mode. In other words, the value of the specified reference sample may be copied as the value of a pixel located in a direction reverse to the direction of the intra-prediction mode. Alternatively, the value of a pixel in the prediction block may be the value of a reference sample located in the direction of the intra-prediction mode with respect to the location of the pixel.

In an example, when the intra-prediction mode of a target block is a vertical mode, the above reference samples may be used for intra prediction. When the intra-prediction mode is the vertical mode, the value of a pixel in the prediction block may be the value of a reference sample vertically located above the location of the pixel. Therefore, the above reference samples adjacent to the top of the target block may be used for intra prediction. Furthermore, the values of pixels in one row of the prediction block may be identical to those of the above reference samples.

In an example, when the intra-prediction mode of a target block is a horizontal mode, the left reference samples may be used for intra prediction. When the intra-prediction mode is the horizontal mode, the value of a pixel in the prediction block may be the value of a reference sample horizontally located left to the location of the pixel. Therefore, the left reference samples adjacent to the left of the target block may be used for intra prediction. Furthermore, the values of pixels in one column of the prediction block may be identical to those of the left reference samples.

In an example, when the mode value of the intra-prediction mode of the current block is 34, at least some of the left reference samples, the above-left corner reference sample, and at least some of the above reference samples may be used for intra prediction. When the mode value of the intra-prediction mode is 34, the value of a pixel in the prediction block may be the value of a reference sample diagonally located at the above-left corner of the pixel.

Further, At least a part of the above-right reference samples may be used for intra prediction in a case that an intra prediction mode of which a mode value is a value ranging from 52 to 66.

Further, At least a part of the below-left reference samples may be used for intra prediction in a case that an intra prediction mode of which a mode value is a value ranging from 2 to 17.

Further, the above-left corner reference sample may be used for intra prediction in a case that an intra prediction mode of which a mode value is a value ranging from 19 to 49.

The number of reference samples used to determine the pixel value of one pixel in the prediction block may be either 1, or 2 or more.

As described above, the pixel value of a pixel in the prediction block may be determined depending on the location of the pixel and the location of a reference sample indicated by the direction of the intra-prediction mode. When the location of the pixel and the location of the reference sample indicated by the direction of the intra-prediction mode are integer positions, the value of one reference sample indicated by an integer position may be used to determine the pixel value of the pixel in the prediction block.

When the location of the pixel and the location of the reference sample indicated by the direction of the intra-prediction mode are not integer positions, an interpolated reference sample based on two reference samples closest to the location of the reference sample may be generated. The value of the interpolated reference sample may be used to determine the pixel value of the pixel in the prediction block. In other words, when the location of the pixel in the prediction block and the location of the reference sample indicated by the direction of the intra-prediction mode indicate the location between two reference samples, an interpolated value based on the values of the two samples may be generated.

The prediction block generated via prediction may not be identical to an original target block. In other words, there may be a prediction error which is the difference between the target block and the prediction block, and there may also be a prediction error between the pixel of the target block and the pixel of the prediction block.

Hereinafter, the terms “difference”, “error”, and “residual” may be used to have the same meaning, and may be used interchangeably with each other.

For example, in the case of directional intra prediction, the longer the distance between the pixel of the prediction block and the reference sample, the greater the prediction error that may occur. Such a prediction error may result in discontinuity between the generated prediction block and neighbor blocks.

In order to reduce the prediction error, filtering for the prediction block may be used. Filtering may be configured to adaptively apply a filter to an area, regarded as having a large prediction error, in the prediction block. For example, the area regarded as having a large prediction error may be the boundary of the prediction block. Further, an area regarded as having a large prediction error in the prediction block may differ depending on the intra-prediction mode, and the characteristics of filters may also differ depending thereon.

As illustrated in FIG. 8, for intra prediction of a target block, at least one of reference line 0 to reference line 3 may be used.

Each reference line in FIG. 8 may indicate a reference sample line comprising one or more reference samples. As the number of the reference line is lower, a line of reference samples closer to a target block may be indicated.

Samples in segment A and segment F may be acquired through padding that uses samples closest to the target block in segment B and segment E instead of being acquired from reconstructed neighbor blocks.

Index information indicating a reference sample line to be used for intra-prediction of the target block may be signaled. The index information may indicate a reference sample line to be used for intra-prediction of the target block, among multiple reference sample lines. For example, the index information may have a value corresponding to any one of 0 to 3.

When the top boundary of the target block is the boundary of a CTU, only reference sample line 0 may be available. Therefore, in this case, index information may not be signaled. When an additional reference sample line other than reference sample line 0 is used, filtering of a prediction block, which will be described later, may not be performed.

In the case of inter-color intra prediction, a prediction block for a target block of a second color component may be generated based on the corresponding reconstructed block of a first color component.

For example, the first color component may be a luma component, and the second color component may be a chroma component.

In order to perform inter-color intra prediction, parameters for a linear model between the first color component and the second color component may be derived based on a template.

The template may include reference samples above the target block (above reference samples) and/or reference samples to the left of the target block (left reference samples), and may include above reference samples and/or left reference samples of a reconstructed block of the first color component, which correspond to the reference samples.

For example, parameters for a linear model may be derived using 1) the value of the sample of a first color component having the maximum value, among the samples in the template, 2) the value of the sample of a second color component corresponding to the sample of the first color component, 3) the value of the sample of a first color component having the minimum value, among the samples in the template, and 4) the value of the sample of a second color component corresponding to the sample of the first color component.

When the parameters for the linear model are derived, a prediction block for the target block may be generated by applying the corresponding reconstructed block to the linear model.

Depending on the image format, sub-sampling may be performed on samples neighbor the reconstructed block of the first color component and the corresponding reconstructed block of the first color component. For example, when one sample of the second color component corresponds to four samples of the first color component, one corresponding sample may be calculated by performing sub-sampling on the four samples of the first color component. When sub-sampling is performed, derivation of the parameters for the linear model and inter-color intra prediction may be performed based on the sub-sampled corresponding sample.

Information about whether inter-color intra prediction is performed and/or the range of the template may be signaled in an intra-prediction mode.

The target block may be partitioned into two or four sub-blocks in a horizontal direction and/or a vertical direction.

The sub-blocks resulting from the partitioning may be sequentially reconstructed. That is, as intra-prediction is performed on each sub-block, a sub-prediction block for the sub-block may be generated. Also, as dequantization (inverse quantization) and/or an inverse transform are performed on each sub-block, a sub-residual block for the corresponding sub-block may be generated. A reconstructed sub-block may be generated by adding the sub-prediction block to the sub-residual block. The reconstructed sub-block may be used as a reference sample for intra prediction of the sub-block having the next priority.

A sub-block may be a block including a specific number (e.g., 16) of samples or more. For example, when the target block is an 8×4 block or a 4×8 block, the target block may be partitioned into two sub-blocks. Also, when the target block is a 4×4 block, the target block cannot be partitioned into sub-blocks. When the target block has another size, the target block may be partitioned into four sub-blocks.

Information about whether intra prediction based on such sub-blocks is performed and/or information about a partition direction (horizontal direction or vertical direction) may be signaled.

Such sub-block-based intra prediction may be limited such that it is performed only when reference sample line 0 is used. When sub-block-based intra-prediction is performed, filtering of a prediction block, which will be described below, may not be performed.

A final prediction block may be generated by performing filtering on the prediction block generated via intra prediction.

Filtering may be performed by applying specific weights to a filtering target sample, which is the target to be filtered, a left reference sample, an above reference sample, and/or an above-left reference sample.

The weights and/or reference samples (e.g., the range of reference samples, the locations of the reference samples, etc.) used for filtering may be determined based on at least one of a block size, an intra-prediction mode, and the location of the filtering target sample in a prediction block.

For example, filtering may be performed only in a specific intra-prediction mode (e.g., DC mode, planar mode, vertical mode, horizontal mode, diagonal mode and/or adjacent diagonal mode).

The adjacent diagonal mode may be a mode having a number obtained by adding k to the number of the diagonal mode, and may be a mode having a number obtained by subtracting k from the number of the diagonal mode. In other words, the number of the adjacent diagonal mode may be the sum of the number of the diagonal mode and k, or may be the difference between the number of the diagonal mode and k. For example, k may be a positive integer of 8 or less.

The intra-prediction mode of the target block may be derived using the intra-prediction mode of a neighbor block present near the target block, and such a derived intra-prediction mode may be entropy-encoded and/or entropy-decoded.

For example, when the intra-prediction mode of the target block is identical to the intra-prediction mode of the neighbor block, information indicating that the intra-prediction mode of the target block is identical to the intra-prediction mode of the neighbor block may be signaled using specific flag information.

Further, for example, indicator information for a neighbor block having an intra-prediction mode identical to the intra-prediction mode of the target block, among intra-prediction modes of multiple neighbor blocks, may be signaled.

For example, when the intra-prediction mode of the target block is different from the intra-prediction mode of the neighbor block, entropy encoding and/or entropy decoding may be performed on information about the intra-prediction mode of the target block by performing entropy encoding and/or entropy decoding based on the intra-prediction mode of the neighbor block.

FIG. 9 is a diagram for explaining an embodiment of an inter prediction procedure.

The rectangles shown in FIG. 9 may represent images (or pictures). Further, in FIG. 9, arrows may represent prediction directions. An arrow pointing from a first picture to a second picture means that the second picture refers to the first picture. That is, each image may be encoded and/or decoded depending on the prediction direction.

Images may be classified into an Intra Picture (I picture), a Uni-prediction Picture or Predictive Coded Picture (P picture), and a Bi-prediction Picture or Bi-predictive Coded Picture (B picture) depending on the encoding type. Each picture may be encoded and/or decoded depending on the encoding type thereof.

When a target image that is the target to be encoded is an I picture, the target image may be encoded using data contained in the image itself without inter prediction that refers to other images. For example, an I picture may be encoded only via intra prediction.

When a target image is a P picture, the target image may be encoded via inter prediction, which uses reference pictures existing in one direction. Here, the one direction may be a forward direction or a backward direction.

When a target image is a B picture, the image may be encoded via inter prediction that uses reference pictures existing in two directions, or may be encoded via inter prediction that uses reference pictures existing in one of a forward direction and a backward direction. Here, the two directions may be the forward direction and the backward direction.

A P picture and a B picture that are encoded and/or decoded using reference pictures may be regarded as images in which inter prediction is used.

Below, inter prediction in an inter mode according to an embodiment will be described in detail.

Inter prediction or a motion compensation may be performed using a reference image and motion information.

In an inter mode, the encoding apparatus 100 may perform inter prediction and/or motion compensation on a target block. The decoding apparatus 200 may perform inter prediction and/or motion compensation, corresponding to inter prediction and/or motion compensation performed by the encoding apparatus 100, on a target block.

Motion information of the target block may be individually derived by the encoding apparatus 100 and the decoding apparatus 200 during the inter prediction. The motion information may be derived using motion information of a reconstructed neighbor block, motion information of a col block, and/or motion information of a block adjacent to the col block.

For example, the encoding apparatus 100 or the decoding apparatus 200 may perform prediction and/or motion compensation by using motion information of a spatial candidate and/or a temporal candidate as motion information of the target block. The target block may mean a PU and/or a PU partition.

A spatial candidate may be a reconstructed block which is spatially adjacent to the target block.

A temporal candidate may be a reconstructed block corresponding to the target block in a previously reconstructed co-located picture (col picture).

In inter prediction, the encoding apparatus 100 and the decoding apparatus 200 may improve encoding efficiency and decoding efficiency by utilizing the motion information of a spatial candidate and/or a temporal candidate. The motion information of a spatial candidate may be referred to as ‘spatial motion information’. The motion information of a temporal candidate may be referred to as ‘temporal motion information’.

Below, the motion information of a spatial candidate may be the motion information of a PU including the spatial candidate. The motion information of a temporal candidate may be the motion information of a PU including the temporal candidate. The motion information of a candidate block may be the motion information of a PU including the candidate block.

Inter prediction may be performed using a reference picture.

The reference picture may be at least one of a picture previous to a target picture and a picture subsequent to the target picture. The reference picture may be an image used for the prediction of the target block.

In inter prediction, a region in the reference picture may be specified by utilizing a reference picture index (or refIdx) for indicating a reference picture, a motion vector, which will be described later, etc. Here, the region specified in the reference picture may indicate a reference block.

Inter prediction may select a reference picture, and may also select a reference block corresponding to the target block from the reference picture. Further, inter prediction may generate a prediction block for the target block using the selected reference block.

The motion information may be derived during inter prediction by each of the encoding apparatus 100 and the decoding apparatus 200.

A spatial candidate may be a block 1) which is present in a target picture, 2) which has been previously reconstructed via encoding and/or decoding, and 3) which is adjacent to the target block or is located at the corner of the target block. Here, the “block located at the corner of the target block” may be either a block vertically adjacent to a neighbor block that is horizontally adjacent to the target block, or a block horizontally adjacent to a neighbor block that is vertically adjacent to the target block. Further, “block located at the corner of the target block” may have the same meaning as “block adjacent to the corner of the target block”. The meaning of “block located at the corner of the target block” may be included in the meaning of “block adjacent to the target block”.

For example, a spatial candidate may be a reconstructed block located to the left of the target block, a reconstructed block located above the target block, a reconstructed block located at the below-left corner of the target block, a reconstructed block located at the above-right corner of the target block, or a reconstructed block located at the above-left corner of the target block.

Each of the encoding apparatus 100 and the decoding apparatus 200 may identify a block present at the location spatially corresponding to the target block in a col picture. The location of the target block in the target picture and the location of the identified block in the col picture may correspond to each other.

Each of the encoding apparatus 100 and the decoding apparatus 200 may determine a col block present at the predefined relative location for the identified block to be a temporal candidate. The predefined relative location may be a location present inside and/or outside the identified block.

For example, the col block may include a first col block and a second col block. When the coordinates of the identified block are (xP, yP) and the size of the identified block is represented by (nPSW, nPSH), the first col block may be a block located at coordinates (xP+nPSW, yP+nPSH). The second col block may be a block located at coordinates (xP+(nPSW>>1), yP+(nPSH>>1)). The second col block may be selectively used when the first col block is unavailable.

The motion vector of the target block may be determined based on the motion vector of the col block. Each of the encoding apparatus 100 and the decoding apparatus 200 may scale the motion vector of the col block. The scaled motion vector of the col block may be used as the motion vector of the target block. Further, a motion vector for the motion information of a temporal candidate stored in a list may be a scaled motion vector.

The ratio of the motion vector of the target block to the motion vector of the col block may be identical to the ratio of a first temporal distance to a second temporal distance. The first temporal distance may be the distance between the reference picture and the target picture of the target block. The second temporal distance may be the distance between the reference picture and the col picture of the col block.

The scheme for deriving motion information may change depending on the inter-prediction mode of a target block. For example, as inter-prediction modes applied for inter prediction, an Advanced Motion Vector Predictor (AMVP) mode, a merge mode, a skip mode, a merge mode with a motion vector difference, a sub block merge mode, a triangle partition mode, an inter-intra combined prediction mode, an affine inter mode, a current picture reference mode, etc. may be present. The merge mode may also be referred to as a “motion merge mode”. Individual modes will be described in detail below.

### 1) AMVP Mode

When an AMVP mode is used, the encoding apparatus 100 may search a neighbor region of a target block for a similar block. The encoding apparatus 100 may acquire a prediction block by performing prediction on the target block using motion information of the found similar block. The encoding apparatus 100 may encode a residual block, which is the difference between the target block and the prediction block.

### 1-1) Creation of List of Prediction Motion Vector Candidates

When an AMVP mode is used as the prediction mode, each of the encoding apparatus 100 and the decoding apparatus 200 may create a list of prediction motion vector candidates using the motion vector of a spatial candidate, the motion vector of a temporal candidate, and a zero vector. The prediction motion vector candidate list may include one or more prediction motion vector candidates. At least one of the motion vector of a spatial candidate, the motion vector of a temporal candidate, and a zero vector may be determined and used as a prediction motion vector candidate.

Hereinafter, the terms “prediction motion vector (candidate)” and “motion vector (candidate)” may be used to have the same meaning, and may be used interchangeably with each other.

Hereinafter, the terms “prediction motion vector candidate” and “AMVP candidate” may be used to have the same meaning, and may be used interchangeably with each other.

Hereinafter, the terms “prediction motion vector candidate list” and “AMVP candidate list” may be used to have the same meaning, and may be used interchangeably with each other.

Spatial candidates may include a reconstructed spatial neighbor block. In other words, the motion vector of the reconstructed neighbor block may be referred to as a “spatial prediction motion vector candidate”.

Temporal candidates may include a col block and a block adjacent to the col block. In other words, the motion vector of the col block or the motion vector of the block adjacent to the col block may be referred to as a “temporal prediction motion vector candidate”.

The zero vector may be a (0, 0) motion vector.

The prediction motion vector candidates may be motion vector predictors for predicting a motion vector. Also, in the encoding apparatus 100, each prediction motion vector candidate may be an initial search location for a motion vector.

1-2) Search for Motion Vectors that Use List of Prediction Motion Vector Candidates

The encoding apparatus 100 may determine the motion vector to be used to encode a target block within a search range using a list of prediction motion vector candidates. Further, the encoding apparatus 100 may determine a prediction motion vector candidate to be used as the prediction motion vector of the target block, among prediction motion vector candidates present in the prediction motion vector candidate list.

The motion vector to be used to encode the target block may be a motion vector that can be encoded at minimum cost.

Further, the encoding apparatus 100 may determine whether to use the AMVP mode to encode the target block.

### 1-3) Transmission of Inter-Prediction Information

The encoding apparatus 100 may generate a bitstream including inter-prediction information required for inter prediction. The decoding apparatus 200 may perform inter prediction on the target block using the inter-prediction information of the bitstream.

The inter-prediction information may contain 1) mode information indicating whether an AMVP mode is used, 2) a prediction motion vector index, 3) a Motion Vector Difference (MVD), 4) a reference direction, and 5) a reference picture index.

Hereinafter, the terms “prediction motion vector index” and “AMVP index” may be used to have the same meaning, and may be used interchangeably with each other.

Further, the inter-prediction information may contain a residual signal.

The decoding apparatus 200 may acquire a prediction motion vector index, an MVD, a reference direction, and a reference picture index from the bitstream through entropy decoding when mode information indicates that the AMVP mode is used.

The prediction motion vector index may indicate a prediction motion vector candidate to be used for the prediction of a target block, among prediction motion vector candidates included in the prediction motion vector candidate list.

1-4) Inter Prediction in AMVP Mode that Uses Inter-Prediction Information

The decoding apparatus 200 may derive prediction motion vector candidates using a prediction motion vector candidate list, and may determine the motion information of a target block based on the derived prediction motion vector candidates.

The decoding apparatus 200 may determine a motion vector candidate for the target block, among the prediction motion vector candidates included in the prediction motion vector candidate list, using a prediction motion vector index. The decoding apparatus 200 may select a prediction motion vector candidate, indicated by the prediction motion vector index, from among prediction motion vector candidates included in the prediction motion vector candidate list, as the prediction motion vector of the target block.

The encoding apparatus 100 may generate an entropy-encoded prediction motion vector index by applying entropy encoding to a prediction motion vector index, and may generate a bitstream including the entropy-encoded prediction motion vector index. The entropy-encoded prediction motion vector index may be signaled from the encoding apparatus 100 to the decoding apparatus 200 through a bitstream. The decoding apparatus 200 may extract the entropy-encoded prediction motion vector index from the bitstream, and may acquire the prediction motion vector index by applying entropy decoding to the entropy-encoded prediction motion vector index.

The motion vector to be actually used for inter prediction of the target block may not match the prediction motion vector. In order to indicate the difference between the motion vector to be actually used for inter prediction of the target block and the prediction motion vector, an MVD may be used. The encoding apparatus 100 may derive a prediction motion vector similar to the motion vector to be actually used for inter prediction of the target block so as to use an MVD that is as small as possible.

A Motion Vector Difference (MVD) may be the difference between the motion vector of the target block and the prediction motion vector. The encoding apparatus 100 may calculate the MVD, and may generate an entropy-encoded MVD by applying entropy encoding to the MVD. The encoding apparatus 100 may generate a bitstream including the entropy-encoded MVD.

The MVD may be transmitted from the encoding apparatus 100 to the decoding apparatus 200 through the bitstream. The decoding apparatus 200 may extract the entropy-encoded MVD from the bitstream, and may acquire the MVD by applying entropy decoding to the entropy-encoded MVD.

The decoding apparatus 200 may derive the motion vector of the target block by summing the MVD and the prediction motion vector. In other words, the motion vector of the target block derived by the decoding apparatus 200 may be the sum of the MVD and the motion vector candidate.

Also, the encoding apparatus 100 may generate entropy-encoded MVD resolution information by applying entropy encoding to calculated MVD resolution information, and may generate a bitstream including the entropy-encoded MVD resolution information. The decoding apparatus 200 may extract the entropy-encoded MVD resolution information from the bitstream, and may acquire MVD resolution information by applying entropy decoding to the entropy-encoded MVD resolution information. The decoding apparatus 200 may adjust the resolution of the MVD using the MVD resolution information.

Meanwhile, the encoding apparatus 100 may calculate an MVD based on an affine model. The decoding apparatus 200 may derive the affine control motion vector of the target block through the sum of the MVD and an affine control motion vector candidate, and may derive the motion vector of a sub-block using the affine control motion vector.

The reference direction may indicate a list of reference pictures to be used for prediction of the target block. For example, the reference direction may indicate one of a reference picture list L0 and a reference picture list L1.

The reference direction merely indicates the reference picture list to be used for prediction of the target block, and may not mean that the directions of reference pictures are limited to a forward direction or a backward direction. In other words, each of the reference picture list L0 and the reference picture list L1 may include pictures in a forward direction and/or a backward direction.

That the reference direction is unidirectional may mean that a single reference picture list is used. That the reference direction is bidirectional may mean that two reference picture lists are used. In other words, the reference direction may indicate one of the case where only the reference picture list L0 is used, the case where only the reference picture list L1 is used, and the case where two reference picture lists are used.

The reference picture index may indicate a reference picture that is used for prediction of the target block, among reference pictures present in a reference picture list. The encoding apparatus 100 may generate an entropy-encoded reference picture index by applying entropy encoding to the reference picture index, and may generate a bitstream including the entropy-encoded reference picture index. The entropy-encoded reference picture index may be signaled from the encoding apparatus 100 to the decoding apparatus 200 through the bitstream. The decoding apparatus 200 may extract the entropy-encoded reference picture index from the bitstream, and may acquire the reference picture index by applying entropy decoding to the entropy-encoded reference picture index.

When two reference picture lists are used to predict the target block, a single reference picture index and a single motion vector may be used for each of the reference picture lists. Further, when two reference picture lists are used to predict the target block, two prediction blocks may be specified for the target block. For example, the (final) prediction block of the target block may be generated using the average or weighted sum of the two prediction blocks for the target block.

The motion vector of the target block may be derived by the prediction motion vector index, the MVD, the reference direction, and the reference picture index.

The decoding apparatus 200 may generate a prediction block for the target block based on the derived motion vector and the reference picture index. For example, the prediction block may be a reference block, indicated by the derived motion vector, in the reference picture indicated by the reference picture index.

Since the prediction motion vector index and the MVD are encoded without the motion vector itself of the target block being encoded, the number of bits transmitted from the encoding apparatus 100 to the decoding apparatus 200 may be decreased, and encoding efficiency may be improved.

For the target block, the motion information of reconstructed neighbor blocks may be used. In a specific inter-prediction mode, the encoding apparatus 100 may not separately encode the actual motion information of the target block. The motion information of the target block is not encoded, and additional information that enables the motion information of the target block to be derived using the motion information of reconstructed neighbor blocks may be encoded instead. As the additional information is encoded, the number of bits transmitted to the decoding apparatus 200 may be decreased, and encoding efficiency may be improved.

For example, as inter-prediction modes in which the motion information of the target block is not directly encoded, there may be a skip mode and/or a merge mode. Here, each of the encoding apparatus 100 and the decoding apparatus 200 may use an identifier and/or an index that indicates a unit, the motion information of which is to be used as the motion information of the target unit, among reconstructed neighbor units.

### 2) Merge Mode

As a scheme for deriving the motion information of a target block, there is merging. The term “merging” may mean the merging of the motion of multiple blocks. “Merging” may mean that the motion information of one block is also applied to other blocks. In other words, a merge mode may be a mode in which the motion information of the target block is derived from the motion information of a neighbor block.

When a merge mode is used, the encoding apparatus 100 may predict the motion information of a target block using the motion information of a spatial candidate and/or the motion information of a temporal candidate. The spatial candidate may include a reconstructed spatial neighbor block that is spatially adjacent to the target block. The spatial neighbor block may include a left neighbor block and an above neighbor block. The temporal candidate may include a col block. The terms “spatial candidate” and “spatial merge candidate” may be used to have the same meaning, and may be used interchangeably with each other. The terms “temporal candidate” and “temporal merge candidate” may be used to have the same meaning, and may be used interchangeably with each other.

The encoding apparatus 100 may acquire a prediction block via prediction. The encoding apparatus 100 may encode a residual block, which is the difference between the target block and the prediction block.

### 2-1) Creation of Merge Candidate List

When the merge mode is used, each of the encoding apparatus 100 and the decoding apparatus 200 may create a merge candidate list using the motion information of a spatial candidate and/or the motion information of a temporal candidate. The motion information may include 1) a motion vector, 2) a reference picture index, and 3) a reference direction. The reference direction may be unidirectional or bidirectional. The reference direction may mean a inter prediction indicator.

The merge candidate list may include merge candidates. The merge candidates may be motion information. In other words, the merge candidate list may be a list in which pieces of motion information are stored.

The merge candidates may be pieces of motion information of temporal candidates and/or spatial candidates. In other words, the merge candidates list may comprise motion information of a temporal candidates and/or spatial candidates, etc.

Further, the merge candidate list may include new merge candidates generated by a combination of merge candidates that are already present in the merge candidate list. In other words, the merge candidate list may include new motion information generated by a combination of pieces of motion information previously present in the merge candidate list.

Also, a merge candidate list may include history-based merge candidates. The history-based merge candidates may be the motion information of a block which is encoded and/or decoded prior to a target block.

Also, a merge candidate list may include a merge candidate based on an average of two merge candidates.

The merge candidates may be specific modes deriving inter prediction information. The merge candidate may be information indicating a specific mode deriving inter prediction information. Inter prediction information of a target block may be derived according to a specific mode which the merge candidate indicates. Furthermore, the specific mode may include a process of deriving a series of inter prediction information. This specific mode may be an inter prediction information derivation mode or a motion information derivation mode.

The inter prediction information of the target block may be derived according to the mode indicated by the merge candidate selected by the merge index among the merge candidates in the merge candidate list.

For example, the motion information derivation modes in the merge candidate list may be at least one of 1) motion information derivation mode for a sub-block unit and 2) an affine motion information derivation mode.

Furthermore, the merge candidate list may include motion information of a zero vector. The zero vector may also be referred to as a “zero-merge candidate”.

In other words, pieces of motion information in the merge candidate list may be at least one of 1) motion information of a spatial candidate, 2) motion information of a temporal candidate, 3) motion information generated by a combination of pieces of motion information previously present in the merge candidate list, and 4) a zero vector.

Motion information may include 1) a motion vector, 2) a reference picture index, and 3) a reference direction. The reference direction may also be referred to as an “inter-prediction indicator”. The reference direction may be unidirectional or bidirectional. The unidirectional reference direction may indicate L0 prediction or L1 prediction.

The merge candidate list may be created before prediction in the merge mode is performed.

The number of merge candidates in the merge candidate list may be predefined. Each of the encoding apparatus 100 and the decoding apparatus 200 may add merge candidates to the merge candidate list depending on the predefined scheme and predefined priorities so that the merge candidate list has a predefined number of merge candidates. The merge candidate list of the encoding apparatus 100 and the merge candidate list of the decoding apparatus 200 may be made identical to each other using the predefined scheme and the predefined priorities.

Merging may be applied on a CU basis or a PU basis. When merging is performed on a CU basis or a PU basis, the encoding apparatus 100 may transmit a bitstream including predefined information to the decoding apparatus 200. For example, the predefined information may contain 1) information indicating whether to perform merging for individual block partitions, and 2) information about a block with which merging is to be performed, among blocks that are spatial candidates and/or temporal candidates for the target block.

2-2) Search for Motion Vector that Uses Merge Candidate List

The encoding apparatus 100 may determine merge candidates to be used to encode a target block. For example, the encoding apparatus 100 may perform prediction on the target block using merge candidates in the merge candidate list, and may generate residual blocks for the merge candidates. The encoding apparatus 100 may use a merge candidate that incurs the minimum cost in prediction and in the encoding of residual blocks to encode the target block.

Further, the encoding apparatus 100 may determine whether to use a merge mode to encode the target block.

### 2-3) Transmission of Inter-Prediction Information

The encoding apparatus 100 may generate a bitstream that includes inter-prediction information required for inter prediction. The encoding apparatus 100 may generate entropy-encoded inter-prediction information by performing entropy encoding on inter-prediction information, and may transmit a bitstream including the entropy-encoded inter-prediction information to the decoding apparatus 200. Through the bitstream, the entropy-encoded inter-prediction information may be signaled to the decoding apparatus 200 by the encoding apparatus 100. The decoding apparatus 200 may extract entropy-encoded inter-prediction information from the bitstream, and may acquire inter-prediction information by applying entropy decoding to the entropy-encoded inter-prediction information.

The decoding apparatus 200 may perform inter prediction on the target block using the inter-prediction information of the bitstream.
information indicating whether a merge mode is used, 2) a merge index and 3) correction information.

Further, the inter-prediction information may contain a residual signal.

The decoding apparatus 200 may acquire the merge index from the bitstream only when the mode information indicates that the merge mode is used.

The mode information may be a merge flag. The unit of the mode information may be a block. Information about the block may include mode information, and the mode information may indicate whether a merge mode is applied to the block.

The merge index may indicate a merge candidate to be used for the prediction of the target block, among merge candidates included in the merge candidate list. Alternatively, the merge index may indicate a block with which the target block is to be merged, among neighbor blocks spatially or temporally adjacent to the target block.

The encoding apparatus 100 may select a merge candidate having the highest encoding performance among the merge candidates included in the merge candidate list and set a value of the merge index to indicate the selected merge candidate.

Correction information may be information used to correct a motion vector. The encoding apparatus 100 may generate correction information. The decoding apparatus 200 may correct the motion vector of a merge candidate selected by a merge index based on the correction information.

The correction information may include at least one of information indicating whether correction is to be performed, correction direction information, and correction size information. A prediction mode in which the motion vector is corrected based on the signaled correction information may be referred to as a “merge mode having a motion vector difference”.

2-4) Inter Prediction of Merge Mode that Uses Inter-Prediction Information

The decoding apparatus 200 may perform prediction on the target block using the merge candidate indicated by the merge index, among merge candidates included in the merge candidate list.

The motion vector of the target block may be specified by the motion vector, reference picture index, and reference direction of the merge candidate indicated by the merge index.

### 3) Skip Mode

A skip mode may be a mode in which the motion information of a spatial candidate or the motion information of a temporal candidate is applied to the target block without change. Also, the skip mode may be a mode in which a residual signal is not used. In other words, when the skip mode is used, a reconstructed block may be the same as a prediction block.

The difference between the merge mode and the skip mode lies in whether or not a residual signal is transmitted or used. That is, the skip mode may be similar to the merge mode except that a residual signal is not transmitted or used.

When the skip mode is used, the encoding apparatus 100 may transmit information about a block, the motion information of which is to be used as the motion information of the target block, among blocks that are spatial candidates or temporal candidates, to the decoding apparatus 200 through a bitstream. The encoding apparatus 100 may generate entropy-encoded information by performing entropy encoding on the information, and may signal the entropy-encoded information to the decoding apparatus 200 through a bitstream. The decoding apparatus 200 may extract entropy-encoded information from the bitstream, and may acquire information by applying entropy decoding to the entropy-encoded information.

Further, when the skip mode is used, the encoding apparatus 100 may not transmit other syntax information, such as an MVD, to the decoding apparatus 200. For example, when the skip mode is used, the encoding apparatus 100 may not signal a syntax element related to at least one of an MVD, a coded block flag, and a transform coefficient level to the decoding apparatus 200.

### 3-1) Creation of Merge Candidate List

The skip mode may also use a merge candidate list. In other words, a merge candidate list may be used both in the merge mode and in the skip mode. In this aspect, the merge candidate list may also be referred to as a “skip candidate list” or a “merge/skip candidate list”.

Alternatively, the skip mode may use an additional candidate list different from that of the merge mode. In this case, in the following description, a merge candidate list and a merge candidate may be replaced with a skip candidate list and a skip candidate, respectively.

The merge candidate list may be created before prediction in the skip mode is performed.

3-2) Search for Motion Vector that Uses Merge Candidate List

The encoding apparatus 100 may determine the merge candidates to be used to encode a target block. For example, the encoding apparatus 100 may perform prediction on the target block using the merge candidates in a merge candidate list. The encoding apparatus 100 may use a merge candidate that incurs the minimum cost in prediction to encode the target block.

Further, the encoding apparatus 100 may determine whether to use a skip mode to encode the target block.

### 3-3) Transmission of Inter-Prediction Information

The encoding apparatus 100 may generate a bitstream that includes inter-prediction information required for inter prediction. The decoding apparatus 200 may perform inter prediction on the target block using the inter-prediction information of the bitstream.

The inter-prediction information may include 1) mode information indicating whether a skip mode is used, and 2) a skip index.

The skip index may be identical to the above-described merge index.

When the skip mode is used, the target block may be encoded without using a residual signal. The inter-prediction information may not contain a residual signal. Alternatively, the bitstream may not include a residual signal.

The decoding apparatus 200 may acquire a skip index from the bitstream only when the mode information indicates that the skip mode is used. As described above, a merge index and a skip index may be identical to each other. The decoding apparatus 200 may acquire the skip index from the bitstream only when the mode information indicates that the merge mode or the skip mode is used.

The skip index may indicate the merge candidate to be used for the prediction of the target block, among the merge candidates included in the merge candidate list.

3-4) Inter Prediction in Skip Mode that Uses Inter-Prediction Information

The decoding apparatus 200 may perform prediction on the target block using a merge candidate indicated by a skip index, among the merge candidates included in a merge candidate list.

The motion vector of the target block may be specified by the motion vector, reference picture index, and reference direction of the merge candidate indicated by the skip index.

### 4) Current Picture Reference Mode

The current picture reference mode may denote a prediction mode that uses a previously reconstructed region in a target picture to which a target block belongs.

A motion vector for specifying the previously reconstructed region may be used. Whether the target block has been encoded in the current picture reference mode may be determined using the reference picture index of the target block.

A flag or index indicating whether the target block is a block encoded in the current picture reference mode may be signaled by the encoding apparatus 100 to the decoding apparatus 200. Alternatively, whether the target block is a block encoded in the current picture reference mode may be inferred through the reference picture index of the target block.

When the target block is encoded in the current picture reference mode, the target picture may exist at a fixed location or an arbitrary location in a reference picture list for the target block.

For example, the fixed location may be either a location where a value of the reference picture index is 0 or the last location.

When the target picture exists at an arbitrary location in the reference picture list, an additional reference picture index indicating such an arbitrary location may be signaled by the encoding apparatus 100 to the decoding apparatus 200.

### 5) Subblock Merge Mode

A sub-block merge mode may be a mode in which motion information is derived from the sub-block of a CU.

When the sub-block merge mode is applied, a sub-block merge candidate list may be generated using the motion information of a co-located sub-block (col-sub-block) of a target sub-block (i.e., a sub-block-based temporal merge candidate) in a reference image and/or an affine control point motion vector merge candidate.

### 6) Triangle Partition Mode

In a triangle partition mode, a target block may be partitioned in a diagonal direction, and sub-target blocks resulting from partitioning may be generated. For each sub-target block, motion information of the corresponding sub-target block may be derived, and a prediction sample for each sub-target block may be derived using the derived motion information. A prediction sample for the target block may be derived through a weighted sum of the prediction samples for the sub-target blocks resulting from the partitioning.

### 7) Combination Inter-Intra Prediction Mode

The combination inter-intra prediction mode may be a mode in which a prediction sample for a target block is derived using a weighted sum of a prediction sample generated via inter-prediction and a prediction sample generated via intra-prediction.

In the above-described modes, the decoding apparatus 200 may autonomously correct derived motion information. For example, the decoding apparatus 200 may search a specific area for motion information having the minimum sum of Absolute Differences (SAD) based on a reference block indicated by the derived motion information, and may derive the found motion information as corrected motion information.

In the above-described modes, the decoding apparatus 200 may compensate for the prediction sample derived via inter prediction using an optical flow.

In the above-described AMVP mode, merge mode, skip mode, etc., motion information to be used for prediction of the target block may be specified among pieces of motion information in a list using the index information of the list.

In order to improve encoding efficiency, the encoding apparatus 100 may signal only the index of an element that incurs the minimum cost in inter prediction of the target block, among elements in the list. The encoding apparatus 100 may encode the index, and may signal the encoded index.

Therefore, the above-described lists (i.e. the prediction motion vector candidate list and the merge candidate list) must be able to be derived by the encoding apparatus 100 and the decoding apparatus 200 using the same scheme based on the same data. Here, the same data may include a reconstructed picture and a reconstructed block. Further, in order to specify an element using an index, the order of the elements in the list must be fixed.

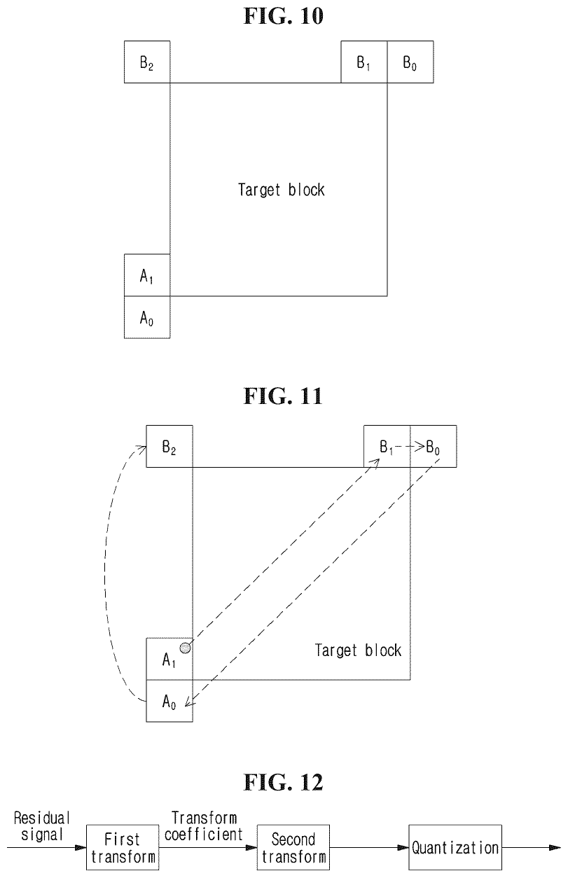

FIG. 10 illustrates spatial candidates according to an embodiment.

In FIG. 10, the locations of spatial candidates are illustrated.

The large block in the center of the drawing may denote a target block. Five small blocks may denote spatial candidates.

The coordinates of the target block may be (xP, yP), and the size of the target block may be represented by (nPSW, nPSH).

Spatial candidate A₀ may be a block adjacent to the below-left corner of the target block. A₀ may be a block that occupies pixels located at coordinates (xP−1, yP+nPSH).

Spatial candidate A₁ may be a block adjacent to the left of the target block. A₁ may be a lowermost block, among blocks adjacent to the left of the target block. Alternatively, A₁ may be a block adjacent to the top of A₀. A₁ may be a block that occupies pixels located at coordinates (xP−1, yP+nPSH−1).

Spatial candidate B₀ may be a block adjacent to the above-right corner of the target block. B₀ may be a block that occupies pixels located at coordinates (xP+nPSW, yP−1).

Spatial candidate B₁ may be a block adjacent to the top of the target block. B₁ may be a rightmost block, among blocks adjacent to the top of the target block. Alternatively, B₁ may be a block adjacent to the left of B₀. B₁ may be a block that occupies pixels located at coordinates (xP+nPSW−1, yP−1).

Spatial candidate B₂ may be a block adjacent to the above-left corner of the target block. B₂ may be a block that occupies pixels located at coordinates (xP−1, yP−1).

### Determination of Availability of Spatial Candidate and Temporal Candidate

In order to include the motion information of a spatial candidate or the motion information of a temporal candidate in a list, it must be determined whether the motion information of the spatial candidate or the motion information of the temporal candidate is available.

Hereinafter, a candidate block may include a spatial candidate and a temporal candidate.

For example, the determination may be performed by sequentially applying the following steps 1) to 4).
Step 1) When a PU including a candidate block is out of the boundary of a picture, the availability of the candidate block may be set to “false”. The expression “availability is set to false” may have the same meaning as “set to be unavailable”.
Step 2) When a PU including a candidate block is out of the boundary of a slice, the availability of the candidate block may be set to “false”. When the target block and the candidate block are located in different slices, the availability of the candidate block may be set to “false”.
Step 3) When a PU including a candidate block is out of the boundary of a tile, the availability of the candidate block may be set to “false”. When the target block and the candidate block are located in different tiles, the availability of the candidate block may be set to “false”.
Step 4) When the prediction mode of a PU including a candidate block is an intra-prediction mode, the availability of the candidate block may be set to “false”. When a PU including a candidate block does not use inter prediction, the availability of the candidate block may be set to “false”.

FIG. 11 illustrates the order of addition of motion information of spatial candidates to a merge list according to an embodiment.

As shown in FIG. 11, when pieces of motion information of spatial candidates are added to a merge list, the order of A₁, B₁, B₀, A₀, and B₂ may be used. That is, pieces of motion information of available spatial candidates may be added to the merge list in the order of A₁, B₁, B₀, A₀, and B₂.

### Method for Deriving Merge List in Merge Mode and Skip Mode

As described above, the maximum number of merge candidates in the merge list may be set. The set maximum number is indicated by “N”. The set number may be transmitted from the encoding apparatus 100 to the decoding apparatus 200. The slice header of a slice may include N. In other words, the maximum number of merge candidates in the merge list for the target block of the slice may be set by the slice header. For example, the value of N may be basically 5.

Pieces of motion information (i.e., merge candidates) may be added to the merge list in the order of the following steps 1) to 4).
Step 1) Among spatial candidates, available spatial candidates may be added to the merge list. Pieces of motion information of the available spatial candidates may be added to the merge list in the order illustrated in FIG. 11. Here, when the motion information of an available spatial candidate overlaps other motion information already present in the merge list, the motion information may not be added to the merge list. The operation of checking whether the corresponding motion information overlaps other motion information present in the list may be referred to in brief as an “overlap check”.

The maximum number of pieces of motion information that are added may be N.
Step 2) When the number of pieces of motion information in the merge list is less than N and a temporal candidate is available, the motion information of the temporal candidate may be added to the merge list. Here, when the motion information of the available temporal candidate overlaps other motion information already present in the merge list, the motion information may not be added to the merge list.
Step 3) When the number of pieces of motion information in the merge list is less than N and the type of a target slice is “B”, combined motion information generated by combined bidirectional prediction (bi-prediction) may be added to the merge list.

The target slice may be a slice including a target block.

The combined motion information may be a combination of L0 motion information and L1 motion information. L0 motion information may be motion information that refers only to a reference picture list L0. L1 motion information may be motion information that refers only to a reference picture list L1.

In the merge list, one or more pieces of L0 motion information may be present. Further, in the merge list, one or more pieces of L1 motion information may be present.

The combined motion information may include one or more pieces of combined motion information. When the combined motion information is generated, L0 motion information and L1 motion information, which are to be used for generation, among the one or more pieces of L0 motion information and the one or more pieces of L1 motion information, may be predefined. One or more pieces of combined motion information may be generated in a predefined order via combined bidirectional prediction, which uses a pair of different pieces of motion information in the merge list. One of the pair of different pieces of motion information may be L0 motion information and the other of the pair may be L1 motion information.

For example, combined motion information that is added with the highest priority may be a combination of L0 motion information having a merge index of 0 and L1 motion information having a merge index of 1. When motion information having a merge index of 0 is not L0 motion information or when motion information having a merge index of 1 is not L1 motion information, the combined motion information may be neither generated nor added. Next, the combined motion information that is added with the next priority may be a combination of L0 motion information, having a merge index of 1, and L1 motion information, having a merge index of 0. Subsequent detailed combinations may conform to other combinations of video encoding/decoding fields.

Here, when the combined motion information overlaps other motion information already present in the merge list, the combined motion information may not be added to the merge list.
Step 4) When the number of pieces of motion information in the merge list is less than N, motion information of a zero vector may be added to the merge list.

The zero-vector motion information may be motion information for which the motion vector is a zero vector.

The number of pieces of zero-vector motion information may be one or more. The reference picture indices of one or more pieces of zero-vector motion information may be different from each other. For example, the value of the reference picture index of first zero-vector motion information may be 0. The value of the reference picture index of second zero-vector motion information may be 1.

The number of pieces of zero-vector motion information may be identical to the number of reference pictures in the reference picture list.

The reference direction of zero-vector motion information may be bidirectional. Both of the motion vectors may be zero vectors. The number of pieces of zero-vector motion information may be the smaller one of the number of reference pictures in the reference picture list L0 and the number of reference pictures in the reference picture list L1. Alternatively, when the number of reference pictures in the reference picture list L0 and the number of reference pictures in the reference picture list L1 are different from each other, a reference direction that is unidirectional may be used for a reference picture index that may be applied only to a single reference picture list.

The encoding apparatus 100 and/or the decoding apparatus 200 may sequentially add the zero-vector motion information to the merge list while changing the reference picture index.

When zero-vector motion information overlaps other motion information already present in the merge list, the zero-vector motion information may not be added to the merge list.

The order of the above-described steps 1) to 4) is merely exemplary, and may be changed. Further, some of the above steps may be omitted depending on predefined conditions.

### Method for Deriving Prediction Motion Vector Candidate List in AMVP Mode

The maximum number of prediction motion vector candidates in a prediction motion vector candidate list may be predefined. The predefined maximum number is indicated by N. For example, the predefined maximum number may be 2.

Pieces of motion information (i.e. prediction motion vector candidates) may be added to the prediction motion vector candidate list in the order of the following steps 1) to 3).

Step 1) Available spatial candidates, among spatial candidates, may be added to the prediction motion vector candidate list. The spatial candidates may include a first spatial candidate and a second spatial candidate.

The first spatial candidate may be one of A₀, A₁, scaled A₀, and scaled A₁. The second spatial candidate may be one of B₀, B₁, B₂, scaled B₀, scaled B₁, and scaled B₂.

Pieces of motion information of available spatial candidates may be added to the prediction motion vector candidate list in the order of the first spatial candidate and the second spatial candidate. In this case, when the motion information of an available spatial candidate overlaps other motion information already present in the prediction motion vector candidate list, the motion information may not be added to the prediction motion vector candidate list. In other words, when the value of N is 2, if the motion information of a second spatial candidate is identical to the motion information of a first spatial candidate, the motion information of the second spatial candidate may not be added to the prediction motion vector candidate list.

The maximum number of pieces of motion information that are added may be N.
Step 2) When the number of pieces of motion information in the prediction motion vector candidate list is less than N and a temporal candidate is available, the motion information of the temporal candidate may be added to the prediction motion vector candidate list. In this case, when the motion information of the available temporal candidate overlaps other motion information already present in the prediction motion vector candidate list, the motion information may not be added to the prediction motion vector candidate list.
Step 3) When the number of pieces of motion information in the prediction motion vector candidate list is less than N, zero-vector motion information may be added to the prediction motion vector candidate list.

The zero-vector motion information may include one or more pieces of zero-vector motion information. The reference picture indices of the one or more pieces of zero-vector motion information may be different from each other.

The encoding apparatus 100 and/or the decoding apparatus 200 may sequentially add pieces of zero-vector motion information to the prediction motion vector candidate list while changing the reference picture index.

When zero-vector motion information overlaps other motion information already present in the prediction motion vector candidate list, the zero-vector motion information may not be added to the prediction motion vector candidate list.

The description of the zero-vector motion information, made above in connection with the merge list, may also be applied to zero-vector motion information. A repeated description thereof will be omitted.

The order of the above-described steps 1) to 3) is merely exemplary, and may be changed. Further, some of the steps may be omitted depending on predefined conditions.

FIG. 12 illustrates a transform and quantization process according to an example.

As illustrated in FIG. 12, quantized levels may be generated by performing a transform and/or quantization process on a residual signal.

A residual signal may be generated as the difference between an original block and a prediction block. Here, the prediction block may be a block generated via intra prediction or inter prediction.

The residual signal may be transformed into a signal in a frequency domain through a transform procedure that is a part of a quantization procedure.

A transform kernel used for a transform may include various DCT kernels, such as Discrete Cosine Transform (DCT) type 2 (DCT-II) and Discrete Sine Transform (DST) kernels.

These transform kernels may perform a separable transform or a two-dimensional (2D) non-separable transform on the residual signal. The separable transform may be a transform indicating that a one-dimensional (1D) transform is performed on the residual signal in each of a horizontal direction and a vertical direction.

The DCT type and the DST type, which are adaptively used for a 1D transform, may include DCT-V, DCT-VIII, DST-I, and DST-VII in addition to DCT-II, as shown in each of the following Table 3 and the following table 4.

TABLE 3

| Transform set | Transform candidates |
|---|---|
| 0 | DST-VII, DCT-VIII |
| 1 | DST-VII, DST-I |
| 2 | DST-VII, DCT-V |

TABLE 4

| Transform set | Transform candidates |
|---|---|
| 0 | DST-VII, DCT-VIII, DST-I |
| 1 | DST-VII, DST-I, DCT-VIII |
| 2 | DST-VII, DCT-V, DST-I |

As shown in Table 3 and Table 4, when a DCT type or a DST type to be used for a transform is derived, transform sets may be used. Each transform set may include multiple transform candidates. Each transform candidate may be a DCT type or a DST type.

The following Table 5 shows examples of a transform set to be applied to a horizontal direction and a transform set to be applied to a vertical direction depending on intra-prediction modes.

TABLE 5

| | | | | | | | | | | |
|---|---|---|---|---|---|---|---|---|---|---|
| Intra | 0 | 1 | 2 | 3 | 4 | 5 | 6 | 7 | 8 | 9 |
| prediction | | | | | | | | | | |
| mode | | | | | | | | | | |
| Vertical | 2 | 1 | 0 | 1 | 0 | 1 | 0 | 1 | 0 | 1 |
| direction | | | | | | | | | | |
| transform | | | | | | | | | | |
| set | | | | | | | | | | |
| Horizontal | 2 | 1 | 0 | 1 | 0 | 1 | 0 | 1 | 0 | 1 |
| direction | | | | | | | | | | |
| transform | | | | | | | | | | |
| set | | | | | | | | | | |
| Intra | 10 | 11 | 12 | 13 | 14 | 15 | 16 | 17 | 18 | 19 |
| prediction | | | | | | | | | | |
| mode | | | | | | | | | | |
| Vertical | 0 | 1 | 0 | 1 | 0 | 0 | 0 | 0 | 0 | 0 |
| direction | | | | | | | | | | |
| transform | | | | | | | | | | |
| set | | | | | | | | | | |
| Horizontal | 0 | 1 | 0 | 1 | 2 | 2 | 2 | 2 | 2 | 2 |
| direction | | | | | | | | | | |
| transform | | | | | | | | | | |
| set | | | | | | | | | | |
| Intra | 20 | 21 | 22 | 23 | 24 | 25 | 26 | 27 | 28 | 29 |
| prediction | | | | | | | | | | |
| mode | | | | | | | | | | |
| Vertical | 0 | 0 | 0 | 1 | 0 | 1 | 0 | 1 | 0 | 1 |
| direction | | | | | | | | | | |
| transform | | | | | | | | | | |
| set | | | | | | | | | | |
| Horizontal | 2 | 2 | 2 | 1 | 0 | 1 | 0 | 1 | 0 | 1 |
| direction | | | | | | | | | | |
| transform | | | | | | | | | | |
| set | | | | | | | | | | |
| Intra | 30 | 31 | 32 | 33 | 34 | 35 | 36 | 37 | 38 | 39 |
| prediction | | | | | | | | | | |
| mode | | | | | | | | | | |
| Vertical | 0 | 1 | 0 | 1 | 0 | 1 | 0 | 1 | 0 | 1 |
| direction | | | | | | | | | | |
| transform | | | | | | | | | | |
| set | | | | | | | | | | |
| Horizontal | 0 | 1 | 0 | 1 | 0 | 1 | 0 | 1 | 0 | 1 |
| direction | | | | | | | | | | |
| transform | | | | | | | | | | |
| set | | | | | | | | | | |
| Intra | 40 | 41 | 42 | 43 | 44 | 45 | 46 | 47 | 48 | 49 |
| prediction | | | | | | | | | | |
| mode | | | | | | | | | | |
| Vertical | 0 | 1 | 0 | 1 | 0 | 1 | 2 | 2 | 2 | 2 |
| direction | | | | | | | | | | |
| transform | | | | | | | | | | |
| set | | | | | | | | | | |
| Horizontal | 0 | 1 | 0 | 1 | 0 | 1 | 0 | 0 | 0 | 0 |
| direction | | | | | | | | | | |
| transform | | | | | | | | | | |
| set | | | | | | | | | | |
| Intra | 50 | 51 | 52 | 53 | 54 | 55 | 56 | 57 | 58 | 59 |
| prediction | | | | | | | | | | |
| mode | | | | | | | | | | |
| Vertical | 2 | 2 | 2 | 2 | 2 | 1 | 0 | 1 | 0 | 1 |
| direction | | | | | | | | | | |
| transform | | | | | | | | | | |
| set | | | | | | | | | | |
| Horizontal | 0 | 0 | 0 | 0 | 0 | 1 | 0 | 1 | 0 | 1 |
| direction | | | | | | | | | | |
| transform | | | | | | | | | | |
| set | | | | | | | | | | |
| Intra | 60 | 61 | 62 | 63 | 64 | 65 | 66 | | | |
| prediction | | | | | | | | | | |
| mode | | | | | | | | | | |
| Vertical | 0 | 1 | 0 | 1 | 0 | 1 | 0 | | | |
| direction | | | | | | | | | | |
| transform | | | | | | | | | | |
| set | | | | | | | | | | |
| Horizontal | 0 | 1 | 0 | 1 | 0 | 1 | 0 | | | |
| direction | | | | | | | | | | |
| transform | | | | | | | | | | |
| set | | | | | | | | | | |

In Table 5, numbers of vertical transform sets and horizontal transform sets that are to be applied to the horizontal direction of a residual signal depending on the intra-prediction modes of the target block are indicated.

As exemplified in Table 5, transform sets to be applied to the horizontal direction and the vertical direction may be predefined depending on the intra-prediction mode of the target block. The encoding apparatus 100 may perform a transform and an inverse transform on the residual signal using a transform included in the transform set corresponding to the intra-prediction mode of the target block. Further, the decoding apparatus 200 may perform an inverse transform on the residual signal using a transform included in the transform set corresponding to the intra-prediction mode of the target block.

In the transform and inverse transform, transform sets to be applied to the residual signal may be determined, as exemplified in Tables 3, 4, and 5, and may not be signaled. Transform indication information may be signaled from the encoding apparatus 100 to the decoding apparatus 200. The transform indication information may be information indicating which one of multiple transform candidates included in the transform set to be applied to the residual signal is used.

For example, when the size of the target block is 64×64 or less, transform sets, transform sets having three transforms may be configured depending on the intra-prediction mode, respectively. An optimal transform method may be selected from among a total of nine multiple transform methods resulting from combinations of three transforms in a horizontal direction and three transforms in a vertical direction. Through such an optimal transform method, the residual signal may be encoded and/or decoded, and thus coding efficiency may be improved.

Here, information indicating which one of transforms belonging to each transform set has been used for at least one of a vertical transform and a horizontal transform may be entropy-encoded and/or -decoded. Here, truncated unary binarization may be used to encode and/or decode such information.

As described above, methods using various transforms may be applied to a residual signal generated via intra prediction or inter prediction.

The transform may include at least one of a first transform and a secondary transform. A transform coefficient may be generated by performing the first transform on the residual signal, and a secondary transform coefficient may be generated by performing the secondary transform on the transform coefficient.

The first transform may be referred to as a “primary transform”. Further, the first transform may also be referred to as an “Adaptive Multiple Transform (AMT) scheme”. AMT may mean that, as described above, different transforms are applied to respective 1D directions (i.e. a vertical direction and a horizontal direction).

A secondary transform may be a transform for improving energy concentration on a transform coefficient generated by the first transform. Similar to the first transform, the secondary transform may be a separable transform or a non-separable transform. Such a non-separable transform may be a Non-Separable Secondary Transform (NSST).

The first transform may be performed using at least one of predefined multiple transform methods. For example, the predefined multiple transform methods may include a Discrete Cosine Transform (DCT), a Discrete Sine Transform (DST), a Karhunen-Loeve Transform (KLT), etc.

Further, a first transform may be a transform having various transform types depending on a kernel function that defines a Discrete Cosine Transform (DCT) or a Discrete Sine Transform (DST).

For example, the transform type may be determined based at least one of 1) a prediction mode of a target block (for example, one of an intra prediction and an inter prediction), 2) a size of a target block, 3) a shape of a target block, 4) an intra prediction mode of a target block, 5) a component of a target block (for example, one of a luma component an a chroma component), and 6) a partitioning type applied to a target block (for example, one of a Quad Tree, a Binary Tree and a Ternary Tree).

For example, the first transform may include transforms, such as DCT-2, DCT-5, DCT-7, DST-7, DST-1, DST-8, and DCT-8 depending on the transform kernel presented in the following Table 6. In the following Table 6, various transform types and transform kernel functions for Multiple Transform Selection (MTS) are exemplified.

MTS may refer to the selection of combinations of one or more DCT and/or DST kernels so as to transform a residual signal in a horizontal and/or vertical direction.

TABLE 6

| Transform | |
|---|---|
| type | Transform kernel function Tᵢ(j) |
| DCT-2 | ${T}_{i} ( j ) = {ω}_{0} \cdot \sqrt{\frac{2}{N}} \cdot cos ( \frac{π \cdot i \cdot ( 2 j + 1 )}{2 N} ) where {ω}_{0} = \sqrt{\frac{2}{N}} ( i = 0 ) or 1 ( otherwise )$ |
| DST-7 | ${T}_{i} ( j ) = \sqrt{\frac{4}{2 N + 1}} \cdot sin ( \frac{π \cdot ( 2 j + 1 ) \cdot ( j + 1 )}{2 N + 1} )$ |
| DCT-5 | ${T}_{i} ( j ) = {ω}_{0} \cdot {ω}_{1} \cdot \sqrt{\frac{2}{2 N - 1}} \cdot cos ( \frac{2 π \cdot i \cdot j}{2 N + 1} ) where {ω}_{0 / 1} = \sqrt{\frac{2}{N}} ( i or j = 0 ) or 1 ( otherwise )$ |
| DCT-8 | ${T}_{i} ( j ) = \sqrt{\frac{4}{2 n + 1}} \cdot cos ( \frac{π \cdot ( 2 j + 1 ) \cdot ( 2 j + 1 )}{4 N + 2} )$ |
| DST-1 | ${T}_{i} ( j ) = \sqrt{\frac{2}{N + 1}} \cdot sin ( \frac{π \cdot ( i + 1 ) \cdot ( j + 1 )}{N + 1} )$ |

In Table 6, i and j may be integer values that are equal to or greater than 0 and are less than or equal to N−1.

The secondary transform may be performed on the transform coefficient generated by performing the first transform.

As in the first transform, transform sets may also be defined in a secondary transform. The methods for deriving and/or determining the above-described transform sets may be applied not only to the first transform but also to the secondary transform.

The first transform and the secondary transform may be determined for a specific target.

For example, a first transform and a secondary transform may be applied to signal components corresponding to one or more of a luminance (luma) component and a chrominance (chroma) component. Whether to apply the first transform and/or the secondary transform may be determined depending on at least one of coding parameters for a target block and/or a neighbor block. For example, whether to apply the first transform and/or the secondary transform may be determined depending on the size and/or shape of the target block.

In the encoding apparatus 100 and the decoding apparatus 200, transform information indicating the transform method to be used for the target may be derived by utilizing specified information.

For example, the transform information may include a transform index to be used for a primary transform and/or a secondary transform. Alternatively, the transform information may indicate that a primary transform and/or a secondary transform are not used.

For example, when the target of a primary transform and a secondary transform is a target block, the transform method(s) to be applied to the primary transform and/or the secondary transform indicated by the transform information may be determined depending on at least one of coding parameters for the target block and/or blocks neighbor the target block.

Alternatively, transform information indicating a transform method for a specific target may be signaled from the encoding apparatus 100 to the decoding apparatus 200.

For example, for a single CU, whether to use a primary transform, an index indicating the primary transform, whether to use a secondary transform, and an index indicating the secondary transform may be derived as the transform information by the decoding apparatus 200. Alternatively, for a single CU, the transform information, which indicates whether to use a primary transform, an index indicating the primary transform, whether to use a secondary transform, and an index indicating the secondary transform, may be signaled.

The quantized transform coefficient (i.e. the quantized levels) may be generated by performing quantization on the result, generated by performing the first transform and/or the secondary transform, or on the residual signal.

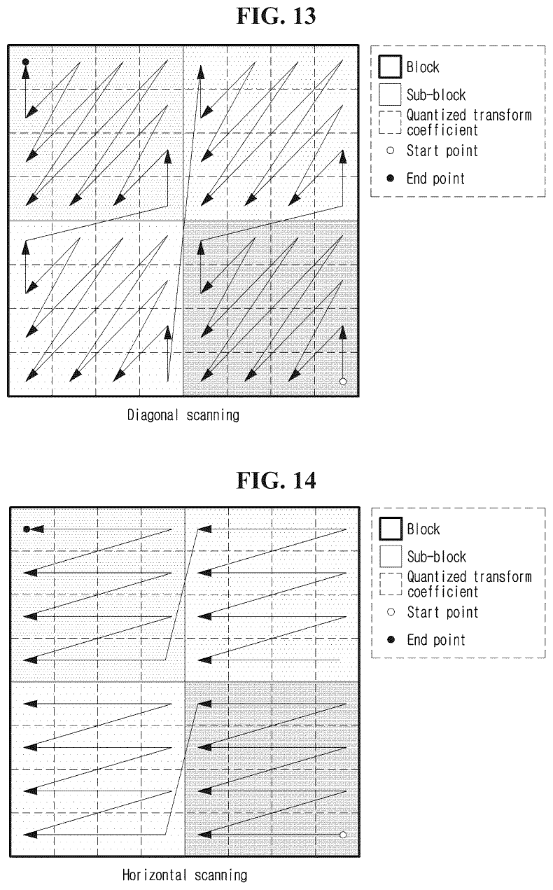

FIG. 13 illustrates diagonal scanning according to an example.

FIG. 14 illustrates horizontal scanning according to an example.

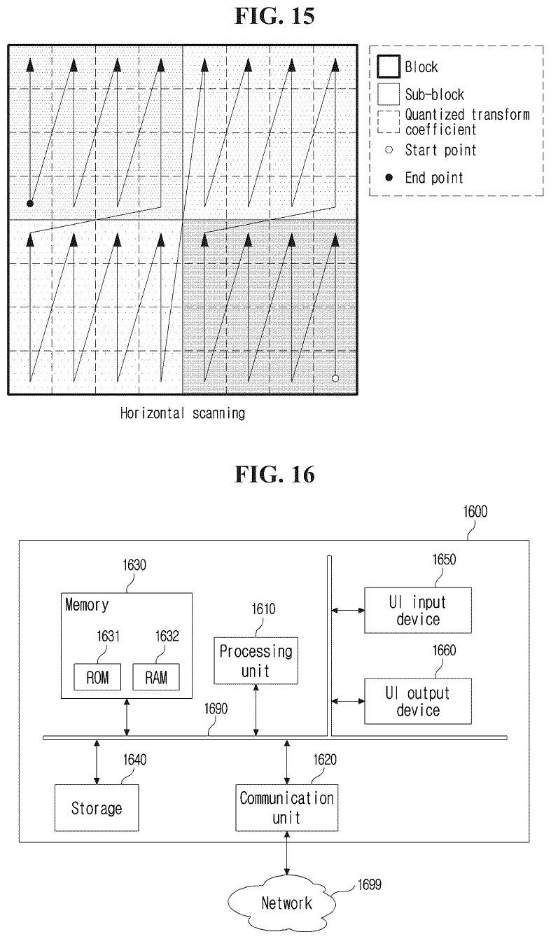

FIG. 15 illustrates vertical scanning according to an example.

Quantized transform coefficients may be scanned via at least one of (up-right) diagonal scanning, vertical scanning, and horizontal scanning depending on at least one of an intra-prediction mode, a block size, and a block shape. The block may be a Transform Unit (TU).

Each scanning may be initiated at a specific start point, and may be terminated at a specific end point.

For example, quantized transform coefficients may be changed to 1D vector forms by scanning the coefficients of a block using diagonal scanning of FIG. 13. Alternatively, horizontal scanning of FIG. 14 or vertical scanning of FIG. 15, instead of diagonal scanning, may be used depending on the size and/or intra-prediction mode of a block.

Vertical scanning may be the operation of scanning 2D block-type coefficients in a column direction. Horizontal scanning may be the operation of scanning 2D block-type coefficients in a row direction.

In other words, which one of diagonal scanning, vertical scanning, and horizontal scanning is to be used may be determined depending on the size and/or inter-prediction mode of the block.

As illustrated in FIGS. 13, 14, and 15, the quantized transform coefficients may be scanned along a diagonal direction, a horizontal direction or a vertical direction.

The quantized transform coefficients may be represented by block shapes. Each block may include multiple sub-blocks. Each sub-block may be defined depending on a minimum block size or a minimum block shape.

In scanning, a scanning sequence depending on the type or direction of scanning may be primarily applied to sub-blocks. Further, a scanning sequence depending on the direction of scanning may be applied to quantized transform coefficients in each sub-block.

For example, as illustrated in FIGS. 13, 14, and 15, when the size of a target block is 8×8, quantized transform coefficients may be generated through a first transform, a secondary transform, and quantization on the residual signal of the target block. Therefore, one of three types of scanning sequences may be applied to four 4×4 sub-blocks, and quantized transform coefficients may also be scanned for each 4×4 sub-block depending on the scanning sequence.

The encoding apparatus 100 may generate entropy-encoded quantized transform coefficients by performing entropy encoding on scanned quantized transform coefficients, and may generate a bitstream including the entropy-encoded quantized transform coefficients.

The decoding apparatus 200 may extract the entropy-encoded quantized transform coefficients from the bitstream, and may generate quantized transform coefficients by performing entropy decoding on the entropy-encoded quantized transform coefficients. The quantized transform coefficients may be aligned in the form of a 2D block via inverse scanning. Here, as the method of inverse scanning, at least one of up-right diagonal scanning, vertical scanning, and horizontal scanning may be performed.

In the decoding apparatus 200, dequantization may be performed on the quantized transform coefficients. A secondary inverse transform may be performed on the result generated by performing dequantization depending on whether to perform the secondary inverse transform. Further, a first inverse transform may be performed on the result generated by performing the secondary inverse transform depending on whether the first inverse transform is to be performed. A reconstructed residual signal may be generated by performing the first inverse transform on the result generated by performing the secondary inverse transform.

For a luma component which is reconstructed via intra prediction or inter prediction, inverse mapping having a dynamic range may be performed before in-loop filtering.

The dynamic range may be divided into 16 equal pieces, and mapping functions for respective pieces may be signaled. Such a mapping function may be signaled at a slice level or a tile group level.

An inverse mapping function for performing inverse mapping may be derived based on the mapping function.

In-loop filtering, the storage of a reference picture, and motion compensation may be performed in an inverse mapping area.

A prediction block generated via inter prediction may be changed to a mapped area through mapping using a mapping function, and the changed prediction block may be used to generate a reconstructed block. However, since intra prediction is performed in the mapped area, a prediction block generated via intra prediction may be used to generate a reconstructed block without requiring mapping and/or inverse mapping.

For example, when the target block is a residual block of a chroma component, the residual block may be changed to an inversely mapped area by scaling the chroma component of the mapped area.

Whether scaling is available may be signaled at a slice level or a tile group level.

For example, scaling may be applied only to the case where mapping is available for a luma component and where the partitioning of the luma component and the partitioning of the chroma component follow the same tree structure.

Scaling may be performed based on the average of the values of samples in a luma prediction block, which corresponds to a chroma prediction block. Here, when the target block uses inter prediction, the luma prediction block may mean a mapped luma prediction block.

A value required for scaling may be derived by referring to a look-up table using the index of a piece to which the average of sample values of the luma prediction block belongs.

The residual block may be changed to an inversely mapped area by scaling the residual block using a finally derived value. Thereafter, for the block of a chroma component, reconstruction, intra prediction, inter prediction, in-loop filtering, and the storage of a reference picture may be performed in the inversely mapped area.

For example, information indicating whether the mapping and/or inverse mapping of a luma component and a chroma component are available may be signaled through a sequence parameter set.

A prediction block for the target block may be generated based on a block vector. The block vector may indicate displacement between the target block and a reference block. The reference block may be a block in a target image.

In this way, a prediction mode in which the prediction block is generated by referring to the target image may be referred to as an “Intra-Block Copy (IBC) mode”.

An IBC mode may be applied to a CU having a specific size. For example, the IBC mode may be applied to an M×N CU. Here, M and N may be less than or equal to 64.

The IBC mode may include a skip mode, a merge mode, an AMVP mode, etc. In the case of the skip mode or the merge mode, a merge candidate list may be configured, and a merge index is signaled, and thus a single merge candidate may be specified among merge candidates present in the merge candidate list. The block vector of the specified merge candidate may be used as the block vector of the target block.

In the case of the AMVP mode, a differential block vector may be signaled. Also, a prediction block vector may be derived from the left neighbor block and the above neighbor block of the target block. Further, an index indicating which neighbor block is to be used may be signaled.

A prediction block in the IBC mode may be included in a target CTU or a left CTU, and may be limited to a block within a previously reconstructed area. For example, the value of a block vector may be limited so that a prediction block for a target block is located in a specific area. The specific area may be an area defined by three 64×64 blocks that are encoded and/or decoded prior to a 64×64 block including the target block. The value of the block vector is limited in this way, and thus memory consumption and device complexity caused by the implementation of the IBC mode may be decreased.

FIG. 16 is a configuration diagram of an encoding apparatus according to an embodiment.

An encoding apparatus 1600 may correspond to the above-described encoding apparatus 100.

The encoding apparatus 1600 may include a processing unit 1610, memory 1630, a user interface (UI) input device 1650, a UI output device 1660, and storage 1640, which communicate with each other through a bus 1690. The encoding apparatus 1600 may further include a communication unit 1620 coupled to a network 1699.

The processing unit 1610 may be a Central Processing Unit (CPU) or a semiconductor device for executing processing instructions stored in the memory 1630 or the storage 1640. The processing unit 1610 may be at least one hardware processor.

The processing unit 1610 may generate and process signals, data or information that are input to the encoding apparatus 1600, are output from the encoding apparatus 1600, or are used in the encoding apparatus 1600, and may perform examination, comparison, determination, etc. related to the signals, data or information. In other words, in embodiments, the generation and processing of data or information and examination, comparison and determination related to data or information may be performed by the processing unit 1610.

The processing unit 1610 may include an inter-prediction unit 110, an intra-prediction unit 120, a switch 115, a subtractor 125, a transform unit 130, a quantization unit 140, an entropy encoding unit 150, a dequantization unit 160, an inverse transform unit 170, an adder 175, a filter unit 180, and a reference picture buffer 190.

At least some of the inter-prediction unit 110, the intra-prediction unit 120, the switch 115, the subtractor 125, the transform unit 130, the quantization unit 140, the entropy encoding unit 150, the dequantization unit 160, the inverse transform unit 170, the adder 175, the filter unit 180, and the reference picture buffer 190 may be program modules, and may communicate with an external device or system. The program modules may be included in the encoding apparatus 1600 in the form of an operating system, an application program module, or other program modules.

The program modules may be physically stored in various types of well-known storage devices. Further, at least some of the program modules may also be stored in a remote storage device that is capable of communicating with the encoding apparatus 1200.

The program modules may include, but are not limited to, a routine, a subroutine, a program, an object, a component, and a data structure for performing functions or operations according to an embodiment or for implementing abstract data types according to an embodiment.

The program modules may be implemented using instructions or code executed by at least one processor of the encoding apparatus 1600.

The processing unit 1610 may execute instructions or code in the inter-prediction unit 110, the intra-prediction unit 120, the switch 115, the subtractor 125, the transform unit 130, the quantization unit 140, the entropy encoding unit 150, the dequantization unit 160, the inverse transform unit 170, the adder 175, the filter unit 180, and the reference picture buffer 190.

A storage unit may denote the memory 1630 and/or the storage 1640. Each of the memory 1630 and the storage 1640 may be any of various types of volatile or nonvolatile storage media. For example, the memory 1630 may include at least one of Read-Only Memory (ROM) 1631 and Random Access Memory (RAM) 1632.

The storage unit may store data or information used for the operation of the encoding apparatus 1600. In an embodiment, the data or information of the encoding apparatus 1600 may be stored in the storage unit.

For example, the storage unit may store pictures, blocks, lists, motion information, inter-prediction information, bitstreams, etc.

The encoding apparatus 1600 may be implemented in a computer system including a computer-readable storage medium.

The storage medium may store at least one module required for the operation of the encoding apparatus 1600. The memory 1630 may store at least one module, and may be configured such that the at least one module is executed by the processing unit 1610.

Functions related to communication of the data or information of the encoding apparatus 1600 may be performed through the communication unit 1620.

For example, the communication unit 1620 may transmit a bitstream to a decoding apparatus 1600, which will be described later.

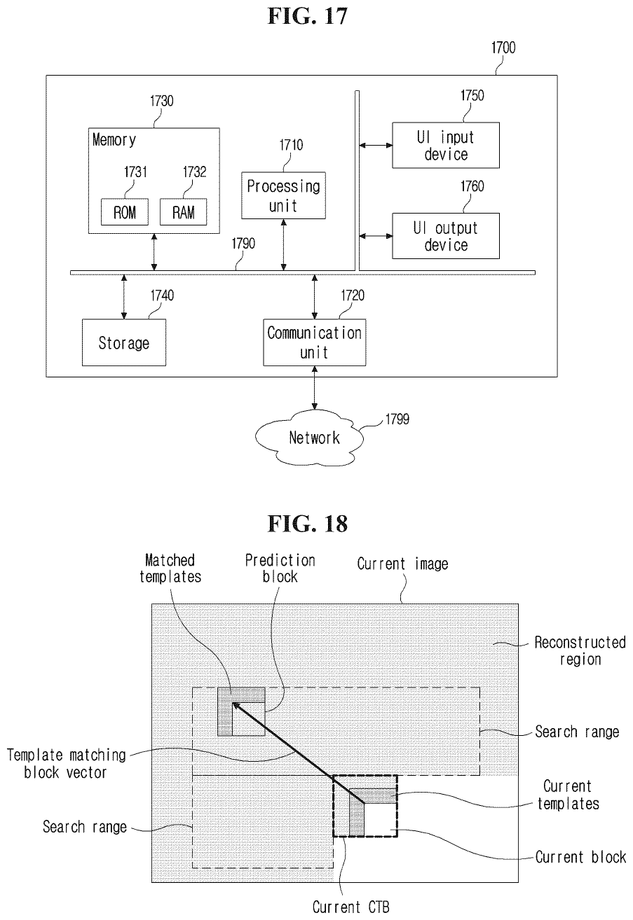

FIG. 17 is a configuration diagram of a decoding apparatus according to an embodiment.

The decoding apparatus 1700 may correspond to the above-described decoding apparatus 200.

The decoding apparatus 1700 may include a processing unit 1710, memory 1730, a user interface (UI) input device 1750, a UI output device 1760, and storage 1740, which communicate with each other through a bus 1790. The decoding apparatus 1700 may further include a communication unit 1720 coupled to a network 1799.

The processing unit 1710 may be a Central Processing Unit (CPU) or a semiconductor device for executing processing instructions stored in the memory 1730 or the storage 1740. The processing unit 1710 may be at least one hardware processor.

The processing unit 1710 may generate and process signals, data or information that are input to the decoding apparatus 1700, are output from the decoding apparatus 1700, or are used in the decoding apparatus 1700, and may perform examination, comparison, determination, etc. related to the signals, data or information. In other words, in embodiments, the generation and processing of data or information and examination, comparison and determination related to data or information may be performed by the processing unit 1710.

The processing unit 1710 may include an entropy decoding unit 210, a dequantization unit 220, an inverse transform unit 230, an intra-prediction unit 240, an inter-prediction unit 250, a switch 245, an adder 255, a filter unit 260, and a reference picture buffer 270.

At least some of the entropy decoding unit 210, the dequantization unit 220, the inverse transform unit 230, the intra-prediction unit 240, the inter-prediction unit 250, the adder 255, the switch 245, the filter unit 260, and the reference picture buffer 270 of the decoding apparatus 200 may be program modules, and may communicate with an external device or system. The program modules may be included in the decoding apparatus 1700 in the form of an operating system, an application program module, or other program modules.

The program modules may be physically stored in various types of well-known storage devices. Further, at least some of the program modules may also be stored in a remote storage device that is capable of communicating with the decoding apparatus 1700.

The program modules may include, but are not limited to, a routine, a subroutine, a program, an object, a component, and a data structure for performing functions or operations according to an embodiment or for implementing abstract data types according to an embodiment.

The program modules may be implemented using instructions or code executed by at least one processor of the decoding apparatus 1700.

The processing unit 1710 may execute instructions or code in the entropy decoding unit 210, the dequantization unit 220, the inverse transform unit 230, the intra-prediction unit 240, the inter-prediction unit 250, the switch 245, the adder 255, the filter unit 260, and the reference picture buffer 270.

A storage unit may denote the memory 1730 and/or the storage 1740. Each of the memory 1730 and the storage 1740 may be any of various types of volatile or nonvolatile storage media. For example, the memory 1730 may include at least one of ROM 1731 and RAM 1732.

The storage unit may store data or information used for the operation of the decoding apparatus 1700. In an embodiment, the data or information of the decoding apparatus 1700 may be stored in the storage unit.

For example, the storage unit may store pictures, blocks, lists, motion information, inter-prediction information, bitstreams, etc.

The decoding apparatus 1700 may be implemented in a computer system including a computer-readable storage medium.

The storage medium may store at least one module required for the operation of the decoding apparatus 1700. The memory 1730 may store at least one module, and may be configured such that the at least one module is executed by the processing unit 1710.

Functions related to communication of the data or information of the decoding apparatus 1700 may be performed through the communication unit 1720.

For example, the communication unit 1720 may receive a bitstream from the encoding apparatus 1700.

Hereinafter, a processing unit may represent the processing unit 1610 of the encoding apparatus 1600 and/or the processing unit 1710 of the decoding apparatus 1700. For example, as to functions relating to prediction, the processing unit may represent the switch 115 and/or the switch 245. As to functions relating to inter prediction, the processing unit may represent the inter-prediction unit 110, the subtractor 125 and the adder 175, and may represent the inter prediction unit 250 and the adder 255. As to functions relating to intra prediction, the processing unit may represent the intra prediction unit 120, the subtractor 125, and the adder 175, and may represent the intra prediction unit 240 and the adder 255. As to functions related to transform, the processing unit may represent the transform unit 130 and the inverse transform unit 170, and may represent the inverse transform unit 230. As to functions relating quantization, the processing unit may represent the quantization unit 140 and the inverse quantization unit 160, and may indicate the inverse quantization unit 220. As to functions relating to entropy encoding and/or entropy decoding, the processing unit may represent the entropy encoding unit 150 and/or the entropy decoding unit 210. As to functions relating filtering, the processing unit may represent the filter unit 180 and/or the filter unit 260. As to functions relating a reference picture, the processing unit may indicate the reference picture buffer 190 and/or the reference picture buffer 270.

The present disclosure provides an image encoding/decoding method using a block vector derived based on template matching and a device performing the same.

Specifically, the present disclosure may provide a method including at least one of an image encoding/decoding process using template matching prediction or an image encoding/decoding process using a template matching block vector determined through template matching prediction. Template matching prediction described in the present disclosure may be referred to as IntraTMP (Intra Template Matching Prediction).

In an image encoding/decoding process, one picture may be encoded/decoded based on at least one prediction mode of an intra prediction, inter prediction, template matching prediction or intra block copy mode.

In addition, in an image encoding/decoding process, one block may be encoded/decoded based on at least one prediction mode of an intra prediction, inter prediction, template matching prediction or intra block copy mode.

Alternatively, a template matching prediction mode using template matching prediction may be used in at least a part of an image encoding/decoding process.

When a template matching prediction mode is used, a part of a reconstructed region around a current block to be encoded/decoded is used as a template (hereinafter referred to as a current template). Then, a region most similar to a current template is searched within a search range which is the whole or a part of a reconstructed region of the same picture. Here, the most similar region represents a region having the minimum error cost. A region corresponding to a current block that exists at a position having the minimum error cost may be used as a reference block of a current block. Meanwhile, a reference block may be set as a prediction block of a current block.

A block vector derived by template matching prediction may also be referred to as a template matching block vector. In addition, in the present disclosure, ‘the same picture’ may refer to a current picture including a current block.

A reconstructed region around a current block configuring a current template may include at least one of a region at the top position of a current block, a region at a top-left position, a region at a top-left position, a region at a left position or a region at a bottom-left position.

A search range may refer to the entire pre-reconstructed region in the same picture or a part of the entire pre-reconstructed region.

The search range may be derived according to the width and height of a current block.

As an example, based on the top-left position of a CTB including a current block, rectangular regions in any size positioned in at least one of the top-left, top-right or left of the reference position may be set as a search range.

The size of a rectangular region may correspond to M times the width of a current block and N times the height of a current block. M and N above may be an integer greater than 0. As an example, each of M and N may be 5.

In this case, a search range may be configured with only regions where there are reconstructed pixel values among the regions configured with the rectangular regions.

In addition, a search range may be limited to the range of a block vector available in an intra block copy mode.

A search range may be configured by further including a reconstructed region within a CTB including a current block in addition to a region configured with the rectangular regions.

Here, a pre-encoded/decoded region within a current picture may be a reconstructed region within a current picture where at least one of chroma scaling and luma mapping which are in-loop filtering, deblocking filtering, adaptive sample offset or adaptive in-loop filtering is not performed. In addition, a pre-encoded/decoded region within a current picture may be a reconstructed/decoded region within a current picture where at least one of chroma scaling and luma mapping which are in-loop filtering, deblocking filtering, adaptive sample offset, adaptive in-loop filtering or bilateral filtering is performed.

The reconstructed region may be a region composed of prediction samples, residual samples or samples reconstructed based on a prediction sample and a residual sample.

A prediction sample may refer to a sample predicted based on at least one of intra prediction, inter prediction, intra block copy or template matching prediction.

For example, when the reconstructed region is composed of prediction samples or reconstructed samples reconstructed based on this, the reconstructed region may be set not to include samples generated by inter prediction.

As another example, when the reconstructed region is composed of prediction samples or reconstructed samples reconstructed based on this, sample values in a region encoded/decoded by inter prediction may be replaced with a specific value and included in a reconstructed region.

As an example, the specific value may be a value padded with neighboring prediction samples.

Alternatively, the specific value may be a result calculated as a statistical value of neighboring prediction samples. Here, a statistical value may be at least one of the occurrence frequency of sample values or the minimum value, the maximum value or the average value of sample values.

A template matching prediction encoding/decoding method may be used for at least one of a dual tree partition structure (i.e., a dual tree structure) where a luma component and a chroma component have an independent block partition structure and a single tree partition structure (i.e., a single tree structure) where a luma component and a chroma component have the same block partition structure.

The following is to describe an example in which a template matching prediction mode is applied under a dual tree structure where a luma component and a chroma component have an independent block partition structure.

Template matching prediction mode information for a luma component and a chroma component may be independently encoded/decoded. Template matching prediction mode information may include a template matching prediction mode flag representing whether a template matching prediction mode is applied.

For two chroma components (i.e., Cb and Cr), single template matching prediction mode information may be encoded/decoded. In this case, two chroma components may be encoded/decoded in the same prediction mode according to one template matching prediction mode information.

Alternatively, template matching prediction mode information may be independently encoded/decoded for two chroma components (Cb, Cr). In this case, each of the two chroma components may be encoded/decoded in an independent prediction mode based on the independent template matching prediction mode information of each of the two chroma components.

In applying template matching prediction to each of a luma component and a chroma component, a template may be configured to include samples included in a reconstructed region around a current block for each component. A template composed of reconstructed regions around a current block may be called a current template.

When a luma component corresponding to a current chroma component is encoded/decoded by using a template matching prediction mode, a current chroma component may also be encoded/decoded in a template matching prediction mode. In this case, encoding/decoding of a template matching prediction mode flag of a chroma component may be omitted.

When a luma component corresponding to a current chroma component is encoded/decoded by using a template matching prediction mode, a current chroma component may be encoded/decoded in a non-directional mode such as a planar or DC mode among the intra prediction modes. In this case, encoding/decoding of a template matching prediction mode flag of a chroma component may be omitted.

When a template matching prediction mode is independently applied to luma and chroma components, a template matching block vector may be independently derived for each component. Since a template matching block vector for each component is independently derived, the template matching block vector of a luma component and the template matching block vector of a chroma component may be the same or different.

In addition, when a template matching prediction mode is independently applied to a Cb component and a Cr component which are a chroma component, a template matching block vector may be independently derived for each chroma component. Since a template matching block vector is derived independently for each chroma component, the template matching block vector of a Cb component and the template matching block vector of a Cr component may be the same or different.

In performing the template matching prediction, the search range of template matching for a luma component may be larger than or equal to the search range of template matching for a chroma component. As an example, the search range of template matching for a luma component may include the search range of template matching for a chroma component.

In addition, the size of a template for a luma component may be larger than or equal to the size of a template for a chroma component.

Below is an embodiment of template matching prediction under a single tree structure where a luma component and a chroma component have the same block partition structure.

Template matching prediction mode information for a luma component and a chroma component may be independently encoded/decoded. Template matching prediction mode information may include a template matching prediction mode flag representing whether a template matching prediction mode is applied.

Alternatively, single template matching prediction mode information may be encoded/decoded for a luma component and a chroma component. In this case, the prediction mode of a luma component and a chroma component may be determined equally according to template matching prediction mode information.

For two chroma components (i.e., Cb and Cr), single template matching prediction mode information may be encoded/decoded. In this case, two chroma components may be encoded/decoded in the same prediction mode according to one template matching prediction mode information.

Alternatively, template matching prediction mode information may be independently encoded/decoded for two chroma components (Cb, Cr). In this case, each of the two chroma components may be encoded/decoded in an independent prediction mode based on the independent template matching prediction mode information of each of the two chroma components.

In applying template matching prediction to each of a luma component and a chroma component, a template may be configured to include samples included in a reconstructed region around a current block for each component. A template composed of reconstructed regions around a current block may be called a current template.

When a luma component corresponding to a current chroma component is encoded/decoded by using a template matching prediction mode, a current chroma component may also be encoded/decoded in a template matching prediction mode. In this case, encoding/decoding of a template matching prediction mode flag of a chroma component may be omitted.

When a luma component corresponding to a current chroma component is encoded/decoded by using a template matching prediction mode, a current chroma component may be encoded/decoded in a non-directional mode such as a planar or DC mode among the intra prediction modes. In this case, encoding/decoding of a template matching prediction mode flag of a chroma component may be omitted.

When single template matching prediction mode information is encoded/decoded for luma and chroma components, the template matching block vector of a chroma component may be derived in the same manner as the template matching block vector of a luma component or may be derived from the template matching block vector of a luma component. As an example, the template matching block vector of a chroma component may be derived by scaling the template matching block vector of a luma component according to a color format.

Alternatively, even when single template matching prediction mode information is encoded/decoded for luma and chroma components, a template matching block vector may be derived independently for each of a luma component and a chroma component. Accordingly, the template matching block vector of a luma component and the template matching block vector of a chroma component may be the same or different.

When single template matching prediction mode information is encoded/decoded for two chroma components (i.e., a Cb component and a Cr component), a template matching block vector may be derived independently for each of the two chroma components. Accordingly, template matching block vectors of the two luma components may be the same or different.

When whether to apply a template matching prediction mode is determined independently for luma and chroma components, the template matching block vector of a luma component and a chroma component may be independently derived. Accordingly, the template matching block vector of a luma component and the template matching block vector of a chroma component may be the same or different.

When whether to apply a template matching prediction mode is determined independently for a Cb component and a Cr component which are a chroma component, the template matching block vector of a Cb component and a Cr component may be independently derived. Accordingly, the template matching block vector of a Cb component and the template matching block vector of a Cr component may be the same or different.

In performing the template matching prediction, the search range of template matching for a luma component may be larger than or equal to the search range of template matching for a chroma component. As an example, the search range of template matching for a luma component may include the search range of template matching for a chroma component.

In addition, the size of a template for a luma component may be larger than or equal to the size of a template for a chroma component.

A template matching block vector determined by template matching prediction encoding/decoding may be stored in the motion information buffer of a current block.

A template matching block vector stored in the motion information buffer may be used when intra block copy is applied to a block encoded/decoded after a current block. In other words, when intra block copy is applied, a template matching block vector stored in a motion information buffer may be added to a block vector candidate list. The motion information buffer may refer to an encoding/decoding information buffer which means a memory storing information encoded/decoded.

A block vector candidate list for intra block copy may be used to derive a block vector under an intra block copy AMVP mode or an intra block copy merge mode.

Template matching block vectors determined by the template matching prediction encoding/decoding may be stored in a lower block unit.

Here, the template matching block vector may be stored in, for example, a memory, a line buffer, an array, etc.

As another example, the template matching block vector may be stored in the buffer of a CTU row including a current block.

The lower block may be a block having an integer size greater than 0. As an example, a lower block may be a 4×4 block.

Alternatively, it may be stored in a line buffer storing the encoding/decoding information of the lowest column of a CTU including a current block among the template matching block vectors stored in a lower block.

A template matching block vector included in the line buffer may be referred to in the step of configuring a block vector candidate list of intra block copy in the intra block copy of encoding/decoding blocks in a CTU adjacent to the bottom of the line buffer. Specifically, a template matching block vector stored in a line buffer may be added to a block vector candidate list for intra block copy.

A template matching block vector may be stored in a history block vector buffer for intra block copy.

A template matching block vector included in the history block vector buffer for intra block copy may be referred to in the step of configuring a block vector candidate list of the intra block copy. Specifically, a template matching block vector stored in a history block vector buffer may be added to the block vector candidate list of intra block copy.

In configuring a block vector candidate list for the intra block copy of a current block, the block vector of blocks encoded/decoded by intra block copy among the blocks adjacent to a current block may be derived as a block vector candidate.

In configuring the block vector list of intra block copy for the intra block copy of a current block, the template matching block vector of blocks encoded/decoded by template matching prediction among the blocks adjacent to a current block may be derived as a block vector candidate.

In configuring the block vector list of intra block copy for the intra block copy of a current block, the block vector of blocks encoded/decoded by intra block copy among the blocks adjacent to a current block or the template matching block vector of blocks encoded/decoded by template matching prediction may be derived as a block vector candidate. At least one derived block vector candidate may be added to a block vector list.

In configuring the block vector list of intra block copy for the intra block copy of a current block, at least one block vector existing in a history block vector buffer for intra block copy may be added to a block vector list. The history block vector buffer for intra block copy may include at least one of a block vector derived from a block encoded/decoded in an intra block copy mode or a template matching block vector derived from a block encoded/decoded in a template matching prediction mode.

FIGS. 18 to 21 are a diagram for describing a template matching prediction method according to an embodiment of the present disclosure.

As in an example shown in FIG. 18, a current template region may be determined within a reconstructed region including reconstructed pixels around a current block.

All or part of the reconstructed regions encoded/decoded before a current block in a current CTB may be used when configuring a current template region.

All or part of the reconstructed regions encoded/decoded before a current block in a current CTB may be included in the search range of template matching of a current block.

A matching template with the minimum error cost with a current template within a reconstructed region may be determined.

Based on the matching template and the current template, the reference block of a current block may be determined.

In this case, a position difference between a specific position for a current block (e.g., a top-left pixel position in a current block) and a specific position of the reference block (e.g., a top-left pixel position in a reference block) may be determined as a template matching block vector.

When the template matching block vector is used to configure the block vector candidate list of intra block copy, a template matching block vector may be scaled or rounded to the same resolution as the resolution of a block vector of intra block copy (e.g., the resolution of a sub-pixel such as ¼ pixel, ½ pixel, etc. or a N-fold integer pixel such as 1 integer pixel, 4 integer pixels, etc.).

Scaling a template matching block vector to the same resolution as a block vector for intra block copy may follow Equation 1 or Equation 2 below. Equation 1 may be applied when block vector resolution for intra block copy is more precise than the resolution of a template matching block vector.

$${BV}_{TMP , hor} = {BV}_{TMP , hor} ≪ shift \qquad [ Equation 1 ]$$

$${BV}_{TMP , ver} = {BV}_{TMP , ver} ≪ shift$$

In Equation 1 above, BV_{TMP, hor} represents the horizontal element value of a template matching block vector and BV_{TMP, ver} represents the vertical element value of a template matching block vector. shift may be determined by block vector resolution for intra block copy.

As an example, let's assume that the resolution of a template matching block vector is 1 integer pixel.

When the block vector resolution of intra block copy is ½ pixel, shifting parameter shift may be set as 1. Through a shifting operation, a template matching block vector may be adjusted in a unit of ½ pixel.

Alternatively, when intra block vector resolution is ¼ pixel, shifting parameter shift may be set as 2. Through a shifting operation, a template matching block vector may be adjusted in a unit of ¼ pixel.

Equation 2 may be applied when the resolution of a template matching block vector is more precise than block vector resolution for intra block copy.

$$offset = ( shift == 0 ) ? 0 : ( 1 ≪ ( shfit - 1 ) ) \qquad [ Equation 2 ]$$

$${BV}_{TMP , hor} = ( {BV}_{TMP , hor} + offset ) ≫ shift$$

$${BV}_{TMP , ver} = ( {BV}_{TMP , ver} + offset ) ≫ shift$$

In Equation 2 above, BV_{TMP, hor} represents the horizontal element value of a template matching block vector and BV_{TMP, ver} represents the vertical element value of a template matching block vector. shift may be determined by block vector resolution for intra block copy.

As an example, let's assume that the resolution of a template matching block vector is 1 pixel.

When the block vector resolution of intra block copy is 4 pixels, shifting parameter shift may be set as 2. Through a shifting operation, a template matching block vector may be adjusted in a unit of 4 pixels.

As another example, a block vector for intra block copy may be scaled according to the resolution of a template matching block vector.

Equations 3 and 4 show an example in which a block vector for intra block copy is scaled according to the resolution of a template matching block vector. Equation 3 may be applied when block vector resolution for intra block copy is more precise than the resolution of a template matching block vector.

$${BV}_{IBC , hor} = {BV}_{IBC , hor} ≪ shift \qquad [ Equation 3 ]$$

$${BV}_{IBC , ver} = {BV}_{IBC , ver} ≪ shift$$

In Equation 3 above, BV_{IBC, hor} represents the horizontal element value of a block vector of intra block copy and BV_{IBC, ver} represents the vertical element value of a block vector of intra block copy.

Let's assume that the block vector resolution of template matching block copy is 1 integer pixel.

When the block vector resolution of intra block copy is ½ integer pixel, shifting parameter shift may be set as 1. According to Equation 3, through a shifting operation, a block vector for intra block copy may be adjusted in a unit of 4 integer pixels.

Alternatively, let's assume that the block vector resolution of template matching block copy is 4 integer pixels.

When the block vector resolution of intra block copy is 1 integer pixel, shifting parameter shift may be set as 2. According to Equation 3, through a shifting operation, a block vector for intra block copy may be adjusted in a unit of 4 integer pixels. Equation 4 may be applied when the resolution of a template matching block vector is more precise than block vector resolution for intra block copy.

$$offset = ( shift == 0 ) ? 0 : ( 1 ≪ ( shfit - 1 ) ) \qquad [ Equation 4 ]$$

$${BV\_int4}_{IBC , hor} = ( {BV}_{IBC , hor} + offset ) ≫ shift , shift = 2$$

$${BV\_int4}_{IBC , ver} = ( {BV}_{IBC , ver} + offset ) ≫ shift , shift = 2$$

Let's assume that the block vector resolution of template matching block copy is 1 integer pixel.

When the block vector resolution of intra block copy is 4 integer pixel, shifting parameter shift may be set as 2. According to Equation 4, through a shifting operation, a block vector for intra block copy may be adjusted in a unit of 1 integer pixels.

As described above, a block vector may have resolution in a unit of a sub-pixel or a multiple of an integer.

In this case, the unit of a sub-pixel may be at least one of 1/16-pel, ⅛-pel, ¼-pel or ½-pel.

In this case, the unit of a multiple of an integer may be at least one of 1-pel, 2-pel, 4-pel, 8-pel or 16-pel.

The block vector may refer to at least one of a template matching block vector and a block vector of intra block copy.

When the block vector is stored in a block vector buffer, the resolution of a block vector may be first resolution. Here, first resolution may be at least one of a unit of a sub-pixel or a multiple of an integer.

When the block vector is used for the template matching or the intra block copy, it may have second resolution.

In this case, the first resolution and the second resolution may be the same or different.

When the first resolution and the second resolution are different, the block vector of the first resolution may be transformed to fit the second resolution. Alternatively, the block vector of the second resolution may be transformed to fit the first resolution. The transform may follow Equation 1 to Equation 4.

For example, according to Equation 2, a template matching block vector having second resolution of ½-pel may be transformed to first resolution of 1-pel when stored in a block vector buffer. In this case, shifting parameter shift may be 1.

Alternatively, according to Equation 2, a template matching block vector having second resolution of ½-pel may be transformed to first resolution of 4-pel when stored in a block vector buffer. In this case, shifting parameter shift may be 3.

Alternatively, according to Equation 2, a template matching block vector having second resolution of ¼-pel may be transformed to first resolution of 1-pel when stored in a block vector buffer. In this case, shifting parameter shift may be 2.

Alternatively, according to Equation 1, a template matching block vector having second resolution of 1-pel may be transformed to first resolution of ½-pel when stored in a block vector buffer. In this case, shifting parameter shift may be 1.

Alternatively, according to Equation 1, a template matching block vector having second resolution of 1-pel may be transformed to first resolution of ¼-pel when stored in a block vector buffer. In this case, shifting parameter shift may be 2.

Alternatively, according to Equation 1, a template matching block vector having second resolution of 2-pel may be transformed to first resolution of ½-pel when stored in a block vector buffer. In this case, shifting parameter shift may be 2.
BV_half_{TMP, hor}=BV_{TMP, hor}<<shift, shift=2
BV_half_{TMP, ver}=BV_{TMP, ver}<<shift, shift=2

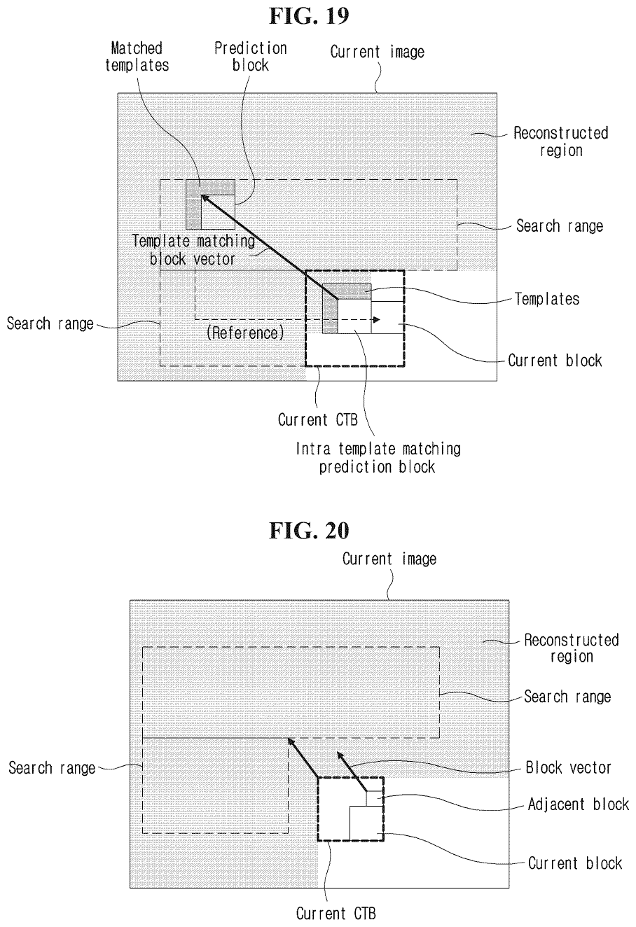

FIG. 19 is for describing an embodiment in which a template matching block vector derived by a template matching prediction method is referred to when applying an intra block copy mode to a current block.

In an example shown in FIG. 19, at least one block among the neighboring blocks adjacent to a current block may be encoded/decoded by intra template matching prediction.

A template matching prediction block may store a template matching block vector derived from the template matching prediction.

It is assumed that a current block is encoded/decoded in an intra block copy mode.

When a block adjacent to a current block is a block encoded/decoded by intra template prediction, the block vector candidate list of a current block may be configured by using the template prediction block vector of an adjacent block. As an example, the template prediction block vector of an adjacent block may be added to the block vector candidate list of a current block.

FIG. 20 shows an embodiment in which a search range is determined by using the block vector of an adjacent block around a current block when applying the template matching prediction method.

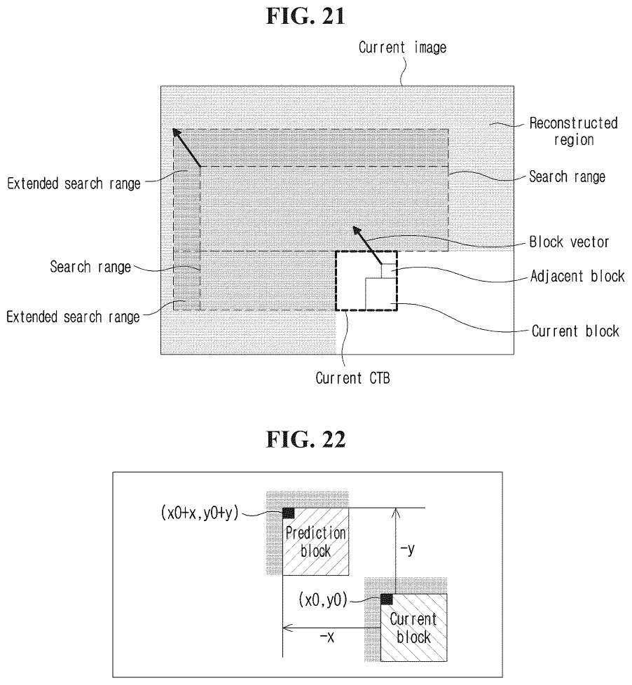

In addition, in applying a template matching prediction method, FIG. 21 is for describing an example in which a search range is expanded by using the block vector of an adjacent block around a current block.

It is assumed that at least one of the neighboring blocks adjacent to a current block is encoded/decoded by a template matching prediction or intra block copy method.

A block vector may be stored in an adjacent block encoded/decoded by a template matching prediction or intra block copy method.

As in an example shown in FIG. 20, a search range may be moved by the block vector of a corresponding adjacent block by referring to a block vector stored in at least one of the adjacent blocks around a current block, and template matching may be performed within a moved search range.

Alternatively, as in an example shown in FIG. 21, a search range may be expanded by a corresponding adjacent block vector by referring to a block vector stored in at least one of the adjacent blocks around a current block, and template matching may be performed within an expanded search range.

When a template matching block vector is derived for a current block through template matching, a derived template matching block vector may be stored for a current block.

Meanwhile, when a search range is determined as in an example shown in FIG. 20 or FIG. 21, a block vector used for determining a search range for template matching prediction of a current block may be selected among the block vectors of adjacent blocks adjacent to a current block.

As an example, after configuring an intra block vector merge candidate list for a current block, one of the block vector candidates included in an intra block vector merge candidate list may be selected, and a search range for template matching prediction may be determined based on the block vector of a selected block vector candidate.

In this case, an index indicating one of a plurality of block vector candidates may be entropy encoded/decoded.

Alternatively, the block vector of an adjacent block at a predefined position may be used for a search range for template matching prediction of a current block. Here, an adjacent block at a predefined position may be a block at the bottom-left or top-right position of a current block.

Alternatively, one of a plurality of adjacent blocks at a predefined position may be selected, and a search range for template matching of a current block may be determined based on the block vector of a selected adjacent block. An adjacent block at a predefined position may be a block at the bottom-left or top-right position of a current block. In this case, a flag indicating one of a plurality of predefined adjacent blocks may be entropy encoded/decoded.

Alternatively, after scanning adjacent blocks at a predefined position sequentially, a search range may be determined by using the block vector of an adjacent block at an available position found first.

As an example, when a block vector exists at the bottom-left position of a current block, the bottom-left position of a current block is used. On the other hand, when there is no block vector stored at the bottom-left position of a current block, a block vector at the top-right position of a current block may be used.

Alternatively, when a block vector exists at the top-right position of a current block, the top-right position of a current block is used. On the other hand, when there is no block vector stored at the top-right position of a current block, a block vector at the bottom-left position of a current block may be used.

Alternatively, when a block vector exists at both the top-right and bottom-left position of a current block, a flag corresponding to a block vector to be used in determining a search range for template matching prediction of the current block may be entropy encoded/decoded.

If there is no block vector at both the top-right and bottom-left position of a current block, the flag may be omitted.

When a current encoding/decoding target block (i.e., a current block) is encoded/decoded by template matching prediction, as described above, a current template and a matching template having the minimum error cost may be derived within a search range. In this case, a distance between a current template and a matching template having the minimum error cost may be set as the block vector (x, y) of a current block. In this case, a reference block having the same size as a current block separated by a sample spaced apart by x from a current block in a horizontal direction (specifically, when x is a positive integer, a sample spaced apart by x in a right horizontal direction, and when x is a negative integer, a sample spaced apart by x in a left horizontal direction) and separated by a sample spaced apart by y in a vertical direction (specifically, when y is a positive integer, a sample spaced apart by y in a bottom vertical direction, and when y is a negative integer, a sample spaced apart by y in a top vertical direction) may be used as the prediction block of a current block. Meanwhile, a reference block may be included in a pre-encoded/decoded region in a current picture.

FIG. 22 shows an example in which a prediction block is derived based on a block vector.

As in an example shown in FIG. 22, when all block vectors are a negative integer, a reference block whose top-left sample position is (x0+x, y0+y) may be set as the prediction block of a current block when the top-left sample position of a current block is (x0, y0).

A sample movement position according to the sign may be set to be opposite to each other. For example, when x is a positive integer, a sample spaced apart by x in a left horizontal direction may be selected, and when x is a negative integer, a sample spaced apart by x in a right horizontal direction may be selected. In addition, when y is a positive integer, a sample spaced apart by y in a top horizontal direction may be selected, and when y is a negative integer, a sample spaced apart by y in a bottom horizontal direction may be selected.

The size of the current block and the size of a reference block may be different from each other. For example, down-sampling or sub-sampling may be performed on a current block to reduce the size of a current block, and then a reference block corresponding to a reduced size may be determined. Afterwards, a determined reference block may be used as the prediction block of a current block by performing up-sampling or interpolation thereon.

At least one of the size of a current block and the size of a reference block may be determined according to at least one of the encoding parameters of a current block/a CTB/a CTU.

In the present invention, a reference block may refer to a block at a position determined according to the encoding/decoding method of a current block among the pre-encoded/decoded regions.

In the present invention, a prediction block may refer to a block used in a prediction process for encoding/decoding a current block.

In the present invention, a reference block and a prediction block may be composed of the same pixel values for at least one of the prediction modes that may be applied to a current block. In addition, a reference block and a prediction block may be considered to be identical to each other.

Template matching may determine a region that minimizes an error cost in pixel values between a current template and a template within a search range while adjusting the position of a template within a search range. As a result of template matching, the reference block of a current block may be determined.

Meanwhile, a current template may be configured to include neighboring pixels of a current block.

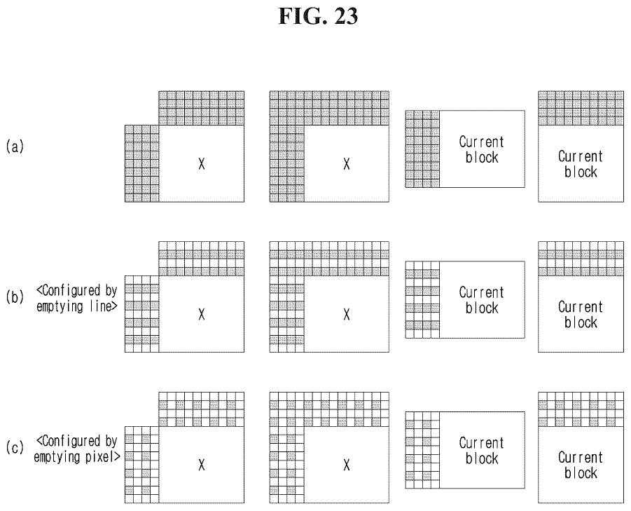

FIG. 23 shows configuration examples of template.

As in an example shown in FIG. 23, a template (a current template) for a current block may be configured by using the neighboring pixel of a current block. A reference template corresponding thereto may be configured by using pixels within a search range.

Alternatively, in configuring a template, a template may be configured by sub-sampling neighboring regions.

As an example, FIG. 23(a) shows an example in which a template is derived without performing sub-sampling.

Sub-sampling may be performed for at least one of a vertical direction and a horizontal direction. As an example, FIG. 23(b) shows an example in which sub-sampling is performed only for a vertical direction. As a result, as in an example shown in FIG. 23(b), a template may be configured to include pixels belonging to a line whose y-axis coordinate is an odd number.

As an example, as in an example shown in FIG. 23(c), sub-sampling may be performed for both horizontal and vertical directions. As a result, as in an example shown in FIG. 23(c), a template may be configured to include pixels whose x-axis coordinate is an even number and whose y-axis coordinate is an odd number.

At least one of the number of pixels configuring a template, the number of lines or the shape of a template may be configured differently based on an encoding parameter.

For example, the shape of a template may be determined differently according to the partition shape or size of a current block or a neighboring block and its statistical value.

For example, a template may be configured so that a tangent line between a template and a current block or a template and a neighboring block has the same size as the boundary of a current block or a neighboring block along the tangent line.

For example, a template may be configured so that a tangent line between a template and a current block or a template and a neighboring block has a size smaller than the boundary of a current block or a neighboring block along the tangent line.

For example, a template may be configured so that a tangent line between a template and a current block or a template and a neighboring block has a size greater than the boundary of a current block or a neighboring block along the tangent line.

For example, the size of a template may be set to be the same as the size of a current block or a neighboring block touching a template.

For example, the size of a template may be set to be smaller than the size of a current block or a neighboring block touching a template.

For example, the size of a template may be set to be greater than the size of a current block or a neighboring block touching a template.

For example, a template may be configured so that it has the same size as the maximum value, the minimum value and a median value among the sizes of a current block and a neighboring block.

For example, when the size of a current block or a neighboring block is smaller than a threshold, the number of lines or pixels included in a template may be decreased compared to otherwise.

Alternatively, conversely, when the size of a current block or a neighboring block is smaller than a threshold, the number of lines or pixels included in a template may be increased compared to otherwise.

For example, when the size of a current block or a neighboring block is greater than a threshold, the number of lines or pixels included in a template may be decreased compared to otherwise.

Alternatively, conversely, when the size of a current block or a neighboring block is greater than a threshold, the number of lines or pixels included in a template may be increased compared to otherwise.

The threshold may be a value preset in an encoder/a decoder or may be a value signaled from an encoder to a decoder.

In addition, the number of pixels configuring a template, the number of lines and the shape of a template may be configured differently based on an encoding parameter.

For example, the shape of a template may be determined based on at least one of the partition shape and size of a current block or a neighboring block or its statistical value.

For example, when one of the statistical values of a motion vector of a neighboring block is smaller than a threshold, a template may include fewer lines or pixels than otherwise.

Conversely, when one of the statistical values of a motion vector of a neighboring block is smaller than a threshold, a template may include more lines or pixels than otherwise.

For example, when one of the statistical values of a motion vector of a neighboring block is greater than a threshold, a template may include fewer lines or pixels than otherwise.

Conversely, when one of the statistical values of a motion vector of a neighboring block is greater than a threshold, a template may include more lines or pixels than otherwise.

The threshold may be a value preset in an encoder/a decoder or may be a value signaled from an encoder to a decoder.

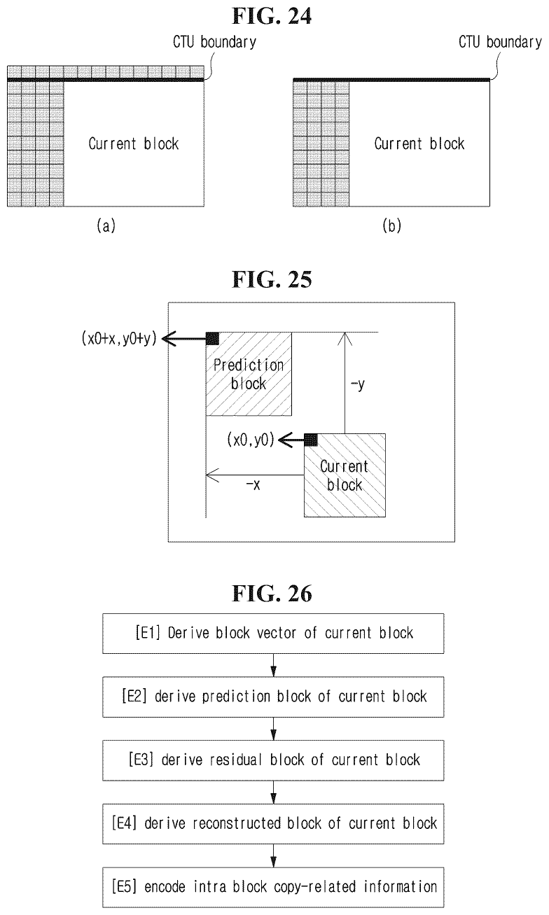

FIG. 24 is a diagram showing a template configuring method when the top boundary of a current block touches a CTU boundary.

Template matching may search for a reference template in the same size/shape as a current template within a search range based on a current template configured by using the neighboring pixel of a current block.

Meanwhile, when the top boundary of a current block touches the boundary of a CTU, a pre-reconstructed region at the top position of a current block may be set not to be included in a template or only reconstructed samples adjacent to a CTU boundary may be set to be included in a template.

In other words, when the top boundary of a current block touches the boundary of a CTU, N, the number of lines including reconstructed samples at the top position of a current block within a template, may be smaller than M, the number of lines including reconstructed samples at the left position of a current block within a template. As an example, N may be 0, 1 or 2 and M may be 4.

As an example, as in an example shown in FIG. 24(a), when the top boundary of a current block touches the boundary of a CTU, only one line at the top of a current block may be included in a template.

Alternatively, as in an example shown in FIG. 24(b), when the top boundary of a current block touches the boundary of a CTU, a template may be configured to include only the left reconstructed region of a current block. In other words, a template does not include a line at the top position of a current block.

An embodiment described through FIG. 24 may also be used to determine the number of left reconstructed lines included in a template. As an example, when the left boundary of a current block touches a CTU boundary, N, the number of lines including reconstructed samples at the left position of a current block in a template, may be smaller than M, the number of line including reconstructed samples at the top position of a current block in a template. As an example, N may be 0, 1 or 2 and M may be 4.

When both the left and top boundary of a current block are included in a CTU boundary, the number of lines at the top and left position of a template may be set to be the same.

An error cost described in the present disclosure may be a value derived from at least one pixel value difference between comparison targets. For example, an error cost may be calculated based on at least one of SAD/SAE, SSD/SSE, MAD/MAD, MSD/MSE, MR-SAD or SATD.
SAD (Sum of Absolute Difference)/SAE (Sum of Absolute Error)
MAD (Mean Absolute Difference)/MAE (Mean Absolute Error)
SSD (Sum of Squared Difference)/SSE (Sum of Squared Error)
MSD (Mean Squared Difference)/MSE (Mean Squared Error)
MR-SAD (Mean Removed Sum of Absolute Difference)
SATD (Sum of Absolute Transformed Difference)

In the present disclosure, motion information may refer to information that includes or may be derived by using at least one of a motion vector, a block vector, a reference image index, an inter prediction indicator, a prediction list utilization flag, reference image list information, a reference image, a motion vector candidate, a motion vector candidate index, a merge candidate, a merge index, etc.

In the present disclosure, intra prediction information may refer to information that includes or may be derived by using at least one of an intra luma prediction mode/direction, an intra chroma prediction mode/direction, an intra prediction mode candidate list (MPM: Most Probable Mode), an intra prediction mode candidate index (MPM index), intra partition information, a gradient/prediction mode derived through a decoder-side intra prediction mode derivation method, a prediction mode derived through a template-based intra prediction mode derivation method, a template matching prediction flag, a template matching block vector, etc.

In the present disclosure, candidate list management may refer to a process of configuring a candidate list, reducing a candidate list or adding and/or removing a candidate to/from a candidate list.

In the present disclosure, a final candidate list may refer to a list including final candidates (candidate blocks) for determining a reference block in a step for determining a reference block.

A method for using a template matching block vector determined through image encoding/decoding and template matching prediction using template matching prediction in an image encoding/decoding process may be applied to at least one of a luma component and a chroma component of a current block.

In addition, a method for using a template matching block vector determined through image encoding/decoding and template matching prediction using template matching prediction in an image encoding/decoding process may be applied to at least one of a Cb component and a Cr component of a current block.

In the present disclosure, an embodiment for performing intra block copy may be applied equally or similarly to a template matching prediction mode.

One picture may be encoded/decoded by using at least one of intra prediction, inter prediction, an intra block copy mode or template matching prediction.

In addition, one block may be encoded/decoded based on one of intra prediction, inter prediction, an intra block copy mode or template matching prediction.

An intra block copy prediction-based encoding/decoding method may be used for at least one of a case where a luma component and a chroma component have an independent block partition structure (i.e., a dual tree structure) or a case where a luma component and a chroma component have the same block partition structure (i.e., a single tree structure).

An intra block copy prediction mode may be a method for deriving a prediction block from a pre-encoded/decoded region within the same picture (i.e., intra) by using a block vector (BV). In this case, the same picture may mean a current picture.

In this case, a block vector may mean an intra block vector.

In this case, the block vector may be derived from a block vector generated by intra block copy.

In this case, the block vector may be derived from a block vector generated by template matching.

In this case, a block vector generated by template matching may be at least one of the prediction value of a block vector used in an intra block copy prediction mode and the value of a block vector itself (i.e., the value of a final block vector).

The block vector generated by template matching may include at least one of a luma block vector generated by template matching, a chroma block vector generated by template matching, a chroma Cb block vector generated by template matching and a chroma Cr block vector generated by template matching.

In this case, a pre-encoded/decoded region may be a region within a reconstructed image or a decoded image for a current picture. Here, a region within a reconstructed image may mean a reconstructed region, and a region within a decoded image may mean a decoded region.

FIG. 25 shows an example in which a reference block is determined based on a block vector of a current block.

As in an example shown in FIG. 25, when both the x component and the y component of a block vector are a negative integer and the top-left sample position of a current block is (x0, y0), a reference block where a top-left sample position is (x0+x, y0+y) may be selected.

The sign of a block vector described in the above-described embodiment and a sample position may be applied in reverse. For example, when the x of a block vector is a positive integer, a sample that is x away in a left horizontal direction may be selected, and when x is a negative integer, a sample that is −x away in a right horizontal direction may be selected. In addition, when y is a positive integer, a sample that is y away in a top horizontal direction may be selected, and when y is a negative integer, a sample that is −y away in a bottom horizontal direction may be selected.

Unlike the above-described embodiment, the size of a reference block may be different from the size of a current block. For example, the size of a current block may be reduced by performing down-sampling or sub-sampling on a current block. A reference block having the same size as a downsized current block is determined through the block vector of a current block. Thereafter, a prediction block for a current block may be derived by performing up-sampling or interpolation on a determined reference block.

At least one of the size of a current block or the size of a reference block may be adaptively determined according to at least one of the encoding parameter of a current block/a CTB/a CTU.

When prediction using an intra block copy mode is applied to a luma component block, one of the following methods may be used to encode/decode a luma component block.
Skip Mode: Similar to a skip mode in an inter prediction mode, the block vector of a current block may be derived from the block vector of a block encoded/decoded before a current block. In addition, when a skip mode is applied, a residual block for a current block may not be entropy encoded/decoded. In other words, a prediction block derived through an intra block copy mode may become the reconstructed block of a current block.
Merge Mode: Similar to a merge mode in an inter prediction mode, the block vector of a current block may be derived from the block vector of a block encoded/decoded before a current block. In addition, when a merge mode is applied, a residual block for a current block may be entropy encoded/decoded.
Intra Block Copy AMVP Mode: Similar to an advanced motion vector prediction (AMVP) mode in an inter prediction mode, a block vector may be encoded/decoded. Specifically, one of the block vector prediction candidates included in a block vector prediction list may be selected, and a selected block vector prediction candidate may be set as a block vector prediction value. In addition, a block vector difference value showing a difference between a block vector and a block vector prediction value may be explicitly encoded/decoded. A decoder may derive the block vector of a current block by adding a block vector prediction value and a block vector difference value.

Meanwhile, also in an intra block copy mode, similar to an adaptive motion vector resolution (AMVR) mode in an inter prediction mode, one of at least one resolution may be selected, and a block vector may be encoded/decoded with selected resolution. An AMVR mode in an intra block copy mode may be referred to as an intra block copy AMVR mode.

Alternatively, in embodiments described in the present disclosure, an intra block copy AMVP mode may refer to an intra block copy AMVR mode.

In addition, an intra block copy mode may be utilized as one of a plurality of modes configuring a multi-hypothesis mode. As an example, a multi-hypothesis mode may be for obtaining the final prediction block of a current block by performing the weighted sum on a plurality of prediction blocks derived by using a plurality of prediction modes. In this case, at least one of a plurality of prediction modes for a multi-hypothesis mode may be an intra block copy mode.

As an example, the final prediction block of a current block may be obtained based on the weighted sum operation of a first prediction block derived based on an intra block copy mode and a second prediction block derived based on at least one of an intra prediction mode, an inter prediction mode or an intra block copy mode.

Meanwhile, when a multi-hypothesis mode is applied, instead of performing the weighted sum on a plurality of prediction blocks, a statistical value based on a plurality of prediction blocks may be used to derive the final prediction block of a current block.

Information indicating whether to use at least one of an intra block copy skip mode, an intra block copy merge mode, an intra block copy AMVP mode, an intra block copy AMVR mode or a multi-hypothesis intra block copy mode may be encoded/decoded. As an example, a flag indicating whether to use one of the listed modes may be encoded.

Meanwhile, the information may be entropy-encoded/decoded according to at least one of the encoding parameters of a current block/a CTB (or, a CTU) or a neighboring block/CTB adjacent to a current block/a CTB.

Whether a deblocking filter is performed at the boundary of a current block may be determined depending on whether an intra block copy mode is performed.

For example, when at least one of the neighboring blocks adjacent to the boundary of a current block is encoded/decoded in an intra block copy mode, the boundary of a current block may be set as the boundary of a target block which will perform deblocking filtering. Accordingly, deblocking filtering may be performed on a boundary between a current block and a neighboring block.

As another example, when all of the neighboring blocks adjacent to the boundary of a current block are not encoded/decoded in an intra block copy mode, the boundary of a current block is not set as the boundary of a target block which will perform deblocking filtering. Accordingly, deblocking filtering may not be performed on a boundary between a current block and a neighboring block.

Meanwhile, in determining whether to apply a deblocking filter, a block to which an intra block copy mode is applied may be considered as a block to which an inter prediction mode is applied to determine whether to apply a deblocking filter. As an example, if the boundary of a current block is set as the boundary of a target block which will perform deblocking filtering when at least one of the neighboring blocks adjacent to the boundary of a current block is applied in an inter prediction mode, the boundary of a current block may be set as the boundary of a target block which will perform deblocking filtering even when a neighboring block adjacent to the boundary of a current block is encoded/decoded in an intra block copy mode.

Alternatively, in determining whether to apply a deblocking filter, a block to which an intra block copy mode is applied may be considered as a block to which an intra prediction mode is applied to determine whether to apply a deblocking filter. As an example, if the boundary of a current block is set as the boundary of a target block which will perform deblocking filtering when at least one of the neighboring blocks adjacent to the boundary of a current block is applied in an intra prediction mode, the boundary of a current block may be set as the boundary of a target block which will perform deblocking filtering even when a neighboring block adjacent to the boundary of a current block is encoded/decoded in an intra block copy mode.

When it is determined to perform deblocking filtering on the boundary of a current block, deblocking filtering may be performed on at least a part of a current block to which an intra block copy mode is applied. Specifically, a deblocking filter in a 8×8 unit may be applied to the boundary of a current block.

At least one of whether to apply a deblocking filter to the boundary of a current block or the filter strength of the deblocking filter may be determined according to at least one of the encoding parameters for an intra block copy mode.

As an example, when a block vector difference value between a current block and a neighboring block adjacent to the boundary of a current block is greater than or equal to a threshold value, a deblocking filter may be set to be applied at the boundary of a current block. Here, a block vector difference value may include at least one of the difference value of a x-axis component or the difference value of a y-axis component.

According to whether the intra block copy mode is performed, in embodiments where deblocking filtering is performed on a block boundary, an intra block copy mode may be replaced with a template matching prediction mode. In other words, whether deblocking filtering is performed on a block boundary may be determined according to whether a template matching prediction mode is performed.

Meanwhile, in an encoder/a decoder, a luma component and a chroma component may be encoded/decoded, respectively. For convenience of a description, a block to be encoded/decoded for a luma component is called a current luma component block, and a block to be encoded/decoded for a chroma component is called a current chroma component block.

At least one of the following encoding information may be used to determine the encoding mode of a current luma component block. Here, an encoding mode may refer to a prediction mode. In addition, encoding information may refer to prediction mode information.

At least one of the encoding information described below may be entropy-encoded/decoded.
1) Information showing whether a skip mode is applied to a current luma component block (e.g., a skip mode identifier, a skip mode flag or a skip mode index (e.g., skip_flag or cu_skip_flag))

According to information showing whether a skip mode is applied, it is possible to show whether a skip mode is applied to a current luma component block. As an example, when a skip mode identifier, a skip mode flag or a skip mode index has a first value (e.g., 1), it may represent that a skip mode is applied to a current luma component block. On the other hand, when a skip mode identifier, a skip mode flag or a skip mode index has a second value (e.g., 0), it may represent that a skip mode is not applied to a current luma component block.
2) Prediction mode information of a current luma component block (e.g., an index, a flag or an identifier)

Whether at least one of an intra prediction mode, an inter prediction mode or an intra block copy mode is applied to a current luma component block may be determined based on the prediction mode information.

For example, when a syntax element representing prediction mode information has a first value (e.g., 0), it represents that an intra prediction mode is applied to a current luma component block. In addition, when the syntax element has a second value (e.g., 1), it represents that an inter prediction mode is applied to a current luma component block. Alternatively, when the syntax element has a third value (e.g., 2), it represents that an intra block copy mode is applied to a current luma component block.

As another example, a plurality of prediction mode information may be encoded/decoded. As an example, among a plurality of prediction mode information, first prediction mode information (e.g., an index, a flag or an identifier (e.g., pred_mode_flag)) may represent whether an intra prediction mode is applied to a current luma component block. As an example, when first prediction mode information has a first value (e.g., 1), it represents that an intra prediction mode is applied to a current luma component block, and when the first prediction mode information has a second value (e.g., 0), it represents that an intra prediction mode is not applied to a current luma component block. When the first prediction mode information represents that an intra prediction mode is not applied, second prediction mode information (e.g., an index, a flag or an identifier (e.g., pred_mode_ibc_flag)) may be additionally entropy-encoded/decoded. The second prediction mode information may represent whether an inter prediction mode is applied or an intra block copy mode is applied to a current luma component block. As an example, when second prediction mode information has a first value (e.g., 1), it may represent that an intra block copy mode is applied to a current luma component block. On the other hand, when the second prediction mode information has a second value (e.g., 0), it may represent that an inter prediction mode is applied to a current luma component block.

As another example, whether an intra prediction mode is applied or an inter prediction mode is applied to a current luma component block may be determined based on first prediction mode information (e.g., an index, a flag or an identifier (e.g., pred_mode_flag)). When first prediction mode information has a first value (e.g., 1), it may represent that an intra prediction mode is applied to a current luma component block. On the other hand, when first prediction mode information has a second value (e.g., 0), it may represent that an inter prediction mode is applied to a current luma component block. Meanwhile, second prediction mode information (e.g., an index or a flag or an identifier or pred_mode_ibc_flag, etc.) representing whether an intra block copy mode is applied to a current luma component block may be entropy encoded/decoded, or the value of the second prediction mode information may be derived from a current luma component block without entropy encoding/decoding the second prediction mode information. As an example, when second prediction mode information has a first value (e.g., 1), it represents that an intra block copy mode is applied to a current luma component block. On the other hand, when second prediction information mode is a second value (e.g., 0), an intra prediction mode or an inter prediction mode may be applied to a current luma component block according to first prediction mode information.
3) Information representing whether a merge mode is applied to a luma component block (e.g., a merge mode identifier, a merge mode flag or a merge mode index (e.g., merge_flag))

When it is determined that a skip mode is not applied to a current luma component block and an intra block copy mode is applied to a current luma component block, information representing whether a merge mode is applied to a current luma component block may be encoded/decoded. Based on the information, whether a merge mode is applied to a current luma component block may be determined. For example, when information representing a merge mode has a first value (e.g., 1), it represents that a merge mode is applied to a current luma component block. On the other hand, when information representing the merge mode has a second value (e.g., 0), it represents that a merge mode is not applied to a current luma component block.

Encoding/decoding of encoding information for determining the encoding mode of a current luma component block may be omitted. In this case, the encoding mode of a current luma component block may be derived based on at least one of the encoding parameters of a current block/a CTB or a neighboring block/CTB adjacent to a current block/a CTB.

In the present disclosure, for convenience of a description, ‘first value’, ‘second value’ or ‘third value’ is expressed as matching a specific natural number. However, ‘first value’, ‘second value’ or ‘third value’ may be set differently from the example of the present disclosure. As an example, in the above-described embodiment, it was illustrated that ‘first value’ is 1 and ‘second value’ is 0, but conversely, ‘first value’ may be set as 0 and ‘second value’ may be set as 1. In the present disclosure, embodiments applied to a current luma component block may also be applied to a current chroma component block. For example, in an embodiment where it is not explicitly described that it is not applied to a current chroma component block, a corresponding embodiment may be implemented by replacing ‘current luma component block’ in an embodiment with ‘current chroma component block’.

According to the above-described encoding information, the encoding mode of a current luma component block may be determined as follows.

When a skip mode is applied to a current luma component block and a sub-picture, a brick, a tile, a tile group or a slice including a current luma component block is an I type, the encoding mode of a current block may be determined as an intra block copy skip mode.

In an I type, an intra prediction mode and an intra block copy mode may be used, but inter prediction may not be used. Accordingly, it may be determined that an intra block copy skip mode is applied to a current luma component block without entropy encoding/decoding prediction mode information representing whether inter prediction is applied to a current luma component block.

Meanwhile, when a skip mode is applied to a current luma component block and a sub-picture, a brick, a tile, a tile group or a slice including a current luma component block is not an I type, prediction mode information may be entropy encoded/decoded. If it is determined that an intra block copy mode is applied to a current luma component block based on the prediction mode information, the encoding mode of a current luma component block may be determined as an intra block copy skip mode. On the other hand, when it is determined that an inter prediction mode is applied to a current luma component block based on prediction mode information, it may be determined that an inter prediction skip mode is applied to a current luma component block.

When it is determined that a skip mode is not applied to a current luma component block, but an intra block copy mode is applied to a current luma component block based on prediction mode information, information representing whether a merge mode is applied to a current luma component block may be entropy encoded/decoded.

In this case, when information representing whether the merge mode is applied indicates that a merge mode is applied to a current luma component block, it may be determined that an intra block copy merge mode is applied to a current luma component block.

Alternatively, it is assumed that a skip mode is not applied to a current luma component block, but a residual block is encoded/decoded for a current luma component block and a current chroma component block. In this case, when it is determined that an intra block copy mode is applied to a current luma component block based on prediction mode information, information representing whether a merge mode is applied to a current luma component block may be entropy encoded/decoded.

In this case, when information representing whether the merge mode is applied indicates that a merge mode is applied to a current luma component block, it may be determined that an intra block copy merge mode is applied to a current luma component block.

When information representing whether a merge mode is applied represents that a merge mode is not applied, it may be determined that an intra block copy AMVP mode is applied to a current luma component block. In other words, when it is determined that both a skip mode and a merge mode are not applied to a current luma component block and it is determined that an intra block copy mode is applied to a current luma component block, it may be determined that an intra block copy AMVP mode is applied to a current luma component block.

The encoding mode of a current luma component block may be determined/derived based on at least one of the encoding information described above or at least one of the encoding parameters of a current block/a CTB or a neighboring block/CTB adjacent to a current block/CTB.

Meanwhile, in the present disclosure, an intra block copy mode may refer to at least one of an intra block copy skip mode, an intra block copy merge mode or an intra block copy AMVP mode.

Information related to the partition of a CTU may be encoded/decoded.

As an example, qtbtt_dual_tree_intra_flag represents whether root nodes of a luma component block and a chroma component block are the same for an I slice. As an example, when qtbtt_dual_tree_intra_flag is a first value (e.g., 0), it may indicate that a 64×64 encoding unit partitioned from a CTU is not used as root nodes of a luma component and a chroma component. On the other hand, when qtbtt_dual_tree_intra_flag is a second value (e.g., 1), it may indicate that a 64×64 encoding unit partitioned from a CTU is used as root nodes of a luma component and a chroma component.

When qtbtt_dual_tree_intra_flag is a first value (e.g., 0), it represents that a block partition structure for a luma component and a block partition structure for a chroma component are the same. However, according to the format of a chroma component, block sizes of a luma component and a chroma component may be different from each other. When block partition structures of a luma component and a chroma component are the same, it may be referred to as a single tree structure. A single tree type may be identified as SINGLE_TREE.

When a slice type is an I slice and qtbtt_dual_tree_intra_flag is a second value (e.g., 1), it represents that when a 64×64 encoding unit is used as a root node, a block partition structure for a luma component and a block partition structure for a chroma component may be different from each other. In other words, a block partition structure for a luma component and a block partition structure for a chroma component may be determined independently. When a block partition structure for a luma component and a block partition structure for a chroma component are independent, it may be referred to as a dual tree structure. In a dual tree structure, a tree type for a luma component may be identified as DUAL_TREE_LUMA, and a tree type for a chroma component may be identified as DUAL_TREE_CHROMA.

When a single tree structure is applied, the minimum size of a chroma component block for applying an intra block copy mode or a template matching prediction mode may be 2×2. In other words, a block having a size smaller than a 2×2 block for a chroma component may not be used. Accordingly, a 2×2 chroma component block using an intra block copy mode may not be allowed to be partitioned into a size smaller than 2×2.

Alternatively, when a single tree structure is applied, the minimum size of a chroma component block for applying an intra block copy mode or a template matching prediction mode may be 4×4. In other words, a block having a size smaller than 4×4 block for a chroma component (e.g., a 2×2 block, a 2×4 block or a 4×2 size) may not be used. Accordingly, a block larger than 2×2, 2×4 or 4×2 using an intra block copy mode may not be allowed to be partitioned into blocks in a 2×2, 2×4 or 4×2 size.

Alternatively, when a double tree structure is applied, the minimum size of a chroma component block for applying an intra block copy mode or a template matching prediction mode may be 4×4. In other words, a block having a size smaller than 4×4 block for a chroma component (e.g., a 2×2 block, a 2×4 block or a 4×2 size) may not be used. Accordingly, a block larger than 2×2, 2×4 or 4×2 using an intra block copy mode may not be allowed to be partitioned into blocks in a 2×2, 2×4 or 4×2 size.

In order to improve the subjective/objective image quality of an image, an encoder may perform primary transform on a residual block to generate a primary transform coefficient and perform secondary transform on a primary transform coefficient to generate a secondary transform coefficient. In addition, a secondary transform coefficient may be quantized to generate a quantized coefficient level, and a quantized coefficient level may be entropy encoded.

A decoder may perform entropy decoding on a quantized coefficient level and dequantize a quantized coefficient level to generate a secondary transform coefficient. And, secondary inverse transform may be performed on a secondary transform coefficient to generate a primary transform coefficient and primary inverse transform may be performed on a primary transform coefficient to reconstruct a residual block.

In an encoder, secondary transform may be performed between primary transform and quantization. In a decoder, secondary inverse transform may be performed between dequantization and primary inverse transform. In this case, secondary transform may be reduced secondary transform or low-frequency non-separable transform (LFNST).

When an intra block copy mode or a template matching prediction mode is applied to a current block, the secondary transform/inverse transform may be applied to a current block. Here, secondary transform/inverse transform may be performed on at least one of a current luma component block and a current chroma component block.

In addition, in order to perform secondary transform/inverse transform, the transform matrix set of a current block may be determined. In this case, when secondary transform is performed on a current block, a transform matrix index representing which transform matrix among the transform matrices included in a transform matrix set will be used for secondary transform/inverse transform may be entropy encoded/decoded.

In an encoder/a decoder, the encoding mode of a current chroma component block may be derived as follows.

First, when a luma component and a chroma component have the same block partition structure (i.e., a single tree type (SINGLE_TREE)), the encoding mode of a current chroma component block may be determined as follows.

The prediction mode of a current chroma component block may be set to be the same as the prediction mode of a corresponding current luma component block. Here, a prediction mode may include at least one of an intra prediction mode, an inter prediction mode or an intra block copy mode.

Meanwhile, in embodiments described in the present disclosure, an intra block copy mode may mean at least one of an intra block copy skip mode, an intra block copy merge mode, an intra block copy AMVP mode or a template matching mode.

As an example, when an intra block copy skip mode is applied to a current luma component block, encoding/decoding of a residual block may be omitted for a current chroma component block corresponding to the current luma component block and accordingly, residual block information may not be signaled. Meanwhile, entropy encoding/decoding for information representing whether residual block information is signaled (e.g., an encoding block flag (cu_cbf or tu_cbf)) may also be omitted. An encoding block flag tu_cbf may include information by chroma component (e.g., at least one of tu_cbf_cb or tu_cbf_cr). Entropy encoding/decoding for an encoding block flag may be omitted, and it may be inferred that the value of an encoding block flag represents that residual block information is not signaled.

Alternatively, when an intra block copy merge mode is applied to a current luma component block, encoding/decoding of a residual block may be omitted for a current chroma component block corresponding to the current luma component block and accordingly, residual block information may not be signaled. Meanwhile, entropy encoding/decoding for information representing whether residual block information is signaled (e.g., an encoding block flag (cu_cbf or tu_cbf)) may also be omitted. An encoding block flag tu_cbf may include information by chroma component (e.g., at least one of tu_cbf_cb or tu_cbf_cr). Entropy encoding/decoding for an encoding block flag may be omitted, and it may be inferred that the value of an encoding block flag represents that residual block information is not signaled.

When a luma component and a chroma component have the same block partition structure and an intra block copy mode or a template matching prediction mode is applied to a current chroma component block, encoding/decoding information of a current chroma component block corresponding to the current luma component block may be derived from encoding/decoding information of a current luma component block.

In this case, encoding information of a current chroma component block may be derived from encoding information of a luma component block corresponding to a sample position corresponding to the center of a current chroma component block. Alternatively, encoding information of a current chroma component block may be derived from encoding information of a luma component block corresponding to a sample position corresponding to the top-left of a current chroma component block.

The encoding mode of a current chroma component block may be derived based on at least one of the encoding parameters of a current chroma component block/a CTB or a luma component block/a CTB corresponding to a current chroma component block/a CTB.

When a luma component and a chroma component have an independent block partition structures (a tree type DUAL_TREE_LUMA or DUAL_TREE_CHROMA for a dual tree structure), encoding mode information for determining the encoding mode of a current chroma component block may be entropy encoded/decoded. Here, an encoding mode may represent a prediction mode. The encoding mode of a chroma component block may include at least one of an intra prediction mode, an inter prediction mode or an intra block copy mode in the same way as the encoding mode of a luma component block.

As an example, when a syntax element representing the prediction mode information of a current chroma component block has a first value (e.g., 0), the encoding mode of a current chroma component block may be determined as an intra prediction mode. When a syntax element representing the prediction mode information of a current chroma component block has a second value (e.g., 1), the encoding mode of a current chroma component block may be determined as an inter prediction mode. When a syntax element representing the prediction mode information of a current chroma component block has a third value (e.g., 2), the encoding mode of a current chroma component block may be determined as an intra block copy mode.

Alternatively, based on first prediction mode information (e.g., an index, a flag or an identifier (e.g., pred_mode_flag)), whether an intra prediction mode is applied to a chroma component block may be determined. As an example, when first prediction mode information has a first value (e.g., 1), it represents that an intra prediction mode is applied to a chroma component block, and when first prediction mode information has a second value (e.g., 0), it represents that an intra prediction mode is not applied to a chroma component block.

When an intra prediction mode is not applied to a chroma component block, second prediction mode information (e.g., an index, a flag or an identifier (e.g., pred_mode_ibc_flag)) may be additionally entropy encoded/decoded. Second prediction mode information may represent whether an intra prediction mode or an intra block copy mode is applied to a chroma component block. As an example, when second prediction mode information has a first value (e.g., 1), it may represent that an intra block copy mode is applied to a chroma component block. On the other hand, when second prediction mode information has a second value (e.g., 2), it may represent that an inter prediction mode is applied to a chroma component block.

Alternatively, first prediction mode information (e.g., an index, a flag or an identifier (e.g., pred_mode_flag)) may represent whether an intra prediction mode or an inter prediction mode is applied to a chroma component block. As an example, when first prediction mode information is a first value (e.g., 1), it represents that an intra prediction mode is applied to a chroma component block. On the other hand, when second prediction mode information has a second value (e.g., 0), it represents that an inter prediction mode is applied to a chroma component block. Second prediction mode information (e.g., an index, a flag or an identifier (e.g., pred_mode_ibc_flag)) representing whether an intra block copy mode is applied may be additionally entropy encoded/decoded, or may derive the value of second prediction mode information. As an example, when second prediction mode information is a first value (e.g., 1), it represents that an intra block copy mode is applied to a chroma component block. On the other hand, when second prediction mode information is a second value (e.g., 0), it represents that an intra prediction mode or an inter prediction mode determined in first prediction mode information is applied to a chroma component block.

Alternatively, when second prediction mode information is a first value (e.g., 1), it represents that an intra block copy mode is applied to a chroma component block, and when second prediction mode information is a second value (e.g., 0), it represents that an intra prediction mode is applied to a chroma component block.

Alternatively, when second prediction mode information indicates that an intra prediction mode is applied, whether a template matching prediction mode is applied may be determined based on a template matching prediction mode flag.

When a luma component and a chroma component have an independent block partition structure and an intra block copy mode or a template matching prediction mode is applied to a current chroma component block, information (e.g., a block vector) required for encoding/decoding a current chroma component block may be derived from encoding information of a luma component block corresponding to a current chroma component block.

In this case, encoding information of a luma component block corresponding to a sample position corresponding to the center of a current chroma component block may be used. Alternatively, encoding information of a luma component block corresponding to a sample position corresponding to the top-left of a current chroma component block may be used.

Based on the above-described description, when an intra block copy mode is applied to a current block, a method for encoding/decoding a current block will be described in detail.

FIG. 26 is a flowchart of a method for encoding a current block under an intra block copy mode.

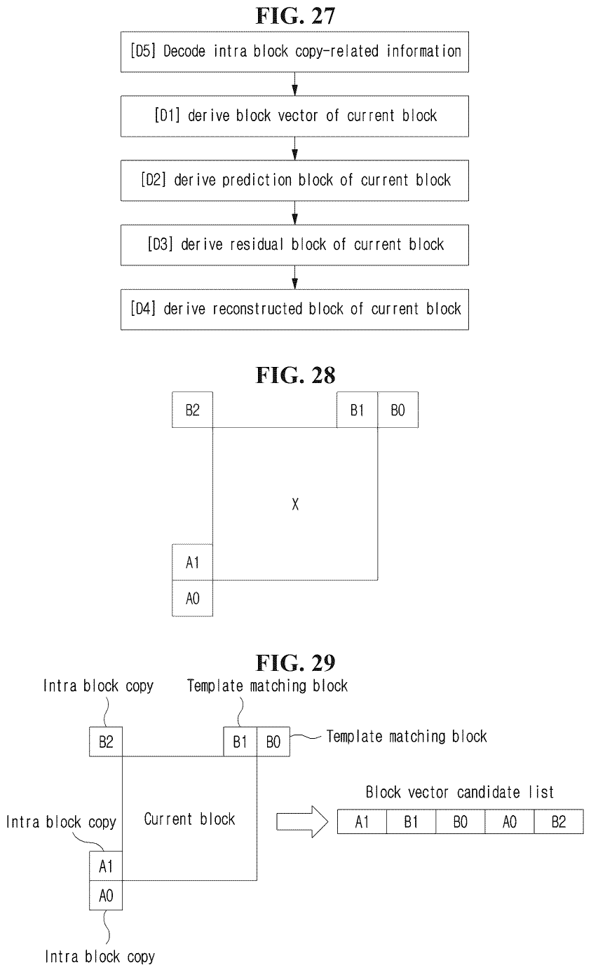

FIG. 27 is a flowchart of a method for decoding a current block under an intra block copy mode.

Hereinafter, each step in FIGS. 26 and 27 will be described in detail.

### [E1/D1] A Step for Deriving Block Vector Information for Intra Block Copy Prediction;

A step for deriving a block vector for prediction using an intra block copy mode may include at least one of a step for deriving the block vector of a luma component block (hereinafter, step [E1-1/D1-1]) and a step for deriving the block vector of a chroma component block (hereinafter, step [E1-2/D1-2]).

For convenience of a description, a step for deriving the block vector of a luma component block and a step for deriving the block vector of a chroma component are described separately. However, unless otherwise described, embodiments described in a step for deriving the block vector of a luma component block may be used to derive the block vector of a chroma component block, and embodiments described in a step for deriving the block vector of a chroma component block may be used to derive the block vector of a luma component block.

### [E1-1/D1-1] A Step for Deriving the Block Vector of a Luma Component Block;

When an intra block copy skip mode or an intra block copy merge mode is applied to a current luma component block, the block vector of a current luma component block may be derived as follows. The following embodiment may also be applied when a template matching prediction mode is applied to a current luma component block.

In addition, in a method for deriving a block vector described below, a block vector configuring a candidate list or a derived block vector may be a block vector for intra block copy or a template matching block vector.

In order to derive the block vector of a current luma component block, the block vector of a luma component block encoded/decoded before a current block is derived as a block vector candidate. At least one block vector candidate may be inserted to configure a block vector candidate list and select at least one of the block vector candidates included in a configured block vector candidate list. A selected block vector candidate may be set as the block vector of a current block.

In this case, block vector candidate information (e.g., an identifier, an index or a flag (e.g., merge_idx)) for identifying a block vector candidate used for a current luma component block among a plurality of block vector candidates included in a block vector candidate list may be entropy encoded/decoded. Alternatively, encoding/decoding of block vector candidate information may be omitted, and a value thereof may be derived based on at least one of the encoding parameters.

In this case, at least one block vector candidate list may be configured for a current block. In addition, at least one block vector candidate may be selected for a current block.

A block vector candidate list may be configured with up to N candidates. In this case, N may be a positive integer and may refer to the maximum number of block vector candidates that may be included in a block vector candidate list. N may be derived based on at least one of the encoding parameters of a current block/a CTB. Alternatively, N may be predefined in an encoder and a decoder. Alternatively, information for determining the N may be entropy encoded/decoded.

A block vector candidate derived from spatial candidates of a current block may be included in a block vector candidate list.

FIG. 28 shows spatial candidates according to an embodiment of the present disclosure.

As in an example shown in FIG. 28, a block vector candidate may be derived from at least one of the blocks corresponding to block B1 adjacent to the top of current block X, block A1 adjacent to the left of a current block, block B0 positioned at the top-right corner of a current block, block B2 positioned at the top-left corner of a current block or block A0 positioned at the bottom-left corner of a current block.

At least one of the block vector candidates derived from spatial candidates may be included in a block vector candidate list.

When an adjacent block is encoded/decoded by an intra block vector, the block vector of an adjacent block may be set as a block vector candidate. Alternatively, the block vector of an adjacent block set as a block vector candidate may be derived by template matching.

Meanwhile, for a neighboring block B2 adjacent to the top-left corner of a current block, when all of neighbor blocks A1, B1, B0 and A0 are available (e.g., when block vector information exists in all of A1, B1, B0 and A1), they may be determined to be unavailable as a block vector candidate. In other words, in this case, block vector information of block B2 may not be included in a block vector candidate list.

In addition, according to a predetermined priority, whether block vector information exists in neighboring blocks at the position of A0, A1, B0, B1 and B2 (i.e., whether a corresponding neighboring block is encoded/decoded by using an intra block copy mode or whether the encoding mode of a corresponding neighboring block is an intra block copy mode) may be determined. When block vector information exists in a corresponding neighboring block, the block vector of a corresponding neighboring block may be set as a block vector candidate. In this case, at least one of the block vectors determined as a set block vector candidate may be inserted into a block vector candidate list. As an example, the search order (i.e., priority) of block vector candidates for configuring a block vector candidate list may be the order of A1, B1, B0, A0 and B2.

In configuring a block vector candidate list according to a predetermined priority, a redundancy check may be performed between a block vector candidate existing in a block vector candidate list and a block vector candidate to be newly added to a block vector candidate list. For example, when a block vector candidate to be newly added to a block vector candidate list overlaps with a block vector candidate existing in a block vector candidate list, a new block vector candidate may not be added to a block vector candidate list.

A redundancy check may be performed between a block vector candidate to be added to a block vector candidate list and all block vector candidates existing in a block vector candidate list.

Alternatively, a redundancy check may be performed only on some of the block vector candidates included in a block vector candidate list. For example, in configuring a block vector candidate list in the order of A1, B1, B0, A0 and B2, a B1 block may perform a redundancy check with a A1 block, and a B0 block may perform a redundancy check with a B1 block. In addition, a A0 block may perform a redundancy check with a A1 block, and a B2 block may perform a redundancy check with a A1 block and a B1 block. A redundancy check may be performed only when a block vector exists in a corresponding block.

In addition, each of the blocks at the position of A0, A1, B0, B1 and B2 may be available as a block vector candidate only when block vector information exists in a corresponding block and the block vector information is available in a current block. The block vector of a neighbor block available as a block vector candidate may be determined as a block vector candidate. A neighbor block that is not available as a block vector candidate may not be used as a block vector candidate. In this case, whether the block vector information of a neighbor block is available may be determined based on whether a reference sample (or, a reference block) at a position indicated by the block vector is available when the block vector of a neighbor block is applied to a current block.

For example, when the position of a reference sample or a reference block indicated by the block vector of a neighbor block indicates a sample included in a current block or includes a sample included in a current block, it may be determined that the block vector of a corresponding neighbor block is not available for a current block.

For example, when the position of a reference sample or a reference block indicated by the block vector of a neighbor block includes at least one of a region/a position/a sample beyond the boundary of a sub-picture, a slice, a tile group, a tile or a brick, it may be determined that the block vector of a corresponding neighbor block is not available for a current block.

The block vector of at least one of the blocks encoded/decoded before a current block may be stored in a buffer, and at least one of the block vectors stored in a corresponding buffer may be set as a block vector candidate for a current block. In this case, at least one block vector candidate derived from the buffer may be included in the block vector candidate list of a current block. In this case, a block vector stored in a buffer may be encoded/decoded by intra block copy prediction. Alternatively, block vector stored in a buffer may be determined by template matching.

The size of a buffer may be predefined in an encoder and a decoder. The block vector of a block encoded/decoded in an intra block copy mode may be stored in a buffer. When a buffer is full, a block vector stored first may be deleted, and a new block vector (i.e., the block vector of the most recently encoded/decoded block) may be stored in a buffer.

According to the storage order among the block vectors stored in a buffer (e.g., the oldest storage order or the most recent storage order), the order of adding a block vector stored in a buffer to a block vector candidate list may be determined. For example, a block vector stored last in a buffer may be added first to a block vector candidate list. In other words, as it is stored later in a buffer, it may be added faster to a block vector candidate list. Alternatively, a block vector stored first in a buffer may be added first to a block vector candidate list. In other words, as it is stored faster in a buffer, it may be added faster to a block vector candidate list.

A buffer storing block vector candidates may be called a history-based block vector candidate list, and a block vector candidate included in the buffer may be called a history-based block vector candidate.

A buffer including a history-based block vector may be managed/used separately from a buffer including a history-based motion vector in an inter prediction mode.

Alternatively, a buffer including a history-based block vector may be managed by being divided into a first block vector buffer storing a block vector encoded/decoded for intra block copy prediction and a second block vector buffer storing a block vector derived by template matching.

When a history-based block vector candidate is added to a block vector candidate list, whether a corresponding history-based block vector candidate is available for a current block may be determined. Only when it is determined that a history-based block vector candidate is available for a current block, a corresponding history-based block vector candidate may be added to a block vector candidate list. In this case, whether a history-based block vector candidate is available may be determined based on whether a reference sample (or a reference block) at a position indicated by the block vector of a corresponding candidate is available.

For example, when the position of a reference sample or a reference block indicated by the block vector of a history-based block vector candidate indicates a sample included in a current block or includes a sample included in a current block, it may be determined that a corresponding history-based block vector candidate is not available for a current block.

For example, when the position of a reference sample or a reference block indicated by the block vector of a history-based block vector candidate includes at least one of a region/a position/a sample beyond the boundary of a sub-picture, a slice, a tile group, a tile or a brick, it may be determined that a corresponding history-based block vector candidate is not available for a current block. When a history-based block vector candidate is added to a block vector candidate list, a redundancy check may be performed between a history-based block vector candidate and block vector candidates existing in a block vector candidate list. A history-based block vector candidate may be added to a block vector candidate list when the same block vector candidate does not exist in a block vector candidate list.

As another example, when a history-based block vector candidate is added to a block vector candidate list, a history-based block vector candidate may be added to a block vector candidate list without performing a redundancy check with a block vector candidate existing in a block vector candidate list.

A buffer including history-based block vector candidates may be initialized in the unit of a picture, a slice, a sub-picture, a brick, a tile group, a tile, a CTU, a CTU row or a CTU column. In other words, the buffer may be maintained and used while encoding/decoding listed units.

In addition, the buffer may include at least one of the encoding information of a previously encoded/decoded block based on a current block within the unit of a picture, a slice, a sub-picture, a brick, a tile group, a tile, a CTU, a CTU row or a CTU column.

When a buffer is initialized, all block vectors existing in a buffer may be deleted. Alternatively, when a buffer is initialized, a block vector existing in a buffer may be changed to a predetermined value, or all candidates in a buffer may be deleted and an initial history-based block vector candidate having a predetermined value may be inserted into a buffer. In this case, a predetermined value may represent the value of at least one of the x component or the y component of a block vector. A predetermined value may be an integer predefined in an encoder and a decoder (e.g., (0, 0), (1, 1), (−1, −1), etc.).

In the present disclosure, a method for deriving a spatial block vector to configure a block vector candidate list is as follows.

In order to configure the block vector candidate list of a current block, a spatial block vector candidate may be derived from adjacent blocks around a current block.

In this case, when an adjacent block is encoded/decoded by an intra block copy method or a template matching prediction method, the block vector of an adjacent block may be derived as a block vector candidate and a derived block vector candidate may be stored in a block vector candidate list.

FIGS. 29 to 31 show a method for configuring a block vector candidate list including spatial block vector candidates.

In referring to the block vector of adjacent blocks of a current block, as in an example shown in FIG. 29, the order of block vectors added to a block vector candidate list may be A1, B1, B0, A0, B2.

Alternatively, in configuring the block vector candidate list of a current block, a block vector candidate derived from an adjacent block encoded/decoded by an intra block copy method among the adjacent blocks of a current block may be stored first in a block vector candidate list. Afterwards, a block vector candidate derived from an adjacent block encoded/decoded by a template matching prediction method among the adjacent blocks of a current block may be stored in a block vector candidate list.

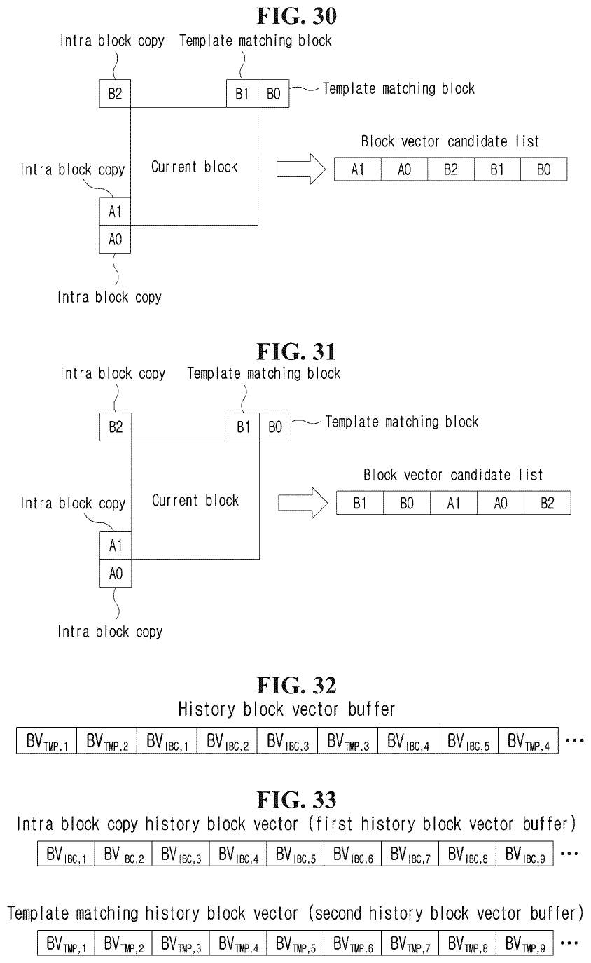

When a rule above is followed, as in an example shown in FIG. 30, a block vector candidate list may be configured. It is assumed that search order among adjacent blocks is A1, B1, B0, A0, B2 as above.

Alternatively, in configuring the block vector candidate list of a current block, a block vector candidate derived from an adjacent block encoded/decoded by a template matching prediction method among the adjacent blocks of a current block may be stored first in a block vector candidate list. Afterwards, a block vector candidate derived from an adjacent block encoded/decoded by an intra block copy method among the adjacent blocks of a current block may be stored in a block vector candidate list.

When a rule above is followed, as in an example shown in FIG. 31, a block vector candidate list may be configured. It is assumed that search order among adjacent blocks is A1, B1, B0, A0, B2 as above.

As described above, the block vector candidate list of a current block may include the block vector of an adjacent block encoded/decoded by an intra block copy method and the block vector of an adjacent block derived through template matching prediction among the adjacent blocks. In this case, the maximum number of block vector candidates based on an intra block copy method that may be stored in a block vector candidate list may be N and the maximum number of block vector candidates derived based on template matching prediction may be M. N and M are an integer greater than 0, and N may be 4 and M may be 2.

Meanwhile, when deriving a block vector candidate from an adjacent block, whether to add the block vector of an adjacent block to a block vector candidate list may be determined by considering the size of an adjacent block.

For example, when W, the width of an adjacent block encoded/decoded by template matching prediction, has a value less than or equal to N, the block vector of a corresponding adjacent block may be added to a block vector candidate list. In this case, a positive integer N may be at least one of 4, 8, 16, 32 and 64.

For example, when H, the height of an adjacent block encoded/decoded by template matching prediction, has a value less than or equal to M, the block vector of a corresponding adjacent block may be added to a block vector candidate list. In this case, a positive integer M may be at least one of 4, 8, 16, 32 and 64.

For example, when the product of the width W and the height H of an adjacent block encoded/decoded by template matching prediction (i.e., W*H) has a value less than or equal to K, the block vector of a corresponding adjacent block may be added to a block vector candidate list. In this case, a positive integer K may be at least one of 16, 32, 64, 96, 128, 256, 512 and 1024.

For example, when W, the width of an adjacent block encoded/decoded by template matching prediction, has a value greater than or equal to N, the block vector of a corresponding adjacent block may be added to a block vector candidate list. In this case, a positive integer N may be at least one of 4, 8, 16, 32 and 64.

For example, when H, the height of an adjacent block encoded/decoded by template matching prediction, has a value greater than or equal to M, the block vector of a corresponding adjacent block may be added to a block vector candidate list. In this case, a positive integer M may be at least one of 4, 8, 16, 32 and 64.

For example, when the product of the width W and the height H of an adjacent block encoded/decoded by template matching prediction (i.e., W*H) has a value greater than or equal to K, the block vector of a corresponding adjacent block may be added to a block vector candidate list. In this case, a positive integer K may be at least one of 16, 32, 64, 96, 128, 256, 512 and 1024.

Meanwhile, in configuring a block vector candidate list, a history block vector may be used.

Block vectors of blocks encoded/decoded by intra prediction within the same picture as a current block and block vectors of blocks encoded/decoded by template matching prediction may be stored in a history block vector buffer. A block vector candidate list may be configured by referring to a history block vector buffer.

Meanwhile, the block vector of a block encoded/decoded by an intra block copy mode and the block vector of a block encoded/decoded by template matching may be stored in the same history block vector buffer.

FIG. 32 shows an example in which the block vector of a block encoded/decoded in an intra block copy mode and the block vector of a block encoded/decoded by template matching are stored in one history block vector buffer.

The size of a history block vector buffer is an integer greater than 0, and may be N. As an example, N may be 5.

For example, as in an example shown in FIG. 32, block vectors (BV_{IBC, i}) of a block encoded/decoded by intra block copy prediction and block vectors (BV_{TMP, j}) of a block encoded/decoded by template matching prediction may be sequentially stored in one buffer in encoding/decoding order among blocks.

The block vector candidate list of a current block may be configured by referring to a history block vector buffer.

The size of a history block vector buffer of the encoded/decoded intra block copy block vector and the size of a history block vector buffer of a block vector derived by template matching may be limited to N and M, an integer greater than 0, respectively, and N may be 25 and M may be 15.

As another example, a history block vector buffer storing the block vector of a block encoded/decoded in an intra block copy and a history block vector buffer storing the block vector of a block encoded/decoded by template matching may exist individually.

FIG. 33 shows an example in which a history block vector buffer storing the block vector of a block encoded/decoded in an intra block copy mode and a history block vector buffer storing the block vector of a block encoded/decoded by template matching are individually managed.

As in an example shown in FIG. 33, block vectors (BV_{IBC, i}) of a block encoded/decoded by intra block copy prediction may be sequentially stored in a first history block vector buffer in encoding/decoding order among blocks. In addition, block vectors (BV_{TMP, j}) of a block encoded/decoded by template matching prediction may be sequentially stored in a second history block vector buffer in encoding/decoding order among blocks.

In this case, the size of a first history block vector buffer may be N, and the size of a second history block vector buffer may be M. N and M are an integer greater than 0, and N may be 25 and M may be 15.

In order to configure the block vector candidate list of a current block, a spatial block vector candidate may be derived from adjacent blocks around a current block.

In this case, the maximum number of spatial block vectors that may be added to the block vector candidate list may be limited to N. N may be an integer greater than 0. As an example, N may be 4.

Afterwards, a block vector candidate list may be updated by referring to at least one of a first history block vector buffer or a second history block vector buffer.

Meanwhile, the maximum number of history block vectors that may be added to a block vector candidate list may be limited to M. M may be an integer greater than 0. As an example, M may be 10.

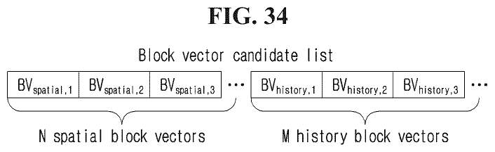

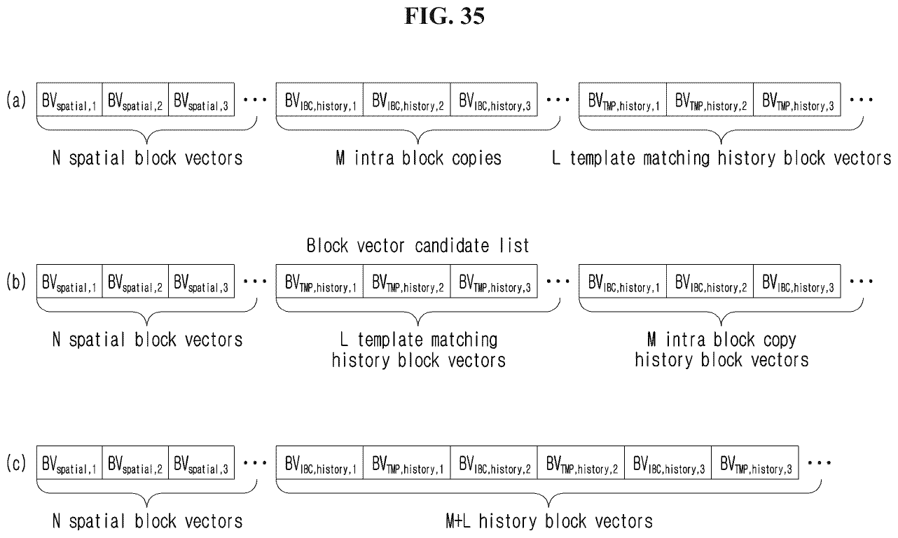

FIGS. 34 and 35 show an example in which the block vector candidate list of a current block is configured.

As in an example shown in FIG. 34, the maximum number of spatial block vector candidates that may be added to a block vector candidate list may be limited to N.

In addition, the maximum number of history block vector candidates that may be added to a block vector candidate list may be limited to M.

When a first history block vector buffer or a second history block vector buffer is managed separately, a block vector candidate list may be updated by referring to at least one of a first history block vector buffer or a second history block vector buffer.

As an example, as in an example shown in FIG. 35(a), a block vector candidate list may be updated based on a first history block vector buffer. When the number of block vector candidates included in a block vector candidate list is less than a threshold value even if a block vector candidate list is updated by using a first history block vector buffer, a block vector candidate list may be re-updated by using a second history block vector buffer.

Alternatively, as in an example shown in FIG. 35(b), a block vector candidate list may be updated based on a second history block vector buffer. When the number of block vector candidates included in a block vector candidate list is less than a threshold value even if a block vector candidate list is updated by using a second history block vector buffer, a block vector candidate list may be re-updated by using a first history block vector buffer.

Here, a threshold value may be the maximum number of block vector candidates that may be included in a block vector candidate list.

Alternatively, as in an example shown in FIG. 35(c), a block vector candidate list may be updated by alternately referring to a first history block vector buffer and a second history block vector buffer. As an example, after inserting a candidate with the largest (or smallest) index in a first history block vector buffer into a block vector candidate list, a candidate with the largest (or smallest) index in a second history block vector buffer may be inserted into a block vector candidate list.

Meanwhile, the maximum number of history block vector candidates that may be added to a block vector candidate list from a first history block vector buffer may be limited to M. In addition, the maximum number of block vector candidates that may be added to a block vector candidate list from a second history block vector buffer may be limited to L.

Here, M and L above may be an integer greater than 0. As an example, M may be 10 and L may be 5.

Template matching may be used to refine block vector candidates in a block vector candidate list. Here, a block vector candidate list may include at least one of a spatial block vector candidate or a block vector candidate derived from a history block vector buffer. Here, a block vector candidate derived from a history block vector may be a block vector candidate derived from a block encoded/decoded in an intra block copy mode or a block vector candidate derived from a block vector encoded/decoded in a template matching prediction mode.

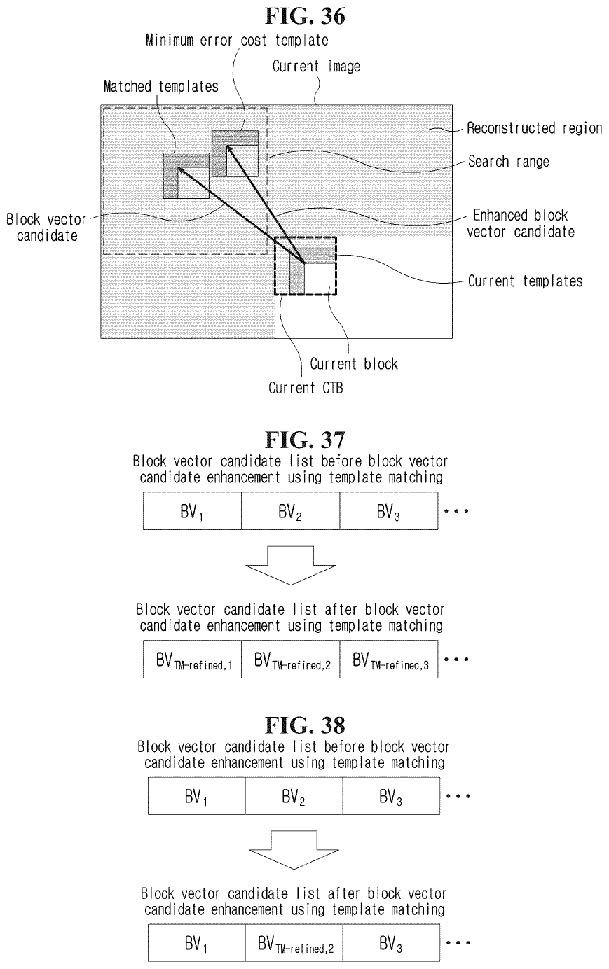

FIG. 36 is to describe an example in which a block vector candidate is improved by applying template matching.

In order to refine block vector candidates, a current template may be configured by using the neighboring reconstructed region of a current block. Afterwards, a search range may be set, focusing on a position indicated by a block vector candidate. Afterwards, the position of a template within a search range may be adjusted to determine the position of a template with the minimum error cost between a current template and pixel values. A block vector indicating the top-left position of a block corresponding to a current block may be derived as a refined block vector from the position of a template having the minimum cost. The block vector of a block vector candidate may be changed/updated to a refined block vector.

FIGS. 37 and 38 show an example in which block vector candidates are updated.

A method for refining a block vector by using template matching may be applied to all or some of the block vector candidates in the block vector candidate list.

As an example, as in an example shown in FIG. 37, an update based on template matching may be performed on all block vector candidates in a block vector candidate list. Alternatively, as in an example shown in FIG. 38, an update based on template matching may be performed on some block vector candidates in a block vector candidate list.

Alternatively, whether to update a block vector candidate may be determined by comparing the cost of the minimum cost template determined through template matching with a threshold value. As an example, a block vector candidate may be updated only when the cost of the minimum cost template is smaller than a threshold value.

Meanwhile, a search range may be limited to a predefined size.

As an example, a search range may be a rectangle including N pixels in top/bottom/left/right directions, focusing on a position indicated by the block vector of a block vector candidate. As an example, N may be 8.

Alternatively, information for determining at least one of the size or shape of a search range may be entropy encoded/decoded within a high level syntax, e.g., a parameter set.

Meanwhile, a search range may not exceed the search range of intra block copy. In other words, a search range may be positioned within a search range for searching block copy under an intra block copy mode.

As another example, block vector candidates within a block vector candidate list may be re-ordered based on template matching.

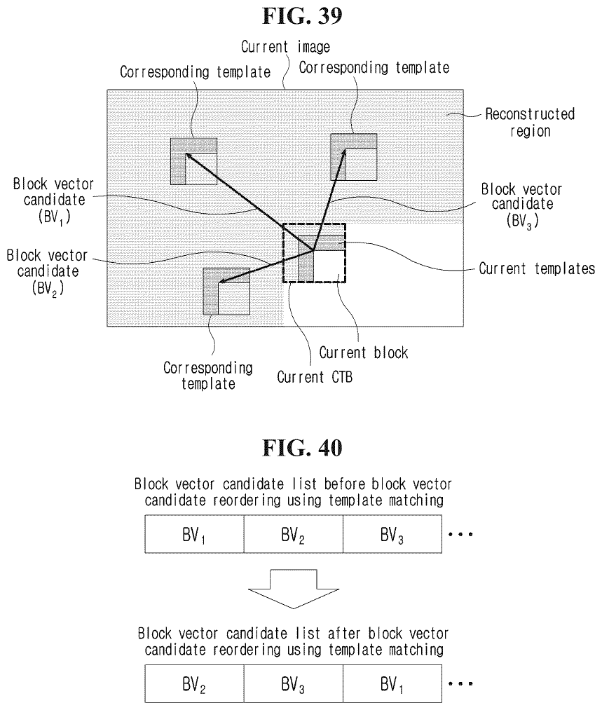

FIGS. 39 and 40 shows an example in which block vector candidates within a block vector candidate list are reordered.

Template matching may be applied to each block vector candidate in a block vector candidate list.

Specifically, a current template may be configured by using the neighboring reconstructed region of a current block, and a corresponding template having the same size/shape as a current template (hereinafter, referred to as a reference template) may be configured in a reconstructed region around a corresponding block at a position indicated by the block vector of a block vector candidate.

Afterwards, an error cost between a current template and a reference template may be calculated.

Afterwards, the error cost of each block vector candidate may be compared to reorder block vector candidates in size order of error blocks. As an example, reordering may be performed so that the smallest index is allocated to a block vector with the minimum error cost and the largest index is allocated to a block vector with the maximum error cost.

A combined block vector candidate may be configured by combining at least two of the block vector candidates existing in a block vector candidate list. A combined block vector candidate generated by combining at least two block vector candidates may be added to a block vector candidate list. Meanwhile, at least one of the block vector candidates existing in a block vector candidate list may be a block vector derived based on template matching.

A combined block vector candidate may be derived based on a statistical value for each of the x component and the y component of a block vector of block vector candidates. As an example, for a plurality of block vector candidates, the value of a x component with the highest frequency and the value of a y component with the highest frequency may be set as the value of a x component and the value of a y component of a combined block vector candidate, respectively.

In this case, in configuring a combined block vector candidate, a history-based block vector candidate may be set not to be used. Alternatively, in configuring a combined block vector candidate, a block vector candidate derived from a neighboring block adjacent to a current block may be set not to be used.

A combined block vector candidate may be added to a block vector candidate list only when a combined block vector candidate derived from block vector candidates is available in a current block. In this case, whether a combined block vector is available may be determined based on whether a reference sample (block) at a position indicated by the block vector of a combined block vector is available.

For example, when a region/a position indicated by a combined block vector candidate includes at least one of the samples included in a current block, a combined block vector candidate may be determined to be unavailable.

For example, when a region/a position indicated by a combined block vector candidate includes at least one of a region/a position/a sample beyond the boundary of a picture, a sub-picture, a slice, a tile group, a tile or a brick, a combined block vector candidate may be determined to be unavailable.

A block vector candidate may also be derived based on the size of a current block. As an example, when the horizontal length of a current luma component block is W and a vertical length is H, (−(W<<n)+a, −(H<<n)+b), (−(W<<n)+c, 0) or (0, −(H<<n)+d) may be added to a block vector candidate list as a block vector candidate. In this case, n may be a positive integer and a, b, c and d may be an integer. A block vector candidate derived based on the size of a current block may be called a fixed basic block vector candidate.

A block vector candidate list may be configured by adding at least one of a block vector candidate derived from a neighboring block adjacent to a current block, a history-based block vector candidate, a combined block vector candidate or a fixed basic block vector candidate.

In this case, the insertion order of block vector candidates may follow a predetermined priority. As an example, the insertion order of block vector candidates may be the order of the block vector candidate of a neighboring block adjacent to a current block, a history-based block vector candidate, a combined block vector candidate and a fixed basic block vector candidate.

Alternatively, when the number of block vector candidates included in a block vector candidate list is not the maximum number, a fixed basic block vector candidate may be inserted into a block vector candidate list until the number of block vector candidates in a block vector candidate list reaches the maximum number. As an example, a fixed basic block vector candidate may be added to a block vector candidate list in the following order.

$$( - ( W ≪ 1 ) , 0 ) . \qquad 1$$

$$( 0 , - ( H ≪ 1 ) ) . \qquad 2$$

$$( - ( W ≪ 1 ) - 1 , 0 ) . \qquad 3$$

$$( 0 , - ( H ≪ 1 ) - 1 ) . \qquad 4$$

$$( - ( W ≪ 1 ) - 2 , 0 ) . \qquad 5$$

$$( 0 , - ( H ≪ 1 ) - 2 ) . \qquad 6$$

$$( - ( W ≪ 1 ) - 3 , 0 ) . \qquad 7$$

$$( 0 , - ( H ≪ 1 ) - 3 ) . \qquad 8$$

$$( - ( W ≪ 1 ) - 4 , 0 ) . \qquad 7$$

$$( 0 , - ( H ≪ 1 ) - 4 ) . \qquad 8$$

As another example, a fixed basic block vector may be a (0, 0) vector. When the number of block vector candidates in a block vector candidate list is smaller than the maximum number of block vector candidates that may be included in a block vector candidate list, a fixed basic block vector may be repeatedly added to a block vector candidate list until the number of block vector candidates reaches the maximum number.

In configuring a block vector candidate list, the maximum number of spatial block vector candidates that may be included in a block vector candidate list may be the maximum number (N) of block vector candidates that may be included in a block vector candidate list or a value (N−m) obtained by subtracting a predetermined value from the maximum number. Here, N may be a positive integer and m may be a positive integer. In addition, N may be a value greater than m. A spatial block vector candidate represents a block vector candidate derived from a neighboring block adjacent to a current block.

In configuring a block vector candidate list, the maximum number of history-based block vector candidates that may be included in a block vector candidate list may be the maximum number (N) of block vector candidates that may be included in a block vector candidate list or a value (N−m) obtained by subtracting a predetermined value from the maximum number. Here, N may be a positive integer and m may be a positive integer. In addition, N may be a value greater than m.

In configuring a block vector candidate list, the maximum number of combined block vector candidates that may be included in a block vector candidate list may be the maximum number (N) of block vector candidates that may be included in a block vector candidate list or a value (N−m) obtained by subtracting a predetermined value from the maximum number. Here, N may be a positive integer and m may be a positive integer. In addition, N may be a value greater than m.

In configuring a block vector candidate list, the maximum number of fixed basic block vector candidates that may be included in a block vector candidate list may be the maximum number (N) of block vector candidates that may be included in a block vector candidate list or a value (N−m) obtained by subtracting a predetermined value from the maximum number. Here, N may be a positive integer and m may be a positive integer. In addition, N may be a value greater than m.

The maximum number of block vector candidates that may be included in a block vector candidate list may be preset in an encoder/a decoder. Alternatively, information for determining the maximum number may be encoded in an encoder and signaled to a decoder.

A block vector candidate may be derived according to at least one of the encoding parameters of a current block/a CTB.

A block vector candidate may be added to a block vector candidate list according to at least one of the encoding parameters of a current block/a CTB.

Each of a plurality of blocks generated by partitioning an upper block may be encoded/decoded in an intra block copy skip mode, an intra block copy merge mode or an intra block copy AMVP mode. In this case, when the size of at least one of the blocks partitioned from an upper block is smaller than a predetermined threshold value, a block vector candidate list configured based on an upper block may be used. For example, blocks partitioned from an upper block may share a block vector candidate list configured based on an upper block.

Whether to share a block vector candidate list configured in an upper block may be determined based on at least one of the width (W) or height (H) of an upper block or a lower block generated by partitioning an upper block. For example, when at least one of the conditions below is satisfied, at least one of the lower blocks (i.e., blocks partitioned from an upper block) may use a block vector candidate list configured based on an upper block.
When an upper block is quad tree-partitioned: (width of upper block×height of upper block)/4<threshold value
When an upper block is binary tree-partitioned horizontally or vertically: (width of upper block×height of upper block)/2<threshold value
When an upper block is ternary tree-partitioned horizontally or vertically: (width of upper block×height of upper block)/4<threshold value

In the above-described conditions, a threshold value may be a preset value in an encoder/a decoder. Alternatively, information for determining the threshold value may be encoded in an encoder and signaled to a decoder. Alternatively, according to a partition type applied to an upper block (i.e., a quad tree, a binary tree or a ternary tree), a threshold value may be set differently.

Meanwhile, a threshold value may be a positive integer. In addition, the threshold value may be at least one of the width of a block, the height of a block or the product of the width and height of a block (i.e., the area of a block).

Alternatively, the threshold value may be determined based on at least one of the encoding parameters of a current block/a CTB.

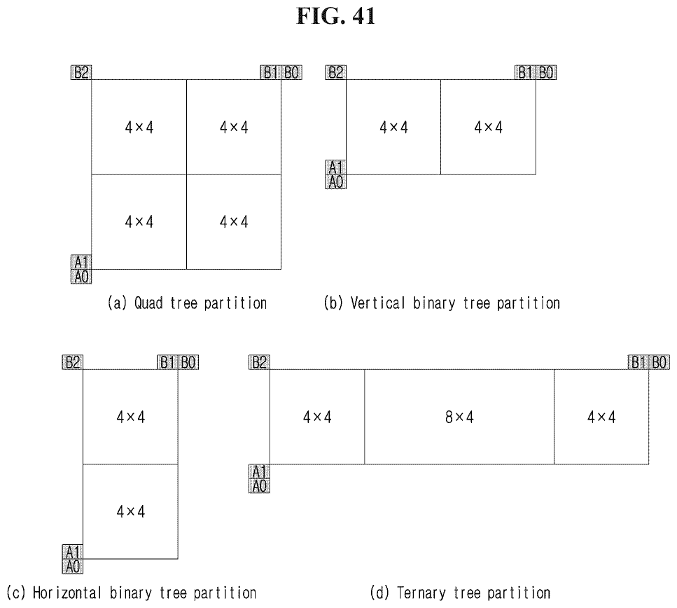

FIG. 41 shows an example in which a block vector candidate list derived based on an upper block is shared with lower blocks.

It is assumed that a threshold value is 32. When quad tree partition, vertical or horizontal binary tree partition or vertical or horizontal ternary tree partition is applied to an upper block and the area of at least one lower block generated accordingly is smaller than a threshold value 32, a lower block to which an intra block copy skip mode, an intra block copy merge mode or an intra block copy AMVP mode is applied may be encoded/decoded based on a block vector candidate list derived based on an upper block. In this case, a block vector candidate list derived based on an upper block may be configured by including at least one of a block vector candidate derived from a neighboring block adjacent to an upper block (i.e., at least one of A1, B1, B0, A0 or B2), a history-based block vector candidate previously encoded/decoded based on an upper block and stored in a buffer, a combined block vector candidate or a fixed basic block vector. In this case, a fixed basic block vector may be derived based on the width and height of an upper block.

When a block vector candidate list derived based on an upper block is used in at least one of the lower blocks, a block vector candidate whose reference block indicated by a block vector is positioned within an upper block may not be available to a lower block.

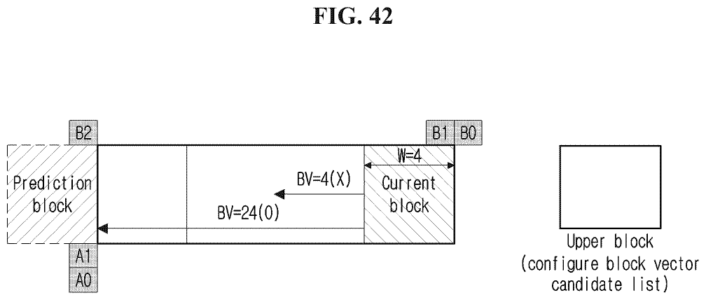

FIG. 42 is an example for describing a block vector candidate that is unavailable to a lower block.

In an example shown in FIG. 42, a bold solid line represents an upper block including a lower block (a current block) indicated by a thin solid line. When a block vector candidate list derived based on an upper block is used for a current block, a block vector candidate may be determined to be valid for a current block only when a region/a position/a sample indicated by a block vector from a current block indicates a region/a position/a sample encoded/decoded before an upper block.

In other words, a block vector candidate may not be available for a lower block when a region/a position/a sample indicated by a block vector from a current block includes a region/a position/a sample included in an upper block.

For a lower block, information indicating one of the block vector candidates included in a block vector candidate list may be encoded and signaled. In this case, the information may indicate one of the block vector candidates available for a lower block in a block vector candidate list. In other words, a block vector candidate list may be reconfigured only with block vector candidates available to a lower block and information indicating one of the reconfigured block vector candidates may be encoded/decoded for a lower block.

When an intra block copy skip mode or an intra block copy merge mode is applied to at least one of the partitioned lower blocks, a block vector candidate list configured based on an upper block may be used in at least one of the lower blocks.

Alternatively, when a merge candidate list configured based on an upper block is used in at least one of the lower blocks, a lower block may not be encoded/decoded in an intra block copy skip mode and an intra block copy merge mode. In this case, a lower block may be encoded/decoded in an intra block copy AMVP mode. However, in this case, a block vector candidate may be available to a lower block only when the block vector of a block vector candidate indicates a region encoded/decoded before an upper block.

When at least one of the width and/or height of a current block is equal to or smaller than a threshold value, it may not be allowed to apply at least one of an intra block copy skip mode or an intra block copy merge mode to a current block. The threshold value may be a positive integer predefined in an encoder/a decoder. Alternatively, information representing the threshold value may be encoded in an encoder and signaled to a decoder.

For example, when the width and height of a current block are smaller than 8, it may not be allowed to apply at least one of an intra block copy skip mode or an intra block copy merge mode to a current block.

A threshold value may be set under a condition for using a merge candidate list configured based on an upper block in a lower block. In this case, when the product of the width and height of a current block is equal to or less than a threshold value for using a merge candidate list configured based on an upper block in a lower block, it may not be allowed to apply at least one of an intra block copy skip mode or an intra block copy merge mode to a current block. In this case, a current block may be one of the blocks partitioned from an upper block.

For example, it is assumed that a threshold value for determining whether a merge candidate list configured based on an upper block is available in a lower block is 32. In this case, only when the product of the width and height of a current block is greater than 32, it may be allowed to apply at least one of an intra block copy skip mode or an intra block copy merge mode to a current block.

In contrast to the embodiment, when the size of a current block (e.g., the product of the width and height of a current block) is less than or equal to a threshold value for determining whether a block vector candidate list configured based on an upper block is available in a lower block, it may not be allowed to apply at least one of a skip mode or a merge mode to a current block. In this case, at least one of the skip mode and the merge mode may refer to a mode for performing encoding/decoding through motion compensation based on a motion vector, not a block vector.

For example, it is assumed that a threshold value for determining whether a block vector candidate list configured based on an upper block is available in a lower block is 32. In this case, only when the product of the width and height of a current block is greater than 32, it may be allowed to apply at least one of a skip mode or a merge mode based on a motion vector, not a block vector, to a current block.

In the embodiment and/or another embodiment in the present disclosure, when a specific mode is not allowed, it may mean that a specific mode is not used as the encoding mode of a current block.

It is also possible to configure an integrated merge candidate list that includes both motion vector information and block vector information. As an example, when a first neighbor block adjacent to a current block is encoded/decoded by inter prediction, motion information of a first neighbor block may be derived as a first merge candidate and inserted into a merge candidate list. In addition, when a second neighbor block adjacent to a current block is encoded/decoded by intra block copy, the block vector of a second neighbor block may be derived as a second merge candidate and inserted into a merge candidate list.

According to the encoding mode of a current block, available merge candidates in an integrated merge candidate list may be determined. As an example, when inter prediction is applied to a current block, only merge candidates having motion information in an integrated merge candidate list may be available for a current block. Alternatively, when an intra block copy mode is applied to a current block, only merge candidates having a block vector in an integrated merge candidate list may be available for a current block.

For example, when a current block is encoded/decoded in an intra block copy skip mode or an intra block copy merge mode, a current block may be encoded/decoded based on at least one of the merge candidates having a block vector, not a motion vector, in an integrated merge candidate list. In this case, when an intra block copy skip mode or an intra block copy merge mode is applied to a current block, index information (i.e., a merge index) for identifying one of the merge candidates included in an integrated merge candidate list may indicate one of the candidates having a block vector included in an integrated merge candidate list.

For example, when a current block is encoded/decoded in a skip mode or a merge mode, a current block may be encoded/decoded based on at least one of the merge candidates having a motion vector, not a block vector, in an integrated merge candidate list. In this case, when a skip mode or a merge mode is applied to a current block, index information (i.e., a merge index) for identifying one of the merge candidates included in an integrated merge candidate list may indicate one of the candidates having a motion vector included in an integrated merge candidate list.

Meanwhile, an integrated merge candidate list derived based on an upper block may be used for at least one lower block. As an example, when at least one of the lower blocks partitioned from an upper block is smaller than a predetermined threshold value, an integrated merge candidate list configured based on an upper block may be used for at least one of the lower blocks.

Meanwhile, an integrated merge candidate list may include at least one of a motion vector candidate derived from a neighboring block adjacent to a block, a block vector candidate derived from a neighboring block adjacent to a block, a temporal motion vector candidate, a history-based motion vector candidate, a history-based block vector candidate, a (0,0) motion vector candidate or a fixed basic block vector candidate.

When a block vector candidate list configured based on an upper block is used in at least one of the lower blocks, the block vector of a lower block may not be added to a buffer used to derive a history-based block vector candidate. In other words, the buffer may not be updated with the block vector of a lower block.

On the other hand, when a block vector candidate list configured based on an upper block is not used in at least one of the lower blocks (e.g., when the block vector list of a lower block is configured based on a lower block), the block vector of a lower block may be added to a buffer used to derive a history-based block vector candidate. In other words, an update may be performed to add the block vector of a lower block to the buffer.

As another example, when a current block is a luma component block and an intra block copy AMVP mode is applied to a current luma component block, a method for deriving the block vector of a current luma component block may be as follows. Meanwhile, although a current luma component block is encoded/decoded in a template matching prediction mode, the block vector of a current luma component block may be derived according to an embodiment described below.

In addition, in a method for deriving a block vector described below, a block vector used to configure a candidate list and a block vector derived based on a candidate list may be at least one of a block vector for intra block copy or a block vector derived through template matching.

Similar to an intra block copy skip mode or an intra block copy merge mode, a prediction block vector candidate list may be configured that may include up to N prediction block vector candidates. In this case, N may be a positive integer. Here, N may refer to the maximum number of prediction block vector candidates that may be included in a prediction block vector candidate list.

At least one of the prediction block vector candidates included in a prediction block vector candidate list may be selected. In a prediction block vector candidate list, at least one of the information (e.g., an identifier or an index or a flag or mvp_l0_flag, etc.) for identifying a prediction block vector candidate selected for a current block may be entropy encoded/decoded. Alternatively, a prediction block vector candidate may be selected based on at least one of the encoding parameters.

In this case, at least one prediction block vector candidate list may be configured. In addition, at least one prediction block vector candidate may be used in a current block. In addition, at least one prediction block vector candidate information may be entropy encoded/decoded. Prediction block vector candidate information may be for selecting at least one of a plurality of prediction block vector candidates. When there are a plurality of prediction block candidate lists, prediction block vector candidate information may be entropy encoded/decoded for each list.

A prediction block vector candidate selected by prediction vector candidate information may be used for a current block. Specifically, the block vector of a prediction block vector candidate may be set as the prediction block vector of a current block.

An encoder may calculate a block vector difference (BVD) between the block vector of a current block and a prediction block vector and entropy encode a calculated block vector difference.

A decoder may entropy decode a block vector difference and derive the block vector of a current block by combining a block vector difference and the prediction block vector of a current block.

Meanwhile, information about a block vector difference may include sign information of a block vector difference and magnitude information of a block vector difference.

In this case, sign information may be entropy encoded/decoded based on prediction of a block vector sign. As an example, the sign combination of a block vector difference is four: (+, +), (−, +), (−, +), and (−, −). Accordingly, when the magnitude information of a block vector difference is (Vxd, Vyd), the block vector difference of a current block may be (Vxd, Vyd), (−Vxd, Vyd), (Vxd, −Vyd) and (−Vxd, −Vyd).

A prediction block vector may be added to each of the four block vector difference candidates to derive four block vectors and calculate a template matching cost for each of the four block vectors. Afterwards, a sign combination may be sorted according to a template matching cost. Specifically, the smallest index may be allocated to a sign combination with the smallest template matching cost.

Afterwards, one of the four sign combinations may be selected based on an index.

In addition, instead of encoding/decoding the entire magnitude of a block vector, some bits may be replaced with an index. As an example, magnitude combinations may be configured for N most significant suffix bins (MSSB) among the bits generated when the size of a block vector difference is encoded/decoded with an exponential golomb code. As an example, N may be a natural number greater than or equal to 1 such as 2, 4 or 6. Afterwards, according to the magnitude combinations, N block vector candidates are derived, and a prediction block vector is added to each of the N block vector candidates to derive N block vectors. Then, a template matching cost may be calculated for each of the N block vectors, and magnitude candidates may be sorted according to a template matching cost. Specifically, the smallest index may be allocated to a magnitude candidate with the smallest template matching cost.

Afterwards, one of the N magnitude candidates may be selected based on an index.

In addition, entropy encoding/decoding based on prediction may be applied for both a sign and a magnitude. As an example, when N is 4, a total of 16 block vector difference value candidates may be derived. A template matching cost for each of the 16 block vector difference value candidates may be calculated, and block vector difference value candidates may be sorted according to a template matching cost.

Afterwards, one of the 16 block vector difference value candidates may be selected based on an index.

A block vector candidate list for an intra block copy AMVP mode may be configured in the same manner as the block vector candidate list of an intra block copy merge mode. For example, a prediction block vector candidate list may include at least one of the following prediction block vector candidates.

In FIG. 28, adjacent blocks may be searched in the order of A0 and A1, and whether an adjacent block is encoded/decoded in an intra block copy mode may be determined. The block vector of an adjacent block encoded/decoded in an intra block copy mode may be determined as prediction block vector candidate A.

Alternatively, prediction block vector candidate A may be derived by considering only a block corresponding to A1. As an example, when an adjacent block at position A1 is encoded/decoded in an intra block copy mode, it may be determined as prediction block vector candidate A.

In addition, in FIG. 28, adjacent blocks may be searched in the order of B0, B1 and B2, and whether an adjacent block is encoded/decoded in an intra block copy mode may be determined. The block vector of an adjacent block encoded/decoded in an intra block copy mode may be determined as prediction block vector candidate B.

Alternatively, prediction block vector candidate B may be derived by considering only a block corresponding to B1. As an example, when an adjacent block at position B1 is encoded/decoded in an intra block copy mode, it may be determined as prediction block vector candidate B.

At least one of the prediction block vector candidates derived by the above-described method may be added to a prediction block vector candidate list.

In this case, the order of insertion into a prediction block vector candidate list may be the order of A and B.

Meanwhile, in the above-described embodiments, even when an adjacent block is encoded/decoded in a template matching prediction mode, not in an intra block copy mode, a block vector candidate may be derived based on the block vector of an adjacent block.

In addition, a block vector stored in a history block vector buffer may be inserted into a prediction block vector candidate list as a block vector candidate.

Meanwhile, the block vector of a block may be stored in a block vector buffer according to the encoding/decoding order of blocks. In this case, when a buffer is full, a block vector stored first may be deleted and a new block vector (i.e., the block vector of a block encoded/decoded most recently) may be stored.

A priority of including a block vector stored in a corresponding buffer in a prediction block vector candidate list may be changed according to the order of storage among the block vectors stored in a corresponding buffer (e.g., the order of oldest storage or the order of most recent storage). For example, a block vector may be included first in a prediction block vector candidate list in the order of most recent storage in a buffer. Alternatively, a block vector may be included first in a prediction block vector candidate list in the order of earliest storage.

Such a prediction block vector candidate may be called a history-based prediction block vector candidate. In other words, a block vector stored in a corresponding buffer may mean a history-based prediction block vector candidate.

When a prediction block vector candidate list is configured by using at least one of the history-based prediction block vector candidates, whether a corresponding history-based prediction block vector candidate is available for a current block may be determined. Only when a history-based prediction block vector candidate is available, a corresponding history-based prediction block vector candidate may be added to a prediction block vector candidate list.

In this case, whether a history-based prediction block vector candidate is available may be determined according to whether a reference sample (block) at a position indicated by a corresponding prediction block vector candidate is available.

For example, when a region/a position indicated by a history-based prediction block vector candidate includes at least one of the samples included in a current block, it may be determined that a corresponding history-based prediction block vector candidate is unavailable.

For example, when a region/a position indicated by a history-based prediction block vector candidate includes at least one of the regions/positions/samples beyond the boundary of a picture, a sub-picture, a slice, a tile group, a tile or a brick, it may be determined that a corresponding history-based prediction block vector candidate is unavailable.

When a prediction block vector candidate list is configured by using at least one of the history-based prediction block vector candidates, a redundancy check may be performed between a corresponding history-based prediction block vector candidate and prediction block vector candidates existing in a prediction block vector candidate list. As a result of the redundancy check, when the same prediction block vector candidate as a history-based prediction block vector does not exist, a corresponding history-based prediction block vector candidate may be added to a prediction block vector candidate list.

Alternatively, a history-based prediction block vector candidate may be added to a prediction block vector candidate list without performing a redundancy check.

A buffer including history-based prediction block vector candidates may be maintained during encoding/decoding in a unit of a picture, a slice, a sub-picture, a brick, a tile group, a tile, a CTU, a CTU row or a CTU column and may be used within a unit of a picture, a slice, a sub-picture, a brick, a tile group, a tile, a CTU, a CTU row or a CTU column.

In addition, the buffer may include at least one of the encoding information of a block encoded/decoded before a current block within a unit of a picture, a slice, a sub-picture, a brick, a tile group, a tile, a CTU, a CTU row or a CTU column.

In addition, when the buffer is configured in a unit of a picture, a slice, a sub-picture, a brick, a tile group, a tile, a CTU, a CTU row or a CTU column, it may be initialized at a start position/region/block/unit in a unit of a picture, a slice, a sub-picture, a brick, a tile group, a tile, a CTU, a CTU row or a CTU column. In this case, when a buffer is initialized, all block vectors existing in a buffer may be deleted. In addition, when a buffer is initialized, all block vectors existing in a buffer may be determined as a predetermined value. In this case, a predetermined value may mean the value of x and y from block vector (x, y), and for example, x and y may be one of the integer values.

A combined prediction block vector candidate may be configured by combining at least two of the prediction block vector candidates existing in a prediction block vector candidate list. A combined prediction block vector candidate generated by combining at least two prediction block vector candidates may be added to a prediction block vector candidate list. Meanwhile, at least one of the prediction block vector candidates existing in a prediction block vector candidate list may be a block vector derived based on template matching.

A combined prediction block vector candidate may be derived based on a statistical value for each of the x component and the y component of a block vector of prediction block vector candidates. As an example, for a plurality of prediction block vector candidates, the value of a x component with the highest frequency and the value of a y component with the highest frequency may be set as the value of a x component and the value of a y component of a combined prediction block vector candidate, respectively.

In this case, when configuring a combined prediction block vector candidate, a history-based prediction block vector candidate may be set not to be used. Alternatively, when configuring a combined prediction block vector candidate, a prediction block vector candidate derived from a neighboring block adjacent to a current block may be set not to be used.

Only when a combined prediction block vector candidate derived from prediction block vector candidates is available in a current block, a combined prediction block vector candidate may be added to a prediction block vector candidate list. In this case, whether a combined block vector is available may be determined according to whether a reference sample (block) at a position indicated by the block vector of a combined block vector is available.

For example, when a region/a position indicated by a combined prediction block vector candidate includes at least one of the samples included in a current block, it may be determined that a combined prediction block vector candidate is unavailable.

For example, when a region/a position indicated by a combined prediction block vector candidate includes at least one of the regions/positions/samples beyond the boundary of a picture, a sub-picture, a slice, a tile group, a tile or a brick, it may be determined that a combined prediction block vector candidate is unavailable.

A prediction block vector candidate may also be derived based on the size of a current block. As an example, when the width of a current luma component block is W and the height is H, (−(W<<n)+a, −(H<<n)+b), (−(W<<n)+c, 0) or (0, −(H<<n)+d) may be added to a prediction block vector candidate list as a prediction block vector candidate. In this case, n may be a positive integer and a, b, c and d may be an integer. A prediction block vector candidate derived based on the size of a current block may be called a fixed basic prediction block vector candidate.

A prediction block vector candidate list may be configured by adding at least one of a prediction block vector candidate derived from a neighboring block adjacent to a current block, a history-based prediction block vector candidate, a combined prediction block vector candidate or a fixed basic prediction block vector candidate.

In this case, the insertion order of prediction block vector candidates may follow the priority of composition. As an example, the insertion order of prediction block vector candidates may be in the order of the prediction block vector candidate of a neighboring block adjacent to a current block, a history-based prediction block vector candidate, a combined prediction block vector candidate and a fixed basic prediction block vector candidate.

Alternatively, when the number of prediction block vector candidates included in a prediction block vector candidate list is not the maximum number, a fixed basic prediction block vector candidate may be inserted into a prediction block vector candidate list until the number of prediction block vector candidates in a prediction block vector candidate list reaches the maximum number. As an example, a fixed basic prediction block vector candidate may be added to a prediction block vector candidate list in the following order.

$$( - ( W ≪ 1 ) , 0 ) . \qquad 1$$

$$( 0 , - ( H ≪ 1 ) ) . \qquad 2$$

$$( - ( W ≪ 1 ) - 1 , 0 ) . \qquad 3$$

$$( 0 , - ( H ≪ 1 ) - 1 ) . \qquad 4$$

$$( - ( W ≪ 1 ) - 2 , 0 ) . \qquad 5$$

$$( 0 , - ( H ≪ 1 ) - 2 ) . \qquad 6$$

$$( - ( W ≪ 1 ) - 3 , 0 ) . \qquad 7$$

$$( 0 , - ( H ≪ 1 ) - 3 ) . \qquad 8$$

$$( - ( W ≪ 1 ) - 4 , 0 ) . \qquad 7$$

$$( 0 , - ( H ≪ 1 ) - 4 ) . \qquad 8$$

As another example, a fixed basic block vector may be a (0, 0) vector. When the number of prediction block vector candidates in a prediction block vector candidate list is less than the maximum number of prediction block vector candidates that may be included in a prediction block vector candidate list, a fixed basic block vector may be repeatedly added to a prediction block vector candidate list until the number of prediction block vector candidates reaches the maximum number.

When configuring a prediction block vector candidate list, the maximum number of spatial prediction block vector candidates that may be included in a prediction block vector candidate list may be the maximum number (N) of prediction block vector candidates that may be included in a prediction block vector candidate list or a value (N−m) obtained by subtracting a predetermined value from the maximum number. Here, N may be a positive integer and m may be a positive integer. In addition, N may be greater than m. A spatial prediction block vector candidate represents a prediction block vector candidate derived from a neighboring block adjacent to a current block.

When configuring a prediction block vector candidate list, the maximum number of history-based prediction block vector candidates that may be included in a prediction block vector candidate list may be the maximum number (N) of prediction block vector candidates that may be included in a prediction block vector candidate list or a value (N−m) obtained by subtracting a predetermined value from the maximum number. Here, N may be a positive integer and m may be a positive integer. In addition, N may be greater than m.

When configuring a prediction block vector candidate list, the maximum number of combined prediction block vector candidates that may be included in a prediction block vector candidate list may be the maximum number (N) of prediction block vector candidates that may be included in a prediction block vector candidate list or a value (N−m) obtained by subtracting a predetermined value from the maximum number. Here, N may be a positive integer and m may be a positive integer. In addition, N may be greater than m.

When configuring a prediction block vector candidate list, the maximum number of fixed basic prediction block vector candidates that may be included in a prediction block vector candidate list may be the maximum number (N) of prediction block vector candidates that may be included in a prediction block vector candidate list or a value (N−m) obtained by subtracting a predetermined value from the maximum number. Here, N may be a positive integer and m may be a positive integer. In addition, N may be greater than m.

The maximum number of prediction block vector candidates that may be included in a prediction block vector candidate list may be preset in an encoder/a decoder. Alternatively, information for determining the maximum number may be encoded in an encoder and signaled to a decoder.

A prediction block vector candidate may be derived according to at least one of the encoding parameters of a current block/a CTB.

A prediction block vector candidate may be added to a prediction block vector candidate list according to at least one of the encoding parameters of a current block/a CTB.

As another example, when a current block is a luma component block and an intra block copy skip mode, an intra block copy merge mode or an intra block copy AMVP mode is applied to a current luma component block, the block vector of a current luma component block may be derived as follows.

First, a block vector candidate list may include up to N block vector candidates. Here, N is a positive integer, and may represent the maximum number of block vector candidates that may be included in a block vector candidate list. N may be derived based on the encoding parameter of a current block/a CTB.

The maximum number of block vector candidates that may be included in a block vector candidate list may be determined based on the maximum number of merge candidates that may be included in a merge candidate list under an inter prediction mode.

For example, information indicating the maximum number of merge candidates that may be included in a merge candidate list used in an inter prediction mode (e.g., six_minus_max_num_merge_cand) may be entropy encoded/decoded. The maximum number of merge candidates that may be included in a merge candidate list used in an inter prediction mode may be derived as in Equation 5 below.

$$Max NumMergeCand = N - six\_minus \_max \_num \_merge \_cand \qquad [ Equation 5 ]$$

A variable MaxNumMergeCand represents the maximum number of merge candidates that may be included in a merge candidate list. MaxNumMergeCand may have a value from 1 to N. Here, N may be a positive integer. As an example, N may be 6.

MaxNumMergeCand, the maximum number of merge candidate that may be included in a merge candidate list used in an inter prediction mode, may be set as the maximum number of block vector candidates that may be included in a block vector candidate list.

$$Max NumIBCCand = max NumMergeCand \qquad [ Equation 6 ]$$

In Equation 6 above, a variable MaxNumIBCCand represents the maximum number of block vector candidates that may be included in a block vector candidate list.

As another example, information indicating the maximum number of merge candidates that may be included in a merge candidate list used in an inter prediction mode (e.g., six_minus_max_num_merge_cand) may be entropy encoded/decoded. Based on the information, the maximum number (MaxNumMergeCand) of merge candidates that may be included in a merge candidate list used in an inter prediction mode may be derived. Meanwhile, based on the maximum number MaxNumMergeCand, the maximum number of block vector candidates that may be included in a block vector candidate list may be determined as in Equation 7 below.

$$Max NumIBCCCand = Max ( M , max NumMergeCand ) \qquad [ Equation 7 ]$$

In Equation 7 above, M is a positive integer, for example, may be 2.

As another example, information indicating the maximum number of merge candidates that may be included in a merge candidate list used in an inter prediction mode (e.g., six_minus_max_num_merge_cand) may be entropy encoded/decoded. Based on the information, the maximum number (MaxNumMergeCand) of merge candidates that may be included in a merge candidate list used in an inter prediction mode may be derived. Meanwhile, based on the maximum number MaxNumMergeCand and the encoding mode of a current block, the maximum number of block vector candidates that may be included in a block vector candidate list may be derived.

As an example, when an intra block copy skip mode or an intra block copy merge mode is applied to a current block, MaxNumIBCCand, the maximum number of block vector candidates that may be included in a block vector candidate list, may be set to be the same as the maximum number MaxNumMergeCand according to Equation 6.

On the other hand, when an intra block copy AMVP mode is applied to a current block, MaxNumIBCCand, the maximum number of block vector candidates that may be included in a block vector candidate list, may be determined according to Equation 7.

For example, let's assume that M is 2 and MaxNumMergeCand is 1. When an intra block copy skip mode or an intra block copy merge mode is applied to a current block, the maximum number of block vector candidates that may be included in a block vector candidate list may be determined as 1 according to Equation 6. On the other hand, when an intra block copy AMVP mode is applied to a current block, the maximum number of block vector candidates that may be included in a block vector candidate list may be determined as 2 according to Equation 7.

As another example, when an intra block copy skip mode or an intra block copy merge mode is applied to a current block, MaxNumIBCCand, the maximum number of block vector candidates that may be included in a block vector candidate list, may be set to be the same as the maximum number MaxNumMergeCand according to Equation 6.

On the other hand, when an intra block copy AMVP mode is applied to a current block, the maximum number of block vector candidates that may be included in a block vector candidate list may be fixed to M.

Here, M is a positive integer, for example, may be 2.

For example, it is assumed that MaxNumMergeCand is 6 and M is 2. In this case, when an intra block copy skip mode or an intra block copy merge mode is applied to a current block, the maximum number of block vector candidates that may be included in the block vector candidate list of a current block may be set as 6. On the other hand, when an intra block copy AMVP mode is applied to a current block, the maximum number of block vector candidates that may be included in the block vector candidate list of a current block may be determined as 2.

Alternatively, information indicating the maximum number of block vector candidates that may be included in a block vector candidate list may be separately entropy encoded/decoded.

For example, information indicating the maximum number of block vector candidates that may be included in a block vector candidate list (e.g., six_minus_max_num_ibc_cand) may be entropy encoded/decoded. In this case, the maximum number of block vector candidates that may be included in a block vector candidate list may be derived as in Equation 8 below.

$$Max NumIBCCand = N - six\_minus \_max \_num \_ibc \_cand \qquad [ Equation 8 ]$$

A variable MaxNumIBCCand may have a value from 0 to N. Here, N may be a positive integer. For example, N may be 6.

As another example, information indicating a difference between the maximum number of merge candidates that may be included in a merge candidate list and the maximum number of block vector candidates that may be included in a block vector candidate list (e.g., max_num_merge_cand_minus_max_num_ibc_cand) may be entropy encoded/decoded. In this case, the maximum number of block vector candidates that may be included in a block vector candidate list may be derived according to Equation 9 below.

$$Max NumIBCCand = Max NumMergeCand - max\_num \_merge \_cand \_minus \_max \_num \_ibc \_cand \qquad [ Equation 9 ]$$

In Equation 9 above, MaxNumIBCCand may have a value from 2 to MaxNumMergeCand.

Information indicating the maximum number of block vector candidates that may be included in a block vector candidate list (e.g., at least one of six_minus_max_num_ibc_cand or max_num_merge_cand_minus_max_num_ibc_cand) may be encoded/decoded in a high level parameter or header within a bitstream. Meanwhile, information related to the maximum number may be entropy encoded/decoded only when information indicating whether an intra block copy (IBC) function signaled in a high level parameter or header is used indicates that an intra block copy (IBC) function is used.

For example, information related to the maximum number may be entropy encoded/decoded only when sps_ibc_enabled_flag which is entropy encoded/decoded in a sequence parameter set is a second value (e.g., 1).

At least one of the N and M may be derived according to at least one of the encoding parameters of a current block/a CTB.

Alternatively, the maximum number of block vector candidates that may be included in a block vector candidate list may be fixed/pre-defined as N in an encoder/a decoder. Here, N may have a positive integer value. N may also be derived according to at least one of the encoding parameters of a current block/a CTB.

For example, N, the maximum number of candidates in a block vector candidate list, may be 2.

For example, N, the maximum number of candidates in a block vector candidate list, may be 5.

For example, N, the maximum number of candidates in a block vector candidate list, may be 6.

Meanwhile, a value of N may be determined differently according to the encoding mode of a current block. Here, an encoding mode may represent at least one of an intra block copy skip mode, an intra block copy merge mode or an intra block copy AMVP mode based on an intra block copy mode.

For example, when an intra block copy skip mode or an intra block copy merge mode is applied to a current block, a value of N may be 6.

For example, when an intra block copy AMVP mode is applied to a current block, a value of N may be 2.

A block vector candidate list according to the present disclosure may include at least one of the following candidates.

In an example of FIG. 28, a block vector from at least one of the blocks corresponding to block A1 adjacent to the left of a current block and block B1 adjacent to the top of a current block may be determined as a block vector candidate for a current block. In this case, at least one of the derived block vector candidates may be added to a block vector candidate list.

Blocks at the position of A1 and B1 are sequentially searched according to a predetermined priority. The block vector of a block in which a block vector exists (i.e., a block encoded/decoded by using an intra block copy mode) may be determined as a block vector candidate in predefined order. In this case, a predetermined priority of insertion into a block vector candidate list may be A1 and B1.

When configuring a block vector candidate list according to the predetermined priority, a redundancy check may be performed between a block vector candidate existing in a block vector candidate list and a block vector candidate newly added to a block vector candidate list. For example, when a block vector candidate newly added to a block vector candidate list overlaps with a block vector candidate that already exists in a block vector candidate list, an overlapping block vector candidate may not be added to a block vector candidate list.

For example, when configuring a block vector candidate list in the order of A1 and B1, a redundancy check may be performed between the block vector of block B1 and the block vector of block A1. Only when block B1 has a block vector that is not the same as block A1, the block vector of block B1 may be added to a block vector candidate list. The redundancy check may be performed only when a block vector exists in a corresponding block.

In addition, when a block vector exists in at least one of the blocks included in at least one position of A1 and B1, the block vector of a corresponding neighboring block may be determined as a block vector candidate only when the block vector of a corresponding block is available after determining whether it is available in a current block. When it is not available, it may not be used as a block vector candidate. In this case, whether a block vector is available may be determined according to whether a reference sample (block) at a position indicated by a corresponding block vector is available.

For example, when a region/a position indicated by a corresponding block vector includes at least one of the samples included in a current block, it may be determined that a corresponding block vector is unavailable.

For example, when a region/a position indicated by a corresponding block vector includes at least one of the regions/positions/samples beyond the boundary of a picture, a sub-picture, a slice, a tile group, a tile or a brick, it may be determined that a corresponding block vector is unavailable.

When the number of candidates in a block vector candidate list is less than the maximum number of candidates in a block vector candidate list, a block vector candidate list may be updated based on a buffer where at least one of the block vectors of blocks encoded/decoded before a current block is stored. Specifically, a block vector stored in the buffer may be added to a block vector candidate list as a block vector candidate.

At least one of the block vectors of blocks encoded/decoded before a current block may be stored in a buffer. It may be stored in a buffer and at least one of the block vectors stored in a corresponding buffer may be determined as a block vector candidate for a current block. In this case, at least one of the determined block vector candidates may be included in a block vector candidate list.

In this case, the block vector of blocks whose encoding/decoding is completed may be sequentially stored in a buffer of a specific size. When a buffer is full, a block vector stored first may be deleted and a new block vector (i.e., the block vector of the most recently encoded/decoded block) may be stored in a buffer.

The priority of including a block vector stored in a corresponding buffer in a block vector candidate list may be different according to the storage order of block vectors stored in a corresponding buffer (e.g., the order of old storage or the order of recent storage). For example, as it is stored in a buffer recently, it may be added to a block vector candidate list first. In other words, a block vector stored last in a buffer may be added to a block vector candidate list first.

Alternatively, as it is stored in a buffer earlier, it may be added to a block vector candidate list first. In other words, a block vector stored first in a buffer may be added to a block vector candidate list first.

As above, a block vector candidate derived from a buffer may be called a history-based block vector candidate. In other words, a block vector stored in a corresponding buffer may refer to a history-based block vector candidate.

When at least one of the history-based block vector candidates are used to configure a block vector candidate list, a corresponding history-based block vector candidate may be added to a block vector candidate list only when a corresponding history-based block vector candidate is used by determining whether it is available in a current block. In this case, whether a corresponding history-based block vector is available may be determined by whether a reference sample (block) is available at a position indicated by a corresponding block vector.

For example, when a region/a position indicated by a corresponding history-based block vector includes at least one of the samples included in a current block, a corresponding history-based block vector may be determined to be unavailable.

For example, when a region/a position indicated by a corresponding history-based block vector includes at least one of a region/a position/a sample beyond the boundary of a picture, a sub-picture, a slice, a tile group, a tile or a brick, a corresponding history-based block vector may be determined to be unavailable.

When the number of candidates in a block vector candidate list is less than the maximum number of candidates in a block vector candidate list and at least one block vector exists in a buffer where the block vector of blocks encoded/decoded before a current block is stored, a history-based block vector candidate may be added to a block vector candidate list until the number of candidates in a block vector candidate list reaches the maximum number of candidates in a block vector candidate list.

When a block vector candidate list is configured by using at least one of the history-based block vector candidates, a redundancy check may be performed between a corresponding history-based block vector candidate and block vector candidates existing in a block vector candidate list. As a result of performing a redundancy check, when the same block vector as a history-based block vector candidate does not exist, a history-based block vector candidate may be added to a block vector candidate list.

For example, a redundancy check may be performed between a history-based block vector candidate and block vector candidates derived from neighboring blocks A1 and B1 adjacent to a current block.

Alternatively, a redundancy check may be performed only for a history-based block vector candidate in specific order. As an example, a redundancy check with block vectors A1 and B1 may be performed only for a first history-based block vector candidate in a buffer. Alternatively, a redundancy check with block vectors A1 and B1 may be performed only for first and second history-based block vector candidates in a buffer.

Alternatively, a redundancy check with block vectors A1 and B1 may be performed for all history-based block vector candidates in a buffer.

As another example, when a history-based block vector candidate is added to a block vector candidate list, a history-based block vector candidate may be added to a block vector candidate list without performing a redundancy check with a block vector candidate existing in a block vector candidate list.

A buffer including history-based block vector candidates may be used within the unit of a picture, a slice, a sub-picture, a brick, a tile group, a tile, a CTU, a CTU row or a CTU column by being maintained during encoding/decoding in the unit of a picture, a slice, a sub-picture, a brick, a tile group, a tile, a CTU, a CTU row or a CTU column.

In addition, the buffer may include at least one of the encoding information of a block encoded/decoded before a current block within a unit of a picture, a slice, a sub-picture, a brick, a tile group, a tile, a CTU, a CTU row or a CTU column.

In addition, when the buffer is configured in a unit of a picture, a slice, a sub-picture, a brick, a tile group, a tile, a CTU, a CTU row or a CTU column, it may be initialized at a start position/region/block/unit in a unit of a picture, a slice, a sub-picture, a brick, a tile group, a tile, a CTU, a CTU row or a CTU column. In this case, when a buffer is initialized, all block vectors existing in a buffer may be deleted. In addition, when a buffer is initialized, all block vectors existing in a buffer may be determined as a predetermined value. In this case, a predetermined value may mean the value of x and y from block vector (x, y), and for example, x and y may be one of the integer values.

A combined block vector candidate may be configured by combining at least two of the block vector candidates existing in a block vector candidate list. A combined block vector candidate generated by combining at least two block vector candidates may be added to a block vector candidate list. Meanwhile, at least one of the block vector candidates existing in a block vector candidate list may be a block vector derived based on template matching.

A combined block vector candidate may be derived based on a statistical value for each of the block vector x-component and y-component of block vector candidates. As an example, for a plurality of block vector candidates, the value of a x-component with the highest frequency and the value of a y-component with the highest frequency may be set as the value of a x-component and the value of a y-component of a combined block vector candidate, respectively.

In this case, in configuring a combined block vector candidate, a history-based block vector candidate may be set not to be used. Alternatively, in configuring a combined block vector candidate, a block vector candidate derived from a neighboring block adjacent to a current block may be set not to be used.

A combined block vector candidate may be added to a block vector candidate list only when a combined block vector candidate derived from block vector candidates is available in a current block. In this case, whether a combined block vector is available may be determined according to whether a reference sample (block) at a position indicated by the block vector of a combined block vector is available.

For example, when a region/a position indicated by a combined block vector candidate includes at least one of the samples included in a current block, a combined block vector candidate may be determined to be unavailable.

For example, when a region/a position indicated by a combined block vector candidate includes at least one of a region/a position/a sample beyond the boundary of a picture, a sub-picture, a slice, a tile group, a tile or a brick, a combined block vector candidate may be determined to be unavailable.

A block vector candidate may also be derived based on the size of a current block. As an example, when the width of a current luma component block is W and the height is H, (−(W<<n)+a, −(H<<n)+b), (−(W<<n)+c, 0) or (0, −(H<<n)+d) may be added to a block vector candidate list as a block vector candidate. In this case, n may be a positive integer and a, b, c and d may be an integer. A block vector candidate derived based on the size of a current block may be called a fixed basic block vector candidate.

A block vector candidate list may be configured by adding at least one of a block vector candidate derived from a neighboring block adjacent to a current block, a history-based block vector candidate, a combined block vector candidate or a fixed basic block vector candidate.

In this case, the insertion order of the block vector candidates may follow the priority of the composition. As an example, the insertion order of the block vector candidates may be the order of a block vector candidate of a neighboring block adjacent to a current block, a history-based block vector candidate, a combined block vector candidate and a fixed basic block vector candidate.

Alternatively, when the number of block vector candidates included in a block vector candidate list is not the maximum number, a fixed basic block vector candidate may be inserted into a block vector candidate list until the number of block vector candidates in a block vector candidate list reaches the maximum number. As an example, a fixed basic block vector candidate may be added to a block vector candidate list according to the following order.

$$1. ( - ( W << 1 ) , 0 )$$

$$2. ( 0 , - ( H << 1 ) )$$

$$3. ( - ( W << 1 ) - 1 , 0 )$$

$$4. ( 0 , - ( H << 1 ) - 1 )$$

$$5. ( - ( W << 1 ) - 2 , 0 )$$

$$6. ( 0 , - ( H << 1 ) - 2 )$$

$$7. ( - ( W << 1 ) - 3 , 0 )$$

$$8. ( 0 , - ( H << 1 ) - 3 )$$

$$7. ( - ( W << 1 ) - 4 , 0 )$$

$$8. ( 0 , - ( H << 1 ) - 4 )$$

As another example, a fixed basic block vector may be a (0, 0) vector. When the number of block vector candidates in a block vector candidate list is less than the maximum number of block vector candidates that may be included by a block vector candidate list, a fixed basic block vector may be repeatedly added to a block vector candidate list until the number of block vector candidates reaches the maximum number.

In configuring a block vector candidate list, the maximum number of spatial block vector candidates that may be included in a block vector candidate list may be the maximum number (N) of block vector candidates that may be included in a block vector candidate list or a value (N−m) obtained by subtracting a predetermined value from the maximum number. Here, N may be a positive integer and m may be a positive integer. In addition, N may be greater than m. A spatial block vector candidate represents a block vector candidate derived from a neighboring block adjacent to a current block.

In configuring a block vector candidate list, the maximum number of history-based block vector candidates that may be included in a block vector candidate list may be the maximum number (N) of block vector candidates that may be included in a block vector candidate list or a value (N−m) obtained by subtracting a predetermined value from the maximum number. Here, N may be a positive integer and m may be a positive integer. In addition, N may be greater than m.

In configuring a block vector candidate list, the maximum number of combined block vector candidates that may be included in a block vector candidate list may be the maximum number (N) of block vector candidates that may be included in a block vector candidate list or a value (N−m) obtained by subtracting a predetermined value from the maximum number. Here, N may be a positive integer and m may be a positive integer. In addition, N may be greater than m.

In configuring a block vector candidate list, the maximum number of fixed basic block vector candidates that may be included in a block vector candidate list may be the maximum number (N) of block vector candidates that may be included in a block vector candidate list or a value (N−m) obtained by subtracting a predetermined value from the maximum number. Here, N may be a positive integer and m may be a positive integer. In addition, N may be greater than m.

The maximum number of block vector candidates that may be included by a block vector candidate list may be preset in an encoder/a decoder. Alternatively, information for determining the maximum number may be encoded in an encoder and signaled to a decoder.

A block vector candidate may be derived according to at least one of the encoding parameters of a current block/a CTB.

A block vector candidate may be added to a block vector candidate list according to at least one of the encoding parameters of a current block/a CTB.

At least one of information indicating the maximum number of candidates in a block vector candidate list, information indicating the maximum number of candidates in the merge candidate list of an inter prediction mode, block vector candidate information, a merge index, a L0 motion prediction flag and AMVP resolution-related information (amvr_precision_flag and/or amvr_precision_idx and/or amvr_flag) may be entropy encoded/decoded in at least one of a parameter set, a header, a brick, a CTU, a CU, a PU, a TU, a CB, a PB or a TB.

Meanwhile, information indicating the maximum value of amvr_precision_idx (max_amvr_precision_idx) and/or information indicating the maximum integer sample unit size that a block vector may have (max_amvr_precision) may be entropy encoded/decoded in at least one of a parameter set, a header, a brick, a CTU, a CU, a PU, a TU, a CB, a PB or a TB.

The value of the information indicating the maximum value of amvr_precision_idx (max_amvr_precision_idx) may be an integer greater than or equal to N.

Here, max_amvr_precision indicating the maximum integer sample unit size of the block vector may refer to a difference between the maximum sample unit size and N.

Here, the maximum integer sample unit size determined by max_amvr_precision may be derived as 2^{max_amvr_precision}.

A different integer sample unit size value may be applied to the horizontal direction and vertical direction of a block vector, respectively.

In order to apply a different integer sample unit size value for the horizontal direction and vertical direction of a block vector, respectively, information (amvr_separate_precision) indicating an integer N greater than or equal to 0 when an integer sample unit size in a horizontal direction is 2^{N} times an integer sample unit size in a vertical direction may be entropy encoded/decoded in at least one of a parameter set, a header, a brick, a CTU, a CU, a PU, a TU, a CB, a PB or a TB.

Alternatively, in order to apply a different integer sample unit size value for the horizontal direction and vertical direction of a block vector, respectively, information (amvr_separate_precision) indicating an integer N greater than or equal to 0 when an integer sample unit size in a vertical direction is 2^{N} times an integer sample unit size in a horizontal direction may be entropy encoded/decoded in at least one of a parameter set, a header, a brick, a CTU, a CU, a PU, a TU, a CB, a PB or a TB.

Alternatively, in order to apply a different integer sample unit size value for the horizontal direction and vertical direction of a block vector, respectively, information (amvr_separate_precision) indicating an integer N when an integer sample unit size in a horizontal direction is 2^{N} times an integer sample unit size in a vertical direction may be entropy encoded/decoded in at least one of a parameter set, a header, a brick, a CTU, a CU, a PU, a TU, a CB, a PB or a TB.

In this case, when the value of N is 2, the horizontal integer sample unit size of a block vector may be 4 (=2²) times a vertical integer sample unit size.

In this case, when the value of N is −1, the horizontal integer sample unit size of a block vector may be ½(=2⁻¹) times a vertical integer sample unit size.

The number of integer sample unit size values that may be applied to a block vector may be explicitly entropy encoded/decoded.

Information (num_additional_amvr_precisions) indicating a difference value between the total number of integer sample unit size values that may be applied to a block vector and M, the number of pre-defined integer sample unit size values, may be entropy encoded/decoded in at least one of a parameter set, a header, a brick, a CTU, a CU, a PU, a TU, a CB, a PB or a TB.

num_additional_amvr_precisions may refer to O integer sample unit size values that may be additionally used for M, the number of pre-defined integer sample unit size values.

In this case, the number of integer sample unit size values that may be applied to a block vector may be determined by the sum of O and M.

In this case, an additional_amvr_precisions[num_additional_amvr_precisions] set consisting of integers as many as the number of num_additional_amvr_precisions may be transmitted.

In this case, an integer sample unit size value that may be additionally used may be determined as 2^{(additional_amvr_precisions[i])} for parameter i indicating an additionally available integer sample unit size value that may be applied to a current block vector.

An additional_amvr_precisions set, which is a set of integer sample unit size values that may be applied to a block vector, may be entropy encoded/decoded in at least one of a parameter set, a header, a brick, a CTU, a CU, a PU, a TU, a CB, a PB or a TB.

num_amvr_precisions may refer to the number of integer sample unit size values.

In this case, the number of integer sample unit size values that may be applied to a block vector may be determined by the sum of O and M.

Hereinafter, a method for determining the block vector resolution of a current block is described in more detail.

The resolution of a block vector may be adaptively determined. In other words, a block vector may have resolution in the unit of an integer pixel or resolution in the unit of a fractional pixel. The resolution of a block vector may be called an integer sample unit size.

The number of integer sample unit size values that may be applied to a block vector (i.e., the number of integer sample unit size candidates or resolution candidates) may be explicitly entropy encoded/decoded.

As an example, information indicating the total number of integer sample unit size values that may be applied to a block vector (num_amvr_precisions) may be entropy encoded/decoded in at least one of a parameter set, a header, a brick, a CTU, a CU, a PU, a TU, a CB, a PB or a TB.

A syntax num_amvr_precisions may refer to the total number of integer sample unit size values that may be applied to a block vector. The number of integer sample unit size candidates that may be applied to a block vector may be M. M may be a positive integer.

In this case, a set of amvr_precisions[num_amvr_precisions] consisting of integer sample unit size candidates as many as determined by num_amvr_precisions may be transmitted to a decoder.

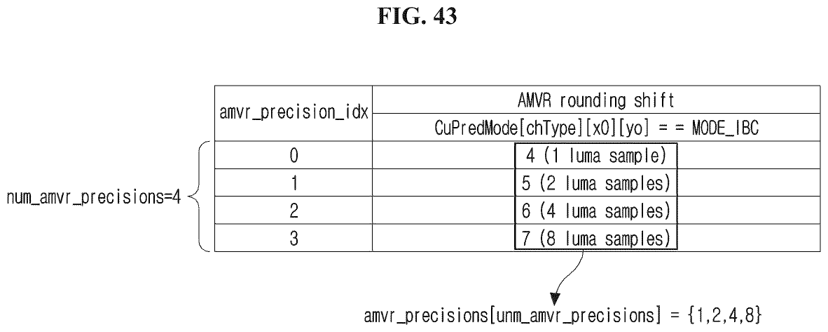

FIG. 43 shows a configuration example of a set including integer sample unit candidates.

When a syntax num_amvr_precision is 4, it represents that 4 integer sample unit size candidates are included in a set. In addition, in FIG. 43, it was illustrated that each integer sample unit size candidate is 1, 2, 4 and 8, respectively.

The value of each integer sample unit size candidate may be encoded and signaled. In other words, an amvr_precisions set, which is a set of integer sample unit size values that may be applied to a block vector, may be entropy encoded/decoded in at least one of a parameter set, a header, a brick, a CTU, a CU, a PU, a TU, a CB, a PB or a TB.

As an example, a syntax amvr_precision[i] indicating an integer sample unit size value may be encoded and signaled. A syntax amvr_precision[i] may represent the value of an integer sample unit size candidate whose index in an integer sample unit set is i. As an example, the value of an integer sample unit size candidate whose index is i may be determined as 2^{(amvr_precisions[i])}.

Alternatively, integer sample unit size candidates having an index from 0 to num_amvr_precisions among the integer sample unit size candidates that are predefined in a decoder may be available for a current block.

Alternatively, information (num_additional_amvr_precision) indicating a difference between the total number of integer sample unit size values that may be applied to a block vector and MM, the number of pre-defined integer sample unit size values, may be encoded/decoded.

A syntax num_additional_amvr_precisions may be entropy encoded/decoded in at least one of a parameter set, a header, a brick, a CTU, a CU, a PU, a TU, a CB, a PB or a TB.

num_additional_amvr_precisions may mean P, the number of additionally available integer sample unit size values, in addition to M pre-defined integer sample unit size values. In other words, the number of integer sample unit size values that may be applied to a block vector may be determined by the sum of P and M.

M integer sample unit size values may be pre-defined in an encoder and a decoder. Accordingly, encoding/decoding of information about M integer sample unit size values may be omitted.

On the other hand, information about P integer sample unit size values may be explicitly encoded and signaled. In other words, a set of additional_amvr_precisions[num_additional_amvr_precisions] consisting of as many integer sample unit size values as indicated by num_additional_amvr_precisions may be encoded and signaled.

In this case, the value of an additionally available integer sample unit size may be determined based on parameter i indicating the value of an integer sample unit size that may be applied to a current block vector. As an example, the value of an additionally available integer sample unit size may be determined as 2^{(additional_amvr_precisions[i])} additional_amvr_precisions[i] represents the exponent of an integer sample unit size whose index is i among the additionally available integer sample unit size values.

Meanwhile, an additional_amvr_precisions set including integer sample unit size values that may be applied to a block vector may be entropy encoded/decoded in at least one of a parameter set, a header, a brick, a CTU, a CU, a PU, a TU, a CB, a PB or a TB.

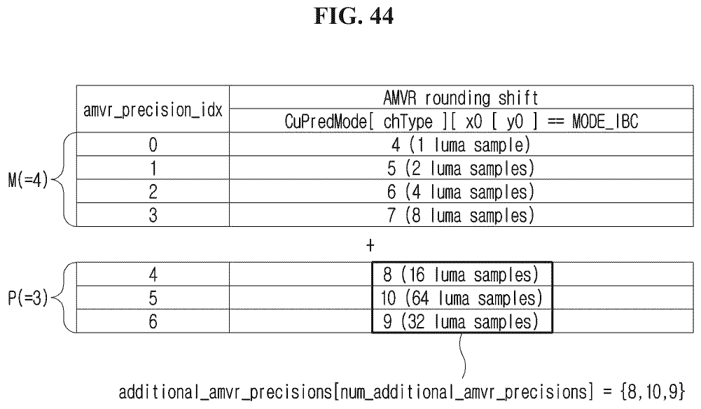

FIG. 44 illustrates rounding shift values that may be applied to a current block.

When it is assumed that M is 4 and P is 3, as in an example shown in FIG. 44, a total of 7 integer sample unit values may be available for a current block.

Meanwhile, M integer sample unit values may be predefined in an encoder and a decoder. On the other hand, information for determining P integer sample unit values may be additionally encoded and signaled.

The value of each integer sample unit size candidate may be encoded and signaled. In other words, an amvr_precisions set, which is a set of integer sample unit size values that may be applied to a block vector, may be entropy encoded/decoded in at least one of a parameter set, a header, a brick, a CTU, a CU, a PU, a TU, a CB, a PB or a TB.

Alternatively, among the integer sample unit size candidates predefined in a decoder, M predefined integer sample unit size candidates are selected in descending order of indices. And, an integer sample unit set may be configured by additionally selecting P integer sample unit size candidates as many as indicated by num_additional_amvr_precisions. In other words, in addition to M predefined integer sample unit size candidates, integer sample unit size candidates with an index from M to (P−1) may be additionally included in an integer sample unit set.

The value of an integer sample unit size for a current block may be determined by an index i indicating an integer sample unit size that may be applied to a current block vector among a plurality of integer sample unit size candidates. As an example, the value of an integer sample unit size available for a current block may be determined as 2^{(amvr_precisions[i])}.

An index i may be determined based on one of amvr_precision_idx, amvr_precision_flag or amvr_flag. amvr_precision[i] represents an integer sample unit size candidate whose index is i among the integer sample unit size candidates included in an integer sample unit size set.

An amvr_precisions set including integer sample unit size candidates that may be applied to a block vector may be entropy encoded/decoded in at least one of a parameter set, a header, a brick, a CTU, a CU, a PU, a TU, a CB, a PB or a TB.

At least one of information indicating the maximum number of block vector candidates that may be included in a block vector candidate list, information indicating the maximum number of merge candidates that may be included in a merge candidate list used in an inter prediction mode, block vector candidate information, a merge index, a L0 motion prediction flag or AMVP resolution-related information (amvr_precision_flag and/or amvr_precision_idx and/or amvr_flag) may be entropy encoded/decoded in at least one of a parameter set, a header, a brick, a CTU, a CU, a PU, a TU, a CB, a PB or a TB.

An embodiment in Table 7 represents an integer sample unit size applied to the block vector of a current block and the size of a rounding shift value corresponding thereto according to the value of amvr_flag and amvr_precision_flag when the prediction mode of a current block is an intra block copy mode.

TABLE 7

| | amvr_ | AMVR rounding shift |
|---|---|---|
| amvr_ | precision_ | CuPredMode[ chType ][ x0 ][ y0 ] = = |
| flag | flag | MODE_IBC |
| 0 | — | — |
| 1 | 0 | 4 (1 luma sample) |
| 1 | 1 | 6 (4 luma samples) |

When amvr_flag is 0, block vector rounding is not applied to the block vector of a current block.

When amvr_flag is 1, the resolution (i.e., integer sample unit size) of a block vector may be set differently according to the value of amvr_precision_flag.

As an example, when amvr_precision_flag is 0, the integer sample unit size of a block vector of a current block may be the same as the size of 1 sample.

As an example, when amvr_precision_flag is 1, the integer sample unit size of a block vector of a current block may be the same as the size of 4 sample.

When a current block is an intra block copy skip mode or an intra block copy merge mode, a block vector candidate in a block vector candidate list identified by block vector candidate information (e.g., a merge index) may be used as the block vector of a current block.

Alternatively, when an intra block copy AMVP mode is applied to a current block, a prediction block vector candidate in a block vector candidate list identified by block vector candidate information may be set as the prediction block vector of a current block. The block vector of a current block may be derived by adding a block vector difference that is entropy encoded/decoded to a prediction block vector. Meanwhile, a prediction block vector may be rounded according to the resolution of a block vector difference or the resolution of a prediction block vector. In this case, the resolution may be determined based on at least one of amvr_flag and amvr_precision_flag.

As an example, when amvr_precision_flag is a first value (e.g., 0), a block vector may have a size of N integer sample units.

As an example, when amvr_precision_flag is a second value (e.g., 1), a block vector may have a size of M integer sample units.

Here, N and M may be a positive integer. For example, N may be 1, and M may be 4. In addition, N may be less than M, and M may be less than N.

Equation 10 shows an example in which rounding is performed on a prediction block vector (mvX[0], mvX[1]).

$$offset = ( rightShift == 0 ) ? 0 : ( 1 << ( rightShift ? 1 ) ) \qquad [ Equation 10 ]$$

$$mvX [ 0 ] = ( ( mvX [ 0 ] + offset ? ( mvX [ 0 ] \geq 0 ) ) >> rightShift ) << leftShift$$

$$mvX [ 1 ] = ( ( mvX [ 0 ] + offset ? ( mvX [ 1 ] \geq 0 ) ) >> rightShift ) << leftShift$$

According to Table 7, when amvr_precision_flag is a first value (e.g., 0) (i.e., when a block vector has a size of 1 integer sample unit), rightshift and leftshift may be 2, respectively.

When amvr_precision_idx is a second value (e.g., 1) (i.e., when a block vector has a size of 4 integer sample unit), rightshift and leftshift may be 6, respectively.

At least one of the amvr_precision_flag, the resolution of a block vector difference and the resolution of a prediction block vector may be derived according to at least one of the encoding parameters of a current block/a CTB.

When amvr_flag is a first value (e.g., 0), rightshift and leftshift may be 4, respectively.

When amvr_flag is a second value (e.g., 1) and amvr_precision_idx is 0 (i.e., a block vector has a size of ¼ sample unit), rightshift and leftshift may be 2, respectively.

When amvr_flag is a second value and amvr_precision_idx is 1 (i.e., a block vector has a size of ½ sample unit), rightshift and leftshift may be 3, respectively.

When amvr_flag is a second value and amvr_precision_idx is 2 (i.e., a block vector has a size of 1 sample unit), rightshift and leftshift may be 4, respectively.

When amvr_flag is a second value and amvr_precision_idx is 0 (i.e., a block vector has a size of 4 sample units), rightshift and leftshift may be 6, respectively.

Table 8 illustrates a syntax structure that includes amvr_flag and amvr_precision_flag.

TABLE 8

| | |
|---|---|
| coding_unit( x0, y0, cbWidth, cbHeight, treeType ) { | Descriptor |
| ... | |
| } else if ( CuPredMode[ x0 ][ y0 ] = = MODE_IBC ) { | |
| mvd_coding( x0, y0, 0, 0 ) | |
| mvp_l0_flag[ x0 ][ y0 ] | ae(v) |
| if( sps_amvr_enabled_flag && | |
| ( | |
| MvdL0[ x0 ][ y0 ][ 0 ] != 0 ∥ | |
| MvdL0[ x0 ][ y0 ][ 1 ] != 0 ) ) { | |
| amvr_flag[ x0 ][ y0 ] | ae(v) |
| if( amvr_flag[ x0 ][ y0 ]) | |
| amvr_precision_flag[ x0 ][ y0 ] | ae(v) |
| } | |
| } else { | |
| ... | |

As in an example of Table 8, rounding may be performed on a prediction block vector (mvX[0], mvX[1] based on at least one of amvr_flag or amvr_precision_flag that is entropy encoded/decoded.

As an example, when amvr_flag is a first value (e.g., 0), a block vector may have a size of N integer sample units.

As an example, when amvr_flag is a second value (e.g., 1), a block vector may have a size of M integer or P integer sample units.

As an example, when amvr_flag is a second value and amvr_precision_flag is a first value (e.g., 0), a block vector may have a size of M integer sample units.

As an example, when amvr_flag is a second value and amvr_precision_flag is a second value (e.g., 1), a block vector may have a size of P integer sample units.

Here, N, M and P may be a positive integer. For example, N may be 1, M may be 4 and P may be 16.

In addition, N may be smaller than M and P. In addition, P may be larger than N and M.

In performing a rounding operation according to Equation 10, when amvr_flag is a first value (e.g., 0) (i.e., when a block vector has a size of 1 integer sample unit), rightshift and leftshift may be 4, respectively.

Alternatively, when amvr_flag is a second value (e.g., 1) and amvr_precision_flag is a first value (e.g., 0) (i.e., when a block vector has a size of 4 integer sample units), rightshift and leftshift may be 6, respectively.

Alternatively, when amvr_flag is a second value (e.g., 1) and amvr_precision_flag is a second value (e.g., 1) (i.e., when a block vector has a size of 16 integer sample units), rightshift and leftshift may be 8, respectively.

At least one of amvr_flag, amvr_precision_flag, the resolution of a block vector difference or the resolution of a prediction block vector may be derived according to at least one of the encoding parameters of a current block/a CTB/a CTU.

Instead of amvr_precision_flag, the integer sample unit size of a block vector may also be derived based on amvr_precision_idx. The number/type of resolution candidates available to a current block may be different between a case where amvr_precision_idx is used and a case where amvr_precision_flag is used. As an example, when amvr_precision_flag is used, one of two resolution candidates may be selected based on amvr_precision_flag. On the other hand, when amvr_precision_idx is used, one of N resolution candidates may be selected. Here, N is a natural number greater than 2, which may represent 3, 4 or 5.

As in Table 9, according to the value of amvr_flag and amvr_precision_idx, an integer sample unit size applied to the block vector of a current block and the size of a rounding shift value corresponding thereto may be determined.

TABLE 9

| | amvr_ | AMVR rounding shift |
|---|---|---|
| amvr_ | precision_ | CuPredMode[ chType ][ x0 ][ y0 ] = = |
| flag | idx | MODE_IBC |
| 0 | — | — |
| 1 | 0 | 4 (1 luma sample) |
| 1 | 1 | 6 (4 luma samples) |
| 1 | 2 | 7 (8 luma samples) |
| . . . | . . . | . . . |

When amvr_flag is 0, block vector rounding is not applied to the block vector of a current block.

When amvr_flag is 1, resolution (i.e., an integer sample unit size) of a block vector may be set differently according to the value of amvr_precision_idx.

As an example, when amvr_precision_idx is 0, the integer sample unit size of a block vector of a current block may be the same as the size of 1 integer sample.

As an example, when amvr_precision_idx is 1, the integer sample unit size of a block vector of a current block may be the same as the size of 4 integer samples.

As an example, when amvr_precision_idx is 2, the integer sample unit size of a block vector of a current block may be the same as the size of 8 integer samples.

Information indicating the maximum value of amvr_precision_idx (max_amvr_precision_idx) may be entropy encoded/decoded in at least one of a parameter set, a header, a brick, a CTU, a CU, a PU, a TU, a CB, a PB or a TB.

In this case, the value of information (max_amvr_precision_idx) indicating the maximum value of amvr_precision_idx may be an integer greater than or equal to 0.

Alternatively, the maximum value of amvr_precision_idx may be determined according to a syntax num_amvr_precisions representing the number of integer sample unit size candidates.

Alternatively, as in Table 10, the size of an integer sample unit applied to the block vector of a current block and the size of a rounding shift value corresponding thereto may be determined according to the value of amvr_flag and amvr_precision_idx.

TABLE 10

| | amvr_ | AMVR rounding shift |
|---|---|---|
| amvr_ | precision_ | CuPredMode[ chType ][ x0 ][ y0 ] = = |
| flag | idx | MODE_IBC |
| 0 | — | — |
| 1 | 0 | 4 (1 luma sample) |
| 1 | 1 | 5 (2 luma samples |
| 1 | 2 | 6 (4 luma samples) |
| 1 | 3 | 7 (8 luma samples) |
| . . . | . . . | . . . |

When amvr_flag is 0, block vector rounding may not be applied to the block vector of a current block.

When amvr_flag is 1, resolution (i.e., an integer sample unit size) of a block vector may be set differently according to the value of amvr_precision_idx.

As an example, when amvr_precision_idx is 0, the integer sample unit size of a block vector of a current block may be the same as the size of 1 integer sample.

As an example, when amvr_precision_idx is 1, the integer sample unit size of a block vector of a current block may be the same as the size of 2 integer samples.

As an example, when amvr_precision_idx is 2, the integer sample unit size of a block vector of a current block may be the same as the size of 4 integer samples.

As an example, when amvr_precision_idx is 3, the integer sample unit size of a block vector of a current block may be the same as the size of 8 integer samples.

As another example, when an intra block copy AMVP mode is applied to a current block, a prediction block vector in a block vector candidate list may be selected. In this case, a prediction block vector may be identified by block vector candidate information. Afterwards, the block vector of a current block may be derived by adding a block vector difference that is entropy encoded/decoded to a prediction block vector.

At least one of amvr_flag, amvr_precision_idx, the resolution of a block vector difference or the resolution of a prediction block vector may be derived based on at least one of the encoding parameters of a current block/a CTB.

Information representing the maximum value of amvr_precision_idx may be encoded and signaled. As an example, a syntax max_amvr_precision_idx indicating the maximum value of amvr_precision_idx may be encoded and signaled. The maximum value of a syntax amvr_precision_idx may be less than or equal to a value indicated by a syntax max_amvr_precision_idx.

Table 11 illustrates a syntax structure including a syntax for determining the resolution of a block vector.

TABLE 11

| | |
|---|---|
| coding_unit( x0, y0, cb Width, cbHeight, treeType ) { | Descriptor |
| ... | |
| } else if ( CuPredMode[ x0 ][ y0 ] = = MODE_IBC ) { | |
| mvd_coding( x0, y0, 0, 0) | |
| mvp_l0_flag[ x0 ][ y0 ] | ae(v) |
| if( sps_amvr_enabled_flag && | |
| ( | |
| MvdL0[ x0 ][ y0 ][ 0 ] != 0 ∥ | |
| MvdL0[ x0 ][ y0 ][ 1 ] != 0 ) ) { | |
| amvr flag[ x0 ][ y0 ] | ae(v) |
| if( amvr_flag[ x0 ][ y0 ]) | |
| amvr_precision_idx[ x0 ][ y0 ] | ae(v) |
| } | |
| } else { | |
| ... | |

In Table 11, it was illustrated that amvr_flag and amvr_precision_idx are included in a syntax structure to determine the resolution of a block vector. In addition, it was illustrated that a syntax amvr_precision_idx is encoded and signaled only when the value of amvr_flag is 1.

Unlike the above-described embodiments, when amvr_flag is 0, the predefined block vector resolution may be set to be applied. As an example, when amvr_flag is a first value (e.g., 0), a block vector may have a size of N integer sample units.

In addition, when amvr_flag is a second value (e.g., 1), a block vector may have a sample unit size greater than or equal to M.

As an example, when amvr_flag is a second value and amvr_precision_idx is 0, a block vector may have M sample unit sizes.

As an example, when amvr_flag is a second value and amvr_precision_idx is 1, a block vector may have P sample unit sizes.

As an example, when amvr_flag is a second value and amvr_precision_idx is 2, a block vector may have Q sample unit sizes.

Here, N, M, P, Q may be a positive integer. For example, N may be 1, M may be 4, P may be 8 and Q may be 16.

Meanwhile, rounding may be performed on a prediction block vector (mvX[0] and mvX[1]) identified by block vector candidate information according to the value of at least one of amvr_flag and amvr_precision_idx that are entropy encoded/decoded. Specifically, the resolution of a block vector difference and/or a prediction block vector may be determined based on the value of at least one of amvr_flag and amvr_precision_idx.

The range or maximum value of the amvr_precision_idx may be derived through a syntax signaled at a high level.

The size of each resolution candidate (e.g., at least one of N, M, P or Q) may be different from each other, but the order of resolution candidates may not be proportional to the value of amvr_precision_idx. In other words, the order of resolution candidates that may be selected by amvr_precision_idx may be determined based on at least one of the performance of video encoding, the characteristic of an input video or a statistical probability.

Rounding for a prediction block vector may be performed according to Equation 10.

As an example, when amvr_flag is a first value (i.e., 0) (i.e., when a block vector has a size of 1 integer sample unit), rightshift and leftshift may be 4, respectively.

Alternatively, when amvr_flag is a second value (i.e., 1) and amvr_precision_idx is 0 (i.e., when a block vector has a size of 4 integer sample units), rightshift and leftshift may be 6, respectively.

Alternatively, when amvr_flag is a second value (i.e., 1) and amvr_precision_idx is 1 (i.e., when a block vector has a size of 8 integer sample units), rightshift and leftshift may be 7, respectively.

Alternatively, when amvr_flag is a second value (i.e., 1) and amvr_precision_idx is 2 (i.e., when a block vector has a size of 16 integer sample units), rightshift and leftshift may be 8, respectively.

As another example, when amvr_flag is a first value (e.g., 0) (i.e., when a block vector has a size of 1 integer sample unit), rightshift and leftshift may be 4, respectively.

Alternatively, when amvr_flag is a second value (e.g., 1) and amvr_precision_idx is 0, a first value (i.e., when a block vector has a size of 1 integer sample unit), rightshift and leftshift may be 4, respectively.

Alternatively, when amvr_flag is a second value (e.g., 1) and amvr_precision_idx is a second value (e.g., 1) (i.e., when a block vector has a size of 2 integer sample units), rightshift and leftshift may be 5, respectively.

Alternatively, when amvr_flag is a second value (e.g., 1) and amvr_precision_idx is a third value (e.g., 2) (i.e., when a block vector has a size of 4 integer sample units), rightshift and leftshift may be 6, respectively.

Alternatively, when amvr_flag is a second value (e.g., 1) and amvr_precision_idx is a fourth value (e.g., 3) (i.e., when a block vector has a size of 8 integer sample units), rightshift and leftshift may be 7, respectively.

Unlike the above-described example, when amvr_flag is 0, the block vector resolution may be set as ¼, and when amvr_flag is 1, the block vector resolution may be set as 1 or 4 according to amvr_precision_idx.

The resolution of a prediction block vector and a block vector difference may be determined by using only a syntax amvr_precision_idx without omitting encoding/decoding of a syntax amvr_flag or referring to amvr_flag that is encoded/decoded. Specifically, rounding may be performed on a prediction block vector (mvX[0], mvX[1]) according to the value of amvr_precision_idx that is entropy encoded/decoded.

Here, a block vector difference and the resolution of a prediction block vector may be determined according to the value of amvr_precision_idx.

As an example, when amvr_precision_idx is a first value (e.g., 0), a block vector may have a size of N integer sample units.

As an example, when amvr_precision_idx is a second value (e.g., 1), a block vector may have a size of M integer sample units.

As an example, when amvr_precision_idx is a third value (e.g., 2), a block vector may have a size of L integer sample units.

Here, N, M and L may be a positive integer. As an example, N may be 1, M may be 4 and L may be 8.

Table 12 represents the size of an integer sample unit of a block vector according to the value of amvr_precision_idx.

TABLE 12

| amvr_ | AMVR rounding shift |
|---|---|
| precision_ | CuPredMode[ chType ][ x0 ][ y0 ] = = |
| idx | MODE_IBC |
| 0 | 4 (1 luma sample) |
| 1 | 6 (4 luma samples) |
| 2 | 7 (8 luma samples) |
| . . . | . . . |

Rounding for a prediction block vector may be performed according to Equation 10. According to Table 12, when amvr_precision_idx is a first value (e.g., 0) (i.e., when a block vector has a size of 1 integer sample unit), rightshift and leftshift may be 4, respectively.

Alternatively, when amvr_precision_idx is a second value (e.g., 1) (i.e., when a block vector has a size of 4 integer sample units), rightshift and leftshift may be 6, respectively.

Alternatively, when amvr_precision_idx is a third value (e.g., 2) (i.e., when a block vector has a size of 8 integer sample units), rightshift and leftshift may be 7, respectively.

Alternatively, according to the following Table 13, the size of an integer sample unit of a block vector may be determined.

TABLE 13

| amvr_ | AMVR rounding shift |
|---|---|
| precision_ | CuPredMode[ chType ][ x0 ][ y0 ] = = |
| idx | MODE_IBC |
| 0 | 4 (1 luma sample) |
| 1 | 5 (2 luma samples) |
| 2 | 6 (4 luma samples) |
| 3 | 7 (8 luma samples) |
| . . . | . . . |

The size of an integer sample unit applied to a block vector may vary according to the value of amvr_precision_idx.

As an example, when amvr_precision_idx is 0, the integer sample unit size of a block vector of a current block may be the same as the size of 1 integer sample.

As an example, when amvr_precision_idx is 1, the integer sample unit size of a block vector of a current block may be the same as the size of 2 integer samples.

As an example, when amvr_precision_idx is 2, the integer sample unit size of a block vector of a current block may be the same as the size of 4 integer samples.

As an example, when amvr_precision_idx is 3, the integer sample unit size of a block vector of a current block may be the same as the size of 8 integer samples.

Rounding on a prediction block vector may be performed according to Equation 10. When Table 13 is followed, when amvr_precision_idx is a first value (e.g., 0) (i.e., when a block vector has a size of 1 integer sample unit), rightshift and leftshift may be 4, respectively.

Alternatively, when amvr_precision_idx is a second value (e.g., 1) (i.e., when a block vector has a size of 2 integer sample units), rightshift and leftshift may be 5, respectively.

Alternatively, when amvr_precision_idx is a third value (e.g., 2) (i.e., when a block vector has a size of 4 integer sample units), rightshift and leftshift may be 6, respectively.

Alternatively, when amvr_precision_idx is a third value (e.g., 3) (i.e., when a block vector has a size of 8 integer sample units), rightshift and leftshift may be 7, respectively.

Alternatively, according to the following Table 14, the size of an integer sample unit of a block vector may be determined.

TABLE 14

| amvr_ | AMVR rounding shift |
|---|---|
| precision_ | CuPredMode[ chType ][ x0 ][ |
| idx | y0 ] = = MODE_IBC |
| 0 | 4 (1 luma sample) |
| 1 | 6 (4 luma samples) |
| 2 | 7 (8 luma samples) |
| 3 | 8 (16 luma samples) |
| . . . | . . . |

The size of an integer sample unit applied to a block vector may vary according to the value of amvr_precision_idx.

As an example, when amvr_precision_idx is 0, the integer sample unit size of a block vector of a current block may be the same as the size of 1 integer sample.

As an example, when amvr_precision_idx is 1, the integer sample unit size of a block vector of a current block may be the same as the size of 4 integer samples.

As an example, when amvr_precision_idx is 2, the integer sample unit size of a block vector of a current block may be the same as the size of 8 integer samples.

As an example, when amvr_precision_idx is 3, the integer sample unit size of a block vector of a current block may be the same as the size of 16 integer samples.

Rounding on a prediction block vector may be performed according to Equation 10. When Table 14 is followed, when amvr_precision_idx is a first value (e.g., 0) (i.e., when a block vector has a size of 1 integer sample unit), rightshift and leftshift may be 4, respectively.

Alternatively, when amvr_precision_idx is a second value (e.g., 1) (i.e., when a block vector has a size of 4 integer sample units), rightshift and leftshift may be 6, respectively.

Alternatively, when amvr_precision_idx is a third value (e.g., 2) (i.e., when a block vector has a size of 8 integer sample units), rightshift and leftshift may be 7, respectively.

Alternatively, when amvr_precision_idx is a third value (e.g., 3) (i.e., when a block vector has a size of 16 integer sample units), rightshift and leftshift may be 8, respectively.

At least one of amvr_flag, amvr_precision_idx, the resolution of a block vector difference or the resolution of a prediction block vector may be derived according to at least one of the encoding parameters of a current block/a CTB.

Table 15 illustrates a syntax structure including a syntax for determining the resolution of a block vector.

TABLE 15

| | |
|---|---|
| } else if ( CuPredMode[ x0 ][ y0 ] = = MODE_IBC ) { | |
| mvd_coding(x0, y0, 0, 0 ) | |
| if( MaxNumMergeCand > 1 ) | |
| mvp_10_flag[ x0 ][ y0 ] | ae(v) |
| if( sps_amvr_enabled_flag && | |
| ( MvdL0[ x0 ][ y0 ][ 0 ] | |
| != 0 \|\| MvdL0[ x0 ][ y0 ][ 1 ] != 0 ) ) { | |
| amvr_precision_idx[ x0 ][ y0 ] | ae(v) |
| } | |

In Table 15, it was illustrated that amvr_flag is not encoded/decoded and amvr_precision_idx is encoded/decoded immediately.

As in the above-described example, information about block vector candidates may be encoded and signaled.

Alternatively, in an encoder and a decoder, a mapping table defining a mapping relationship between information related to the integer pixel size of a block vector (e.g., at least one of amvr_flag or amvr_precision_idx) and resolution candidates may be predefined. In a decoder, a resolution candidate mapped to decoded integer pixel size-related information may be selected based on a predefined mapping table.

Alternatively, a plurality of mapping tables may be pre-stored in an encoder and a decoder. After selecting one of a plurality of mapping tables, a resolution candidate may be selected by using a selected mapping table. In this case, information identifying one of a plurality of mapping tables may be encoded and signaled. Alternatively, one of a plurality of mapping tables may be adaptively selected based on at least one of the size/shape of a current block, the size of a block vector or the resolution of a neighbor block.

Meanwhile, block vector resolution candidates (e.g., 1, 4, 16 integer sample units) used in an intra block copy AMVP mode may be the same as a result of performing a multiplication by K or a left shift operation by J on motion vector resolution candidates (e.g., ¼, 1, 4 integer sample units) used in an inter AMVP mode or an affine AMVP mode. Here, K and J may be a positive integer, and for example, K may be 4 and J may be 2.

Meanwhile, at least one of information indicating the maximum number of candidates in a block vector candidate list, information indicating the maximum number of candidates in the merge candidate list of an inter prediction mode, block vector candidate information, a merge index, a L0 motion prediction flag or AMVP resolution-related information (amvr_precision_flag and/or amvr_precision_idx and/or amvr_flag) may be entropy encoded/decoded in at least one of a parameter set, a header, a brick, a CTU, a CU, a PU, a TU, a CB, a PB or a TB.

Information indicating the maximum value of amvr_precision_idx (max_amvr_precision_idx) may be entropy encoded/decoded in at least one of a parameter set, a header, a brick, a CTU, a CU, a PU, a TU, a CB, a PB or a TB.

In this case, the value of information indicating the maximum value of amvr_precision_idx (max_amvr_precision_idx) may be an integer greater than or equal to 0.

Table 16 is an example for describing an example in which the value of amvr_precision_idx is restricted according to max_amvr_precision_idx.

TABLE 16

| amvr_ | AMVR rounding shift |
|---|---|
| precision_ | CuPredMode[ chType ][ |
| idx | x0 ][ y0 ] = = MODE_IBC |
| 0 | 4 (1 luma sample) |
| 1 | 5 (2 luma samples) |
| 2 | 6 (4 luma samples |
| 3 | 7 (8 luma samples) |
| 4 | 8 (16 luma samples) |
| 5 | 9 (32 luma samples) |
| . . . | . . . |

When the value of max_amvr_precision_idx is 5, it represents that the maximum value of amvr_precision_idx is 5. In other words, the value of amvr_precision_idx may have a value from 0 to max_amvr_precision_idx.

In the example, when the value of amvr_precision_idx is the same as the value of max_amvr_precision_idx (i.e., values of amvr_precision_idx and max_amvr_predicion_idx are 5), the maximum integer sample unit size of a block vector may be determined as 32. In this case, in Equation 10, rightshift and leftshift may be 9, respectively.

Meanwhile, a resolution candidate having a value greater than max_amvr_precision_idx may not be available for a current block.

As an example, when max_amvr_precision_idx is 4, the value of amvr_precision_idx may not be greater than 4. Accordingly, a resolution candidate (i.e., a size of 32 integer samples) mapped to 5, the value of amvr_precision_idx, may not be available for a current block.

Alternatively, when max_amvr_precision_idx is 4, candidates that the value of amvr_precision_idx is greater than 4, through clipping, may be set as a resolution candidate (in Table 16, a size of 16 integer sample units) when the value of amvr_precision_idx is the maximum value (i.e., 4).

At least one of information indicating the maximum number of candidates in a block vector candidate list, information indicating the maximum number of candidates in the merge candidate list of an inter prediction mode, block vector candidate information, a merge index, a L0 motion prediction flag or AMVP resolution-related information (amvr_precision_flag and/or amvr_precision_idx and/or amvr_flag) may be entropy encoded/decoded in at least one of a parameter set, a header, a brick, a CTU, a CU, a PU, a TU, a CB, a PB or a TB.

Meanwhile, information representing the maximum size of a resolution candidate (i.e., the maximum size of an integer sample unit that a block vector may have) may be encoded and signaled. As an example, a syntax max_amvr_precision representing the maximum size of an integer sample unit that a block vector may have may be encoded and signaled.

A syntax max_amvr_precision may be an integer greater than or equal to N. A syntax max_amvr_precision may represent a value derived when taking Log 2 to the maximum value of the maximum integer sample unit size of a block vector. As an example, the maximum value of an integer sample unit size determined by max_amvr_precision may be derived as 2^{max_amvr_precision}.

Meanwhile, according to the value of max_amvr_precision_idx, a resolution candidate to which amvr_precision_idx is applied may be determined. As an example, when max_amvr_precision_idx is 4, it represents that the value of amvr_precision_idx is not greater than 4. Accordingly, when max_amvr_precision_idx is 4, the value of a resolution candidate that amvr_precision_idx is equal to or greater than 4 may be derived as 2^{max_amvr_precision}.

Meanwhile, at least one of information indicating the maximum value of amvr_precision_idx (e.g., max_amvr_precision_idx) and/or information indicating the maximum integer sample unit size that a block vector may have (e.g., max_amvr_precision) may be entropy encoded/decoded in at least one of a parameter set, a header, a brick, a CTU, a CU, a PU, a TU, a CB, a PB or a TB.

Meanwhile, a different integer sample unit size value may be applied to each of horizontal and vertical directions of a block vector.

To this end, information (amvr_separate_prec_flag) indicating a reference direction among the horizontal and vertical directions of a block vector may be encoded and signaled. The information may be entropy encoded/decoded in at least one of a parameter set, a header, a brick, a CTU, a CU, a PU, a TU, a CB, a PB or a TB.

As an example, when amvr_separate_prec_flag is 0, a reference direction may be a vertical direction. When amvr_separate_prec_flag is 1, a reference direction may be a horizontal direction.

Alternatively, conversely, when amvr_separate_prec_flag is 0, a reference direction may be a horizontal direction. When amvr_separate_prec_flag is 1, a reference direction may be be a vertical direction.

When amvr_separate_prec_flag does not exist, a reference direction may be set as one predefined direction among the horizontal or vertical directions.

A reference direction may be the one with a smaller integer sample unit size.

When an integer sample unit size in another direction is 2^{N} times that of a reference direction determined by amvr_separate_prec_flag, information indicating N (amvr_separate_precision) may be encoded and signaled. Here, N may be an integer greater than or equal to 0. The information may be entropy encoded/decoded in at least one of a parameter set, a header, a brick, a CTU, a CU, a PU, a TU, a CB, a PB or a TB.

When the value of N is 0, it represents that the size of a horizontal integer sample unit of a block vector is the same as the size of a vertical integer sample unit.

When the value of N is 1, the size of a horizontal integer sample unit of a block vector may be 2 (=2¹) times the size of a vertical integer sample unit.

When the value of N is 2, the size of a horizontal integer sample unit of a block vector may be 4 (=2²) times the size of a vertical integer sample unit.

An embodiment in Table 17 shows the integer sample unit size of a block vector according to the value of amvr_separate_precision when amvr_separate_prec_flag is 0 and a reference direction is vertical.

TABLE 17

| | AMVR rounding shift | | | |
|---|---|---|---|---|
| | CuPredMode[ chType ][ x0 ][ y0 ] = = MODE IBC | | | |
| amvr_ | amvr_separate_prec_flag == 0 && | | amvr_separate_prec_flag == 0 && | |
| precision_ | amvr_separate_precision == 0 | | amvr_separate_precision == 1 | |
| idx | Vertical precision | Horizontal precision | Vertical precision | Horizontal precision |
| 0 | 4 (1 luma sample) | 4 (1 luma sample) | 4 (1 luma sample) | 5 (2 luma sample) |
| 1 | 5 (2 luma samples) | 5 (2 luma samples) | 5 (2 luma samples) | 6 (4 luma samples) |
| 2 | 6 (4 luma samples) | 6 (4 luma samples) | 6 (4 luma samples) | 7 (8 luma samples) |
| 3 | 7 (8 luma samples) | 7 (8 luma samples) | 7 (8 luma samples) | 8 (16 luma samples) |
| . . . | . . . | . . . | . . . | . . . |

A different integer sample unit size value may be applied to the horizontal direction and vertical direction of a block vector, respectively.

An embodiment in Table 18 shows the integer sample unit size of a block vector according to the value of amvr_separate_precision when amvr_separate_prec_flag is 1 and a reference direction is horizontal.

TABLE 18

| | AMVR rounding shift | | | |
|---|---|---|---|---|
| | CuPredMode[ chType ][ x0 ][ y0 ] = = MODE IBC | | | |
| amvr_ | amvr_separate_prec_flag == 1 && | | amvr_separate_prec_flag == 1 && | |
| precision_ | amvr_separate_precision == 0 | | amvr_separate_precision == 1 | |
| idx | Vertical precision | Horizontal precision | Vertical precision | Horizontal precision |
| 0 | 4 (1 luma sample) | 4 (1 luma sample) | 5 (2 luma sample) | 4 (1 luma sample) |
| 1 | 5 (2 luma samples) | 5 (2 luma samples) | 6 (4 luma samples) | 5 (2 luma samples) |
| 2 | 6 (4 luma samples) | 6 (4 luma samples) | 7 (8 luma samples) | 6 (4 luma samples) |
| 3 | 7 (8 luma samples) | 7 (8 luma samples) | 8 (16 luma samples) | 7 (8 luma samples) |
| . . . | . . . | . . . | . . . | . . . |

Alternatively, the horizontal/vertical resolution of a block vector may be determined according to the value of amvr_precision_idx.

As an example, when amvr_precision_idx is 0, a block vector may have a size of N integer sample units. In other words, the horizontal and vertical resolution may be derived in the same way.

In addition, when amvr_precision_idx is 1, a block vector may have an integer sample unit size of horizontal sample unit M and vertical sample unit O (M≠O).

In addition, when amvr_precision_idx is 2, a block vector may have an integer sample unit size of horizontal sample unit P and vertical sample unit Q (P≠Q).

The range or maximum value of the amvr_precision_idx may be derived through a high-level syntax.

Here, an integer sample unit size such as N, M, O, P, Q, etc. may be a positive integer.

One of the predefined pairs may be indicated by amvr_predcision_idx. The horizontal and vertical resolution may be determined by a pair identified by amvr_precision_idx among a plurality of pairs. As an example, a predefined pair may include at least one of (1, 4), (1, 8), (1, 16), (4, 8), (4, 16), (4, 32) or (8, 16).

As another example, resolution in a reference direction may be determined by amvr_precision_idx, and resolution in another direction may be determined by amvr_separate_precision.

Table 19 shows an example therefor.

TABLE 19

| | AMVR rounding shift | | | | | |
|---|---|---|---|---|---|---|
| | CuPredMode[chType][x0][y0] == MODE_IBC | | | | | |
| | amvr_separate_{—} | | amvr_separate_{—} | | amvr_separate_{—} | |
| amvr_{—} | precision == 0 | | precision == 1 | | precision == −1 | |
| precision_{—} | Vertical | Horizontal | Vertical | Horizontal | Vertical | Horizontal |
| idx | precision | precision | precision | precision | precision | precision |
| 0 | 4 (1 luma | 4 (1 luma | 4 (1 luma | 5 (2 luma | 4 (1 luma | 3 (½ luma |
| | sample) | sample) | sample) | sample) | sample) | sample) |
| 1 | 5 (2 luma | 5 (2 luma | 5 (2 luma | 6 (4 luma | 5 (2 luma | 4 (1 luma |
| | samples) | samples) | samples) | samples) | samples) | samples) |
| 2 | 6 (4 luma | 6 (4 luma | 6 (4 luma | 7 (8 luma | 6 (4 luma | 5 (2 luma |
| | samples) | samples) | samples) | samples) | samples) | samples) |
| 3 | 7 (8 luma | 7 (8 luma | 7 (8 luma | 8 (16 luma | 7 (8 luma | 6 (4 luma |
| | samples) | samples) | samples) | samples) | samples) | samples) |
| . . . | . . . | . . . | . . . | . . . | . . . | . . . |

amvr_precision_idx represents the resolution of a reference direction. In this case, a reference direction may be fixed to either a horizontal or vertical direction.

In this case, at least one of amvr_precision_idx, the resolution of a block vector difference and the resolution of a prediction block vector may be derived according to at least one of the encoding parameters of a current block/a CTB/a CTU.

The maximum value of the amvr_precision_idx may be less than or equal to the value of max_amvr_precision_idx indicating the maximum value of amvr_precision_idx.

When an integer sample unit size in another direction is 2^{N} times that in a reference direction, information indicating integer N (amvr_separate_precision) may be entropy encoded/decoded in at least one of a parameter set, a header, a brick, a CTU, a CU, a PU, a TU, a CB, a PB or a TB.

In this case, when a reference direction is a vertical direction and the value of N is 0, the horizontal integer sample unit size of a block vector may be the same as a vertical integer sample unit size.

In this case, when a reference direction is a vertical direction and the value of N is 1, the horizontal integer sample unit size of a block vector may be 2 (=2¹) times a vertical integer sample unit size.

In this case, when a reference direction is a vertical direction and the value of N is 2, the horizontal integer sample unit size of a block vector may be 4 (=2²) times a vertical integer sample unit size.

In this case, when a reference direction is a vertical direction and the value of N is −1, the horizontal integer sample unit size of a block vector may be ½ (=2⁻¹) times a vertical integer sample unit size.

In this case, when a reference direction is a vertical direction and the value of N is −2, the horizontal integer sample unit size of a block vector may be ¼ (=2⁻²) times a vertical integer sample unit size.

Alternatively, as in an embodiment of Table 20, a different integer sample unit size value may be applied to each of horizontal and vertical directions of a block vector.

TABLE 20

| | AMVR rounding shift | | | |
|---|---|---|---|---|
| amvr_ | CuPredMode[ chType ][ x0 ][ y0 ] = = MODE_IBC | | | |
| precision_ | amvr_separate_precision == 2 | | amvr_separate_precision == −2 | |
| idx | Vertical precision | Horizontal precision | Vertical precision | Horizontal precision |
| 0 | 4 (1 luma sample) | 5 (2 luma sample) | 4 (1 luma sample) | 3 (½ luma sample) |
| 1 | 5 (2 luma samples) | 6 (4 luma samples) | 5 (2 luma samples) | 4 (1 luma samples) |
| 2 | 6 (4 luma samples) | 7 (8 luma samples) | 6 (4 luma samples) | 5 (2 luma samples) |
| 3 | 7 (8 luma samples) | 8 (16 luma samples) | 7 (8 luma samples) | 6 (4 luma samples) |
| . . . | . . . | . . . | . . . | . . . |

When a current block is an intra block copy AMVP mode, the block vector of a current block may be derived by adding a block vector difference that is entropy encoded/decoded to a prediction block vector identified by block vector candidate information in a block vector candidate list.

In this case, rounding according to Equations 11 and 12 may be performed on at least one of a prediction block vector (mvX[0] and mvX[1]), the horizontal element value of a block vector (mvX[0].hor, mvX[1].hor) or the vertical element value of a block vector (mvX[0].ver, mvX[1].ver).

$$offset\_hor = ( rightShift\_hor == 0 ) ? 0 : ( 1 << ( rightShift\_hor - 1 ) ) \qquad [ Equation 11 ]$$

$$offset\_ver = ( rightShift\_ver == 0 ) ? 0 : ( 1 << ( rightShift\_ver - 1 ) )$$

$$mvX [ 0 ] = ( ( mvX [ 0 ] . hor + offset\_hor - ( mvX [ 0 ] . hor \geq 0 ) ) >> rightShift\_hor ) << leftShift\_hor \qquad [ Equation 12 ]$$

$$mvX [ 0 ] = ( ( mvX [ 0 ] . ver + offset\_ver - ( mvX [ 0 ] . ver \geq 0 ) ) >> rightShift\_ver ) << leftShift\_ver$$

$$mvX [ 1 ] = ( ( mvX [ 1 ] . hor + offset\_hor - ( mvX [ 1 ] . hor \geq 0 ) ) >> rightShift\_hor ) << leftShift\_hor$$

$$mvX [ 1 ] = ( ( mvX [ 1 ] . ver + offset\_ver - ( mvX [ 1 ] . ver \geq 0 ) ) >> rightShift\_ver ) << leftShift\_ver$$

In Equations 11 and 12 above, when a block vector has a size of 4 and 1 integer sample unit in width and height, respectively, the value of rightshift_hor and leftshift_hor may be 6, and the size of rightshift_ver and leftshift_ver may be 4.

Alternatively, when a block vector has a size of 8 and 4 integer sample units in width and height, respectively, the value of rightshift_hor and leftshift_hor may be 7, and the size of rightshift_ver and leftshift_ver may be 6.

When a block vector has a size of 16 and 8 integer sample units in width and height, respectively, the value of rightshift_hor and leftshift_hor may be 8, and the size of rightshift_ver and leftshift_ver may be 7.

In the above-described embodiments, at least one of a parameter set, a header, a brick, a CTU, a CU, a PU, a TU, a CB, a PB or a TB may be at least one of a video parameter set, a decoding parameter set, a sequence parameter set, an adaptation parameter set, a picture parameter set, a picture header, a sub-picture header, a slice header, a tile group header, a tile header, a brick, a coding tree unit (CTU), a coding unit (CU), a prediction unit (PU), a transform unit (TU), a coding block (CB), a prediction block (PB) or a transform block (TB).

Here, prediction using an intra block copy mode may be performed by using at least one of information indicating the maximum number of candidates in the block vector candidate list, information indicating the maximum number of candidates in the merge candidate list of an inter prediction mode, block vector candidate information, a merge index, a L0 motion prediction flag or AMVP resolution-related information (amvr_precision_flag and/or amvr_precision_idx and/or amvr_flag and/or max_amvr_precision_idx and/or max_amvr_precision and/or amvr_separate_precision and/or num_additional_amvr_precisions and/or additional_amvr_precisions set and/or num_amvr_precisions and/or amvr_precisions set) in at least one of a unit of a parameter set, a header, a brick, a CTU, a CU, a PU, a TU, a CB, a PB or a TB signaled above.

Here, at least one of information indicating the maximum number of candidates in the block vector candidate list, information indicating the maximum number of candidates in the merge candidate list of an inter prediction mode, block vector candidate information, a merge index, a L0 motion prediction flag or AMVP resolution-related information (amvr_precision_flag and/or amvr_precision_idx and/or amvr_flag and/or max_amvr_precision_idx and/or max_amvr_precision and/or amvr_separate_precision and/or num_additional_amvr_precisions and/or additional_amvr_precisions set and/or num_amvr_precisions and/or amvr_precisions set) may be derived according to at least one of the encoding parameters of a current block/a CTB/a CTU.

When at least one of information indicating the maximum number of candidates in the block vector candidate list, information indicating the maximum number of candidates in the merge candidate list of an inter prediction mode, block vector candidate information, a merge index, a L0 motion prediction flag or AMVP resolution-related information (amvr_precision_flag and/or amvr_precision_idx and/or amvr_flag and/or max_amvr_precision_idx and/or max_amvr_precision and/or amvr_separate_precision and/or num_additional_amvr_precisions and/or additional_amvr_precisions set and/or num_amvr_precisions and/or amvr_precisions set) does not exist in a bitstream, at least one of information indicating the maximum number of candidates in the block vector candidate list, information indicating the maximum number of candidates in the merge candidate list of an inter prediction mode, block vector candidate information, a merge index, a L0 motion prediction flag or AMVP resolution-related information (amvr_precision_flag and/or amvr_precision_idx and/or amvr_flag and/or max_amvr_precision_idx and/or max_amvr_precision and/or amvr_separate_precision and/or num_additional_amvr_precisions and/or additional_amvr_precisions set and/or num_amvr_precisions and/or amvr_precisions set) may be inferred as a first value (e.g., 0).

When a block vector candidate list is configured, information for identifying one of the candidates included in a block vector candidate list (e.g., at least one of an identifier, an index or a flag) may be entropy encoded/decoded or derived based on at least one of the encoding parameters.

As an example, when a current block is an intra block copy skip mode or an intra block copy merge mode, a block vector candidate in a block vector candidate list identified by block vector candidate information (e.g., a merge index) may be used as the block vector of a current block. In other words, in the same way as in an inter prediction mode, a block vector candidate may be identified based on a merge index, even in an intra block copy skip mode or an intra block copy merge mode.

As an example, when an intra block copy skip mode or an intra block copy merge mode is applied to a current block, merge index (e.g., merge_idx) information may be encoded/decoded or inferred for a current block. Based on the merge index, one of a plurality of candidates included in a block vector candidate list may be identified. Here, a merge index may indicate an index for a block vector.

Alternatively, when an intra block copy AMVP mode is applied to a current block, a prediction block vector candidate in a block vector candidate list identified by block vector candidate information may be set as the prediction block vector of a current block.

As an example, when an intra block copy AMVP mode is applied to a current block, L0 motion prediction flag (e.g., mvp_l0_flag) information for identifying the block vector candidate information of a current block may be encoded/decoded or inferred. In other words, in the same way as in an inter prediction mode, a block vector candidate may be identified based on a L0 motion prediction flag even in an intra AMVP mode.

Based on the L0 motion prediction flag, a block vector candidate in a block vector candidate list may be selected. Here, a L0 motion prediction flag may represent an index allocated to a block vector candidate in a block vector candidate list.

Meanwhile, the above-described merge index or L0 motion prediction flag may not be entropy encoded/decoded when the maximum number of block vector candidates in a block vector candidate list is 1. When a merge index or a L0 motion prediction flag is not entropy encoded/decoded, its value may be inferred as 0.

Table 21 shows an example in which encoding/decoding of a L0 motion prediction flag is omitted according to the maximum number of block vector candidates.

TABLE 21

| | |
|---|---|
| } else if ( CuPredMode[ x0 ][ y0 ] = = MODE_IBC ) { | |
| mvd_coding(x0, y0, 0, 0 ) | |
| if( MaxNumMergeCand > 1 ) | |
| mvp_l0_flag[ x0 ][ y0 ] | ae(v) |
| if( sps_amvr_enabled_flag && | |
| ( MvdL0[ x0 ][ y0 ][ 0 ] | |
| != 0 \| \| MvdL0[ x0 ][ y0 ][ 1 ] != 0 ) ) { | |
| amvr_precision_flag[ x0 ][ y0 ] | ae(v) |
| } | |

In Table 21, MaxNumMergeCand represents the maximum number of block vector candidates in a block vector candidate list. As in an example of Table 21, when MaxNumMergeCand is 1, a L0 motion prediction flag may not be entropy encoded/decoded. In this case, the value of a L0 motion prediction flag may be inferred as 0.

In other words, a L0 motion prediction flag may be entropy encoded/decoded only when MaxNumMergeCand is greater than 1.

As another example, the maximum number (MaxNumIBCCand) of candidates in a block vector candidate list may always be set to be greater than 1. In this case, when a current block corresponds to an intra block copy skip mode or an intra block copy merge mode, merge index information may always be entropy encoded/decoded regardless of the maximum number of candidates in a block vector candidate list.

Table 22 shows an example therefor.

TABLE 22

| | |
|---|---|
| coding_unit( x0, y0, cbWidth, cbHeight, treeType ) { | De- |
| ... | scriptor |
| if( CuPredMode[ x0 ][ y0 ] = = MODE_IBC ) { | |
| merge_idx[ x0 ][ y0 ] | ae(v) |
| } else { | |

Meanwhile, a block vector candidate selected under an intra AMVP mode may be set as the prediction block vector of a current block. The block vector of a current block may be derived by adding a block vector difference that is entropy encoded/decoded to a prediction block vector.

Meanwhile, rounding may be performed on a prediction block vector identified by block vector candidate information. The rounding may be performed based on the resolution of a block vector of a current block.

As described above, block vector resolution may be adaptively determined based on at least one of amvr_flag, amvr_precision_flag and amvr_precision_idx.

For example, when amvr_flag is a first value (e.g., 0), a block vector may have a size of N integer sample units.

In addition, when amvr_flag is a second value (e.g., 1), a block vector may have a size of M integer or P integer sample units.

For example, when amvr_flag is a second value and amvr_precision_flag is a first value (e.g., 0), a block vector may have a size of M integer sample units.

Alternatively, when amvr_flag is a second value and amvr_precision_flag is a second value (e.g., 1), a block vector may have a size of P integer sample units.

Here, N, M and P may be a positive integer. For example, N may be 1, M may be 4 and P may be 16. In addition, N may be smaller than M and P. In addition, P may be larger than N and M.

As an example, in performing a rounding operation according to Equation 10, when amvr_flag is a first value (e.g., 0) (i.e., when a block vector has a size of 1 integer sample unit), both rightshift and leftshift may be 4.

Alternatively, when amvr_flag is a second value (e.g., 1) and amvr_precision_flag is a first value (e.g., 0) (i.e., when a block vector has a size of 4 integer sample units), both rightshift and leftshift may be 6.

Alternatively, when amvr_flag is a second value (e.g., 1) and amvr_precision_flag is a second value (e.g., 1) (i.e., when a block vector has a size of 16 integer sample units), both rightshift and leftshift may be 8.

When an intra block copy mode is applied, the range of a block vector or the position of a reference block indicated by a block vector may be limited.

If the range of a block vector or the position of a reference block indicated by a block vector is not limited, the reconstructed image of all regions encoded/decoded before a current block in a current picture must be stored. In this case, when implementing an encoder/a decoder, a lot of memory is required to store a reconstructed image.

In order to solve the problem, when an intra block copy mode is applied, the range of a block vector or the position of a reference block indicated by a block vector may be limited.

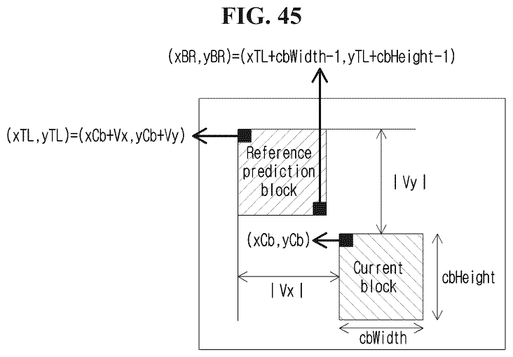

FIG. 45 is a diagram for describing an example in which the range of a block vector is restricted.

As in an example shown in FIG. 45, it is assumed that the coordinate of the top-left sample position of a current block is (xCb, yCb), the width of a current block is cbWidth, the height of a current block is cbHeight and the block vector of a current block is (Vx, Vy). In this case, the coordinate (xTL, yTL) of the top-left sample position of a reference block obtained by using the block vector of a current block may be (xCb+Vx, yCb+Vy) and the coordinate (xBR, yBR) of the bottom-right sample position of a reference block may be (xTL+cbWidth−1, yTL+cbHeight−1).

A method for limiting the range of values held by a block vector or the position of a reference block indicated by a block vector may be at least one of the following.

The range of values held by a block vector or the position of a reference block indicated by a block vector may be limited based on the encoding parameter of at least one of a current block or a neighboring block adjacent to a current block. Alternatively, the range of values held by a block vector or the position of a reference block indicated by a block vector may be limited based on the encoding parameter of at least one of a current CTU and a neighboring CTU adjacent to a current CTU.

A region including (xTL, yTL), the coordinate of the top-left sample position of a reference block, and a region including (xBR, yBR), the coordinate of a bottom-right sample position, may be available. Here, being available may mean that a corresponding region exists/is referenceable. Specifically, it may mean that a corresponding position is reconstructed or that a reconstructed sample for a corresponding position is stored.

In the embodiment and/or other embodiments of the present disclosure, the top-left coordinate of a reference block may refer to the coordinate of the top-left sample position of a reference block and the bottom-right coordinate of a reference block may refer to the coordinate of the bottom-right sample position of a reference block.

The size of a block vector may be limited so that the bottom-right coordinate of a reference block is not included in a current block. In other words, the size of a block vector may be limited so that a reference block does not overlap with a current block. To this end, a block vector may have to satisfy at least one of the following conditions.

$$Vx + cbWidth \leq 0$$

$$Vy + cbHeight \leq 0$$

A reference block may be included in at least one of the same CTB as a current block or (N−1) left CTBs of a current CTB. When a CTB size is 128×128, N may be 2. When a CTB size is smaller than 128×128, when a CTB size is 64×64 or when a CTB size is smaller than 64×64, the size of a region including a current CTB and left (N−1) may be the same as (height of CTB*(N*width of CTB)).

In this case, N may be determined based on the encoding parameter of at least one of a current CTU and a neighboring CTU adjacent to a current CTU.

When a CTB size is 128×128, a reference block may be included in the same CTB as a current block or a left CTB. When a reference block is included in the same CTB as a current block, a reference block may be included in a region encoded/decoded before a current block. For example, when a current CTB and the left CTB of a current CTB are partitioned in a 64×64 unit size, a reference block may exist in at least one of a 64×64 block to which a current block belongs or three 64×64 blocks encoded/decoded before a 64×64 block to which a current block belongs.

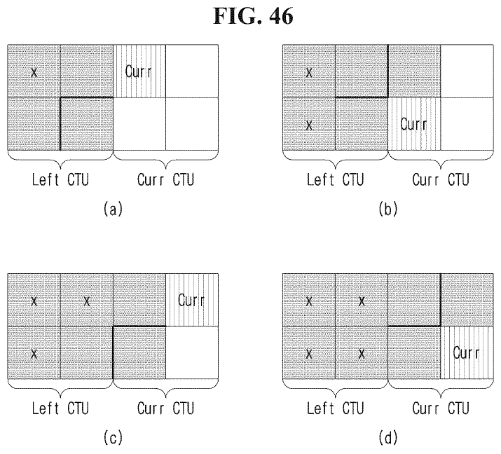

FIG. 46 is a diagram for describing the position of a reference block.

In an example of FIG. 46, a 64×64 block to which a reference block may belong is indicated according to the position of a 64×64 block to which a current block (Curr) in a CTB belongs. As in a shown example, a reference block may be included in one of a 64×64-sized block to which a current block belongs or three 64×64-sized blocks encoded/decoded before a 64×64-sized block to which a current block belongs.

In an example of FIG. 46, a region marked with “x” represents a region that may not include a reference block.

With a setting as in FIG. 46, the number of reconstructed samples that must be stored to derive a reference block may be limited to up to four 64×64 blocks, i.e., the number of 128×128-sized samples.

A reference region that may be used in an intra block copy mode may be stored in an independent buffer. By using the independent buffer, the range of a reference block may be limited.

As an example, under an intra block copy mode, the size of a reference region buffer may be M1×M2 and may be stored in M3 bits per sample. In this case, M1 and M2 may be a positive integer that is a multiple of 2 (e.g., 8, 16, 32, 64, 128, etc.), respectively, and M3 may be any positive integer (e.g., 3, 4, 5, 6, 7, 8, 9, 10, 11, 12, etc.).

Values stored in a corresponding buffer may be the value of a reconstructed sample to which loop filtering is not applied. In addition, when a corresponding reconstructed sample is not expressed as M3 bits per sample, it may be converted to be M3 bits per sample.

At least one of the M1, M2 and M3 may be determined based on the encoding parameter of at least one of a current block and a neighboring block adjacent to a current block. Alternatively, at least one of the M1, M2 and M3 may be determined based on the encoding parameter of at least one of a current CTU/CTB and a neighboring CTU/CTB adjacent to a current CTU/CTB.

A reference region buffer may be newly set for each CTB or CTU row of a brick or a tile or a slice or a sub-picture or a picture or a tile group. Being newly set may refer to resetting or initializing a corresponding buffer.

A corresponding buffer may be configured in at least one of the following ways.

The size of a reference region buffer for a luma component may be the same as the size of a CTB including a current block. For example, when a CTB size is 128×128, the size of a reference region buffer may be 128×128. Alternatively, the size of a reference region buffer may be smaller than a CTB size.

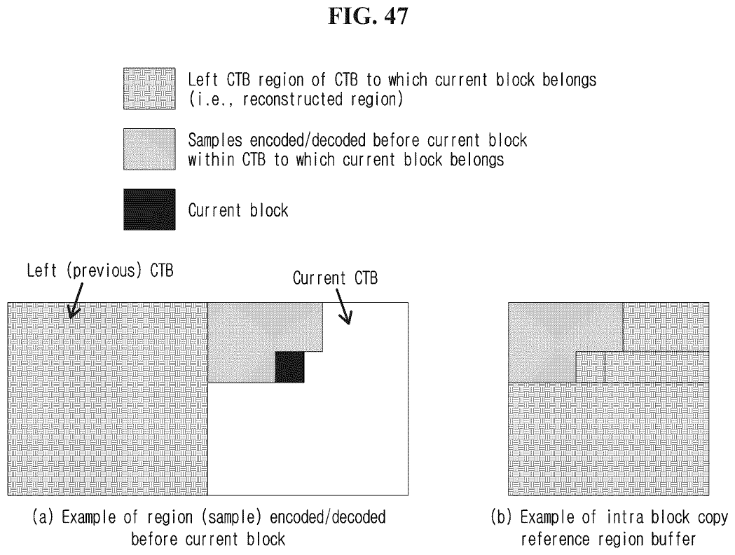

FIG. 47 is a drawing for describing a reference region buffer.

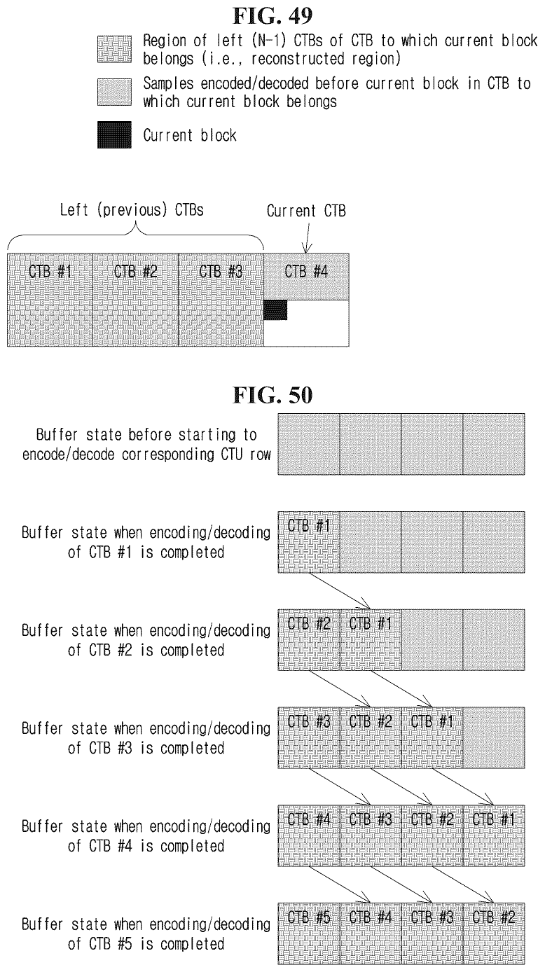

In an example shown in FIG. 47(a), a reference region buffer may be configured to include a region encoded/decoded before a current block in a CTB (a current CTB) including a current block and an encoded/decoded region in a CTB at the left position of a current CTB (refer to FIG. 49(b)).

In a reference region buffer, a position where reconstructed samples of a region encoded/decoded before a current block in a current CTB in a reference region buffer are stored may be the same position as the relative position of reconstructed samples in a current CTB. In the remaining region excluding a region corresponding to a region encoded/decoded before a current block in a reference region buffer and a current block in a current CTB, reconstructed samples included in a CTB adjacent to the left of a current CTB may be stored. In this case, a position where reconstructed samples included in a left CTB in a reference region buffer are stored may be the same as the relative position of reconstructed samples in a left CTB.

In other words, when the coordinate of a reconstructed sample is (x, y), a position where a corresponding reconstructed sample is stored in a reference region buffer may be (x % CTB width or height, y % CTB width or height), (x % M1, y % M2) or (x % M1, y % CTB height). Here, (x, y) may represent a relative distance from the top-left sample position of a CTB. Here, an operation result of Modulo Operation “%” may always be a positive value. In other words, when x is a negative value, x % L may be −(−x % L). For example, when M1 or a CTB width and/or height is 128, (−3% 128) may be 125.

When a block vector is (Vx, Vy), a prediction sample for a prediction target sample positioned at (x, y) may be set as a sample value at a position of ((x+Vx) % 128, (y+Vy) % 128) in a reference block buffer.

As described above, a region occupied by a current block in a reference region buffer may store reconstructed samples in a region corresponding to a current block in a left CTB. Accordingly, when a reference region buffer is used, a reference block may be allowed to overlap at least a part of a current block.

When a reference region buffer is used, there may be a limit that the block vector of a current block indicates a region included in a reference region buffer.

As an example, when the block vector of a current block is (Vx, Vy), the block vector of a current block may satisfy a condition in Equation 13 below.

$$Min Vx \leq Vx \leq Max Vx \qquad [ Equation 13 ]$$

$$Min Vy \leq Vy \leq Max Vy$$

In Equation 13, MinVx, MaxVx, MinVy and MaxVy may be derived as follows.

When the top-left coordinate of a reference region buffer is (0,0): MinVx=0,

$$Max Vx = ( Width of Reference Region Buffer - 1 ) ,$$

$$Min Vy = 0 ,$$

$$Max Vy = ( Height of Reference Region Buffer - 1 )$$

Meanwhile, in a reference region buffer, a coordinate may be set based on the center position.

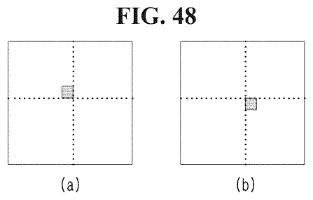

FIG. 48 shows an example in which a coordinate is set based on the center position of a reference region.

As in an example shown in FIG. 48(a), when the coordinate of a top-left sample at the center position is set as (0, 0), variables may be derived as follows.

$$Min Vx = - ( ( Width of Reference Region Buffer / 2 ) - 1 ) ,$$

$$Max Vx = ( Width of Reference Region Buffer / 2 ) ,$$

$$Min Vy = - ( ( Width of Reference Region Buffer / 2 ) - 1 ) ,$$

$$Max Vy = ( Height of Reference Region Buffer / 2 )$$

As in an example shown in FIG. 48(b), when the coordinate of a sample at the center position is set as (0, 0), variables may be derived as follows.

$$Min Vx = - ( Width of Reference Region Buffer / 2 ) ,$$

$$Max Vx = ( ( Width of Reference Region Buffer / 2 ) - 1 ) ,$$

$$Min Vy = - ( Width of Reference Region Buffer / 2 ) ,$$

$$Max Vy = ( ( Height of Reference Region Buffer / 2 ) - 1 )$$

At least one of the MinVx, MaxVx, MinVy and MaxVy may be determined based on the encoding parameter of at least one of a current block or a neighboring block adjacent to a current block. Alternatively, at least one of the MinVx, MaxVx, MinVy and MaxVy may be determined based on the encoding parameter of at least one of a current CTU or a neighboring CTU adjacent to a current CTU.

By limiting a value that a block vector may have in a reference region buffer, whether an invalid block vector is signaled/used in a current block may be determined.

Specifically, when the block vector of a current block exceeds the range of a reference region buffer or when the block vector of a current block is (0, 0), the block vector of a current block may be determined to be invalid.

When a block vector signaled/derived for a current block is out of a limited range, at least one of the following methods may be applied to adjust the block vector of a current block to fall within a limited range or to generate a prediction block based on the block vector of a current block.

When the block vector of a current block is out of a limited range, the block vector of a current block may be replaced with the closest block vector. In other words, it is assumed that a block vector signaled/derived for a current block is (V1x, V1y) and V1x is smaller than MinVx. In this case, the block vector of a current block may be replaced with (MinVx, V1y).

Alternatively, it is assumed that a block vector signaled or derived for a current block is (V1x, V1y) and Vax is larger than MaxVx. In this case, the block vector of a current block may be replaced with (MaxVx, V1y).

Alternatively, it is assumed that a block vector signaled or derived for a current block is (V1x, V1y) and V1y is smaller than MinVy. In this case, the block vector of a current block may be replaced with (V1x, MinVy).

Alternatively, it is assumed that a block vector signaled or derived for a current block is (V1x, V1y) and V1y is greater than MaxVy. In this case, the block vector of a current block may be replaced with (V1x, MaxVy).

Alternatively, the value of an unavailable sample indicated by a block vector may be padded with the closest available sample value. As an example, a sample value at a position out of a reference region buffer may be replaced with a sample value positioned at the boundary of a reference region buffer and a replaced sample value may be derived as the prediction sample of a current block.

Alternatively, when the block vector of a current block is unavailable, the block vector of a current block may be set as any fixed value. For example, the block vector of a current block may be replaced with (0,0) (i.e., a value indicating the position of a current block), (0, P1), (P2, 0) or (P3, P4). In this case, P1, P2, P3 or P4 may be any integer value.

Alternatively, instead of replacing the block vector of a current block, the value of a prediction sample obtained by using the block vector of a current block may be set as any fixed value.

In this case, any fixed value may be a value from 0 to 2\hat{ }(bitdepth)−1. Here, bitdepth is a positive integer greater than 5, and may be 5, 6, 7, 8, 9, 10, 11, 12, etc. As an example, any fixed value may be 0, 2\hat{ }(bitdepth−1) or 2\hat{ }(bitdepth)−1.

Alternatively, any fixed value may be a value from 0 to ((2<<bitdepth)−1). As an example, any fixed value may be 0, (2<<(bitdepth−N−1)) or ((2<<(bitdepth−N))−1). Here, N may be 0 or a positive integer. The N may be a value preset in an encoder/a decoder. Alternatively, information representing N may be signaled from an encoder to a decoder.

bitdepth may refer to the bit depth/depth of an input sample. The bitdepth may be a value preset in an encoder/a decoder. Alternatively, in an encoder, a bitdepth value may be encoded and signaled to a decoder.

At least one of the N and bitdepth may be set as a different value in a luma component block and a chroma component (Cb and/or Cr) block.

At least one of the N and bitdepth may be set as a different value according to the encoding mode of a current block. Here, an encoding mode may include at least one of an intra block copy skip mode, an intra block copy merge mode or an intra block copy AMVP mode.

At least one of the N and bitdepth may be determined according to at least one of the encoding parameters of a current block/CTB.

After a current block is encoded/decoded, the value of a reconstructed sample in a current block may be stored in a reference region buffer. This process may be called a reference region buffer update process. After a reference region buffer is updated, encoding/decoding of a next block may be performed based on an updated reference region buffer.

Through the reference region buffer update, sample values included in a reference region buffer are gradually updated, and as a result, when encoding/decoding of all blocks in a current CTB is completed, only reconstructed image samples in a current CTB may be included in a reference region buffer.

The size of a reference region buffer may be expressed as M1*M2. M1 represents the width of a reference region buffer, and M2 represents the height of a reference region buffer. M1 may be the width of a CTB or N times the width of a CTB. M2 may be the height of a CTB or N times the height of a CTB. As an example, N may be a positive integer that makes M1 and M2 128 respectively.

The height M2 of a reference region buffer may be the same as the height M1 of a reference region buffer.

Alternatively, the width M1 of a reference region may be ((128/CTB width)*K). K may represent the width of a reference region buffer when a CTB width is 128. As an example, K may be 256, 128 or 64.

At least one of the M1, M2, N and K may be determined based on the encoding parameter of at least one of a current block or a neighboring block adjacent to a current block. Alternatively, at least one of the M1, M2, N and K may be determined based on the encoding parameter of at least one of a current CTU/CTB or a neighboring CTU/CTB adjacent to a current CTU/CTB.

FIG. 49 shows a configuration example of a reference region buffer.

As in an example shown in FIG. 49, a reference region buffer may include (N−1) left CTBs encoded/decoded before a current CTB. In addition, a region encoded/decoded before a current block in a current CTB may also be included in a reference region buffer.

FIGS. 50 to 53 show an aspect in which a reference region buffer is updated as a CTB is encoded/decoded.

In an example shown in FIGS. 50 to 53, a reference region buffer may include (N−1) left CTBs encoded/decoded before a current CTB.

When CTB #1 is the first CTB of a current CTB row, a reference region buffer before starting to encode/decode CTB #1 may be empty. The block vector of a current block must not indicate an empty region in a reference region buffer.

Alternatively, an empty region in a reference region buffer may be filled with an initial value. An initial value may be a predetermined value within a range that a reconstructed sample may have. In this case, an initial value may be any integer value that is greater than or equal to 0 and less than or equal to “2\hat{ }(bitdepth)−1”. As an example, an initial value may be 0, 2\hat{ }(bitdepth−1) or (2\hat{ }(bitdepth)−1).

Alternatively, an initial value may be a value from 0 to (2<<bitdepth)−1. As an example, an initial value may be 0, (2<<(bitdepth−N−1)) or ((2<<(bitdepth−N))−1).

Here, N may be an positive integer including 0.

The N may be a value preset in an encoder/a decoder. Alternatively, information representing N may be signaled from an encoder to a decoder.

bitdepth may refer to the bit depth/depth of an input sample. The bitdepth may be a value preset in an encoder/a decoder. Alternatively, in an encoder, a bitdepth value may be encoded and signaled to a decoder.

At least one of the N and bitdepth may be set as a different value in a luma component block and a chroma component (Cb and/or Cr) block.

At least one of the N and bitdepth may be set as a different value according to the encoding mode of a current block. Here, an encoding mode may include at least one of an intra block copy skip mode, an intra block copy merge mode or an intra block copy AMVP mode.

At least one of the N and bitdepth may be determined according to at least one of the encoding parameters of a current block/CTB.

When an empty region in a reference region buffer is filled with an initial value, the block vector of a current block may be allowed to indicate a region set as an initial value. In other words, according to whether an initial value is allocated to an empty region in a reference block buffer, whether it is allowed to predict a current block may be determined based on a corresponding region.

When encoding/decoding of CTB #1 is completed, all of the reconstructed samples of CTB #1 may be stored in a reference region buffer.

When encoding/decoding of CTB #2 is completed, reconstructed samples of CTB #2 may be additionally stored in a reference region buffer.

In this case, when encoding/decoding of CTB #2 is completed, as in an example shown in FIG. 50, the storage position of samples of CTB #1 may be moved to the right by one CTB size in a reference region buffer and the reconstructed samples of CTB #2 may be stored in a position where CTB #1 was stored. In other words, as in an example shown in FIG. 50, the most recently encoded/decoded reconstructed sample in a CTB may be set to be stored on the leftmost of a reference region buffer.

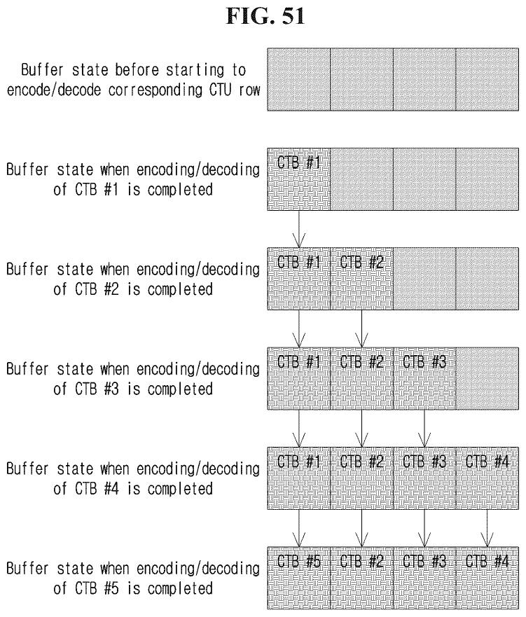

Alternatively, as in an example shown in FIG. 51, the storage position of samples of CTB #1 may be left as it is and reconstructed samples of CTB #2 may be additionally stored in the right region of CTB #1. In other words, as in an example shown in FIG. 51, a reference region buffer may be filled sequentially.

When encoding/decoding of CTB #4 is completed, a reference image buffer becomes full.

In this state, when encoding/decoding of CTB #5 is performed, as in an example shown in FIG. 50, reconstructed samples of CTB #5 may be stored on the leftmost of a reference region buffer.

Alternatively, as in an example shown in FIG. 51, when encoding/decoding of CTB #5 is performed, reconstructed samples of CTB #5 may be stored at a position where reconstructed samples of CTB #1 were stored.

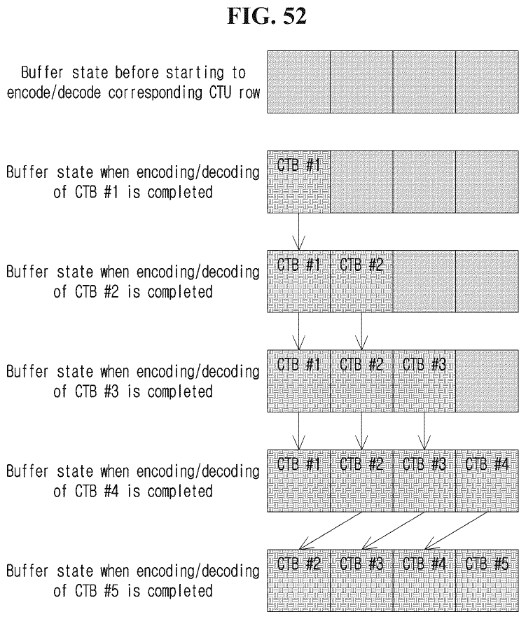

Meanwhile, as in an example shown in FIG. 52, the storage position of reconstructed samples of CTB #2 to CTB #4 may be moved to the left by one CTB size, and reconstructed samples of CTB #5 may be stored at a position where reconstructed samples of CTB #4 were stored.

By doing this, a position between CTBs in a picture and the position of CTBs in a reference region buffer may be set to be the same. Accordingly, the prediction block of a current block may be derived without converting a block vector.

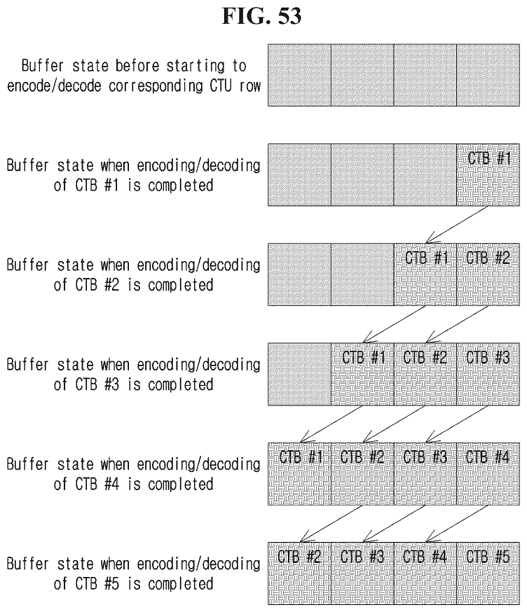

As another example, as in an example shown in FIG. 53, the reconstructed sample of the last encoded/decoded CTB may be stored on the rightmost of a reference block buffer. In this case, when encoding/decoding of CTB #2 is completed, the storage position of samples of CTB #1 may be moved to the left by one CTB size in a reference region buffer, and reconstructed samples of CTB #2 may be stored at a position where CTB #1 was stored.

When encoding/decoding of CTB #4 is complete, a reference image buffer becomes full. In this state, when CTB #5 is encoded/decoded, the storage position of reconstructed samples of CTB #1 to CTB #4 may be moved to the left by one CTB size, and reconstructed samples of CTB #5 may be stored at a position where reconstructed samples of CTB #4 were stored.

At the time of starting to encode/decode the K-th CTB, i.e., at the time of starting to encode/decode the first block of the K-th CTB, reconstructed samples of the (K−1), (K−2) to (K−N)-th CTBs may be stored in a reference region buffer. For example, when a CTB size is 64×64, N may be 4. In this case, at the time of starting to encode/decode the K-th CTB, reconstructed samples of the (K−1), (K−2), (K−3) and (K−4)-th CTBs may be stored in a reference region buffer.

The K may refer to any positive integer. As an example, K may be an integer greater than or equal to 5. A first block in the K-th CTB may be encoded/decoded by referring to a reference region buffer. After encoding/decoding of a corresponding block is completed, at least one of the state of a reference region buffer or a range that a block vector may have may be determined as follows.

In a reference region buffer, reconstructed samples of the (K−N)-th CTB may be deleted from a reference region buffer, and reconstructed samples of the first block of the K-th CTB may be stored in a reference region buffer. A reference region that the A-th block of the K-th CTB may refer to may be limited to (N−1) CTBs on the left of a current CTB. This may mean that the top-left coordinate (or position) and the bottom-right coordinate (or position) of a prediction block derived by the block vector of the A-th block are included in a region composed of (N−1) left CTBs. Here, A may be any positive integer greater than 1. Alternatively, A may be 0 or a positive integer.

Alternatively, the reference region of the A-th block of the K-th CTB may be limited to a region including blocks encoded/decoded before the A-th block in a current CTB and (N−1) CTBs on the left of a current CTB. This may mean that the top-left coordinate (or position) and the bottom-right coordinate (or position) of a prediction block derived by the block vector of the A-th block are included in a region composed of (N−1) left CTBs and blocks encoded/decoded before the A-th block of a current CTB.

As another example, in a reference region buffer, only samples at a position where a relative position in a CTB is the same as that of the first block of the K-th CTB among the reconstructed samples of the (K−N)-th CTB may be deleted. In a deleted position, reconstructed samples of the first block of the K-th CTB may be stored. In this case, the reference region of a current block in a reference region buffer may be limited to blocks encoded/decoded before a current block in a current CTB and (N−1) CTBs on the left of a current CTB. According to this method, when configuring a reference region buffer, all regions of a reference region buffer may be configured with reconstructed samples, improving encoding efficiency.

In the above-described embodiments related to a reference region buffer, when starting to encode/decode the first block of the K-th CTB or before encoding/decoding the first block of the K-th CTB, a region where reconstructed sample values of the encoded/decoded block of the K-th CTB or a block to be encoded/decoded will be stored may be initialized to an any fixed value or may be empty. Since a method for deriving an initial value has been described above, a detailed description is omitted at this step.

When a region included in a reference region buffer is empty, it represents that a corresponding region may not be indicated by a block vector. In other words, a block vector indicating an empty region may be unavailable to a current block.

On the other hand, when a region included in a reference region buffer is filled with an initial value, it represents that a corresponding region may be indicated by a block vector. When the block vector of a current block indicates a region filled with an initial value, the prediction sample value of a current block may be derived in the same manner as an initial value.

After a specific block in a current CTB is encoded/decoded, reconstructed sample values of an encoded/decoded block may be stored in an empty region in a reference region or a region set as an initial value. A region that is not encoded/decoded among the regions where a current CTB will be stored in a reference region buffer may be still empty or may be filled with an initial value.

The K may be determined according to at least one of the encoding parameters of a current block/CTB.

It is assumed that the width and height of a CTB are C1 and C2, respectively. When it is assumed that a current CTB and (N−1) CTBs on the left of a current CTB may be stored in a reference region buffer, a position where a block whose coordinate in a picture is (x, y) will be stored in a reference region buffer may be set as follows. Here, N may be determined according to at least one of the encoding parameters of a current block/CTB.

When following an embodiment shown in FIG. 50, a block whose coordinate in a picture included in the K-th CTB is (x,y) may be stored at the position of (x % C1, y % C2) in a reference picture buffer. At the time when blocks included in the K-th CTB are stored, the storage position of blocks included in the left CTBs of the K-th CTB in a reference region buffer may be as follows. A block whose coordinate included in the (K−1)-th CTB is (x1, y1) may be stored at (x1% C1+C1, y1% C2) within a reference picture buffer. A block whose coordinate included in the (K−2)-th CTB is (x1, y1) may be stored at (x1% C1+(C1*2), y1% C2) within a reference picture buffer. A block whose coordinate included in the (K−3)-th CTB is (x1, y1) may be stored at (x1% C1+(C1*3), y1% C2) within a reference picture buffer. In other words, a block whose coordinate included in the (K−A)-th CTB is (x1, y1) may be stored at (x1% C1+(C1*A), y1% C2) within a reference picture buffer. In this case, A may be a value greater than or equal to 0 and less than or equal to (N−1).

According to an embodiment shown in FIG. 51, a block whose coordinate included in the K-th CTB is (x,y) may be stored at the position of (x % C1, y % C2) in a reference picture buffer. At the time when blocks included in the K-th CTB are stored, the storage position of blocks included in the left CTBs of the K-th CTB in a reference region buffer may be as follows. A block whose coordinate included in the (K−1)-th CTB is (x1, y1) may be stored at (x1% C1+(C1*3), y1% C2). A block whose coordinate included in the (K−2)-th CTB is (x1, y1) may be stored at (x1% C1+(C1*2), y1% C2). A block whose coordinate included in the (K−3)-th CTB is (x1, y1) may be stored at (x1% C1+(C1*1), y1% C2). In other words, a block whose coordinate included in the (K−A)-th CTB is (x1, y1) may be stored at (x1% C1+(C1*(N−A)), y1% C2). A may be a value greater than or equal to 0 and less than or equal to (N−1). Alternatively, a block whose coordinate included in the (K−A)-th CTB is (x1, y1) may be stored at the position of (x % M1, y % M2), (x % M1, y % CTB Height) or (x % M1, y).

When following an embodiment shown in FIG. 52 or FIG. 53, a block whose coordinate included in the K-th CTB is (x,y) may be stored at the position of (x % C1+(C1*(N−1)), y % C2) in a reference picture buffer. At the time when blocks included in the K-th CTB are stored, the storage position of blocks included in the left CTBs of the K-th CTB in a reference region buffer may be as follows. A block whose coordinate included in the (K−1)-th CTB is (x1, y1) may be stored at (x1% C1+(C1*(N−2), y1% C2). A block whose coordinate included in the (K−2)-th CTB is (x1, y1) may be stored at (x1% C1+(C1*(N−3)), y1% C2). A block whose coordinate included in the (K−3)-th CTB is (x1, y1) may be stored at (x1% C1+(C1*(N−4)), y1% C2). In other words, a block whose coordinate included in the (K−A)-th CTB is (x1, y1) may be stored at (x1% C1+(C1*(N−(A+1))), y1% C2). A may be a value greater than or equal to 0 and less than or equal to (N−1).

A block vector may be expressed in one of the following method. Alternatively, it may be signaled or derived so that it may be expressed in one of the following methods.

When a coordinate within a picture at the top-left position of a current block is (x,y) and a coordinate within a picture at the top-left position of a prediction block is (x+VPx, y+VPy), a block vector may be expressed as (VPx, VPy), a difference between two coordinates.

When a coordinate within a reference region buffer at the top-left position of a current block is (x,y) and a coordinate within a reference region buffer at the top-left position of a prediction block is (x+VBx, y+VBy), a block vector may be expressed as (VBx, VBy), a difference between two coordinates.

In this case, when there is an empty region in a reference region buffer, the range of a block vector may be limited so that a prediction block does not include a corresponding region. Specifically, a block vector (VBx, VBy) may be limited so that both (x+VBx, y+VBy), the top-left coordinate of a prediction block, and (x+VBx+cbWidth−1, y+Vby+cbHeight−1), the bottom-right coordinate of a prediction block, are not included in the empty region of the reference region buffer. In other words, when the top-left coordinate of a prediction block is (x+VBx, y+VBy), the range of a block vector may be limited to satisfy (0≤x+VBx) and (0≤y+VBy).

In addition, when the bottom-right coordinate of a prediction block is (x+VBx+cbWidth−1, y+Vby+cbHeight−1), the range of a block vector may be limited to satisfy (x+VBx+cbWidth−1≤((C1*(N−1))−1)) and (y+VBy+cbHeight−1<(C2−1)). When it is assumed that it is possible to refer to a region encoded/decoded before a current block in a current CTB, a block vector may be limited to satisfy (x+VBx+cbWidth−1<x) or (y+VBy+cbHeight−1<y).

Alternatively, when an empty region in a reference region buffer is filled with an initial value, the range of a block vector may be limited to a range in which a prediction block is included in a reference buffer region. In other words, when the top-left coordinate of a prediction block is (x+VBx, y+VBy), the range of a block vector may be limited to satisfy (0≤x+VBx) and (0≤y+VBy). In addition, when the bottom-right coordinate of a prediction block is (x+VBx+cbWidth−1, y+Vby+cbHeight−1), a block vector may be limited to satisfy (x+VBx+cbWidth−1<((C1*N)−1)) and (y+VBy+cbHeight−1<(C2−1)).

As in embodiments described above, a template matching technique may be applied under an intra block copy merge mode or an intra block copy AMVP mode. Specifically, when an intra block copy merge mode or an intra block copy AMVP mode is applied to a current block, at least one of a technique for reordering a block vector candidate list based on template matching or a technique for improving a block vector based on template matching may be applied.

In this case, only one of a template matching-based intra block copy merge mode and a general intra block copy merge mode may be used for a current block. In other words, based on a flag indicating whether a template matching-based intra block copy merge mode is applied (e.g., a TM-merge flag), whether to apply a template matching-based intra block copy merge mode or whether to use a general intra block copy merge mode may be selected.

Meanwhile, when a template matching-based merge/AMVP mode is applied, the first N block vector candidates may be inserted into a block vector candidate list. Afterwards, a template matching cost for each of the N block vector candidates may be calculated, and only M block vector candidates with a low cost may be set to be available for a current block. Here, M may be a number smaller than N. As an example, when it is assumed that N is 3 and M is 2, one candidate with a low cost among the three block vector candidates may be set to be unavailable for a current block.

As another example, when a template matching-based merge/AMVP mode is applied, a block vector may be limited to be improved only in an integer pixel unit. As an example, a block vector derived from a block vector candidate may be set to be improved only in a 1-pel unit or a 4-pel unit. In this case, there is an advantage that block vector improvement is possible without performing interpolation.

Meanwhile, an improved block vector must meet the range restriction of a block vector which will be described later.

As another example, each block vector candidate included in a block vector candidate list may be improved based on template matching to update a block vector candidate list. In other words, a block vector candidate list may include improved block vector candidates obtained by improving block vector candidates that are inserted first.

Meanwhile, a block vector candidate may be improved and improved block vector candidates may be pruned to select a candidate to be inserted into a block vector candidate list.

A template matching-based block vector improvement method may also be performed in a sub-block unit. As an example, when a block vector is derived for a current block, the block vector of a current block may be set as the prediction block vector of each sub-block. Afterwards, a template may be set for each sub-block to apply a template matching-based block vector improvement method independently to each sub-block.

### [E1-2/D1-2] A Step for Deriving the Block Vector of a Chroma Component Block;

When a single tree type (SINGLE_TREE) in which the block partition structure of a luma component and a chroma component within the same CTU is the same is applied and a current chroma component block is encoded/decoded in an intra block copy mode, a step for deriving the block vector of a current chroma component block may be derived according to an embodiment described in a step for deriving the block vector of a luma component block ([E1-1/D1-1]). In other words, under a single tree type, a method for deriving the block vector of a chroma component block may be the same as a method for deriving the block vector of a luma component block.

Let's assume that a dual tree structure in which the block partition structure of a luma component and a chroma component within the same CTU is independently formed is applied and a current block is a chroma component block (DUAL_TREE_CHROMA). In this case, a step for deriving the block vector of a current chroma component block may be derived according to an embodiment described in a step for deriving the block vector of a luma component block ([E1-1/D1-1]). In other words, under a dual tree type, a method for deriving the block vector of a chroma component block may be the same as a method for deriving the block vector of a luma component block.

As another example, when a single tree type in which the block partition structure of a luma component and a chroma component within the same CTU is the same is applied and a current chroma component block is encoded/decoded in an intra block copy mode or a template matching prediction mode, the block vector of a current chroma component block may be derived as follows.

In addition, in a method for deriving a block vector described below, a block vector configuring a candidate list or a derived block vector may be a block vector for intra block copy or a template matching block vector.

First, a luma component block corresponding to a current chroma component block may be determined as follows.

Let's assume that the top-left sample position of a current chroma component block is (xc, yc), the width of a current chroma component block is We and the height of a current chroma component block is Hc. In this case, the top-left sample position of a luma component block corresponding to a current chroma component block may be (xc/K1, yc/K2), a width may be K1×Wc and a height may be K2×Hc. In this case, K1 and K2 may have a different value according to a chroma component format.

As an example, when the chroma component format of a current picture is a 4:2:0 format, both K1 and K2 may be 2.

As an example, when the chroma component format of a current picture is a 4:2:2 format, K1 may be 2 and K2 may be 1.

As an example, when the chroma component format of a current picture is a 4:4:4 format, both K1 and K2 may be 1.

Since the block partition structure of a chroma component block and a luma component block is the same, only one luma component block may be included in a region specified by the position, width and height of a luma component block corresponding to a current chroma component block.

When the block vector of a luma component block corresponding to a chroma component block is (MVL[0], MVL[1]), the block vector of a corresponding chroma component block may be set as (MVL[0]/K1, MVL[1]/K2). As described above, K1 and K2 may be determined according to a chroma component format.

In embodiments described below, it is described by assuming that the basic unit of MVL[0] and MVL[1] is 1 sample. However, the basic unit of MVL[0] and MVL[1] may be 1/16 sample, 1/N sample or N samples. Here, N is a positive integer, and may be 1, 2, 4 or 8.

Let's assume that a dual tree structure in which the block partition structure of a luma component and a chroma component in the same CTU is configured independently is applied and a current block is a chroma component block (DUAL_TREE_CHROMA). When a current chroma component block is encoded/decoded in an intra block copy mode or a template matching prediction mode, the block vector of a current chroma component block may be derived as follows.

A luma component region corresponding to a current chroma component block may be determined as follows.

Let's assume that the top-left sample position of a current chroma component block is (xc, yc), a width is We and a height is Hc. In this case, the top-left sample position of a luma component region corresponding to a current chroma component block may be (xc/K1, yc/K2), a width may be K1×ωc and a height may be K2×Hc. As described above, K1 and K2 may have a different value according to a chroma component format.

Since the partition structure of a chroma component block and a luma component block is independently determined, a luma component region corresponding to a current chroma component block may include only a part of a partitioned luma component block or may include at least one luma component block.

Considering this, a current chroma component block may be partitioned into N×M-sized sub-blocks and a luma component region corresponding to a current chroma component may also be partitioned into (N*K1)×(M*K2)-sized sub-blocks. Afterwards, the block vector of a N×M-sized sub-block in a current chroma component block may be derived from a (N*K1)×(M*K2)-sized luma component sub-block corresponding thereto. In this case, N and M may be an integer greater than or equal to 1.

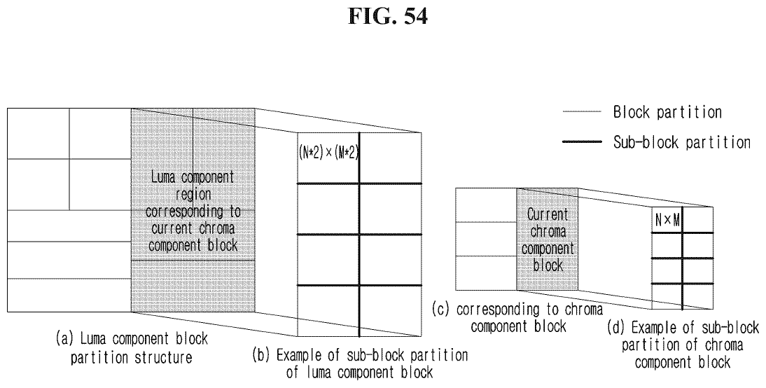

FIG. 54 shows an example in which a block vector is derived for each sub-block after a current chroma block is partitioned into a plurality of sub-blocks.

A current chroma component block may be partitioned into N×M-sized sub-blocks and a luma component region corresponding to a current chroma component block may also be partitioned into (N*K1)×(M*K2)-sized sub-blocks. In this case, N and M may be an integer greater than or equal to 1.

As another example, when the width of a current chroma component block is We and a height is Hc, a current chroma component block may be partitioned into P1 parts horizontally and P2 parts vertically to generate N×M-sized sub-blocks. In this case, N may be Wc/P1 and M may be Hc/P2. In addition, P1 and P2 may be an integer greater than or equal to 1.

When there is a luma component sub-block corresponding to a sub-block in a current chroma component block, the block vector of a sub-block in a current chroma component block may be derived from the block vector of a corresponding luma component sub-block.

As an example, when the block vector of a luma component sub-block corresponding to a sub-block in a chroma component block is (MVL[0], MVL[1]), the block vector of a sub-block in a corresponding chroma component block may be (MVL[0]/K1, MVL[1]/K2). As described above, K1 and K2 may be a value determined by a chroma component format.

Meanwhile, there may be a case where sub-blocks in a luma component region corresponding to a current chroma component block are not encoded/decoded in the same prediction mode. In other words, since the block partition structure of a luma component and a chroma component is independent, a luma component sub-block corresponding to a sub-block in a chroma component block may not match a luma component prediction block or at least two luma component prediction blocks may exist in a luma component sub-block.

Here, a luma component prediction block may refer to a leaf node block. In other words, a luma component prediction block may refer to a block to which the same prediction or the same transform/inverse transform is applied in encoding/decoding. A luma component prediction block may be determined by block partition for a luma component.

A luma component region corresponding to a chroma component block mentioned in the present disclosure does not refer to only a block (i.e., a leaf node block) determined by luma component block partition, as in an example shown in FIG. 54. A luma component region may refer to a region corresponding to the position and size of a chroma component block. Accordingly, in a luma component region, only a single leaf node block may exist or a plurality of leaf node blocks may exist.

Accordingly, the block vector of a luma component sub-block corresponding to a sub-block in a current chroma component block may be the block vector of a luma component prediction block including a sample at a predefined position in a luma component block.

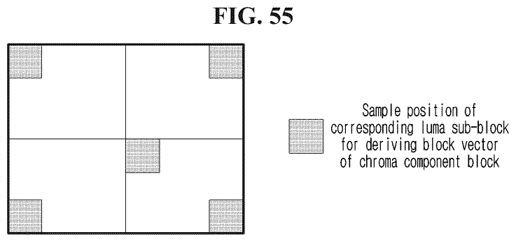

FIG. 55 illustrates a sample at a predefined position.

When a luma component prediction block including one of the sample positions indicated in FIG. 55 is encoded/decoded in an intra block copy mode or a template matching prediction mode, the block vector of a corresponding luma component prediction block may be derived as the block vector of a sub-block in a current chroma component block.

As an example, the block vector of a sub-block in a current chroma component block may be derived based on the block vector of a luma component prediction block including the top-left sample of a luma component sub-block.

Alternatively, the block vector of a sub-block in a current chroma component block may be derived based on the block vector of a luma component prediction block including a sample at the center position of a luma component sub-block.

Alternatively, after sequentially searching for a plurality of samples at a predefined position, the block vector of a sub-block in a current chroma component block may be derived from the luma component prediction block of a block encoded/decoded in an intra block copy mode or a template matching prediction mode that is found first.

Alternatively, the block vector of a sub-block in a current chroma component block may be derived from a luma component prediction block that includes the largest number of samples among a plurality of samples at a predefined position.

Alternatively, the block vector of a sub-block in a current chroma component block may be derived based on the block vector of a luma component prediction block that occupies the largest region in a luma component sub-block.

Meanwhile, when a luma component prediction block selected according to the condition is not encoded/decoded in an intra block copy mode or a template matching prediction mode or is encoded/decoded in an intra prediction mode, a problem may occur in which a block vector may not be derived from a corresponding luma component prediction block. In other words, when the prediction mode of a luma component sub-block corresponding to a sub-block in a current chroma component is not an intra block copy mode or a template matching prediction mode, a problem may occur in which it is difficult to derive the block vector of a sub-block in a current chroma component block from a corresponding luma component sub-block.

In this case, the block vector of a sub-block in a current chroma component block may be derived by one of the following methods.

The block vector of a current sub-block may be set as (0,0) or (D1, D2). In this case, D1 and D2 may be an integer such as 0, ±1, ±2 or ±3.

The block vector of a current sub-block may be set as (Wc+D1, D2) or (D1, Hc+D2). In this case, We may represent the width of a current chroma component block, and He may represent the height of a current chroma component block.

The block vector of a current sub-block may be set as one of (−(Wc<<n)+a, −(Hc<<n)+b), (−(Wc<<n)+c, 0) or (0, −(Hc<<n)+d). In this case, n may be a positive integer, and a, b, c and d may have an integer value.

The block vector of the neighboring sub-block of a current sub-block (e.g., at least one of a top sub-block, a bottom sub-block, a left sub-block, a right sub-block, a top-left sub-block, a top-right sub-block, a bottom-left sub-block, a bottom-right sub-block, etc.) may be used as the block vector of a current sub-block.

The block vector of a current sub-block may be derived by using the block vector statistical value of sub-blocks where a block vector is derived from a corresponding luma component sub-block among the sub-blocks of a current chroma component block.

For example, the mean, median, maximum or minimum value of block vectors of sub-blocks where a block vector is derived from a corresponding luma component sub-block may be set as the block vector of a current sub-block.

Alternatively, a block vector with the highest occurrence frequency among the block vectors of the sub-blocks may be set as the block vector of a current sub-block.

Alternatively, when a luma component sub-block corresponding to a current sub-block is not encoded/decoded in an intra block copy mode or a template matching prediction mode, a corresponding sub-block may not be encoded/decoded in an intra block copy mode or a template matching prediction mode. Alternatively, when there is a sub-block where a corresponding luma component sub-block is not encoded/decoded in an intra block copy mode or a template matching prediction mode among the sub-blocks in a current chroma component block, a current chroma component block may be set not to be encoded/decoded in an intra block copy mode or a template matching prediction mode.

The prediction mode of a luma component sub-block corresponding to a sub-block in a current chroma component block may be at least one of an intra prediction mode, an inter prediction mode, an intra block copy mode or a template matching prediction mode. More specifically, an inter prediction mode may be at least one of a skip mode, a merge mode, an AMVP mode, an affine skip mode or an affine inter mode, and an intra block copy mode may be at least one of an intra block copy skip mode, an intra block copy merge mode, an intra block copy AMVP mode or a template matching prediction mode.

The prediction mode of a luma component sub-block may be set to be the same as the prediction mode of a luma component prediction block including a sample at a predefined position in a luma component sub-block. As in an example shown in FIG. 57, a sample at a predefined position may include at least one of a top-left sample, a central sample, a top-right sample, a bottom-left sample or a bottom-right sample.

Alternatively, the prediction mode of a luma component prediction block including the largest number of samples among a plurality of samples at a predefined position may be set as the prediction mode of a luma component sub-block.

Alternatively, the prediction mode of a luma component prediction block occupying the largest region in a luma component sub-block may be set as the prediction mode of a luma component prediction block.

### [E2/D2] A Step for Deriving a Prediction Block;

In describing a step for deriving a prediction block for prediction in an intra block copy mode, a step for deriving the prediction block of a luma component block ([E2-1/D2-1]) and a step for deriving the prediction block of a chroma component block ([E2-2/D2-2]) are described separately.

### [E2-1/D2-1] A Step for Deriving the Prediction Block of a Luma Component Block;

A block indicated by the block vector of a luma component block derived from a current luma component block may be called a reference block. In this case, a reference block may be determined as the prediction block of a current block.

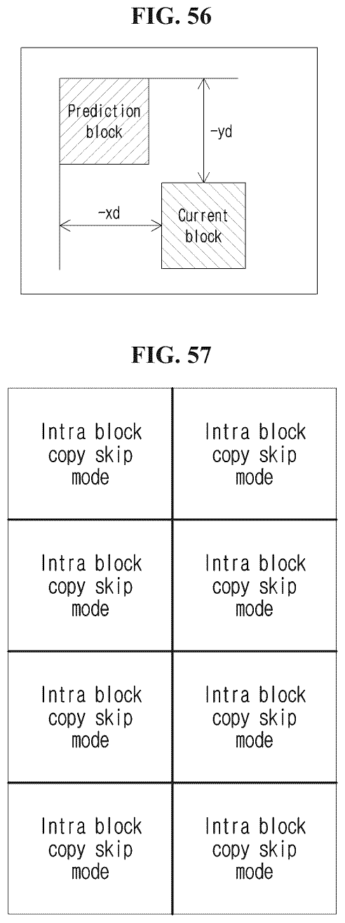

FIG. 56 is to describe an example in which a reference block indicated by a block vector is set as a prediction block.

As in an example of FIG. 56, it is assumed that the top-left sample position of a current luma component block is (x0, y0), a width is WL and a height is HL. When the block vector of a current luma component block is (xd, yd), a sample position (x0+xd, y0+yd) spaced apart by (xd, yd) from the top-left sample position of a current luma component block in the same picture may be set as a top-left sample, and a reference block (i.e., a block in the size of WL×HL) having the same width and height as a current block may be set as the prediction block of a current block.

In this case, when xd is a negative integer, it represents that a reference block is positioned at a position spaced apart by xd in a left horizontal direction based on (x0,y0), and when xd is a positive integer, it represents that a reference block is positioned at a position spaced apart by xd in a right horizontal direction based on (x0, y0). In addition, when yd is a negative integer, it represents that a reference block is positioned at a position spaced apart by yd in a top vertical direction based on (x0,y0), and when yd is a positive integer, it represents that a reference block is positioned at a position spaced apart by yd in a bottom vertical direction based on (x0,y0).

FIG. 56 shows an example in which both xd and yd are a negative integer.

The sample value of a reference block may be set as the prediction sample value of a current luma component block. In other words, a reference block may be called the prediction block of a current luma component block.

The sample value of a reference block may be a reconstructed sample value to which at least one of the loop filterings is not applied.

When a block vector is (0,0), the value of a prediction sample may be set as a fixed value. A fixed value may be a predetermined value within a range that a reconstructed sample may have. In other words, a fixed value may be any integer value greater than or equal to 0 and less than or equal to “2\hat{ }(bitdepth)−1”. For example, a fixed value may be 0, 2\hat{ }(bitdepth−1) or (2\hat{ }(bitdepth)−1).

As another example, a fixed value may be a value from 0 to ((2<<bitdepth)−1_. bitdepth is a positive integer, and for a detailed description of a variable bitdepth, refer to the above-described embodiment. As an example, a fixed value may be 0, (2<<(bitdepth−N−1)) or ((2<<(bitdepth−N))−1).

Here, N may be an positive integer including 0. In addition, the N may be a preset value in an encoder/a decoder and may be a value signaled from an encoder to a decoder.

The bitdepth may refer to the bit depth/depth of an input sample. In addition, the bitdepth may be a preset value in an encoder/a decoder and may be a value signaled from an encoder to a decoder.

At least one of the N and the bitdepth may have a different value in a luma component block and a chroma component (Cb and/or Cr) block.

At least one of the N and the bitdepth may have a different value according to at least one of an intra block copy skip mode, an intra copy merge mode and an intra block copy AMVP mode that are the encoding mode of a current block.

At least one of the N and bitdepth may be determined according to at least one of the encoding parameters of a current block/CTU.

For a block vector, its value may be limited so that a reference block is positioned in a limited region. When a block vector does not have a value within a limited range, the prediction block of a block having a corresponding block vector may set a prediction block sample value as a fixed value. A corresponding fixed value may be set to be the same as a fixed value set when the above-described block vector is (0,0).

When encoding/decoding is performed by applying a reference region buffer, a region spaced apart by the block vector of a current block from a current block position in a reference region buffer may be set as a reference block. In other words, a reference block may be included in a reference region buffer.

When a coordinate in a picture of a sample in a current block is (x,y) and a block vector is (Vx,Vy), the position of a corresponding reference sample positioned in a reference block in a reference region buffer may be ((x+Vx) % M1, (y+Vy) % M2) or ((x+Vx) % M1, (y+Vy)).

### [E2-2/D2-2] A Step for Deriving the Prediction Block of a Chroma Component Block;

For a single tree type (SINGLE_TREE) where the block partition structure of a luma component and a chroma component in the same CTU is the same, the prediction block of a current chroma component block encoded/decoded in an intra block copy mode or a template matching prediction mode may be derived as follows.

A reference block spaced apart from a current chroma component by the block vector of a current chroma component block may be set as the prediction block of a current chroma component block.

For example, it is assumed that the top-left sample position of a current chroma component block is (x0, y0), a width is We and a height is Hc. When the block vector of a current chroma component block is (xd, yd), a block in the same size as a current chroma component block (i.e., a block in the size of Wc×Hc) where a sample position (x0+xd, y0+yd) spaced apart by (xd, yd) from the top-left sample position of a current chroma component block in the same picture is set as a top-left sample position may be set as the prediction block of a current chroma component block.

In this case, when xd is a negative integer, it represents that a reference block is positioned at a position spaced apart by xd in a left horizontal direction based on (x0,y0), and when xd is a positive integer, it represents that a reference block is positioned at a position spaced apart by xd in a right horizontal direction based on (x0, y0). In addition, when yd is a negative integer, it represents that a reference block is positioned at a position spaced apart by yd in a top vertical direction based on (x0,y0), and when yd is a positive integer, it represents that a reference block is positioned at a position spaced apart by yd in a bottom vertical direction based on (x0,y0).

The sample value of a reference block may be set as the prediction sample value of a current chroma component block. In other words, a reference block may be called the prediction block of a current chroma component block.

Under a dual tree structure where the block partition structure of a luma component and a chroma component within the same CTU is independent, the prediction block of a current chroma component block (DUAL_TREE_CHROMA) encoded/decoded in an intra block copy mode or a template matching prediction mode may be derived as follows.

A prediction block for each sub-block may be derived by using a block vector derived in a sub-block unit within a current chroma component block.

In this case, a block indicated by the block vector of a sub-block within a current chroma component block (i.e., a reference block) may be called a prediction sub-block.

For example, it is assumed that the top-left sample position of a sub-block within a current chroma component block is (sx0, sy0), a width is SWc and a height is SHc. When the block vector of a sub-block in a current chroma component block is (Sxd, Syd), a reference block in the same size as a current sub-block (i.e., a block in the size of SWc×SHc) where a sample position (sx0+Sxd, sy0+Syd) spaced apart by (Sxd, Syd) from the top-left sample position of a current sub-block in the same picture is set as a top-left sample position may be set as a prediction sub-block.

The sample value of a prediction sub-block may be set as the prediction sample value of a sub-block in a current chroma component block. In addition, a prediction sub-block may be referred to as the prediction block of a sub-block in a current chroma component block.

Sub-block prediction blocks for sub-blocks included in a current chroma component block may be configured with prediction blocks of a current chroma component block.

Meanwhile, the prediction block of a current block may also be obtained by combining an intra block copy mode and another prediction mode. As an example, the final prediction block of a current block may be derived through the weighted sum of a first prediction block obtained based on an intra block copy mode and a second prediction block obtained based on a second prediction mode. Here, a second prediction mode may be intra prediction or inter prediction.

Meanwhile, when a second prediction mode is intra prediction, a predefined intra prediction mode may be used to obtain a second prediction block. Here, a predefined prediction mode may be a planar, a DC, a vertical mode, a horizontal mode, a top-left diagonal mode, a top-right diagonal mode or a bottom-left diagonal mode.

Alternatively, when a second prediction mode is intra prediction, an intra prediction mode for deriving a second prediction block may be selected from a MPM list.

Meanwhile, a weight applied to a first prediction block and a second prediction block may be determined differently depending on whether an intra block copy mode is an intra block copy merge mode or an intra block copy AMVP mode. As an example, a weight applied to a first prediction block may be set as a larger value when an intra block copy merge mode is applied compared to when an intra block copy AMVP mode is applied.

As another example, an intra block copy mode and geometric partition prediction may be combined to obtain a prediction block. As an example, after a current block is partitioned into two partitions, the block vector candidate of each of the two partitions may be selected from a block vector candidate list.

Afterwards, a first prediction block may be derived based on the first block vector candidate of a first partition, and a second prediction block may be derived based on the second block vector candidate of a second partition. Afterwards, the final prediction block of a current block may be derived through the weighted sum of a first prediction block and a second prediction block.

Alternatively, after a current block is partitioned into two partitions, an intra block copy mode may be applied to a first partition of the two partitions and a different prediction mode may be applied to a second partition. A prediction mode applied to a second partition may be inter prediction or intra prediction.

Meanwhile, geometric partition prediction may be applied to a current block when an intra block copy merge mode is applied to a current block or when a template matching-based intra block copy merge mode is applied to a current block.

As another example, an intra block copy merge mode and an intra block copy AMVP mode may be applied to a current block simultaneously. Specifically, under an intra block copy merge mode, a first block vector for a current block may be derived to obtain a first prediction block for a current block. In addition, under an intra block copy AMVP mode, a second block vector for a current block may be derived to obtain a second prediction block for a current block. Afterwards, based on the average or weighted sum operation of a first prediction block and a second prediction block, the final prediction block of a current block may be derived.

### [E3/D3] A Step for Deriving a Residual Block;

When a residual block exists, generally in an encoding process, at least one of transform and quantization may be performed on a residual block and a transformed and quantized residual block may be entropy encoded. In a decoding process, coefficients in a residual block may be entropy decoded and at least one of dequantization and inverse transform may be performed to reconstruct a residual block. Here, a reconstructed residual block may refer to a residual block.

Identifier information representing whether residual block-related information which is entropy encoded/decoded (e.g., a quantized transform coefficient, a quantized level or a transform coefficient) exists may include at least one of the following.
cu_cbf

When a luma component and a chroma component have the same block partition structure, whether the quantized transform coefficient of a luma component block and the quantized transform coefficient of a chroma component block exist may be determined by the cu_cbf.

When a luma component and a chroma component have an independent block partition structure, the cu_cbf may represent whether the quantized transform coefficient of a luma component block exists or whether the quantized transform coefficient of a chroma component block exists.

When information representing whether a quantized transform coefficient exists in a residual block is a first value (e.g., 1), it may mean that a quantized transform coefficient exists for the residual block of a corresponding block. When the information is a second value (e.g., 0), it may mean that a quantized transform coefficient does not exist for the residual block of a corresponding block.

When a luma component and a chroma component have the same block partition structure and when a quantized transform coefficient exists in a residual block for at least one of a luma component block and a chroma component (Cb and Cr) block, the information may have a first value. On the other hand, when a quantized transform coefficient does not exist in a residual block for all components, the information may have a second value.

tu_cbf_luma

u_cbf_luma may represent whether a quantized transform coefficient exists in the residual block of a luma component block.

When information on whether a quantized transform coefficient exists in the residual block of a luma component block is a first value (e.g., 1), it may mean that a quantized transform coefficient exists in the residual block of a corresponding luma component block.

When information on whether a quantized transform coefficient exists in the residual block of a luma component block is a second value (e.g., 0), it may mean that a quantized transform coefficient does not exist in the residual block of a corresponding luma component block.

tu_cbf_cr, tu_cbf_cb

tu_cbf_cr represents whether a quantized transform coefficient exists in the residual block of a chroma component Cr, and tu_cbf_cb represents whether a quantized transform coefficient exists in the residual block of a chroma component Cb.

When information on whether a quantized transform coefficient exists in the residual block of a chroma component (Cr or Cb) block is a first value (e.g., 1), it may mean that a quantized transform coefficient exists in the residual block of a corresponding chroma component (Cr or Cb) block.

When information on whether a quantized transform coefficient exists in the residual block of a chroma component (Cr or Cb) block is a second value (e.g., 0), it may mean that a quantized transform coefficient does not exist in the residual block of a corresponding chroma component (Cr or Cb) block.

In the embodiment and/or other embodiments of the present disclosure, a quantized transform coefficient may refer to at least one of a quantized level or transform coefficient. In addition, a quantized transform coefficient may refer to a quantized transform coefficient having a non-zero value. A residual block may include a quantized transform coefficient. In other words, when a quantized transform coefficient does not exist in a residual block, it represents that the value of all coefficients in a residual block is 0.

At least one of tu_cbf_luma, tu_cbf_cr or tu_cbf_cb may be additionally signaled only when cu_cbf is a first value. Based on tu_cbf_luma, tu_cbf_cr and tu_cbf_cb, whether a quantized transform coefficient exists in the residual block of a luma component, a chroma component Cr and a chroma component Cb may be determined.

When a luma component and a chroma component have an independent block partition structure, cu_cbf may be the same information as tu_cbf_luma.

Let's assume that it is a single tree type (SINGLE_TREE) where the block partition structure of a luma component and a chroma component in a current encoding target CTU is the same. When an intra block copy skip mode or a template matching prediction mode is applied to a current luma component block, the residual block of a current luma component block and a current chroma component block may be derived as follows.

When an intra block copy skip mode or a template matching prediction mode is applied to a current luma component block, as in a skip mode in inter prediction, a residual block for a current luma component block may not exist. In this case, a residual block may be set as a value of ‘0’.

In the embodiment and/or other embodiments of the present disclosure, when a residual block is set to have a value of ‘0’, it may mean that the value of all quantized transform coefficients in a residual block is set as 0 or that the value of all residual coefficients in a residual block is set as 0 or that all residual samples in a residual block are set as a value of 0.

When an intra block copy skip mode or a template matching prediction mode is applied to a luma component block corresponding to a current chroma component block, a residual block may not exist for a current chroma component block, similarly to a luma component block. In this case, the residual block of a current chroma component block may be set to have a value of ‘0’.

When an intra block copy skip mode or a template matching prediction mode is applied, information identifying whether a residual block exists (e.g., an identifier, a flag or an index (e.g., at least one of cu_cbf, tu_cbf_luma, tu_cbf_cr or tu_cbf_cb)) may not be signaled.

For example, encoding/decoding of cu_cbf indicating whether all quantized transform coefficients exist in the residual block of a luma component, a chroma component Cr and a chroma component Cb may be omitted. In this case, in an encoding/decoding process, the value of the cu_cbf may be inferred (set) as a second value indicating that all quantized transform coefficients do not exist in the residual block of a luma component, a chroma component Cr and a chroma component Cb.

In addition, encoding/decoding of tu_cbf_luma indicating whether a quantized transform coefficient exists in the residual block of a luma component, tu_cbf_cr indicating whether a quantized transform coefficient exists in the residual block of a chroma component Cr and tu_cbf_cb indicating whether a quantized transform coefficient exists in the residual block of a chroma component Cb may also be omitted. Syntaxes where the encoding/decoding is omitted may be derived (set) as a second value in an encoding/decoding process. In other words, each syntax may be inferred (set) as a value indicating that a quantized transform coefficient does not exist in a residual block for a corresponding component block.

Let's assume that under a single tree typ (SINGLE_TREE) where the block partition structure of a luma component and a chroma component in a current encoding target CTU is the same, an intra block copy merge mode or a template matching prediction mode is applied to a current luma component block. In this case, the residual block of a current luma component block and a chroma component block may be derived as follows.

When an intra block copy merge mode or a template matching prediction mode is applied to a current luma component block, a residual block may always exist for a current luma component block. In this case, transform and/or quantization may be performed on a residual block in an encoding process, and a quantized transform coefficient may be encoded and signaled. In a decoding process, dequantization and/or inverse transform may be performed on a quantized transform coefficient to derive a residual block.

When an intra block copy merge mode or a template matching prediction mode is applied to a luma component block corresponding to a current chroma component block, a residual block may also exist for a current chroma component block. In this case, transform and/or quantization may be performed on a residual block in an encoding process, and a quantized transform coefficient may be encoded and signaled. In a decoding process, dequantization and/or inverse transform may be performed on a quantized transform coefficient to derive a residual block.

When an intra block copy merge mode or a template matching prediction mode is applied, information identifying whether a residual block exists (e.g., an identifier, a flag or an index (e.g., cu_cbf)) may not be signaled. In other words, when an intra block copy merge mode or a template matching prediction mode is applied, a residual block always exists, so encoding/decoding of cu_cbf may be omitted and the value of cu_cbf may be inferred (set) as a first value in a decoding process. In other words, the value of cu_cbf may infer that a quantized transform coefficient exists in the residual block of at least one of a luma component, a chroma component Cr or a chroma component Cb. Information identifying whether a residual block exists may not be signaled, and quantized transform coefficient information of a residual block may be encoded and signaled.

However, when an intra block copy merge mode or a template matching prediction mode is applied, there may be a case in which a quantized transform coefficient does not exist in the residual block of at least one of a luma component, a chroma component Cr or a chroma component Cb. Accordingly, identifiers representing whether a quantized transform coefficient exists in a residual block for each component (e.g., tu_cbf_luma for a luma component, tu_cbf_cr and tu_cbf_cb for a chroma component) may be encoded and signaled.

Let's assume that under a single tree typ (SINGLE_TREE) where the block partition structure of a luma component and a chroma component in a current encoding target CTU is the same, an intra block copy AMVP mode or a template matching prediction mode is applied to a current luma component block. In this case, the residual block of a current luma component block and a chroma component block may be derived as follows.

When an intra block copy AMVP mode or a template matching prediction mode is applied to a current luma component block, the residual block of a current luma component block may exist or may not exist. Accordingly, information identifying whether a residual block exists may always be encoded and signaled.

When the residual block of a current luma component block exists, transform and/or quantization may be performed on a residual block in an encoding process. Afterwards, a quantized transform coefficient may be encoded and signaled. In a decoding process, dequantization and/or inverse transform may be performed on a quantized transform coefficient to derive a residual block.

When the residual block of a current luma component block does not exist, a residual block may be set as a value of 0.

When an intra block copy AMVP mode or a template matching prediction mode is applied to a luma component block corresponding to a current chroma component block, a residual block may or may not exist in a current chroma component block in the same way as in a luma component block. When the residual block of a current chroma component block exists, transform and/or quantization may be performed on a residual block in an encoding process. Afterwards, a quantized transform coefficient may be encoded and signaled. In a decoding process, a quantized transform coefficient may be dequantized and/or inversely transformed to derive a residual block. On the other hand, when a residual block does not exist, a residual block may be set as a value of 0.

As described above, when an intra block copy AMVP mode or a template matching prediction mode is applied, a quantized transform coefficient may or may not exist in a residual block for each of a luma component, a chroma component Cr and a chroma component Cb. Accordingly, information identifying whether a residual block exists which indicates whether a quantized transform coefficient exists in the residual block of at least one of a luma component, a chroma component Cr or a chroma component Cb (e.g., an identifier, a flag or an index (e.g., cu_cbf)) may always be encoded and signaled.

In addition, when information identifying whether the residual block exists has a first value representing that a residual block exists, there may be a case where at least one of a luma component, a chroma component Cr or a chroma component Cb has a quantized transform coefficient in a residual block, while the other does not have a quantized transform coefficient in a residual block. Accordingly, when the information identifying whether a residual block exists is a first value, an identifier representing whether a quantized transform coefficient exists in a residual block (e.g., tu_cbf_luma for a luma component, tu_cbf_cr and tu_cbf_cb for a chroma component) may be encoded and signaled for each component.

Under a dual tree structure where the block partition structure of a luma component and a chroma component in a current encoding target CTU is independent, when an intra block copy skip mode or a template matching prediction mode is applied to a current luma component block (DUAL_TREE_LUMA), the residual block of a current luma component block may not exist, as in a skip mode in an inter prediction mode. In this case, the residual block of a current luma component block may be set to have a value of ‘0’. In addition, information identifying whether a residual block exists (e.g., an identifier, a flag or an index (e.g., at least one of cu_cbf or tu_cbf_luma)) may not be signaled.

Under an independent partition structure, when an intra block copy skip mode or a template matching prediction mode is applied to a luma component block, cu_cbf signaled for a luma component block may indicate whether a quantized transform coefficient exists in the residual block of a luma component block. When an intra block copy skip mode or a template matching prediction mode is applied to a luma component block, a quantized transform coefficient does not always exist in the residual block of a luma component block, so cu_cbf is not signaled and may be inferred (set) as a second value (e.g., ‘0’) in a decoding process.

In addition, identification information indicating whether the residual block of a luma component exists (e.g., tu_cbf_luma) is also not signaled and may be inferred (set) as a second value (e.g., ‘0’) in a decoding process.

When the block partition structure of a luma component and a chroma component in a current encoding target CTU is an independent dual tree structure and an intra block copy merge mode or a template matching prediction mode is applied to a current luma component block (DUAL_TREE_LUMA), the residual block of a current luma component block may always exist, as in a merge mode in inter prediction. In this case, transform and/or quantization may be performed on a residual block in an encoding process. Afterwards, a quantized transform coefficient may be encoded and signaled. In a decoding process, a quantized transform coefficient may be dequantized and/or inversely transformed to derive a residual block.

Under an independent partition structure, when an intra block copy merge mode or a template matching prediction mode is applied to a luma component block, cu_cbf signaled for a luma component block may indicate only whether a quantized transform coefficient exists in the residual block of a luma component block. When an intra block copy merge mode or a template matching prediction mode is applied to a luma component block, a quantized transform coefficient always exists in the residual block of a luma component block, so the value of cu_cbf may be inferred (set) as a first value (e.g., ‘1’) in a decoding process without signaling cu_cbf.

Meanwhile, under an independent partition structure, identification information indicating whether the residual block of a luma component exists (e.g., tu_cbf_luma) has the same meaning/value as cu_cbf signaled for a luma component block. Accordingly, the value of tu_cbf_luma may be inferred (set) as a first value (e.g., ‘1’) in a decoding process without signaling tu_cbf_luma.

When the block partition structure of a luma component and a chroma component in a current encoding target CTU is an independent dual tree structure and an intra block copy AMVP mode or a template matching prediction mode is applied to a current luma component block (DUAL_TREE_LUMA), the residual block of a current luma component block may exist or may not exist, as in an AMVPO mode in inter prediction. When a residual block exists, transform and/or quantization may be performed on a residual block in an encoding process. Afterwards, a quantized transform coefficient may be encoded and signaled. In a decoding process, a quantized transform coefficient may be dequantized and/or inversely transformed to derive a residual block. When a residual block does not exist, a residual block may be set as a value of 0.

Under an independent partition structure, when an intra block copy AMVP mode or a template matching prediction mode is applied to a luma component block, cu_cbf signaled for a luma component block may indicate only whether a quantized transform coefficient exists in the residual block of a luma component block. In this case, a quantized transform coefficient may exist or may not exist in the residual block of a corresponding luma component block. Accordingly, when an intra block copy AMVP mode or a template matching prediction mode is applied to a luma component block, cu_cbf for a luma component block may always be encoded and signaled.

Meanwhile, under an independent partition structure, identification information indicating whether the residual block of a luma component exists (e.g., tu_cbf_luma) has the same meaning/value as cu_cbf signaled for a luma component block. Accordingly, it may be inferred (set) as the same value as cu_cbf in a decoding process without signaling tu_cbf_luma.

Whether a residual block exists may be set according to the value of cu_cbf or tu_cbf_luma. For example, when the value of at least one of cu_cbf or tu_cbf_luma has a first value, it may be determined that a residual block exists.

When the block partition structure of a luma component and a chroma component in the same CTU is an independent dual tree structure and an intra block copy mode is applied to a current chroma component block (DUAL_TREE_CHROMA), the residual block of a current chroma component block may be derived as follows.

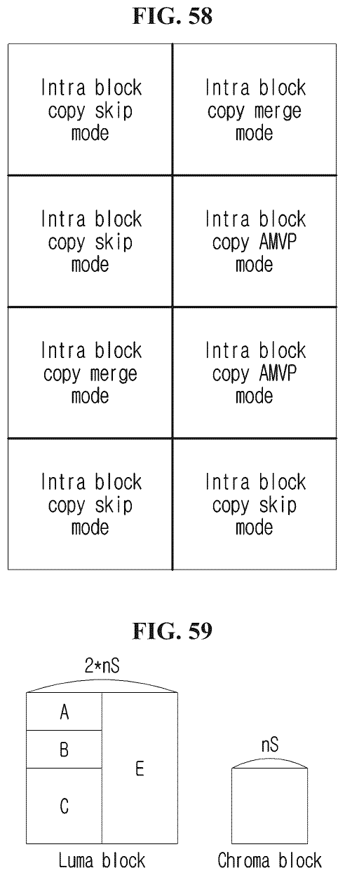

FIGS. 57 and 58 are a drawing for describing an embodiment in which the residual block of a current chroma component block is derived.

There may be a case where all sub-blocks in a current chroma component block and sub-blocks included in a luma component block corresponding to a current chroma component block are encoded/decoded in an intra block copy mode or have the same intra block copy mode. Here, an intra block copy mode may be an intra block copy skip mode, an intra block copy merge mode or an intra block copy AMVP mode.

As an example, as in an example shown in FIG. 57, there may be a case where all sub-blocks in a current chroma component block and sub-blocks in a luma component block corresponding thereto are encoded in an intra block copy skip mode. Alternatively, unlike an example shown in FIG. 59, there may be a case where all sub-blocks in a current chroma component block and sub-blocks in a luma component block corresponding thereto are encoded/decoded in an intra block copy merge mode.

When all sub-blocks in a luma component block corresponding to a current chroma component block have the same intra block copy mode, whether to encode/decode a residual block for a corresponding chroma component block may be determined based on the intra block copy mode of a corresponding luma component block.

As an example, when all sub-blocks included in a corresponding luma component block are encoded/decoded in an intra block copy skip mode, a residual block may not exist for a chroma component block, just as in a case where a luma component block is an intra block copy skip mode. Accordingly, a residual block may not be encoded/decoded for a chroma component block and residual block information may not be signaled. The residual block of a current chroma component block may be set as a value of “0”.

In this case, information identifying whether the residual block of a chroma component block exists (e.g., an identifier or a flag (e.g., at least one of cu_cbf, tu_cbf_cr or tu_cbf_cb)) may not be signaled. When information identifying whether a residual block exists has a first value, it may represent that the residual block of a chroma component block exists. On the other hand, when information identifying whether a residual block exists has a second value, it may represent that the residual block of a chroma component block does not exist. When an intra block copy skip mode is applied to a chroma component block, encoding/decoding of information identifying whether a residual block exists may be omitted, and the value of information identifying whether a residual block exists may always be inferred (set) as a second value in a decoding process.

As an example, when all sub-blocks included in a corresponding luma component block are encoded/decoded in an intra block copy merge mode, a residual block may always exist for a chroma component block, just as in a case where a luma component block is an intra block copy merge mode. Accordingly, in an encoding process, transform a and/or quantization may be performed on the residual block of a chroma component block, and a quantized transform coefficient may be encoded and signaled. In a decoding process, a quantized transform coefficient may be dequantized and/or inversely transformed to derive a residual block.

Under an independent partition structure, information identifying whether there is a residual block signaled for a chroma component block (e.g., an identifier or a flag (e.g., cu_cbf)) may indicate whether there is a quantized transform coefficient in the residual block of at least one of the chroma component Cb or chroma component Cr blocks.

Accordingly, when all sub-blocks included in a corresponding luma component block are encoded/decoded in an intra block copy merge mode, information identifying whether there is a residual block (e.g., an identifier or a flag or an index (e.g., cu_cbf)) may not be signaled. In other words, in a merge mode, since a residual block always exists, encoding/decoding of the information may be omitted, and the value of the information (cu_cbf) may always be inferred (set) as 1 in a decoding process. In other words, in a decoding process, the value of cu_cbf may be inferred as a value indicating that a quantized transform coefficient exists in the residual block of at least one of a chroma component Cr or a chroma component Cb.

However, even when all sub-blocks included in a corresponding luma component block are encoded/decoded in an intra block copy merge mode, there may be a component where a quantized transform coefficient does not exist in the residual block of a chroma component Cr or a chroma component Cb. Accordingly, an identifier (e.g., tu_cbf_cr and tu_cbf_cb) representing whether a quantized transform coefficient exists in a residual block for each chroma component may be encoded and signaled.

As an example, when all sub-blocks included in a corresponding luma component block are encoded/decoded in an intra block copy AMVP mode, a residual block may or may not exist for a chroma component block, just as in a case where a luma component block is an intra block copy AMVP mode. Accordingly, information identifying whether a residual block exists for a chroma component block may always be signaled. When the residual block of a chroma component block exists, transform and/or quantization may be performed on a residual block in an encoding process, and a quantized transform coefficient may be encoded and signaled. In a decoding process, a quantized transform coefficient may be dequantized and/or inversely transformed to derive a residual block. On the other hand, when the residual block of a chroma component block does not exist, a residual block may be set as a value of “0”.

Under an independent partition structure, information identifying whether there is a residual block signaled for a chroma component block (e.g., an identifier or a flag (e.g., cu_cbf)) may indicate whether there is a quantized transform coefficient in the residual block of at least one of the chroma component Cb or chroma component Cr blocks.

When all sub-blocks included in a corresponding luma component block are encoded/decoded in an intra block copy AMVP mode, a quantized transform coefficient may exist or may not exist in the residual block of at least one of a chroma component Cr block or a chroma component Cb block. Accordingly, information identifying whether a quantized transform coefficient exists in the residual block of at least one of a chroma component Cr or a chroma component Cb (e.g., an identifier or a flag or an index (e.g., cu_cbf)) may always be encoded and signaled.

Even when the information identifying whether a residual block exists (e.g., an identifier or a flag or an index or cu_cbf) has a first value representing that a residual block exists, a quantized transform coefficient may exist or may not exist in the residual block of one of a chroma component Cr or a chroma component Cb. Accordingly, for each chroma component, an identifier (e.g., tu_cbf_cr and tu_cbf_cb) representing whether a quantized transform coefficient exists in a residual block may be encoded and signaled.

When an identifier (e.g., tu_cbf_cr) representing that a quantized transform coefficient exists in the residual block of a chroma component Cr has a first value, information about a quantized transform coefficient in a residual block for a Cr component may be signaled. When an identifier (e.g., tu_cbf_cr) representing that a quantized transform coefficient exists in the residual block of a chroma component Cb has a first value, information about a quantized transform coefficient in a residual block for a Cb component may be signaled.

As another example, even when sub-blocks in a corresponding luma component block are encoded/decoded in the same intra block copy mode (e.g., an intra block copy skip mode, an intra block copy merge mode or an intra block copy AMVP mode), this does not mean that all samples included in a luma component block are encoded/decoded in the same intra block copy mode. For example, when a sub-block is occupied by two luma component prediction blocks, some samples in a sub-block may be encoded/decoded in a different intra block copy mode or a prediction mode other than an intra block copy mode. Accordingly, it may not be efficient to encode/decode the residual block of a chroma component block by considering the mode of a luma component block corresponding to a chroma component block.

Considering the problem, when an intra block copy mode is applied to a chroma component block, regardless of the encoding mode of sub-blocks within a corresponding luma component block, information identifying whether there is residual block indicating whether there is a quantized transform coefficient in the residual block of at least one of a chroma component Cr and a chroma component Cb (e.g., an identifier, a flag or an index (e.g., cu_cbf)) may always be encoded and signaled.

In addition, when the information identifying whether there is a residual block (e.g., an identifier, a flag, an index or cu_cbf) has a first value representing that there is a residual block, for each chroma component, an identifier representing whether there is a quantized transform coefficient in a residual block (e.g., tu_cbf_cr and tu_cbf_cb) may be encoded and signaled.

When an identifier (e.g., tu_cbf_cr) representing that a quantized transform coefficient exists in the residual block of a chroma component Cr has a first value, quantized transform coefficient information in a residual block for a Cr component may be signaled. When an identifier (e.g., tu_cbf_cr) representing that a quantized transform coefficient exists in the residual block of a chroma component Cb has a first value, quantized transform coefficient information in a residual block for a Cb component may be signaled.

When quantized transform coefficient information in a residual block is signaled, a quantized transform coefficient may be dequantized and/or inversely transformed to derive a residual block in a decoding process. When there is no residual block of a chroma component block, quantized transform coefficient information in the residual block of a chroma component block may not be signaled, and the residual block of a chroma component may be set to have a value of “0”.

When an intra block copy mode is applied to a current chroma component block or when all sub-blocks included in a luma component block corresponding to a current chroma component block are encoded/decoded in an intra block copy mode, there may be a case where the intra block copy mode (e.g., an intra block copy skip mode, an intra block copy merge mode, an intra block copy AMVP mode) of sub-blocks in a luma component block corresponding to a chroma component block is different.

As an example, as in an example shown in FIG. 58, some sub-blocks in a luma component block may be encoded/decoded in an intra block copy skip mode, other sub-blocks may be encoded/decoded in an intra block copy merge mode and the remaining sub-blocks may be encoded/decoded in an intra block copy AMVP mode.

In this way, when the intra block copy mode of sub-blocks in a luma component block is not the same, regardless of an intra block copy mode applied to sub-blocks in a luma component block, information identifying whether there is a residual block indicating whether there is a quantized transform coefficient in the residual block of at least one of a chroma component Cr or a chroma component Cb (e.g., an identifier or a flag or an index (e.g., cu_cbf)) may always be encoded and signaled.

In addition, when the information identifying whether there is a residual block (e.g., an identifier, a flag, an index or cu_cbf) has a first value representing that there is a residual block, for each chroma component, an identifier representing whether there is a quantized transform coefficient in a residual block (e.g., tu_cbf_cr and tu_cbf_cb) may be encoded and signaled.

When an identifier (e.g., tu_cbf_cr) representing that a quantized transform coefficient exists in the residual block of a chroma component Cr has a first value, quantized transform coefficient information in a residual block for a Cr component may be signaled. When an identifier (e.g., tu_cbf_cr) representing that a quantized transform coefficient exists in the residual block of a chroma component Cb has a first value, quantized transform coefficient information in a residual block for a Cb component may be signaled.

When quantized transform coefficient information in a residual block is signaled, a quantized transform coefficient may be dequantized and/or inversely transformed to derive a residual block in a decoding process. When there is no residual block of a chroma component block, quantized transform coefficient information in the residual block of a chroma component block may not be signaled, and the residual block of a chroma component may be set to have a value of “0”.

### [E4/D4] A Step for Configuring a Reconstructed Block;

The reconstructed block of a current luma component block may be derived by adding the residual block of a luma component block to the prediction block of a luma component block.

When a luma component residual block does not exist, a luma component prediction block may be set as a luma component reconstructed block.

The reconstructed block of a current chroma component (Cb or Cr) block may be derived by adding the residual block of a chroma component (Cb or Cr) block to the prediction block of a chroma component (Cb or Cr) block.

When a chroma component (Cb or Cr) residual block does not exist, a chroma component (Cb or Cr) prediction block may be set as a chroma component (Cb or Cr) reconstructed block.

### [E5/D5] A Step for Entropy Encoding/Decoding Intra Block Copy-Related Encoding Information;

Intra block copy-related encoding information may be entropy encoded into a bitstream or may be entropy decoded from a bitstream. Here, intra block copy-related encoding information may include at least one of the following information.
cu_skip_flag representing whether a skip mode is used,
merge flag representing whether a merge mode is used,
merge_idx (merge index) indicating a merge candidate,
pred_mode_flag representing whether a prediction mode is an intra prediction mode
pre_mode_ibc_flag representing whether a prediction mode is an inter prediction mode or an intra block copy mode,
block vector candidate index (mvp_l0_flag),
block vector difference,
cu_cbf, tu_cbf_luma, tu_cbf_cb, tu_cbf_cr representing whether a quantized transform coefficient exists in a residual block

The cu_skip_flag may mean information on whether a skip mode is used, and may be entropy encoded/decoded in at least one unit of an encoding block and a prediction block. For example, information on whether to use a skip mode may indicate the use of a skip mode when it has a first value of 1, and may not indicate the use of a skip mode when it has a second value of 0. In this case, cu_skip_flag may indicate the use of an intra block copy skip mode.

The merge flag may mean information on whether to use a merge mode, and may be entropy encoded/decoded in at least one unit of an encoding block and a prediction block. For example, information on whether to use a merge mode may indicate the use of a merge mode when it has a first value of 1, and may not indicate the use of a merge mode when it has a second value of 0. In this case, merge flag may indicate the use of an intra block copy merge mode.

The merge_idx may mean information indicating a merge candidate in a merge candidate list, and may be entropy encoded/decoded in at least one unit of an encoding block and a prediction block. In addition, merge_idx may mean merge index information. In addition, merge_idx may indicate a block from which a merge candidate is derived among the blocks reconstructed to be spatially adjacent to a current block. In addition, merge_idx may indicate at least one of the motion information that a merge candidate has. For example, merge index information may indicate a first merge candidate in a merge candidate list when it has a first value of 0, indicate a second merge candidate in a merge candidate list when it has a second value of 1, and indicate a third merge candidate in a merge candidate list when it has a third value of 2. Similarly, when it has a fourth to N-th value, it may indicate a merge candidate corresponding to a value according to the order in a merge candidate list. Here, N may be a positive integer including 0. In this case, merge_idx may indicate a merge index when using an intra block copy merge mode. In other words, the merge candidate list may mean a block vector candidate list, and a merge candidate may mean a block vector candidate.

The pred_mode_flag may mean information on whether to apply an intra prediction mode, and may be entropy encoded/decoded in at least one unit of an encoding block, a prediction block or an encoding unit. For example, information on whether to apply an intra prediction mode may indicate that an intra prediction mode is applied when it has a first value of 1, and may indicate that an intra prediction mode is not applied when it has a second value of 0.

The pred_mode_ibc_flag may mean information on whether to apply an intra block copy mode, and may be entropy encoded/decoded in at least one unit of an encoding block, a prediction block or an encoding unit. For example, information on whether to apply an intra block copy mode may indicate that an intra block copy mode is applied when it has a first value of 1, and may indicate that an inter prediction mode is applied when it has a second value of 0.

The block vector candidate index (mvp_l0_flag) may indicate a prediction block vector used by a current block in the prediction block vector candidate list of an intra block copy AMVP mode, and for this purpose, a block vector candidate index may be entropy encoded/decoded. A current block may derive the prediction block of a current block by using the block vector candidate index and a prediction block vector candidate list. In this case, a block vector candidate index may mean a L0 block vector prediction flag.

The block vector difference may mean a difference between a block vector and a predicted block vector in an intra block copy AMVP mode, and a block vector difference may be entropy encoded/decoded for a current block. A current block may derive the prediction block of a current block by using the block vector difference.

Among cu_cbf, tu_cbf_luma, tu_cbf_cb and tu_cbf_cr representing whether there is a quantized transform coefficient in the residual block, cu_cbf may mean information on whether the quantized transform coefficient of a luma component block exists and whether the quantized transform coefficient of a chroma component block exists when a luma component and a chroma component have the same block partition structure, and may mean information on whether the quantized transform coefficient of a luma component block or a chroma component block exists when a luma component and a chroma component have an independent block partition structure. Information on whether a quantized transform coefficient exists may mean that the quantized transform coefficient of corresponding blocks exists when it has a first value of 1, and may mean that the quantized transform coefficient of corresponding blocks does not exist when it has a second value of 0. tu_cbf_luma may mean whether the quantized transform coefficient of a luma component block exists, and tu_cbf_cr and tu_cbf_cb may mean whether the quantized transform coefficient of chroma components Cr and Cb exists, respectively. Information on whether the quantized transform coefficient of a luma component block exists may mean that the quantized transform coefficient of a corresponding luma component block exists when it has a first value of 1, and may mean that the quantized transform coefficient of a corresponding luma component block does not exist when it has a second value of 0. Information on whether the quantized transform coefficient of a chroma component (Cb, Cr) exists may mean that the quantized transform coefficient of a corresponding chroma component block exists when it has a first value of 1, and may mean that the quantized transform coefficient of a corresponding chroma component block does not exist when it has a second value of 0.

At least one of the intra block copy-related encoding information may be entropy encoded/decoded in at least one of a parameter set, a header, a brick, a CTU, a CU, a PU, a TU, a CB, a PB or a TB.

In this case, at least one of a parameter set, a header, a brick, a CTU, a CU, a PU, a TU, a CB, a PB or a TB may be at least one of a video parameter set, a decoding parameter set, a sequence parameter set, an adaptation parameter set, a picture parameter set, a picture header, a sub-picture header, a slice header, a tile group header, a tile header, a brick, a coding tree unit (CTU), a coding unit (CU), a prediction unit (PU), a transform unit (TU), a coding block (CB), a prediction block (PB) or a transform block (TB).

Here, prediction using an intra block copy mode may be performed by using the intra block copy-related encoding information in at least one of the signaled parameter set, header, brick, CTU, CU, PU, TU, CB, PB, or TB unit.

For example, when at least one of the intra block copy-related encoding information is entropy encoded/decoded in a sequence parameter set, prediction using an intra block copy mode may be performed by using at least one of the intra block copy-related encoding information having the same syntax element value in a sequence unit.

As another example, when at least one of the intra block copy-related encoding information is entropy encoded/decoded in a slice header, prediction using an intra block copy mode may be performed by using at least one of the intra block copy-related encoding information having the same syntax element value in a sequence unit.

As another example, when at least one of the intra block copy-related encoding information is entropy encoded/decoded in an adaptation parameter set, prediction using an intra block copy mode may be performed by using at least one of the intra block copy-related encoding information having the same syntax element value in a unit that refers to the same adaptation parameter set.

As another example, when at least one of the intra block copy-related encoding information is entropy encoded/decoded in a CU, prediction using an intra block copy mode may be performed by using at least one of the intra block copy-related encoding information having the same syntax element value in the same CU unit.

As another example, when at least one of the intra block copy-related encoding information is entropy encoded/decoded in a CB, prediction using an intra block copy mode may be performed by using at least one of the intra block copy-related encoding information having the same syntax element value in the same CB unit.

As another example, when at least one of the intra block copy-related encoding information is entropy encoded/decoded in a PU, prediction using an intra block copy mode may be performed by using at least one of the intra block copy-related encoding information having the same syntax element value in the same PU unit.

As another example, when at least one of the intra block copy-related encoding information is entropy encoded/decoded in a PB, prediction using an intra block copy mode may be performed by using at least one of the intra block copy-related encoding information having the same syntax element value in the same PB unit.

As another example, when at least one of the intra block copy-related encoding information is entropy encoded/decoded in a TU, prediction using an intra block copy mode may be performed by using at least one of the intra block copy-related encoding information having the same syntax element value in the same TU unit.

As another example, when at least one of the intra block copy-related encoding information is entropy encoded/decoded in a TB, prediction using an intra block copy mode may be performed by using at least one of the intra block copy-related encoding information having the same syntax element value in the same TB unit.

Here, at least one of the intra block copy-related encoding information may be derived according to at least one of the encoding parameters of a current block/a CTB/a CTU.

When at least one of the intra block copy-related encoding information does not exist in a bitstream, at least one of the intra block copy-related encoding information may be inferred as a first value (e.g., 0).

An adaptation parameter set may mean a parameter set that may be shared by being referenced by a different picture, sub-picture, slice, tile group, tile or brick. In addition, a sub-picture, a slice, a tile group, a tile or a brick in a picture may refer to a different adaptation parameter set to use information in an adaptation parameter set.

In addition, an adaptation parameter set may use the identifier of a different adaptation parameter set to refer to a different adaptation parameter set in a sub-picture, a slice, a tile group, a tile or a brick in a picture.

In addition, an adaptation parameter set may use the identifier of a different adaptation parameter set to refer to a different adaptation parameter set in a slice, a tile group, a tile or a brick in a sub-picture.

In addition, an adaptation parameter set may use the identifier of a different adaptation parameter set to refer to a different adaptation parameter set in a tile or a brick in a slice.

In addition, an adaptation parameter set may use the identifier of a different adaptation parameter set to refer to a different adaptation parameter set in a brick in a tile.

By including information on an adaptation parameter set identifier in the parameter set or header of the sub-picture, an adaptation parameter set corresponding to a corresponding adaptation parameter set identifier may be used in a sub-picture.

By including information on an adaptation parameter set identifier in the parameter set or header of the tile, an adaptation parameter set corresponding to a corresponding adaptation parameter set identifier may be used in a tile.

By including information on an adaptation parameter set identifier in the header of the brick, an adaptation parameter set corresponding to a corresponding adaptation parameter set identifier may be used in a brick.

The picture may be partitioned into at least one tile row and at least one tile column.

The sub-picture may be partitioned into at least one tile row and at least one tile column in a picture. The sub-picture is a region having a rectangular/square shape in a picture, and may include at least one CTU. In addition, one sub-picture may include at least one tile/brick/slice.

The tile is a region having a rectangular/square shape in a picture, and may include at least one CTU. In addition, a tile may be partitioned into at least one brick.

The brick may mean at least one CTU row in a tile. A tile may be partitioned into at least one brick, and each brick may have at least one CTU row. A tile that is not partitioned into at least two parts may also mean a brick.

The slice may include at least one tile in a picture, and may include at least one brick in a tile.

Tables 23 to 26 show encoding information signaled in relation to a block partition structure.

In particular, Tables 23 to 26 relate to a method for removing redundant signaling of cu_cbf and tu_cbf_luma when a luma component block is predicted by using an intra block copy mode under an independent block partition structure.

TABLE 23

| | |
|---|---|
| coding_unit( x0, y0, cbWidth, cbHeight, treeType ) { | Descriptor |
| if( slice_type != I \| \| sps_ibc_enabled_flag ) { | |
| if( treeType != DUAL_TREE_CHROMA && | |
| !( cbWidth = = 4 && cbHeight = = 4 | |
| && !sps_ibc_enabled_flag ) ) | |
| cu_skip_flag[ x0 ][ y0 ] | ae(v) |
| if( cu_skip_flag[ x0 ][ y0 ] == | |
| 0 && slice_type != I | |
| && !( cbWidth = = 4 && cbHeight = | |
| 4 ) ) | |
| pred_mode_flag | ae(v) |
| if( ( ( slice_type == I && | |
| cu_skip_flag[ x0 ][ y0 ] = = 0 ) ∥ | |
| ( slice_type != I && ( | |
| CuPredMode[ x0 ][ y0 ] != MODE INTRA ∥ | |
| ( cbWidth = = 4 && cbHeight = = 4 | |
| && cu_skip_flag[ x0 ][ y0 ] == 0 ) ) ) ) && | |
| sps_ibc_enabled_flag && ( cbWidth | |
| != 128 cbHeight != 128 ) ) | |
| pred_mode_ibc_flag | ae(v) |
| } | |
| if( CuPredMode[ x0 ][ y0 ] = = MODE_INTRA ) { | |
| ... | |
| } else if( treeType != DUAL_TREE_CHROMA ) { /* | |
| MODE_INTER or MODE_IBC */ | |
| if( cu_skip_flag[ x0 ][ y0 ] = = 0) | |
| general_merge_flag[ x0 ][ y0 ] | ae(v) |
| if( general_merge_flag[ x0 ][ y0 ] ) { | |
| merge_data( x0, y0, cbWidth, cbHeight ) | |
| } else if ( CuPredMode[ x0 ][ y0 ] = = | |
| MODE_IBC ) { | |
| mvd_coding(x0,y0,0,0) | |
| mvp_l0_flag[ x0 ][ y0 ] | ae(v) |
| if( sps_amvr_enabled_flag && | |
| ( | |
| MvdL0[ x0 ][ y0 ][ 0 ] != 0 ∥ | |
| MvdL0[ x0 ][ y0 ][ 1 ] != 0 ) ){ | |
| amvr_precision_flag[ x0 ][ y0 ] | ae(v) |
| } | |
| } else if( treeType != DUAL_TREE_CHROMA ) | |
| { /* MODE_INTER or MODE_IBC */ | |
| ... | |
| } | |
| } | |
| if( !pcm_flag[ x0 ][ y0 ] ) { | |
| if( CuPredMode[ x0 ][ y0 ] != MODE_INTRA | |
| && merge_flag[ x0 ][ y0 ] = = 0 ) | |
| cu_cbf | ae(v) |
| if( cu_cbf ) { | |
| ... | |
| transform_tree( x0, y0, cb Width, cbHeight, treeType ) | |
| } | |
| } | |
| } | |

TABLE 24

| | |
|---|---|
| transform_unit( x0, y0, tbWidth, tbHeight, treeType, | Descriptor |
| subTuIndex ) { | |
| if( treeType = = SINGLE_TREE ∥ treeType = = | |
| DUAL_TREE_LUMA | |
| ){ | |
| if( ( IntraSubPartitionsSplitType = = ISP_NO_SPLIT && | |
| !( cu_sbt_flag && ( | |
| ( subTuIndex == 0 && cu_sbt_pos_flag ) \|\| | |
| ( subTuIndex == 1 && !cu_sbt_pos_flag) ) ) ) \|\| ( | |
| Intra SubPartitionsSplitType != ISP_NO_SPLIT && | |
| ( subTuIndex < NumIntraSubPartitions − 1 \|\| | |
| !InferTuCbfLuma ) ) ) | |
| tu_cbf_luma[ x0 ][ y0 ] | ae(v) |
| if (IntraSubPartitionsSplitType != ISP_NO_SPLIT ) | |
| InferTuCbfLuma = InferTuCbfLuma && | |
| !tu_cbf_luma[ x0 ][ y0 ] | |
| } | |
| if( ( treeType = = SINGLE_TREE ∥ tree Type = = | |
| DUAL_TREE_CHROMA ) { | |
| if( ( IntraSubPartitionsSplitType = = ISP_NO_SPLIT && | |
| !( cu_sbt_flag && ( | |
| ( subTuIndex == 0 && cu_sbt_pos_flag ) \|\| | |
| ( subTuIndex == 1 && !cu_sbt_pos_flag ) ) ) ) \|\| ( | |
| IntraSubPartitionsSplitType != ISP_NO_SPLIT && = = | |
| ( subTuIndex = = | |
| NumIntraSubPartitions − 1 ) ) ) { | |
| tu_cbf_cb[ x0 ][ y0 ] | ae(v) |
| tu_cbf_cr[ x0 ][ y0 ] | ae(v) |
| } | |
| } | |
| ... | |
| if( tu_cbf_luma[ x0 ][ y0 ] ) | |
| residual_coding( x0, y0, Log2( tbWidth ), | |
| Log2( tbHeight ), 0 ) | |
| if( tu_cbf_cb[ x0 ][ y0 ] ) | |
| residual_coding( xC, yC, Log2( wC), Log2( hC ), 1) | |
| if( tu_cbf_cr[ x0 ][ y0 ] ) | |
| residual_coding( xC, yC, Log2( wC ), Log2( hC ), 2) | |
| } | |

TABLE 25

| | |
|---|---|
| transform_unit( x0, y0, tbWidth, tbHeight, treeType, subTuIndex ) { | Descriptor |
| if( treeType == SINGLE_TREE \|\| ( treeType == | |
| DUAL_TREE_LUMA && CuPredMode[x0][y0] == MODE_INTRA)) { | |
| if( ( IntraSubPartitionsSplitType = = ISP_NO_SPLIT && | |
| !( cu_sbt_flag && ( | |
| ( subTuIndex == 0 && cu_sbt_pos_flag ) \|\| | |
| ( subTuIndex == 1 && !cu_sbt_pos_flag ) ) ) ) \|\| ( | |
| Intra SubPartitionsSplitType != ISP_NO_SPLIT & & | |
| ( subTuIndex < NumIntraSubPartitions − 1 \|\| | |
| !InferTuCbfLuma ) ) ) | |
| tu_cbf_luma[ x0 ][ y0 ] | ae(v) |
| if (IntraSubPartitionsSplitType != ISP_NO_SPLIT ) | |
| InferTuCbfLuma = InferTuCbfLuma && | |
| !tu_cbf_luma[ x0 ][ y0 ] | |
| } | |
| if( ( treeType == SINGLE_TREE \|\| treeType = = | |
| DUAL_TREE_CHROMA ) { | |
| if( ( IntraSubPartitionsSplitType = = ISP_NO_SPLIT && | |
| !( cu_sbt_flag && ( | |
| ( subTuIndex == 0 && cu_sbt_pos_flag ) \|\| | |
| ( subTuIndex == 1 && !cu sbt_pos_flag ) ) ) ~ | |
| Intra SubPartitionsSplitType != ISP_NO_SPLIT && | |
| ( subTuIndex = = | |
| Num Intra SubPartitions − 1 ) ) ) { | |
| tu_cbf_cb[ x0 ][ y0 ] | ae(v) |
| tu_cbf_cr[ x0 ][ y0 ] | ae(v) |
| } | |
| } | |
| . . | |
| } | |

As in an example of Tables 23 to 25, tu_cbf_luma may be signaled only when the prediction mode of a luma component block (i.e., treeType is DUAL_TREE_LUMA) is an intra prediction mode under an independent block partition structure (i.e., CuPredMode[x0][y0]==MODE_INTRA). By this, tu_cbf_luma may be set not to be signaled when the luma component block of an independent block partition structure is an intra block copy mode.

TABLE 26

| | |
|---|---|
| transform_unit( x0, y0, tbWidth, tbHeight, treeType, subTuIndex ) { | Descriptor |
| if( tree Type == SINGLE_TREE \|\| ( treeType = = | |
| DUAL_TREE_LUMA && !CuPredMode[x0][y0] == MODE_IBC ) { | |
| if( ( IntraSubPartitionsSplitType = = ISP_NO SPLIT && | |
| !( cu_sbt_flag && ( | |
| ( subTuIndex == 0 && cu_sbt_pos_flag ) \|\| | |
| ( subTuIndex == 1 && !cu_sbt_pos_flag ) ) ) ) \|\| ( | |
| Intra SubPartitionsSplitType != ISP_NO_SPLIT && | |
| ( subTuIndex < NumIntraSubPartitions − 1 \|\| | |
| !InferTuCbfLuma ) ) ) | |
| tu_cbf_luma[ x0 ][ y0 ] | ae(v) |
| if (IntraSubPartitionsSplitType != ISP_NO_SPLIT ) | |
| InferTuCbfLuma = InferTuCbfLuma && | |
| !tu_cbf_luma[ x0 ][ y0 ] | |
| } | |
| if( ( treeType = = SINGLE_TREE \|\| treeType = = | |
| DUAL_TREE_CHROMA ) { | |
| if( ( IntraSubPartitionsSplitType = = ISP_NO_SPLIT && | |
| !( cu_sbt_flag && ( | |
| ( subTuIndex == 0 && cu sbt_pos_flag ) \|\| | |
| ( subTuIndex == 1 && !cu_sbt_pos_flag ) ) ) ) \|\| ( | |
| IntraSubPartitionsSplitType != ISP_NO_SPLIT && | |
| ( subTuIndex = = | |
| NumIntraSubPartitions − 1 ) ) ) { | |
| tu_cbf_cb[ x0 ][ y0 ] | ae(v) |
| tu_cbf_cr[ x0 ][ y0 ] | ae(v) |
| } | |
| } | |
| ... | |
| } | |

As in an example of Table 26, tu_cbf_luma may be signaled only when the prediction mode of a luma component block (i.e., treeType is DUAL_TREE_LUMA) is not an intra block copy mode under an independent block partition structure (i.e., CuPredMode[x0][y0]==MODE_IBC). By this, tu_cbf_luma may be set not to be signaled when the luma component block of an independent block partition structure is an intra block copy mode.

TABLE 27

| | |
|---|---|
| transform_unit( x0, y0, tbWidth, tbHeight, treeType, subTuIndex ) { | Descriptor |
| if( ( treeType == SINGLE_TREE \|\| tree Type = = | |
| DUAL_TREE_CHROMA ) { | |
| if( ( IntraSubPartitionsSplitType = = ISP_NO_SPLIT && | |
| !( cu_sbt_flag && ( | |
| ( subTuIndex == 0 && cu_sbt_pos_flag ) \|\| | |
| ( subTuIndex == 1 && !cu_sbt_pos_flag ) | |
| ) ) ) \|\| ( IntraSubPartitionsSplitType != | |
| ISP_NO_SPLIT & & subTuIndex = = | |
| NumIntraSubPartitions − 1 ) ) ) { | |
| tu_cbf_cb[ x0 ][ y0 ] | ae(v) |
| tu_cbf_cr[ x0 ][ y0 ] | ae(v) |
| } | |
| } | |
| if( treeType = = SINGLE_TREE \|\| treeType = = DUAL_TREE_LUMA | |
| ) { | |
| if( ( IntraSubPartitionsSplitType = = ISP_NO SPLIT && | |
| !( cu_sbt_flag && ( | |
| ( subTuIndex == 0 && cu_sbt_pos_flag ) \|\| | |
| ( subTuIndex == 1 && !cu_sbt_pos_flag ) ) ) && ( | |
| CuPredMode[ x0 ][ y0 ] = = MODE_INTRA \|\| | |
| tu_cbf_cb[ x0 ][ y0 ] \|\| tu_cbf_cr[ x0 ][ y0 ] \|\| | |
| CbWidth[ x0 ][ y0 ] > MaxTbSizeY \|\| CbHeight[ x0 ][ y0 ] > | |
| MaxTbSizeY ) ) | |
| \|\|( (IntraSubPartitionsSplitType != | |
| ISP_NO_SPLIT) && ( subTuIndex < | |
| Num IntraSubPartitions − 1 \| \| ! InferTuCbfLuma ) ) ) | |
| tu_cbf_luma[ x0 ][ y0 ] | ae(v) |
| ... | |
| } | |
| } | |
| ... | |
| } | |

As in an example of Table 27, tu_cbf_luma may be signaled based on tu_cbf_cb and tu_cbf_cr. Under an independent block partition structure, when the prediction mode of a luma component block is an intra block copy mode, tu_cbf_luma may not be signaled. Under an independent block partition structure, tu_cbf_cb and tu_cbf_cr may not be signaled for a luma component block (i.e., treeType is DUAL_TREE_LUMA), and tu_cbf_cb and tu_cbf_cr may be set as ‘0’ in an encoding/decoding process, respectively, when tu_cbf_luma is not signaled. In this case, according to the embodiment of Table 25, when both tu_cbf_cb and tu_cbf_cr are ‘0’, tu_cbf_luma may not be signaled. In this case, the value of tu_cbf_luma that is not signaled may be inferred to be the same as the value of cu_cbf.

As in an example of Tables 23 to 27, when a luma component block is predicted in an intra block copy mode under an independent block partition structure, the value of cu_cbf may be set as the value of tu_cbf_luma without signaling tu_cbf_luma.

In Tables 23 to 27, IntraSubPartitionsSplitType may represent whether a corresponding block is predicted by being divided into sub-blocks when applying intra prediction. When a luma component block applies prediction using an intra block copy mode, a block is not encoded by being divided into sub-blocks, so IntraSubPartitionsSplitType may correspond to ISP_NO_SPLIT. In addition, cu_sbt_flag may represent whether to perform transform in a sub-block unit in case of inter prediction. When applying prediction using an intra block copy mode, transform in a sub-block unit may not be applied, so cu_sbt_flag may always have a value of 0 in case of an intra block copy mode.

According to an indicator tu_joint_cbcr_residual for a method for performing encoding/decoding by integrating the residual signal of chroma components (a Cb component and a Cr component), at least one of tu_cbf_cb and tu_cbf_cr may not be entropy encoded/decoded in a block (a transform block, a transform unit) where tu_joint_cbcr_residual corresponds to a second value (e.g., 1). In addition, at least one of tu_cbf_cb and tu_cbf_cr may be entropy encoded/decoded in a block (a transform block, a transform unit) where tu_joint_cbcr_residual corresponds to a first value (e.g., 0).

For example, when the residual signal of a specific component does not exist in a bitstream due to tu_joint_cbcr_residual, tu_cbf_cb or tu_cbf_cr for a corresponding component may not be entropy encoded/decoded in a block (a transform block, a transform unit) for a corresponding component.

Here, tu_joint_cbcr_residual may mean whether the residual signal of a Cb component is used to derive the residual signal of a Cb component and a Cr component.

For example, when tu_joint_cbcr_residual is a first value (e.g., 0), it may indicate that the residual signal of a Cr component exists in a bitstream according to another syntax element value, and when tu_joint_cbcr_residual is a second value (e.g., 1), it may indicate that the residual signal of a Cb component is used to derive the residual signal of a Cb component and a Cr component.

When tu_joint_cbcr_residual means that the residual signal of a Cb component is used to derive the residual signal of a Cb component and a Cr component, a Cr component may become the specific component and a residual signal for a Cr component may not exist in a bitstream. In this case, tu_cbf_cr may not be entropy encoded/decoded in a block (a transform block, a transform unit) for a Cr component.

In addition, tu_joint_cbcr_residual may mean that the residual signal of a Cr component is used to derive the residual signal of a Cb component and a Cr component.

For example, when tu_joint_cbcr_residual is a first value (e.g., 0), it may indicate that the residual signal of a Cr component exists in a bitstream according to another syntax element value, and when tu_joint_cbcr_residual is a second value (e.g., 1), it may indicate that the residual signal of a Cr component is used to derive the residual signal of a Cb component and a Cr component.

When tu_joint_cbcr_residual means that the residual signal of a Cr component is used to derive the residual signal of a Cb component and a Cr component, a Cb component may become the specific component and a residual signal for a Cb component may not exist in a bitstream. In this case, tu_cbf_cb may not be entropy encoded/decoded in a block (a transform block, a transform unit) for a Cb component.

A detailed description of syntaxes proposed in the present disclosure is as follows.

amvr_flag
amvr_flag may mean whether to apply a method for determining the resolution of a block vector when a current block is an intra block copy mode.

When a current block is an intra block copy mode and the value of amvr_flag does not exist, the value of amvr_flag may be inferred to 1.

amvr_precision_flag

When a current block is an intra block copy mode and the value of amvr_precision_flag does not exist, the value of amvr_precision_flag may be inferred to 1.

amvr_precision_idx

When a current block is an intra block copy mode and the value of amvr_precision_idx does not exist, the value of amvr_precision_idx may be inferred to 1.

The value of amvr_precision_idx may have an integer value less than or equal to the value of max_amvr_precision_idx.

max_amvr_precision_idx

The value of max_amvr_precision_idx may be an integer greater than or equal to 0.

The value of max_amvr_precision_idx may be an integer less than or equal to 8.

When the value of max_amvr_precision_idx does not exist, the value of max_amvr_precision_idx may be inferred to a pre-defined value.

When the value of max_amvr_precision_idx does not exist, the value of max_amvr_precision_idx may be inferred to a value obtained by combining num_amvr_precisions and num_additional_amvr_precisions.

An embodiment below shows the value of amvr_precision_idx and an integer sample unit size corresponding thereto when a current block is an intra block copy mode.

In this case, the value of available amvr_precision_idx may be limited to a value from 0 to 3.

In this case, when the value of max_amvr_precision_idx does not exist, the value of max_amvr_precision_idx may be inferred to 3.

Table 28 illustrates the resolution of a block vector according to the value of amvr_precision_idx.

TABLE 28

| amvr_ | AMVR rounding shift |
|---|---|
| precision_ | CuPredMode[ chType ][ x0 ] |
| idx | [ y0 ] = =MODE_IBC |
| 0 | 4 (1 luma sample) |
| 1 | 5 (2 luma samples) |
| 2 | 6 (4 luma samples) |
| 3 | 7 (8 luma samples) |

max_amvr_precision

The value of max_amvr_precision may be an integer greater than or equal to 0.

The value of max_amvr_precision may be an integer less than or equal to 128.

The value of max_amvr_precision may be an integer less than or equal to log (128).

When the value of max_amvr_precision does not exist, it may be inferred to a pre-defined value as in the embodiment.

When the value of max_amvr_precision exists, an integer sample unit size value applied to a corresponding block vector may be determined by the value of max_amvr_precision when the value of amvr_precision_idx is the same as the maximum value that amvr_precision_idx may have.

amvr_separate_prec_flag

amvr_separate_prec_flag may be a value indicating whether an integer sample unit size applied to the horizontal value and vertical value of a block vector is the same or different.

Here, when amvr_separate_prec_flag is 0, the same integer sample unit size may be applied to the horizontal direction and vertical direction of a block vector.

Here, when amvr_separate_prec_flag is 1, a different integer sample unit size may be applied to the horizontal direction and vertical direction of a block vector.

amvr_separate_prec_flag may be a value indicating any one of horizontal and vertical directions of a block vector as a reference direction.

Here, when amvr_separate_prec_flag is 0, the vertical direction of a block vector may be a reference direction.

Here, when amvr_separate_prec_flag is 0, the horizontal direction of a block vector may be a reference direction.

When amvr_separate_prec_flag does not exist, it may be inferred to 0.

amvr_separate_precision

amvr_separate_precision may be a value indicating a ratio between integer sample unit size values applied to the horizontal value and vertical value of a block vector.

The value of amvr_separate_precision may be an integer greater than or equal to 0.

If the value of the amvr_separate_prec_flag is 0, the value of amvr_separate_precision may be inferred to 0.

If the value of the amvr_separate_precision is a non-zero integer, the value of amvr_separate_prec_flag may be inferred to 1.

The value of amvr_separate_precision may be an integer less than or equal to 128.

The value of amvr_separate_precision may be an integer less than or equal to log(128).

When the value of amvr_separate_precision does not exist, the value of amvr_separate_precision may be inferred to 0.

When the value of amvr_separate_precision is 0, the same integer sample unit size value may be applied to the horizontal direction and vertical direction of a block vector.

In using the value of amvr_separate_precision, any one of horizontal and vertical directions of a block vector may be determined as a reference direction.

In this case, for a non-zero amvr_separate_precision value, when a vertical direction is a reference direction, the horizontal value of a block vector may be inferred to 2^{(amvr_separate_precision)} times a vertical value.

In this case, for a non-zero amvr_separate_precision value, when a horizontal direction is a reference direction, the vertical value of a block vector may be inferred to 2^{(amvr_separate_precision)} times a vertical value.

The value of amvr_separate_precision may be an integer greater than or equal to −128 and less than or equal to 128.

If the value of the amvr_separate_prec_flag is 0, the value of amvr_separate_precision may be inferred to 0.

If the value of the amvr_separate_precision is a non-zero integer, the value of amvr_separate_prec_flag may be inferred to 1.

If the value of the amvr_separate_precision is a non-zero integer, the value of amvr_separate_prec_flag may be inferred to −1.

The value of amvr_separate_precision may be an integer greater than or equal to −log(128) and less than or equal to log(128).

num_amvr_precisions

num_amvr_precisions may mean the number of integer sample unit size values that may be applied to a block vector.

When the value of num_amvr_precisions does not exist, the value of num_amvr_precisions may be inferred to 0.

When the value of num_amvr_precisions does not exist, the value of num_amvr_precisions may be inferred to the number of predefined integer sample unit size values.

When the value of num_amvr_precisions does not exist, the value of num_amvr_precisions may be inferred to the value of max_amvr_precision_idx.

The value of num_amvr_precisions may be an integer greater than 0.

amvr_precisions[num_amvr_precisions]

amvr_precisions[num_amvr_precisions] may be a set of integer sample unit size values having the size of a non-zero num_amvr_precisions value.

When num_amvr_precisions is 0, amvr_precisions may be omitted.

When num_amvr_precisions is greater than 0, the element value of amvr_precisions[i] indicated by an integer i greater than or equal to 0 and less than num_amvr_precisions may be a block vector integer sample unit size or a sequence of its log values.

An amvr_precisions set may consist of integer sample unit size values of a block vector indicated by amvr_flag and/or amvr_precision_flag and/or amvr_precision_idx.

num_additional_amvr_precisions

num_additional_amvr_precisions may mean the number of integer sample unit size values of a block vector that may be additionally used in addition to integer sample unit size values that may be applied to a block vector inferred by a pre-defined and/or num_amvr_precisions and/or amvr_precisions set.

When the value of num_additional_amvr_precisions does not exist, the value of num_additional_amvr_precisions may be inferred to 0.

The value of num_additional_amvr_precisions may be an integer greater than 0.

When the value of num_additional_amvr_precisions does not exist, the value of num_additional_amvr_precisions may be inferred to a difference value between the value of max_amvr_precision_idx and the value of max_amvr_precision_idx.

additional_amvr_precisions[num_additional_amvr_precisions]

additional_amvr_precisions[num_additional_amvr_precisions] may be a set of integer sample unit size values having a size of a non-zero num_additional_amvr_precisions value.

When num_additional_amvr_precisions is 0, additional_amvr_precisions may be omitted.

When num_additional_amvr_precisions is greater than 0, the element value of additional_amvr_precisions[i] indicated by an integer i greater than or equal to 0 and less than num_additional_amvr_precisions may be a block vector integer sample unit size or a sequence of its log values.

An additional_amvr_precisions set may consist of integer sample unit size values of a block vector indicated by amvr_flag and/or amvr_precision_flag and/or amvr_precision_idx.

At least one of the syntax elements for the intra block copy-related encoding information which is entropy encoded in the encoder and entropy decoded in the decoder may use at least one of the following binarization, debinarization and entropy encoding/decoding methods.

Signed 0-th order Exponential Golomb (Exp_Golomb) binarization/debinarization method (se(v))

Signed k-th order Exp_Golomb binarization/debinarization method (sek(v))

0-th order Exp_Golomb binarization/debinarization method for an unsigned positive integer (ue(v))

k-th order Exp_Golomb binarization/debinarization method for an unsigned positive integer (uek(v))

Fixed-length binarization/debinarization method (f(n))

Truncated Rice binarization/debinarization method or truncated unary binarization/debinarization method (tu(v))

Truncated binary binarization/debinarization method (tb(v))

Context-adaptive arithmetic encoding/decoding method (ae(v))

Bit string in bytes (b(8))

Signed integer binarization/debinarization method (i(n))

Unsigned positive integer binarization/debinarization method (u(n))

In this case, u(n) may mean a fixed-length binarization/debinarization method.

Unary binarization/debinarization method

When entropy encoding/decoding at least one of the intra block copy-related encoding information, a context model may be determined by using at least one of the intra block copy-related encoding information of a neighboring block or at least one of the previously encoded/decoded intra block copy-related encoding information or information on a current unit/block depth or information on a current unit/block size.

When entropy encoding/decoding at least one of the intra block copy-related encoding information, entropy encoding/decoding may be performed by using at least one of the intra block copy-related encoding information of a neighboring block or at least one of the previously encoded/decoded intra block copy-related encoding information or information on a current unit/block depth or information on a current unit/block size as a prediction value for at least one of the intra block copy-related encoding information.

Only any one of the embodiments is not applied to the encoding/decoding process of a current block, and a specific embodiment or at least one combination of the embodiments may be applied to the encoding/decoding process of a current block.

An available binarization method for entropy encoding/decoding of syntax elements for implementing the present invention may be performed as follows.

amvr_flag

Unary binarization (u(1))

amvr_precision_flag

Unary binarization (u(1))

amvr_precision_idx

Binarization and entropy encoding/decoding may be performed by using one of
an unsigned positive integer binarization/debinarization method (u(n)),
the 0-th order Exp_Golomb binarization/debinarization method for an unsigned positive integer (ue(v)),
a fixed-length binarization/debinarization method (f(n)),
a truncated Rice binarization/debinarization method or truncated unary binarization/debinarization method (tu(v)),
a truncated binary binarization/debinarization method (tb(v)) and
a context-adaptive arithmetic encoding/decoding method (ae(v)).
   max_amvr_precision_idx

Binarization and entropy encoding/decoding may be performed by using one of
an unsigned positive integer binarization/debinarization method (u(n)),
the 0-th order Exp_Golomb binarization/debinarization method for an unsigned positive integer (ue(v)),
a fixed-length binarization/debinarization method (f(n)),
a truncated Rice binarization/debinarization method or truncated unary binarization/debinarization method (tu(v)),
a truncated binary binarization/debinarization method (tb(v)) and
a context-adaptive arithmetic encoding/decoding method (ae(v)).
   max_amvr_precision

Binarization and entropy encoding/decoding may be performed by using one of
an unsigned positive integer binarization/debinarization method (u(n)),
the 0-th order Exp_Golomb binarization/debinarization method for an unsigned positive integer (ue(v)),
a fixed-length binarization/debinarization method (f(n)),
a truncated Rice binarization/debinarization method or truncated unary binarization/debinarization method (tu(v)),
a truncated binary binarization/debinarization method (tb(v)) and
a context-adaptive arithmetic encoding/decoding method (ae(v)).
   amvr_separate_prec_flag

Unary binarization (u(1))

amvr_separate_precision

Binarization and entropy encoding/decoding may be performed by using one of
an unsigned positive integer binarization/debinarization method (u(n)),
the 0-th order Exp_Golomb binarization/debinarization method for an unsigned positive integer (ue(v)),
a signed 0-th order Exponential Golomb (Exp_Golomb) binarization/debinarization method (se(v)),
the k-th order Exp_Golomb binarization/debinarization method for an unsigned positive integer (uek(v)),
a signed k-th order Exp_Golomb binarization/debinarization method (sek(v)),
a fixed-length binarization/debinarization method (f(n)),
a truncated Rice binarization/debinarization method or truncated unary binarization/debinarization method (tu(v)),
a truncated binary binarization/debinarization method (tb(v)) and
a context-adaptive arithmetic encoding/decoding method (ae(v)).
   num_amvr_precisions

Binarization and entropy encoding/decoding may be performed by using one of
an unsigned positive integer binarization/debinarization method (u(n)),
the 0-th order Exp_Golomb binarization/debinarization method for an unsigned positive integer (ue(v)),
a fixed-length binarization/debinarization method (f(n)),
a truncated Rice binarization/debinarization method or truncated unary binarization/debinarization method (tu(v)),
a truncated binary binarization/debinarization method (tb(v)) and
a context-adaptive arithmetic encoding/decoding method (ae(v)).
   amvr_precisions[num_amvr_precisions]

Binarization and entropy encoding/decoding may be performed by using one of
an unsigned positive integer binarization/debinarization method (u(n)),
the 0-th order Exp_Golomb binarization/debinarization method for an unsigned positive integer (ue(v)),
a fixed-length binarization/debinarization method (f(n)),
a truncated Rice binarization/debinarization method or truncated unary binarization/debinarization method (tu(v)),
a truncated binary binarization/debinarization method (tb(v)) and
a context-adaptive arithmetic encoding/decoding method (ae(v)).
   num_additional_amvr_precisions

Binarization and entropy encoding/decoding may be performed by using one of
an unsigned positive integer binarization/debinarization method (u(n)),
the 0-th order Exp_Golomb binarization/debinarization method for an unsigned positive integer (ue(v)),
a fixed-length binarization/debinarization method (f(n)),
a truncated Rice binarization/debinarization method or truncated unary binarization/debinarization method (tu(v)),
a truncated binary binarization/debinarization method (tb(v)) and
a context-adaptive arithmetic encoding/decoding method (ae(v)).
additional_amvr_precisions[num_additional_amvr_precisions]

Binarization and entropy encoding/decoding may be performed by using one of
an unsigned positive integer binarization/debinarization method (u(n)),
the 0-th order Exp_Golomb binarization/debinarization method for an unsigned positive integer (ue(v)),
a fixed-length binarization/debinarization method (f(n)),
a truncated Rice binarization/debinarization method or truncated unary binarization/debinarization method (tu(v)),
a truncated binary binarization/debinarization method (tb(v)) and
a context-adaptive arithmetic encoding/decoding method (ae(v)).

In the embodiments, values used in the integer sample unit size of a block vector that may be applied to an intra block copy mode and/or syntaxes that may indicate an integer sample unit size and/or a series of processes deriving this may be an integer sample unit size value or a shift value applied in a rounding process for applying that integer sample unit size or the log (log 2) value of an integer sample unit size value.

The shift value may mean a left shift and/or right shift value.

The log value may mean a value calculated from a logarithmic function with a base of 2.

The integer sample unit size may mean the resolution of a block vector.

In the embodiments, the resolution of a block vector may be applied to the resolution of a block vector, the resolution of a block vector difference and/or the resolution of a block vector prediction value.

The following embodiment shows a method for encoding/decoding the intra prediction mode of a chroma component based on the intra prediction mode of a luma component.

The intra prediction mode of a current component may be derived by using the intra prediction mode of another color component (luma, chroma, etc.).

For example, when the current block is a chroma component block, in deriving an intra prediction mode for a current chroma component block, the intra prediction mode of a luma component block corresponding to a current chroma component block may be used.

In this case, a plurality of luma component blocks may correspond to a current chroma component block. A luma component region corresponding to a current chroma component block may be determined based on at least one of the size/shape or encoding parameter of a chroma block. Alternatively, the luma component region may be determined based on at least one of the size/shape or encoding parameter of the luma block. Since an embodiment that determines a luma component region corresponding to a chroma component block has been described above, a detailed description thereof is omitted in this embodiment.

A luma component region corresponding to a chroma component block may be composed of a plurality of partitions. In this case, an intra prediction mode for each of a plurality of partitions may be different. The intra prediction mode of a chroma block may be derived based on the intra prediction mode of at least a part of a plurality of partitions within a luma component region.

As an example, by comparing at least one of the size/shape or depth information between a chroma component block and a luma component region corresponding thereto (i.e., a region including a plurality of partitions), at least a part of a plurality of partitions may be used to use the intra prediction mode of a chroma component block.

Alternatively, a partition within a luma component region corresponding to the predetermined position of a chroma component block may be selected, and based on the intra prediction mode of a selected partition, the intra prediction mode of a chroma component block may be derived. Here, a predetermined position may refer to the corner sample position (e.g., a top-left sample) or center sample position of a chroma component block.

The above-described method is not limited to a case where a chroma block uses the intra prediction mode of a luma block. As an example, the above-described method may also be used to derive encoding/decoding information such as mpm_idx or MPM list of a chroma component block.

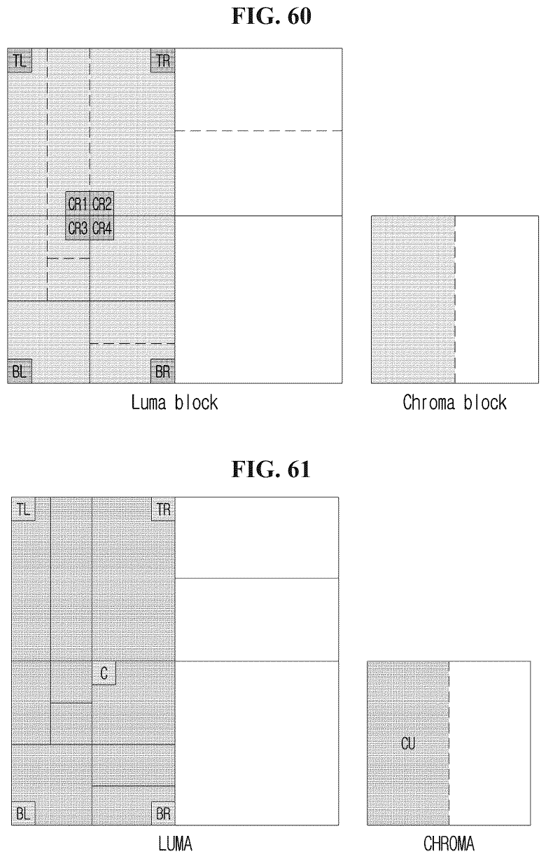

FIGS. 59 and 60 illustrates a luma block and a chroma block when a ratio between color components is 4:2:0.

As in an example shown in FIGS. 59 and 60, when a ratio between color components is 4:2:0, a luma component region corresponding to a chroma component block may be a region that is twice the width and height of a chroma component block, respectively.

In this case, a luma component region corresponding to a chroma component block may include a plurality of blocks, as in a shown example.

In an example shown in FIG. 59, at least one of a plurality of blocks (i.e., A, B, C, D) included in a luma component region may be determined as a luma component block corresponding to a chroma component block.

Specifically, when a luma component region includes a plurality of blocks, a luma corresponding block corresponding to the predetermined position of a chroma component block may be selected. The predetermined position may be determined based on at least one of the size, shape and depth of a chroma block.

When any one of a plurality of luma component blocks (i.e., A, B, C, D) is selected, the intra prediction mode of a selected block may be derived as the intra prediction mode of a chroma block.

Alternatively, based on the statistical value of intra prediction modes of a plurality of luma component blocks in a luma component region, the intra prediction mode of a chroma component block may be derived.

Alternatively, at least one intra prediction mode of at least one block of a plurality of luma component blocks may be combined to derive the intra prediction mode of a chroma component block.

Alternatively, the prediction mode of a chroma block may be derived based on at least one of the size/shape or depth information of a luma component block.

For example, the prediction mode of a chroma block may be derived based on at least one of the size/shape or depth information of a chroma block.

Meanwhile, by sequentially searching predefined positions, the intra prediction mode of a chroma component block may be derived based on an available luma component block found first. Here, an available luma component block may be a block encoded/decoded by intra prediction.

When deriving the intra prediction mode of a chroma component block from a luma component region, the intra prediction mode of a chroma component block may be derived by giving a higher priority to a position corresponding to the center of a chroma component block.

As an example, in an example shown in FIG. 60, a luma component block including at least one of the CR1, CR2, CR3, CR4, TL(Top-Left), TR(Top-Right), BL(Bottom-Left) and BR(Bottom-Right) positions may be determined as a luma component block corresponding to a chroma component block.

The intra prediction mode of a luma component block corresponding to at least one of the CR1, CR2, CR3, CR4, TL, TR, BL and BR positions may be derived as the intra prediction mode of a chroma block.

After searching a luma component block in the order of the CR1, CR2, CR3, CR4, TL, TR, BL and BR positions, the intra prediction mode of an available luma component block found first may be derived as the intra prediction mode of a chroma component block. However, it is not limited to the order, and the order may be adaptively determined based on at least one of the size and shape of a chroma block.

When deriving the intra prediction mode of a chroma component block from a luma component block, the encoding parameter of at least one of a luma component block and a chroma component block may be used.

The MPM list of a chroma component block may be configured to include at least one of the following intra prediction modes. Here, the MPM list of a chroma block may be configured so that a candidate mode in a MPM list does not overlap each other.
Intra prediction mode of a spatial neighboring block (at least one of left, top, bottom-left, top-right and top-left) of a chroma block
Planar mode, DC mode
Intra prediction mode of at least one of the luma component blocks corresponding to a chroma block (e.g., blocks including CR1, CR2, CR3, CR4, TL(Top-Left), TR(Top-Right), BL(Bottom-Left) and BR(Bottom-Right) positions)
Vertical mode, Horizontal mode, etc.
Diagonal mode

At least one of the syntax elements for encoding information related to the intra block copy which is entropy encoded in the encoder and entropy decoded in the decoder may use at least one of the binarization, debinarization and entropy encoding/decoding methods below.
Signed 0-th order Exponential Golomb (Exp_Golomb) binarization/debinarization method (se(v))
Signed k-th order Exp_Golomb binarization/debinarization method (sek(v))
0-th order Exp_Golomb binarization/debinarization method for an unsigned positive integer (ue(v))
k-th order Exp_Golomb binarization/debinarization method for an unsigned positive integer (uek(v))
Fixed-length binarization/debinarization method (f(n))
Truncated Rice binarization/debinarization method or truncated unary binarization/debinarization method (tu(v))
Truncated binary binarization/debinarization method (tb(v))
Context-adaptive arithmetic encoding/decoding method (ae(v))
Bit string in bytes (b(8))
Signed integer binarization/debinarization method (i(n))
Unsigned positive integer binarization/debinarization method (u(n))
In this case, u(n) may mean a fixed-length binarization/debinarization method.
Unary binarization/debinarization method

When at least one of the intra block copy-related encoding information is entropy encoded/decoded, a context model may be determined by using at least one of the intra block copy-related encoding information of a neighboring block or at least one of the intra block copy-related encoding information encoded/decoded previously or information about a current unit/block depth or information about a current unit/block size.

When at least one of the intra block copy-related encoding information is entropy encoded/decoded, entropy encoding/decoding may be performed by using at least one of the intra block copy-related encoding information of a neighboring block or at least one of the intra block copy-related encoding information encoded/decoded previously or information about a current unit/block depth or information about a current unit/block size as a prediction value for at least one of the intra block copy-related encoding information.

Only any one of the embodiments is not applied to the encoding/decoding process of a current block, but a specific embodiment or a combination of at least one of the embodiments may be applied to the encoding/decoding process of a current block.

Next, an intra prediction method for screen content according to an embodiment of the present disclosure will be described.

In embodiments described below, an intra prediction method may be a chroma intra prediction method. In addition, an intra prediction method described in embodiments described below may be based on specific intra prediction or intra prediction.

Alternatively, in embodiments described below, an intra prediction method may be intra prediction using a direct block vector (DBV).

Motion information of a first block may be used to predict at least one corresponding second block. Here, motion information may be a block vector (BV). A first block may be a luma block. At least one second block may be at least one chroma block.

In this case, at least one second block corresponding to a first block may include corresponding blocks of a plurality of components (e.g., Cr and Cb).

Embodiments described below may be performed under a specific condition. A specific condition may mean that values of at least one coding parameter described above are specific values.

For example, when a specific condition related to block partition within a specific region is activated, the motion information of a first block may be used for prediction of at least one corresponding second block.

For example, when a specific tree within a specific slice is activated, the motion information of a first block may be used for prediction of at least one corresponding second block.

For example, when a dual tree within an intra slice is activated, the motion information of a first block may be used for prediction of at least one corresponding second block.

The use may be performed under a specific configuration. As an example, a specific configuration may include All Intra (AI) and Random Access (RA).

An intra mode for a specific component may include one of six cross component linear model (ML) modes, a convolution cross component model (CCCM) mode, a gradient linear model (GLM) mode, a decoder-side intra mode derivation (DIMD) mode, a direct Mode (DM) and n default intra prediction modes. Here, a specific component may be a chroma component. n default intra prediction modes may be n intra prediction modes within a list. n may be an integer greater than or equal to 1. n may be 4.

In addition, intra modes may include an intra block copy (IBC) mode that performs prediction according to a block vector.

In addition, intra modes may include an intra template matching prediction (TMP) mode that derives a block vector according to a template. An intra TMP mode may also derive a BV according to a template, and may be enabled to derive a BV according to a template.

An intra TMP mode may be a mode that uses a template for intra prediction.

In signaling intra modes, as in Table 29 below, an indicator indicating a specific coding mode may be used. Specifically, an indicator intra_chroma_pred_mode indicating the intra prediction mode of a chroma component (i.e., a chroma intra mode) may be encoded and signaled.

TABLE 29

| Indicator | Bin String | Intra Mode |
|---|---|---|
| 0 | 1100 | list[0] |
| 1 | 1101 | list[1] |
| 2 | 1110 | list[2] |
| 3 | 1111 | list[3] |
| 4 | 10 | DIMD (or, DIMD Chroma) |
| 5 | 0 | DM |

Table 29 shows a binarization process for an indicator (i.e., the index value of intra_chroma_pred_mode). According to the value of the intra_chroma_pred_mode, one of a plurality of lists, DIMD or DM mode may be selected. Based on the selection, the intra prediction mode of a chroma block may be derived.

A direct block vector (DBV) may be used for prediction of a specific block. A DBV may be used under a specific condition. A DBV may be used to improve coding efficiency.

A specific block may include at least one chroma block or at least one chroma block related to at least one chroma component.

Prediction using a DBV may be performed under a specific condition. A specific condition may mean that values of at least one coding parameter described above are specific values.

For example, when a specific condition related to block partition within a specific region is activated, prediction using a DBV for a specific block may be performed.

For example, when a specific tree within a specific slice is activated, prediction using a DBV for a specific block may be performed.

For example, when a dual tree within an intra slice is activated, prediction using a DBV for a specific block may be performed.

Prediction using a DBV for a specific block may be performed under a specific configuration. A specific configuration may include All Intra (AI) and Random Access (RA).

Table 30 shows an example in which a DBV mode is added to an intra mode indicated by intra_chroma_pred_mode.

TABLE 30

| Indicator | Bin String | Intra Mode |
|---|---|---|
| 0 | 11100 | list[0] |
| 1 | 11101 | list[1] |
| 2 | 11110 | list[2] |
| 3 | 11111 | list[3] |
| 4 | 110 | DIMD (or, DIMD Chroma) |
| 5 | 10 | DM |
| 6 | 0 | DBV |

Table 30 may represent a binarization process for an indicator (i.e., the index value of intra_chroma_pred_mode). According to the value of the intra_chroma_pred_mode, one of a plurality of lists, DIMD, DM mode and DBV may be selected.

FIG. 61 is a diagram for describing an example in which the prediction mode of a chroma component block is derived based on a luma component block.

When a specific condition is satisfied, if a first mode is applied to a chroma block and a predetermined luma block of the luma blocks at specific positions is coded in a second mode, the motion information of the predetermined luma block may be used to derive the motion information of a chroma block.

Here, a specific condition may mean that the value of at least one coding parameter is a specific value.

For example, the satisfaction of a specific condition may mean that a specific condition related to block partition is activated within a specific region.

For example, the satisfaction of a specific condition may mean that a specific tree is activated within a specific slice.

For example, the satisfaction of a specific condition may mean that a dual tree is activated within an intra slice.

A chroma block and a third block may be blocks corresponding to each other. A block may be a CU.

For example, the number of specific positions for selecting luma blocks may be predefined. As an example, a predefined number may be an integer greater than or equal to 1. A predefined number may be 5.

As an example, luma blocks at a specific position may be blocks including the top-left position of a chroma block, the top-right position of a block, the center position of a block, the bottom-left position of a block and the bottom-right position of a block.

For example, when the top-left coordinates of a block are (x, y), the width of a block is w and the height of a block is h, luma blocks at a specific position may include at least one of a top-left block occupying a coordinate (x, y), a top-right block occupying a coordinate (x+w−1, y), a center block occupying a coordinate (x+w/2, y+h/2), a bottom-left block occupying a coordinate (x, y+h−1) and a bottom-right block occupying a coordinate (x+w−1, y+h−1).

As an example, in an example shown in FIG. 61, a top-left block may be a block occupying block TL or sample TL.

A top-right block may be block TR or a block occupying sample TR.

A center block may be block C or a block occupying sample C.

A bottom-left block may be block BL or a block occupying sample BL.

A bottom-right block may be block BR or a block occupying sample BR.

Alternatively, when the top-left coordinates of a block are (x, y), the width of a block is w and the height of a block is h, luma blocks at a specific position may include at least one of a block occupying a sample at a coordinate (x, y), a block occupying a sample at a coordinate (x+w−1, y), a block occupying a sample at a coordinate (x+w/2, y+h/2), a block occupying a sample at a coordinate (x, y+h−1) and a block occupying a sample at a coordinate (x+w−1, y+h−1).

Meanwhile, a first mode applied to a chroma block among the conditions may be a DBV mode. In addition, a second mode applied to a luma block may be an IBC mode or an intra TMP mode.

Information for specifying a predetermined luma block among a plurality of luma blocks (e.g., an additional bin) may be encoded and signaled. As an example, the information may indicate one of a plurality of luma blocks.

Alternatively, after determining available luma blocks among a plurality of luma blocks, when a plurality of luma blocks are available, one of the available luma blocks may be indicated based on the information. Here, an available luma block may be a block encoded/decoded in a second mode (e.g., an intra block copy mode or an intra TMP mode).

Meanwhile, encoding/decoding of information for selecting one of a plurality of luma blocks may be omitted, and one of a plurality of luma blocks may be selected according to a predefined rule. As an example, a block at a specific position or a block occupying a sample at a specific position among a plurality of luma blocks may be selected.

As an example, a block including a sample at a center position may be selected.

Alternatively, after sequentially searching a plurality of positions, an available luma block found first may be selected.

The motion information of a luma block may be block vector bvL. The block vector bvC of a chroma block may be derived based on the block vector of a luma block.

When the block vector of a chroma block is derived from the block vector of a luma block, block vector scaling processing may be performed on a block vector. In this case, block vector scaling may be performed based on template matching. Template matching may refer to matching in an intra TMP mode.

For example, when a luma block is encoded/decoded in a specific mode, block vector adjustment for the motion information of a luma block may be performed. Block vector adjustment may be flip-aware block vector adjustment.

For example, when a luma block is coded by reconstruction-reordered IBC (RRIBC), block vector adjustment may be performed on the block vector bvL of a luma block.

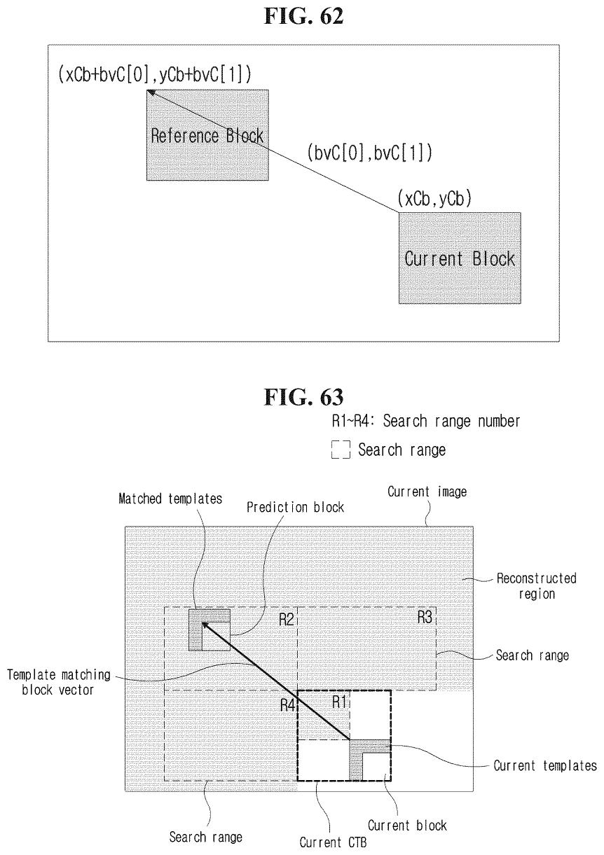

FIG. 62 is a diagram for describing a prediction process based on a DBVB method.

In FIG. 62, (xCb, yCb) represents the coordinate of a current block (e.g., a current chroma block). by represents the block vector of a current block. As an example, bvC[0] and bvC[1] may represent the x component and the y component of a block vector.

Block vector adjustment may be selectively performed based on a coding parameter for a current block.

The position (xCb, YCb) of a current block and the block vector bvC of a current block may be used to determine a corresponding offset position (xCb+bvC[0], yCb+bvC[1]). A block at a position indicated by an offset position may be set as a reference block.

Block copy prediction may be performed by using a reference block. In other words, a reference block may be set as the prediction block of a current block.

The following embodiments may be additionally applied to embodiments related to the above-described template matching prediction.

First, a plurality of search ranges may be set or a set search range may be divided/separated into a plurality of regions.

FIG. 63 illustrates four separated search ranges.

In an example shown in FIG. 63, four search ranges such as R1 to R4, etc. were illustrated.

As in an example shown in FIG. 63, at least one of a region (R3) at the top position of a current block, a region (R4) at the left position of a current block and regions (R1 and R2) at the top-left position of a current block may be set as a search range.

In an example shown in FIG. 63, it was shown that R2, R3 and R4 are not adjacent to a current template, while R1 is adjacent to a current template.

Unlike a shown example, a top template (R3) or a left template (R4) may be configured to be adjacent to a current block or a current template.

In addition, in an example shown in FIG. 63, it was illustrated that two template regions are positioned at the top-left of a current block. Unlike a shown example, one integrated template region may be configured at the top-left of a current block.

In addition, the number or configuration of search ranges is not limited to an example shown in FIG. 63. As an example, fewer search ranges or more search ranges than shown in FIG. 63 may be set.

Meanwhile, a plurality of search ranges may be referred to as sub-search ranges belonging to one search range.

Template matching may be performed on at least one of a plurality of search ranges. Specifically, whether template matching is performed on each of a plurality of search ranges may be determined.

In this case, information representing whether template matching is performed on a corresponding search range may be encoded and signaled per search region.

Alternatively, encoding/decoding of the information may be omitted, and whether to perform template matching on a search range may be determined in a decoder in the same manner as in an encoder.

A determination on whether to perform template matching on a search range may be based on encoding/decoding information of at least one of a current block or a neighboring block. Here, a neighboring block may include at least one of a top neighbor block, a left neighbor block, a top-left neighbor block, a top-right neighbor block or a bottom-left neighbor block of a current block.

As an example, based on the size of a current block or a neighbor block, whether template matching is performed on a search range may be determined.

For example, based on whether the size of a current block is less than or equal to a threshold or whether at least one of the width or height of a current block is less than or equal to a threshold, whether it is allowed to perform template matching on a search range may be determined.

For example, when the size of the width of a current block exceeds a threshold, template matching may be omitted for a search range (at least one of R3 or R2) at the top position of a current block.

For example, when the size of the height of a current block exceeds a threshold, template matching may be omitted for a search range (at least one of R4 or R2) at the left position of a current block.

Alternatively, when at least one of the width or height of an adjacent block exceeds a threshold, template matching may be omitted for a search range in the same direction as an adjacent block.

For example, when the width of an adjacent block at a top (above) position exceeds a threshold, template matching may be omitted for search range R3 at the top (above).

For example, when the height of an adjacent block at a left position exceeds a threshold, template matching may be omitted for search range R4 at the left.

In examples above, whether to perform template matching for each search range may be determined based on the smaller value (i.e., min(width, height)) or larger size (i.e., max(width, height)) of the width and height of a current block or a neighbor block.

As an example, when the width of a current block is larger than a height, template matching may be allowed at all times for a search range positioned on the top of a current block. On the other hand, for a search range positioned on the left of a current block, whether to perform template matching may be determined by referring to a result of comparing the height of a current block with a threshold value.

In the example, a threshold may be a value predefined in an encoder and a decoder. As an example, a threshold may be 64, 32 or 16.

Alternatively, information representing a threshold may be encoded and signaled from an encoder to a decoder.

As another example, whether template matching is performed for a search range may be determined based on prediction mode information of a current block or a neighboring block. Here, prediction mode information may include the directionality information of an intra prediction mode.

For example, when the directional mode of a current block is a vertical prediction or near-vertical prediction mode (e.g., 34-66), template matching may be performed for a search range (at least one of R1, R2 or R3) positioned on the top (above) of a current block. On the other hand, template matching may be omitted for search range R4 positioned on the left of a current block.

Alternatively, whether to perform template matching may be determined by comparing the prediction mode of adjacent blocks with a prediction mode derived from a current block.

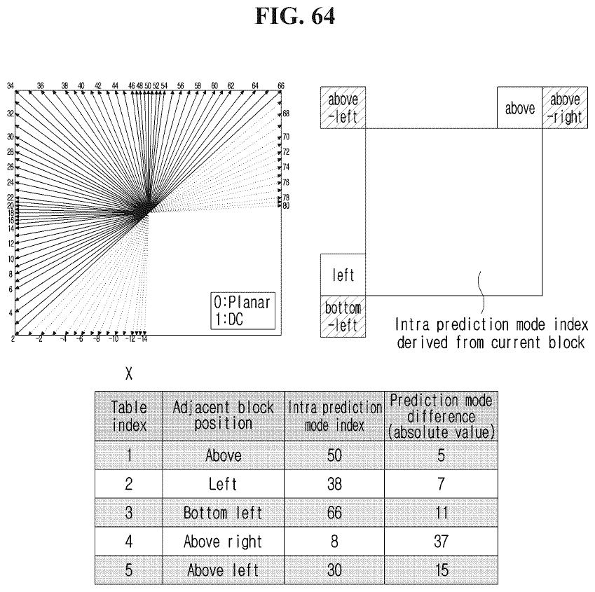

FIG. 64 shows an example in which whether to perform template matching for a search range is determined based on the prediction mode of a current block and the prediction mode of an adjacent block.

After comparing an intra prediction mode derived for a current block with the intra prediction mode of neighboring blocks, a search range to which an adjacent block having a prediction mode with the smallest difference from an intra prediction mode derived for a current block belongs may be set as a target for performing template matching.

As an example, in an example shown in FIG. 64, an intra prediction mode derived for a current block is 45. In this case, among the adjacent blocks, an adjacent block having an intra prediction mode with the smallest difference from the intra prediction mode of a current block is a top adjacent block. Accordingly, template matching may be performed for search range R3 positioned on the top of a current block to which a top adjacent block belongs.

Alternatively, adjacent blocks may be reordered in order of the smallest difference from the intra prediction mode of a current block. The reordering may be performed so that the smallest index is allocated to an adjacent block having an intra prediction mode with the smallest difference from the intra prediction mode of a current block and the largest index is allocated to an adjacent block having an intra prediction mode with the largest difference from the intra prediction mode of a current block.

Afterwards, search ranges to which N blocks with a small index belong may be selected, and template matching may be performed on selected search ranges.

Table 31 shows an example in which neighbor blocks shown in FIG. 64 are reordered in ascending order of differences between intra prediction modes.

TABLE 31

| | | | Prediction |
|---|---|---|---|
| | | | Mode |
| | | | Difference |
| | | Intra | (Absolute |
| Table | Adjacent Block | Prediction | Value of |
| Index | Position | Mode Index | Difference |
| 1 | Above | 50 | 5 |
| 2 | Left | 38 | 7 |
| 3 | Bottom left | 66 | 11 |
| 4 | Above left | 30 | 15 |
| 5 | Above right | 8 | 37 |

When N is 2, a top block (Above) and a left block (Left) may be selected according to the reordered table. Accordingly, template matching may be performed for top search range R3 of a current block to which a top block belongs and left search range R4 to which a left block belongs.

Meanwhile, an intra prediction mode for a current block may be derived through DIMD or TIMD.

For an unselected search range, template matching may be omitted.

Alternatively, when an adjacent block is encoded/decoded by intra prediction, but there is no directional prediction information in an adjacent block, template matching may be omitted for a search range to which a corresponding adjacent block belongs. As an example, when an adjacent block is encoded/decoded in a nondirectional prediction mode such as DC or Planar, template matching may be omitted for a search range to which a corresponding adjacent block belongs.

Alternatively, when an adjacent block is encoded/decoded by inter prediction, template matching may be omitted for a search range to which a corresponding adjacent block belongs.

Whether to perform template matching for a search range may be determined based on the availability of an adjacent block.

As an example, when an adjacent block is not available or is not referenceable, template matching may be omitted for a search range positioned in a direction from a current block toward a corresponding adjacent block (or in a direction adjacent thereto).

For example, when an adjacent block positioned above is not available, template matching for search range R3 positioned above may be omitted.

When a plurality of search ranges are selected, template matching may be performed sequentially for search ranges. In this case, whether to perform template matching for a search range in specific order may be determined based on a template matching cost calculated in a previous pixel or a previous search range.

Specifically, a template matching cost in a previous search range may be compared with a threshold value to determine whether to perform template matching for a current search range.

For example, when template matching is performed in the order of R1 to R4, template matching for a R(N+1) search range may be omitted when an optimal template matching cost calculated in a R(N) search range is smaller than a threshold.

In this case, a threshold may be a value preset in an decoder/a decoder. Alternatively, information about a threshold value may be a value signaled from an encoder to a decoder.

Even within a search range, a template matching cost may be calculated sequentially in predefined order. In this case, initial template matching may be performed in at least one position predefined within a search range.

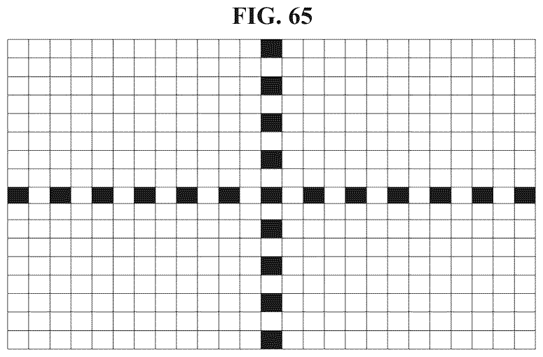

FIG. 65 shows the position of pixels where initial template matching is performed.

When a search range includes a current block or an adjacent block, a region occupied by a current block or an adjacent block in a search range or the position of a current block or an adjacent block may be set as an initial search position. As an example, initial search positions may be set based on the position of a current block or an adjacent block in a search range.

In this case, whether to perform template matching for a specific pixel may be determined based on whether a template matching cost calculated in a previous pixel is smaller than a threshold value. As an example, when a template matching cost calculated in a previous pixel is smaller than a threshold value, calculating a template matching cost may be omitted for the next numbers.

Alternatively, a template matching cost may be calculated for all positions set to perform initial template matching. Afterwards, the smallest of a plurality of initial template matching costs may be compared with a threshold to determine whether to perform template matching for the remaining regions/pixels.

As an example, as in an example shown in FIG. 65, template matching may be performed for pixel positions determined according to a specific pattern. Then, a search range may be reset based on a pixel position having the minimum template cost, and template matching may be performed on a residual search range within a reset search range. Here, a reset search range may be included in an initially set search range.

Alternatively, additional template matching may be performed by selecting a first search range reset based on a pixel position having the minimum template matching cost and a second search range reset based on a pixel position having the next-ranked template matching cost. In the remaining regions excluding a first search range and a second search range within a search range, template matching may be omitted.

Meanwhile, a search pattern for selecting pixels for performing initial template matching may be determined for each search range. Accordingly, pixel positions where initial template matching will be performed may be set based on a different search pattern for each search range. Here, a search pattern may include at least one of a cross pattern, a diagonal pattern, a diamond pattern, a hexagon pattern or a square pattern.

FIG. 65 shows an example in which pixel positions for performing initial template matching are determined by a cross pattern.

In determining a search range for template matching, the block vector of an adjacent block may also be used.

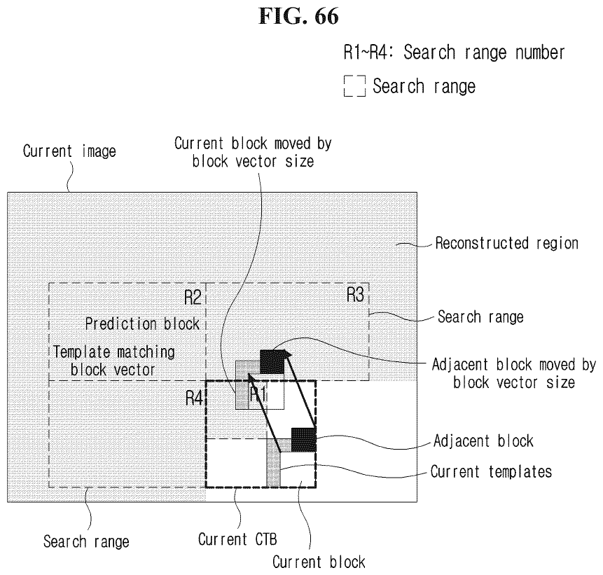

FIG. 66 is a diagram for describing an example in which template matching is performed by using the block vector of an adjacent block.

When there is a block vector (or a motion vector) stored in an encoded/decoded region near a current block and intra template matching prediction is applied to a current block, a pixel position or a search range for performing template matching may be determined by referring to at least one of the block vectors (or motion vectors) stored in the neighboring region.

Specifically, a position indicated by an adjacent block adjacent to a current block or a search range including it may be set as a position for performing template matching or a search range for performing template matching.

As an example, as in an example shown in FIG. 66, a search range including a position separated by the block vector (or motion vector) of an adjacent block from the position of a current block may be set as a target for performing template matching.

In FIG. 66, it was illustrated that a position separated by the block vector of an adjacent block from the top-left sample position of a current block is inculcated in search range R3. Accordingly, search range R3 may be set as a target for performing template matching.

Alternatively, a reference block in the same size as a current block is set at a position separated by the block vector of an adjacent block from the top-left sample position of a current block. Afterwards, a search range including at least a part of a reference block may be set as a target for performing template matching.

As an example, in FIG. 66, it was illustrated that a reference block derived based on the block vector of an adjacent block exists across search ranges R1 and R3. Accordingly, search ranges R1 and R3 may be set as a target for performing template matching.

Alternatively, a search start position within a search range may be set based on the block vector of an adjacent block. In other words, a position spaced apart from the position of a current block by the block vector of an adjacent block may be set as a search start position within a search range.

Based on the search start position, initial search positions (e.g., refer to FIG. 65) according to a search pattern may be set.

As another example, template matching order between search ranges may be determined by using the block vector (or motion vector) of an adjacent block.

As an example, let's assume that predefined order for performing template matching is R1 to R4. For example, when a block vector is not stored in a block adjacent to a current block, template matching may be performed in the order of R1 to R4.

If a block vector is stored in a block adjacent to a current block, template matching may be set to be performed first for a search range that includes a position separated by the block vector of an adjacent block from the position of a current block. As an example, in an example shown in FIG. 66, a position separated by the block vector of an adjacent block from the position of a current block is included in search range R3. Accordingly, the order in which template matching is performed between search ranges may be R3, R1, R2, R4.

Alternatively, when a block vector is stored in a block adjacent to a current block, template matching may be set to be performed first for a search range including a reference block that covers a position spaced apart from the position of a current block by the block of an adjacent block. As an example, in an example shown in FIG. 66, a reference block exists across search ranges R1 and R3. Accordingly, the order in which template matching is performed between search ranges may be R1, R3, R2, R4 or R3, R1, R2, R4.

When there are a plurality of adjacent blocks where a block vector is stored, a correction position may be calculated based on each block vector of a plurality of adjacent blocks. Here, a correction position represents a position spaced apart from the position of a current block by the block vector of an adjacent block.

In this case, template matching may be set to be performed first for a search range including the largest number of reference blocks corresponding to a plurality of correction positions or each correction position.

Alternatively, after searching a plurality of adjacent blocks in predefined order, a search range may be selected by using an available block vector found first.

Alternatively, when a plurality of adjacent blocks are encoded by using a block vector, the process of selecting a search range may be repeatedly performed for each of a plurality of block vectors. As a result, at least one search range may be selected.

Meanwhile, a derived search range may be expanded or reduced.

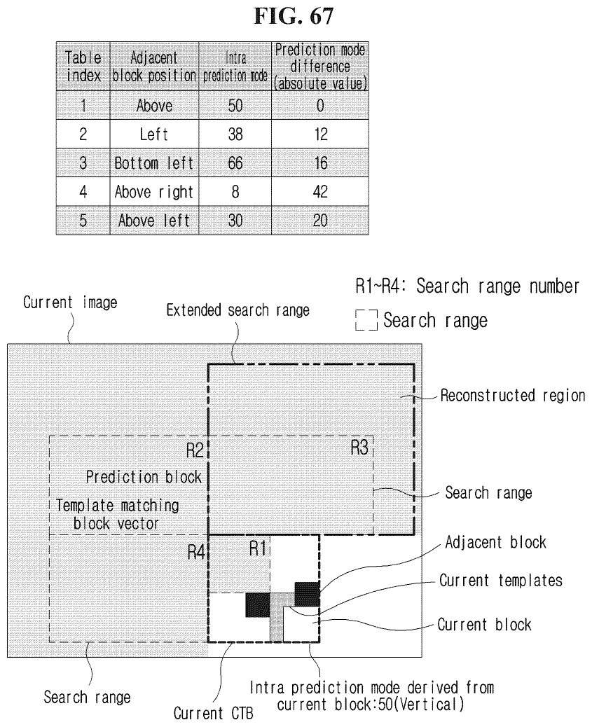

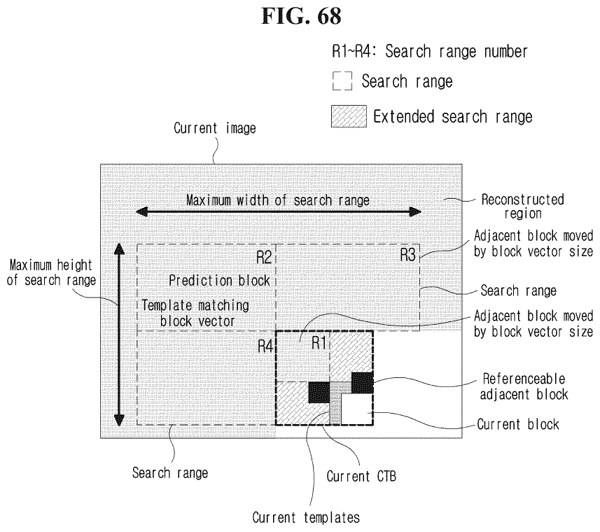

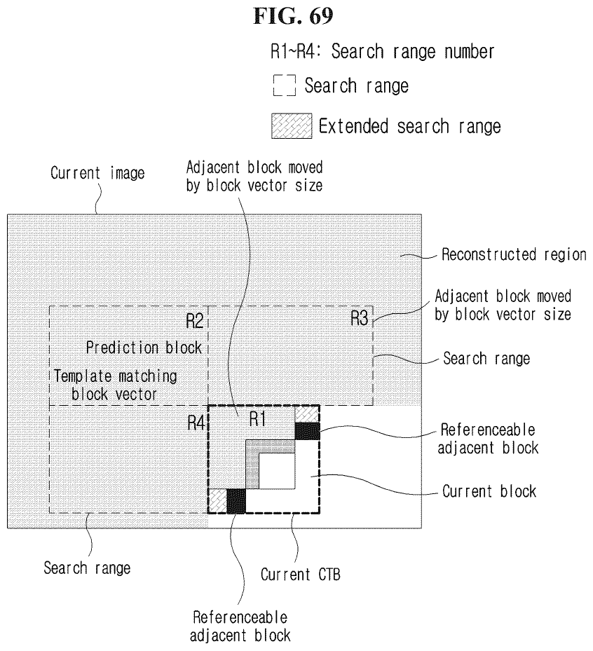

FIGS. 67 to 69 show an example in which the size of a search range is expanded.

In performing template matching, the size of a search range may be determined by using encoding/decoding information of the current block of a neighboring block or a current block.

In determining the size of the search range, the entire referenceable reconstructed region may be set as a search range.

Alternatively, the size of a search range may be determined based on the size of a current block or an adjacent block. As an example, the size of a search range may be adaptively set based on at least one of the width or height of a current block.

For example, let's assume that the width of a search range is SR_W (search range width) and the height of a search range is SR_H. In this case, SR_W and/or SR_H may be expressed in the form of at least one of a value obtained by multiplying the width and/or height of a current block by a weight, a value obtained by dividing the width and/or height of a current block by a weight, a value obtained by adding an offset to the width and/or height of a current block, a value obtained by subtracting an offset from the width and/or height of a current block, a statistical value for the width or a statistical value for the height.

The following example represents an example in which SR_W and SR_H are derived for a search range.
Example 1) SR_W: w1×width (Current Block), SR_H: w2×height
Example 2) SR_W: width/w1, SR_H: height/w2
Example 3) SR_W: width+w1, SR_H: height+w2
Example 4) SR_W: width−w1, SR_H: height−w2
Example 5) SR_W, SR_H: width+height or width*height
Example 6) SR_W, SR_H: CTU size×N (N is a constant greater than or equal to 1)
Example 7) SR_W, SR_H: max(width, height)×w1 or min(width, height)×w2

In the example, weights w1 and w2 may be the same value or a different value. In addition, weights may be a value preset in an encoder/a decoder. Alternatively, information for determining weights may be encoded and signaled from an encoder to a decoder.

In examples 1) to 7) above, the size of a search range may be derived by replacing width, the width of a current block, with the width of an adjacent block and height, the height of a current block, with the height of an adjacent block.

As another example, the size of a search range may be derived based on a size ratio between a current block and an adjacent block. Specifically, the size of a search range may be determined based on at least one of a horizontal ratio between a current block and an adjacent block or a vertical ratio between a current block and an adjacent block.

Let's assume that a boundary between a current block and a left adjacent block (i.e., the height of an adjacent block) is height_L, a boundary between a current block and a top (above) adjacent block (i.e., the width of an adjacent block) is width_A, the width of a current block is width and the height is height. In this case, ratio_A may represent a ratio between width, the width of a current block, and width_A, the width of a top adjacent block, and ratio_L may represent a ratio between height, the height of a current block, and height_L, the height of a left adjacent block. In this case, the size of a search range may be derived as in the following example.
Example 1-1) SR_W: w1×width×ratio_A (current block), SR_H: w2×height×ratio_L
Example 2-1) SR_W: width/w1/ratio_A, SR_H: height/w2/ratio_L
Example 3-1) SR_W: width×ratio_A+w1, SR_H: height×ratio_L+w2
Example 4-1) SR_W: width×ratio_A−w1, SR_H: height ratio_L−w2
Example 5-1) SR_W, SR_H: width×ratio_A+height or width×height×ratio_L or width×ratio_A+height×ratio_L
Example 6-1) SR_W, SR_H: CTU size×ratio_A(or ratio_L)×N or (N is a constant greater than or equal to 1)
Example 7-1) SR_W, SR_H: max(width, height)×w1×ratio_A(or ratio_L) or min(width, height)×w2×ratio_A(or ratio_L)

In determining the size of a search range, the prediction mode information of a current block or an adjacent block may be considered. Here, prediction mode information may be the directional information of an intra prediction mode.

As an example, as in an example shown in FIG. 67, when the directional mode of a current block is a vertical prediction mode (vertical: 50) or a prediction mode close thereto (e.g., 34-66), the size of search range R3 positioned on the top (above) may be expanded. Alternatively, when the directional mode of a current block is a horizontal prediction mode (horizontal: 18), the size of search range R4 positioned on the left may be expanded. Alternatively, when the directional mode of a current block is a diagonal prediction mode (diagonal: 34), the size of at least one of search range R1 or R3 positioned in a diagonal direction may be expanded.

After comparing an intra prediction mode derived for a current block with the intra prediction mode of neighboring blocks, a search range to which an adjacent block having a prediction mode with the smallest difference from an intra prediction mode derived for a current block belongs may be set as a target for expanding a size.

As an example, in an example shown in FIG. 67, an intra prediction mode derived for a current block is 50. In this case, among the adjacent blocks, an adjacent block having an intra prediction mode with the smallest difference from the intra prediction mode of a current block is a top adjacent block. Accordingly, the size of search range R3 at the top position of a current block, to which a top adjacent block belongs, may be expanded.

Alternatively, adjacent blocks may be reordered in order of the smallest difference from the intra prediction mode of a current block. The reordering may be performed so that the smallest index is allocated to an adjacent block having an intra prediction mode with the smallest difference from the intra prediction mode of a current block and the largest index is allocated to an adjacent block having an intra prediction mode with the largest difference from the intra prediction mode of a current block.

Afterwards, search ranges to which N blocks with a small index belong may be selected, and the size of selected search ranges may be expanded.

When N is 2, a top block (Above) and a left block (Left) with the smallest difference from the intra prediction mode of a current block may be selected. Accordingly, the size of top search range R3 of a current block to which a top block belongs and left search range R4 to which a left block belongs may be expanded.

Meanwhile, an intra prediction mode for a current block may be derived through DIMD or TIMD, etc.

The size of a search range that is not a target for expansion may be maintained at its original size or reduced.

Alternatively, the size of a search range may be adaptively determined based on the availability of an adjacent block.

As an example, when an adjacent block is not available or is not referenceable, the size of a search range positioned in a direction from a current block toward a corresponding adjacent block (or in a direction adjacent thereto) may be reduced.

For example, when an adjacent block positioned on the top (ABOV) is not available, the size of search range R3 positioned on the top may be reduced.

On the other hand, when an adjacent block is available or referenceable, the size of a search range positioned in a direction from a current block toward an adjacent block (or in a direction adjacent thereto) may be expanded.

Meanwhile, a direction in which a search range is expanded may be a direction from a current block toward an adjacent region or a search range.

Alternatively, when there is a referenceable region around a search range (e.g., a region where a referenceable reconstructed sample exists), a search range may be expanded to include a referenceable region.

As an example, a search range may be expanded to further include N referenceable lines (e.g., N is a natural number such as 1, 2 or 3) around a search range.

Meanwhile, the maximum expansion range of a search range may be the same as or smaller than the width or height of an initial search range. In this case, the expansion of a search range may be set not to go beyond the boundary of a predetermined region. Here, a predetermined region may be a CTB, a slice, a tile, a sub-picture or a picture. As an example, the expansion of a search range may be performed only within a CTB including a current block.

The size of a search range may also be determined based on the block vector of an adjacent block.

When there is a block vector (or a motion vector) stored within an encoded/decoded region around a current block and intra template matching prediction is applied to a current block, a search range to be expanded or reduced may be determined by referring to at least one of the block vectors (or motion vectors) stored within the neighboring region.

Specifically, the size of a position indicated by an adjacent block adjacent to a current block or a search range including it may be expanded.

Alternatively, a reference block in the same size as a current block is set at a position separated by the block vector of an adjacent block from the top-left sample position of a current block. Afterwards, the size of a search range including at least a part of a reference block may be expanded.

The size of a search range not indicated by the block vector of an adjacent block may be maintained as it is or reduced.

The size of a search range may be determined differently for each search range.

The shape of a search range may be at least one of square/non-square, triangle, pentagon, hexagon or circle. As an example, when a search range is circular, a region within a threshold (i.e., a radius) from a search start position (the center position) may be set as a search range.

When there are a plurality of search ranges, a size or a shape may be determined independently for each search range. Accordingly, at least one of a size or a shape between search ranges may be different.

The boundary of a search range may be set not to be beyond the boundary of a specific unit. Here, a specific unit may include at least one of a sub-picture, a slice, a tile, a CTU, a CTU row and a CTU column.

As in an example described above, the size of a search range may be variable.

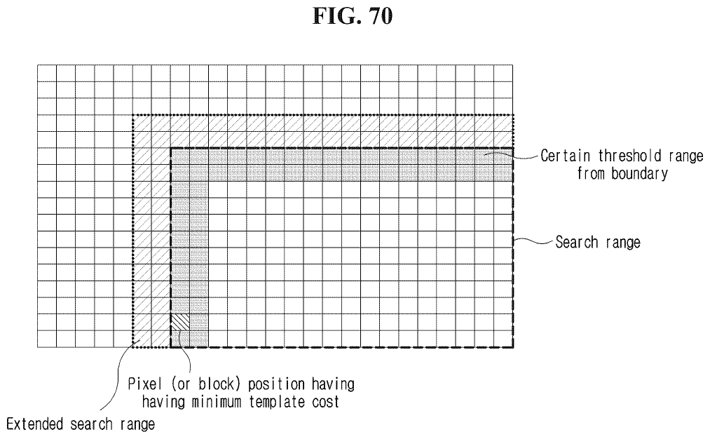

FIGS. 70 to 74 show an example in which the size of a search range is determined variably.

In this case, based on a result of performing initial template matching in at least one position within a search range, whether to change the size of a search range may be determined.

As an example, whether to change the size of a search range may be determined by comparing a template matching cost for initial template matching with a threshold.

As an example, as in an example shown in FIG. 70, when a template matching cost is greater than a threshold, the size of a search range may be expanded.

On the other hand, when a template matching cost is smaller than a threshold, the size of a search range may be reduced.

When there are a plurality of search ranges, initial template matching may be performed in at least one position for each search range. Afterwards, the size of each search range may be adjusted based on an initial template matching cost between search ranges.

As an example, the size of a search range with the smallest template matching cost may be expanded.

Alternatively, N search ranges may be selected in the order of the smallest template matching cost, and the size of N selected search ranges may be expanded. When N is 2, it represents that the size of a search range with the smallest cost and a search range with the next-ranked template matching cost are expanded.

As an example, the size of a search range with the smallest template matching cost may be expanded.

Alternatively, M search ranges may be selected in order of the largest template matching cost, and the size of M selected search ranges may be reduced. When M is 2, it represents that the size of a search range with the largest cost and a search range with the next-ranked template matching cost are reduced.

Alternatively, the size of search ranges may be adjusted based on the ratio of a template matching cost for each search range.

As an example, it is assumed that the ratio of a template cost between search ranges R1 to R4 is 1:2:2:4. In this case, the size of search ranges R1 to R4 may be reduced to 1, ½, ½ and ¼ of their original size, respectively.

Alternatively, the size of search ranges R1 to R4 may be expanded to 4, 2, 2 and 1 of their original size, respectively.

As another example, whether to adjust the size of a search range may be determined based on the statistical value of a template matching cost. Here, a statistical value may represent the minimum value, the maximum value or an average value.

As an example, as in an example shown in FIG. 70, when a pixel having the minimum template matching cost is positioned at the boundary of a search range or within a certain threshold range0 from a boundary, a search range may be expanded.

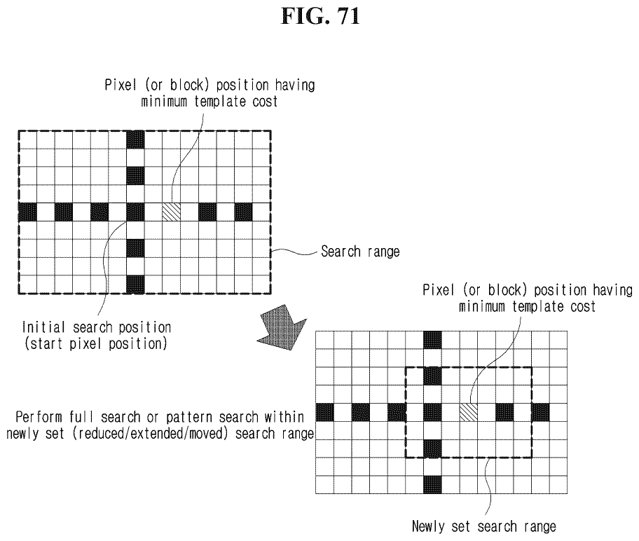

For example, as in an example shown in FIG. 71, a new search range may be set based on a pixel position having the minimum template matching cost in initial template matching using a search pattern. In this case, a full search or a pattern search may be performed within a newly set search range.

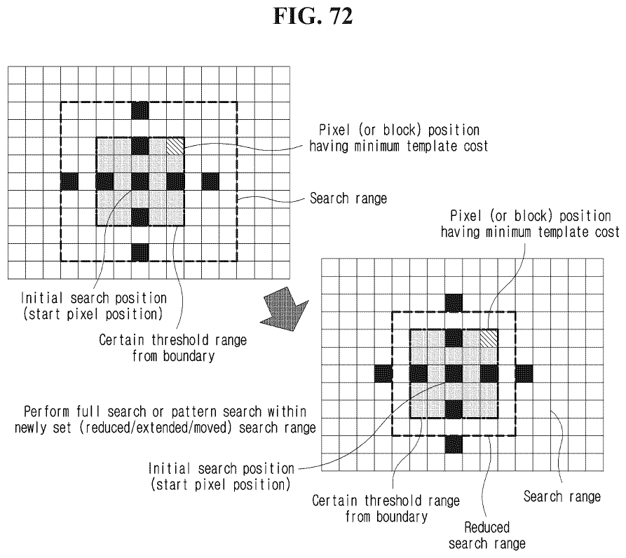

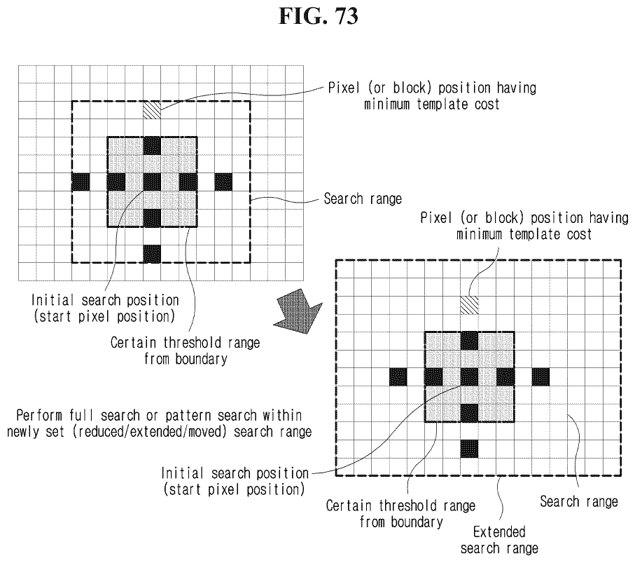

For example, as in an example shown in FIG. 72 or FIG. 73, when a pixel position having the minimum template matching cost is included within a threshold distance from an initial search position (a first/start pixel position) in initial template matching using a search pattern, a search range may be reduced. Conversely, when the position of a corresponding pixel is outside a threshold distance, a search range may be expanded.

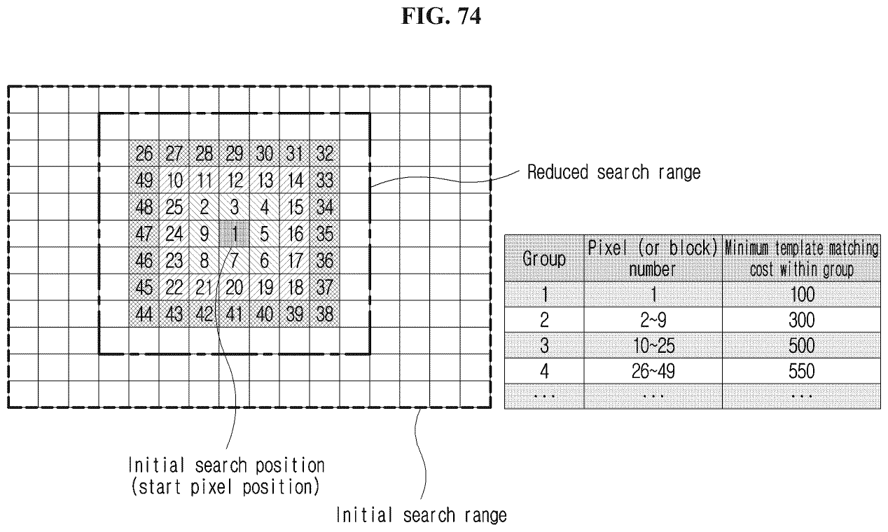

For example, as in an example shown in FIG. 74, pixels at the same distance from an initial position may be grouped, and the minimum template matching cost may be derived for each group. Afterwards, when the minimum template matching cost tends to increase as it moves away from an initial position (Group 1 in FIG. 74), the size of a search range may be reduced. In FIG. 74, the minimum template matching cost in Group 2 is greater than the minimum template matching cost in Group 1, and the minimum template matching cost in Group 3 is greater than the minimum template matching cost in Group 2. In this way, when the minimum template matching increases consecutively N times compared to a previous group, the size of a search range may be reduced. N is a natural number, and may be 1, 2 or 3.

In expanding or reducing the size of the search range, the expansion or reduction ratio of the width and the expansion or reduction ratio of the height may be different.

Meanwhile, in performing template matching for a search range, sub-sampling for a search range may be performed to reduce complexity.

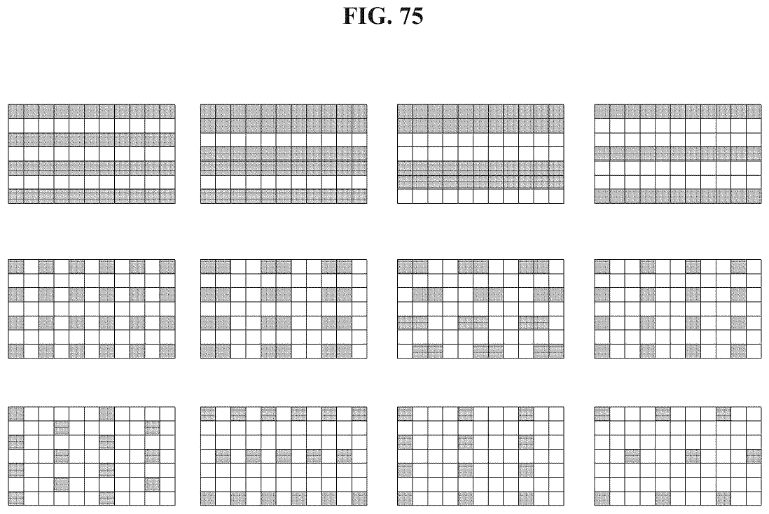

FIGS. 75 to 77 shows an example in which sub-sampling is performed for a search range.

Specifically, FIG. 75 shows an example of various sub-sampling patterns.

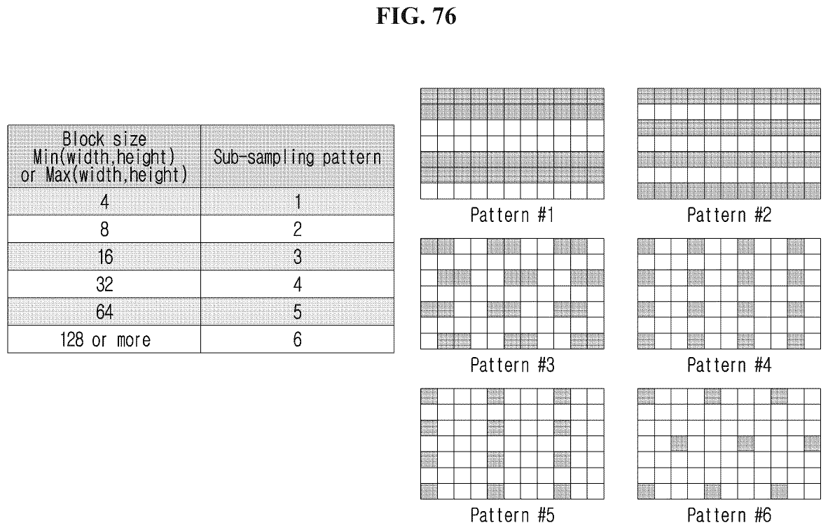

FIG. 76 shows an example in which a sub-sampling level is adaptively determined according to a block size.

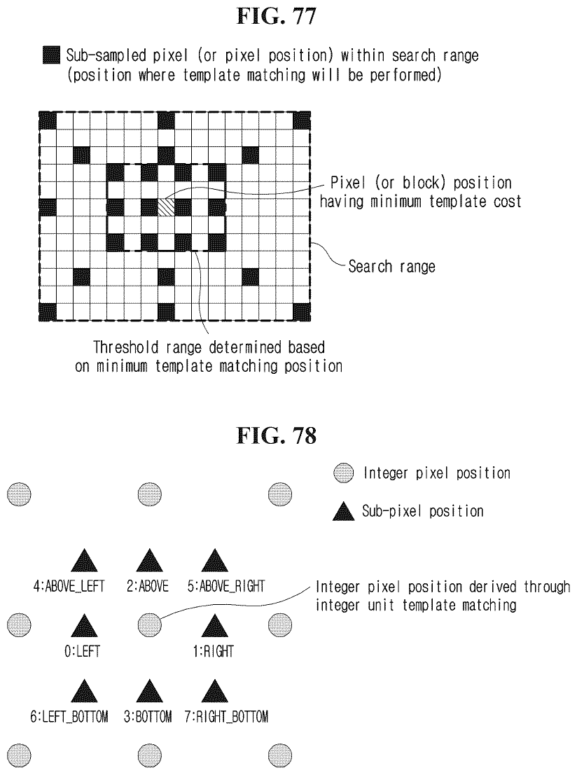

FIG. 77 shows an example in which a sub-sampling level is changed according to a threshold range determined based on a pixel position having the minimum template cost.

In performing template matching for a search range, template matching may be performed by selecting at least one of a full search and a pattern search within a search range.
Full Search: Searching all available pixels in a template matching search range

Pattern Search: 2D logarithmic search, N-step search, Diamond search, Hexagonal search, Test zone search, quadratic equation-based search, sub-sampling-based search, etc.

In this case, a template matching search method used in a search range may be a value preset in an encoder/a decoder or a value signaled from an encoder to a decoder.

As described above, in performing template matching for a search range, sub-sampling for a search range may be performed to reduce complexity.

For example, after performing sub-sampling for a search range, template matching may be performed only for a sub-sampled position within a search range.

As an example of sub-sampling, as in an example shown in FIG. 75, a search range may be configured by emptying at least one pixel or at least one line.

In performing sub-sampling for the search range, differential sub-sampling may be performed by using encoding/decoding information of a neighboring or current block.

In this case, whether to perform sub-sampling for the search range may be determined based on encoding/decoding information of a current block or a neighboring block. Alternatively, sub-sampling performance information may be derived from an encoder/a decoder or may be signaled from an encoder to a decoder.

In this case, one of the various sub-sampling methods shown in FIG. 75 may be selected, and sub-sampling may be performed more densely or more coarsely than a selected level (or pattern).

Here, when sub-sampling is performed more densely, it means that the number of pixels (or positions) where template matching will be performed increases more than the number of pixels (or positions) where template matching in reference sub-sampling will be performed. In addition, when sub-sampling is performed more coarsely, it means that the number of pixels (or positions) where template matching will be performed decreases more than the number of pixels (or positions) where template matching in reference sub-sampling will be performed.

Meanwhile, information on a reference sub-sampling method may be a value preset in an encoder/a decoder or may be a value signaled from an encoder to a decoder.

In this case, a sub-sampling level may be determined based on the size of a current block or an adjacent block.

For example, as in an example shown in FIG. 76, as the size of a current block is smaller, sub-sampling may be performed more coarsely.

Sub-sampling strength may also be adjusted based on the size of an adjacent block, not the size of a current block.

For example, when there are a plurality of search ranges (e.g., R1 to R4), a sub-sampling level for a search range in the same direction as an adjacent block may be determined according to the size of an adjacent block.

As an example, when a left neighbor block is larger than a top neighbor block, sub-sampling for search range R4 positioned on the left of a current block may be performed more coarsely than sub-sampling for search range R2 positioned on the top of a current block.

Alternatively, conversely to the example, sub-sampling may be set to be coarse as the size of a current block or an adjacent block increases.

Alternatively, a sub-sampling level for a search range may be determined based on a template matching cost.

As an example, an initial template matching cost may be calculated at initial template search positions within a search range (e.g., positions in a cross pattern in FIG. 65).

When the minimum template matching cost at initial template search positions is smaller than a predetermined threshold, sub-sampling for the remaining regions may be omitted or sub-sampling may be performed more coarsely than a reference sub-sampling level.

For example, when there are a plurality of search ranges (e.g., R1 to R4), sub-sampling may be omitted for a search range that includes a pixel position having the minimum template cost among a plurality of search ranges or sub-sampling may be performed more densely compared to other search ranges. Alternatively, sub-sampling may be performed relatively more coarsely for other search ranges except for a search range that includes a pixel position having the minimum template cost.

For example, as in an example shown in FIG. 77, sub-sampling may be performed more densely within a determined threshold range based on a pixel position having the minimum template cost and sub-sampling may be performed more coarsely outside a determined threshold range.

In this case, sub-sampling strength may be determined by referring to at least one of the block vectors (or motion vectors) stored in a neighboring block.

As an example, when there are a plurality of search ranges (e.g., R1 to R4), for a search range indicated by the block vector (or motion vector) of an adjacent block, sub-sampling may be omitted or sub-sampling may be performed more densely than a reference sampling method or the remaining search ranges.

Also for a current template, sub-sampling may be performed in the same manner as in a search range.

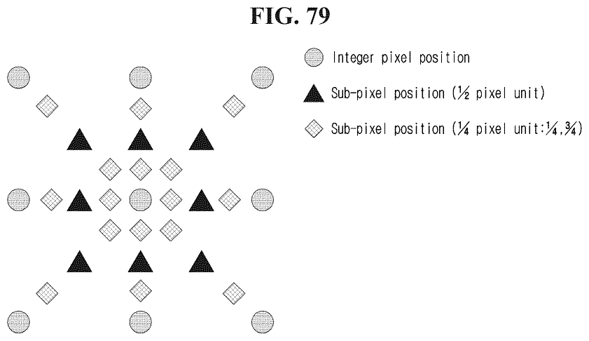

FIGS. 78 and 79 illustrate a position where template matching is performed.

Specifically, FIG. 78 shows a sub-pixel position generated at an integer pixel position derived through integer unit template matching.

FIG. 79 illustrates integer pixel and sub-pixel positions for performing template matching. It was illustrated that integer pixel and sub-pixel positions have a radial pattern.

In the template matching-based prediction, template matching may be performed in the resolution unit of a sub-pixel (sub-pel) such as ¼ pixel, ½ pixel, 1/n pixel, etc. or N multiples of an integer pixel such as 1 integer pixel, 4 integer pixels, etc.

In performing template matching in the sub-pixel unit, template matching may be performed by selecting at least one of a full search and a pattern search in all referenceable sub-pixel positions within a reference region or a search range.

For example, a sub-pixel (¼ pixel, ½ pixel, ¾ pixel) position of a radial pattern may be derived and template matching at a corresponding position may be performed as in FIG. 79 through interpolation between a reference integer pixel in determining a sub-pixel position where template matching will be performed and integer pixels in neighboring 8 directions.

In addition to a radial pattern, a sub-pixel position where template matching is performed may also be determined based on at least one of a horizontal pattern, a vertical pattern, a diagonal pattern or a cross pattern.

In this case, when a current block is determined in an IntraTMP mode, direction information (direction index) and precision (an integer pixel, a sub-pixel: ¼ pixel, ½ pixel, ¾ pixel) information on a position determined by template matching in a corresponding block may be signaled from an encoder to a decoder.

In performing template matching in the sub-pixel unit, a pixel position where template matching will be performed in a sub-pixel unit may be derived based on a template matching cost (or a prediction cost) calculated through template matching in an integer pixel unit (or a higher resolution unit, and for prediction in a ¼ pixel unit, a higher resolution unit is ½ pixel or an integer pixel).

For example, after performing template matching in an integer pixel unit, an error surface may be generated based on the position information of each pixel and a template matching cost and a quadratic equation for an error surface may be derived. A pixel position where template matching will be performed in a sub-pixel unit may be derived by calculating a quadratic equation described above.

Based on an integer pixel position (e.g., a position having the minimum template cost or prediction cost) derived through template matching in an integer pixel unit (or a higher resolution unit), sub-pixels may be generated through interpolation as in FIG. 78, and then template matching may be performed at a derived sub-pixel position.

Template matching may be performed in at least one sub-pixel position among the sub-pixel positions derived through template matching in the integer pixel unit.

In performing template matching in the sub-pixel unit, interpolation may be performed by using a defined interpolation filter.

In performing the interpolation, interpolation may be performed by selecting at least one interpolation filter from multiple filter sets, as in Tables 32 and 33.

TABLE 32

| Interpolation Filter | |
|---|---|
| Type | Filter Coefficient |
| F1 | {−16, 144, 144, −16 |
| F2 | {−16, 216, 64, −8} |
| F3 | {−8, 64, 216, −16} |

TABLE 33

| | ½ Pixel Unit | ¼ Pixel Unit |
|---|---|---|
| Sub-pixel Position | Interpolation | Interpolation |
| LEFT | F1 | F3 |
| RIGHT | F1 | F2 |
| BOTTOM | F1 | F2 |
| ABOVE | F1 | F3 |
| ABOVE LEFT | F1 | F3 |
| ABOVE RIGHT | F1 | F2 |
| LEFT BOTTOM | F1 | F3 |
| RIGHT BOTTOM | F1 | F2 |

In selecting an interpolation filter for generating the sub-pixel, as in an example of Table 41, a different interpolation filter may be used according to the position of a sub-pixel to be generated together.

Alternatively, a different interpolation filter may be used according to the position and resolution (or precision) of a sub-pixel. Table 34 represents a variety of examples of interpolation filters that may be applied to a sub-pixel.

TABLE 34

| | | |
|---|---|---|
| { 0, 256, 0, 0 }, | { −16, 191, 93, −12 }, | { −13, 98, 187, −16}, |
| { −1, 254, 4, −1 }, | { −16, 187, 98, −13 }, | { −12, 93, 191, −16}, |
| { −3, 252, 8, −1 }, | { −16, 183, 102, −13 }, | { −12, 89, 195, −16}, |
| { −4, 250, 12, −2 }, | { −16, 179, 107, −14 }, | { −12, 84, 199, −15}, |
| { −5, 247, 17, −3 }, | { −16, 174, 112, −14 }, | { −11, 79, 203, −15}, |
| { −6, 244, 21, −3 }, | { −16, 170, 116, −14 }, | { −11, 75, 206, −14}, |
| { −7, 242, 25, −4 }, | { −16, 166, 121, −15 }, | { −10, 70, 210, −14}, |
| { −8, 239, 29, −4 }, | { −17, 162, 126, −15 }, | { −9, 65, 214, −14}, |
| { −9, 236, 34, −5 }, | { −16, 157, 130, −15 }, | { −9, 61, 217, −13}, |
| { −9, 233, 38, −6 }, | { −16, 153, 135, −16 }, | { −8, 56, 220, −12}, |
| { −10, 230, 43, −7 }, | { −16, 148, 140, −16 }, | { −8, 52, 224, −12}, |
| { −11, 227, 47, −7 }, | { −16, 144, 144, −16 }, | { −7, 47, 227, −11}, |
| { −12, 224, 52, −8 }, | { −16, 140, 148, −16}, | { −7, 43, 230, −10}, |
| { −12, 220, 56, −8 }, | { −16, 135, 153, −16}, | { −6, 38, 233, −9}, |
| { −13, 217, 61, −9 }, | { −15, 130, 157, −16}, | { −5, 34, 236, −9}, |
| { −14, 214, 65, −9 }, | { −15, 126, 162, −17}, | { −4, 29, 239, −8}, |
| { −14, 210, 70, −10 }, | { −15, 121, 166, −16}, | { −4, 25, 242, −7}, |
| { −14, 206, 75, −11 }, | { −14, 116, 170, −16}, | { −3, 21, 244, −6}, |
| { −15, 203, 79, −11 }, | { −14, 112, 174, −16}, | { −3, 17, 247, −5}, |
| { −15, 199, 84, −12 }, | { −14, 107, 179, −16}, | { −2, 12, 250, −4}, |
| { −16, 195, 89, −12 }, | { −13, 102, 183, −16}, | { −1, 8, 252, −3}, |
| | | { −1, 4, 254, −1} |

In this case, positions of sub-pixels to be generated based on an integer pixel may be divided into several groups to use a different interpolation filter for each group. For example, a different interpolation filter may be used according to whether it is the top, bottom, left or right.

In selecting an interpolation filter for generating the sub-pixel, as in Table 34, a different interpolation filter may be used according to the resolution (precision) of a sub-pixel.

For example, a different filter may be used for interpolation in a ½ pixel unit and interpolation in a ¼ pixel unit.

In selecting an interpolation filter for generating the sub-pixel, an optimal interpolation filter may be selected after using a plurality of interpolation filters.

The interpolation filter information used may be a value preset in an encoder/a decoder or may be a value signaled from an encoder to a decoder.

Based on a template matching cost calculated through integer pixel template matching, whether to perform template matching in a sub-pixel unit may be determined. As an example, the template matching cost may be compared with a threshold value to determine whether to perform template matching in a sub-pixel unit. When a template matching cost is less than a threshold value, template matching in a sub-pixel unit may be omitted and a result of template matching in an integer pixel unit may be used.

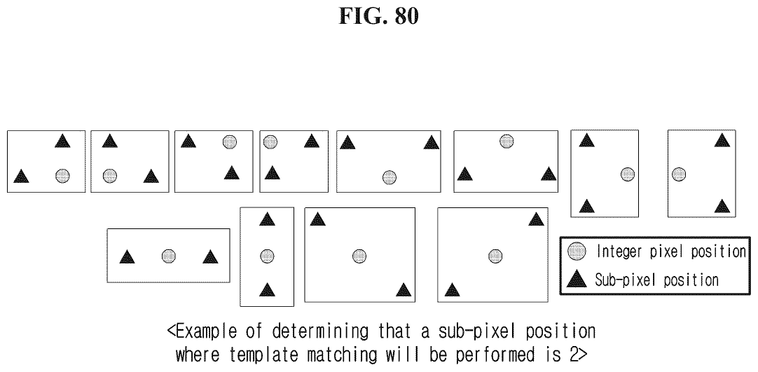

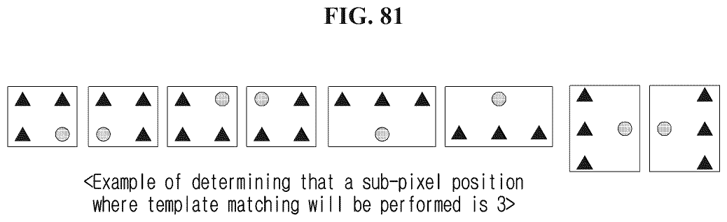

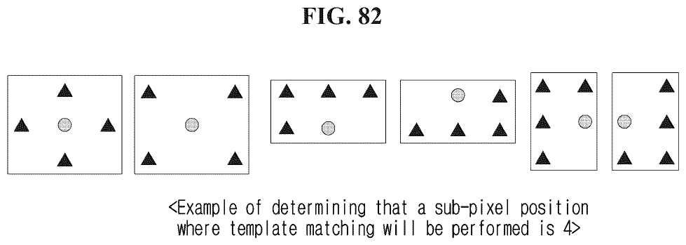

FIGS. 80 to 82 show an example in which template matching is additionally performed on adjacent or symmetrical sub-pixel positions based on a sub-pixel position having a minimum template cost.

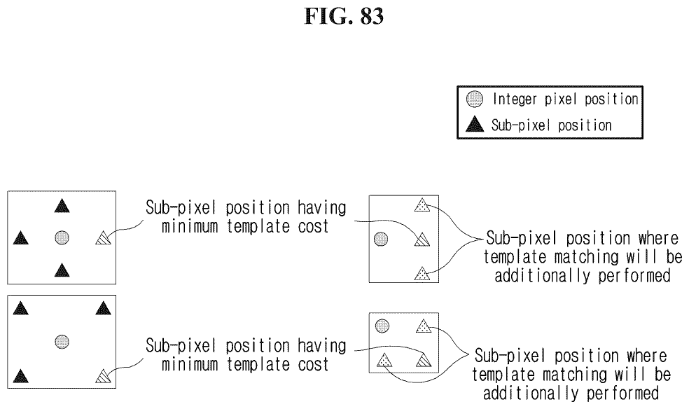

FIG. 83 is an example of a method for determining a pixel position where template matching is performed in a lower resolution unit by inheriting a sub-pixel position determined in a higher resolution (precision) pixel unit.

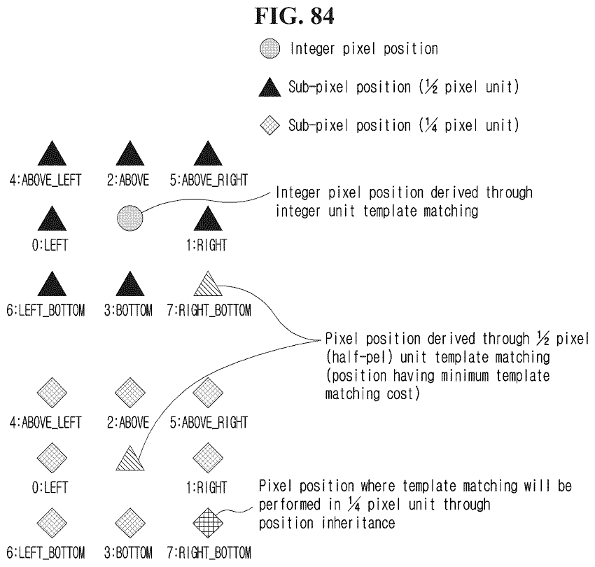

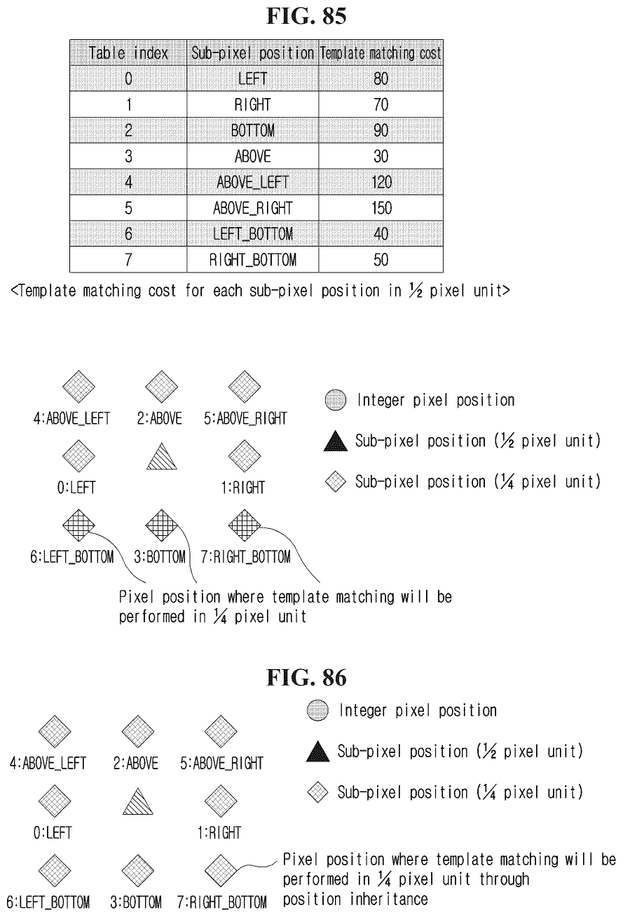

FIGS. 84 and 85 shows an example of a sub-pixel position where template matching is performed in a ¼ pixel unit based on a template matching cost for each sub-pixel position in a ½ pixel unit.

In determining a sub-pixel position where the template matching will be performed, template matching may be performed on sub-pixel positions corresponding to a predefined pattern position among the available sub-pixel positions.

For example, a template matching may be performed on sub-pixels at various pattern positions such as a cross pattern, a diagonal pattern, etc., as in an example shown in FIGS. 80 to 82, based on an integer pixel position derived through template matching in an integer pixel unit.

The patterns in FIGS. 80 to 82 are an example for some of the patterns configured by using available sub-pixel positions, and different patterns may be configured by selecting N of the available sub-pixel positions. The pattern information used may be a value preset in an encoder/a decoder or may be a value signaled from an encoder to a decoder.

In determining a sub-pixel position where the template matching will be performed, it may be determined based on a template matching cost.

For example, after performing template matching in at least one sub-pixel position as in FIG. 83, template matching may be additionally performed on adjacent or symmetrical sub-pixel positions based on a sub-pixel position having the minimum template cost.

In determining a sub-pixel position where the template matching will be performed, a candidate sub-pixel position may be determined by inheriting a pixel position determined/searched in higher resolution.

For example, as in an example shown in FIG. 84, a sub-pixel position determined in ½ pixel unit (a pixel position having the minimum template matching cost in a sub-pixel unit) may be inherited to perform template matching in ¼ pixel unit at a corresponding position.

For example, after performing template matching in ½ pixel unit as in FIG. 85, N pixel positions may be selected in the order of the smallest template matching cost to determine a pixel position where template matching will be performed in a ¼ pixel unit.

In determining a sub-pixel position where the template matching will be performed, it may be determined by considering a movement path or a movement direction to a pixel position having the minimum template matching cost within a search range in a current block.

For example, when a pixel position having the minimum template matching cost in an integer pixel unit is in the diagonal direction of a current block, sub-pixels positioned in a diagonal direction among the sub-pixels may be determined as a sub-pixel position where template matching will be performed.

For example, when a pixel position having the minimum template matching cost in an integer pixel unit is in the vertical direction of a current block, sub-pixels positioned in a vertical direction among the sub-pixels may be determined as a sub-pixel position where template matching will be performed.

FIG. 86 shows a sub-pixel position where template matching is performed in a ¼ pixel unit.

In the template matching in a sub-pixel unit, at least one sub-pixel position among the available sub-pixel positions may be determined as a candidate sub-pixel position for determining a final sub-pixel position.

An encoding cost (e.g., a RD cost) may be calculated for candidate sub-pixel positions selected among the available sub-pixel positions and a final sub-pixel position may be selected based on an encoding cost. In this case, information about a final encoding position may be signaled.

A signaling bit required to transmit a final sub-pixel position may be reduced by selecting a predetermined candidate sub-pixel position among all available sub-pixel positions. (Number of candidate sub-pixels<Number of all available sub-pixels)

In determining a final sub-pixel position among the candidate sub-pixel positions, a final sub-pixel position may be determined by using a template matching cost without signaling.

For example, a pixel position having the minimum template matching cost among the sub-pixel positions where template matching is performed may be determined as a final sub-pixel position.

In determining the candidate sub-pixel position, all available sub-pixel positions may be determined as a candidate sub-pixel position.

For example, a template matching cost or an encoding cost may be calculated for available sub-pixels to derive a final sub-pixel position.

In determining the candidate sub-pixel position, N−1 sub-pixels among the available sub-pixels may be selected and designated as a candidate sub-pixel position to determine a final sub-pixel position. In this case, N may be a value preset in an encoder/a decoder or may be a value signaled from an encoder to a decoder.

In determining the candidate sub-pixel position, N sub-pixels among the sub-pixels where template matching is performed may be selected and designated as a candidate sub-pixel position to determine a final sub-pixel position. In this case, N may be a value preset in an encoder/a decoder or may be a value signaled from an encoder to a decoder.

In this case, in determining a candidate sub-pixel position for determining a final sub-pixel position, it may be determined based on a template matching cost.

For example, as in FIG. 86, template matching may be performed at available sub-pixel positions to calculate a template matching cost, and N sub-pixel positions may be selected and designated as a candidate sub-pixel position based on a calculated template matching cost. In this case, N may be a value preset in an encoder/a decoder or may be a value signaled from an encoder to a decoder.

For example, available sub-pixel positions may be divided into arbitrary groups, and based on a template matching cost, all sub-pixel positions in a group including a sub-pixel position having the minimum template cost may be designated as a candidate sub-pixel position.

In this case, a candidate sub-pixel position may be determined by inheriting a pixel position determined/searched in higher resolution.

For example, as in an example shown in FIGS. 84 and 85 above, a sub-pixel position determined in ½ pixel unit may be inherited and determined as a candidate sub-pixel position for determining a sub-pixel position for template matching in ¼ pixel unit or a final sub-pixel position in ¼ pixel unit.

In this case, a finally determined sub-pixel position determined through an encoding process may be signaled. However, when there is only one position of a derived candidate sub-pixel, a final sub-pixel position may be derived from a decoder without signaling.

In order to derive the finally determined sub-pixel information from a decoder, information on whether to apply a sub-pixel and a sub-pixel position must be signaled in an encoder.

In this case, whether to apply a sub-pixel may be expressed as “not applying a sub-pixel (an integer pixel unit)”, “a sub-pixel application level (½ pixel unit or ¼ pixel unit)”, etc., and may be expressed as at least one flag.

For example, when one flag is used, it may be expressed as 0: integer pixel, 1: 1½ pixel, 2: ¼ pixel.

For example, when two flags are used, it may be expressed as 12 pixel for sub_pel_flag=0 (integer pixel), sub_pel_flag=1 and sub_pel_level=0 and as 14 pixel for sub_pel_level=1.

In this case, a sub-pixel position may also be expressed as a direction or offset value similar to a MMVD (merge with motion vector difference) method.

Here, a sub-pixel level may be expressed through an offset or a direction in which a sub-pixel finally determined through direction information is positioned.

In expressing the direction information, direction information to be expressed (transmitted) may be reduced by using a template matching cost.

For example, when a sub-pixel position with the minimum template cost among the eight directions is in a diagonal direction, direction information to be transmitted may be reduced by a method for determining only four sub-pixels positioned in a diagonal direction as a candidate sub-pixel. In the same way, when a sub-pixel position with the minimum template cost is positioned in a vertical/horizontal direction, only four sub-pixels positioned in a vertical/horizontal direction may be determined as a candidate sub-pixel.

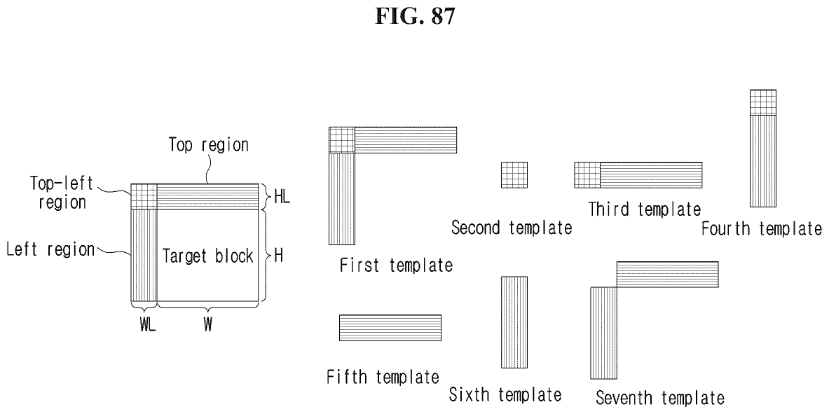

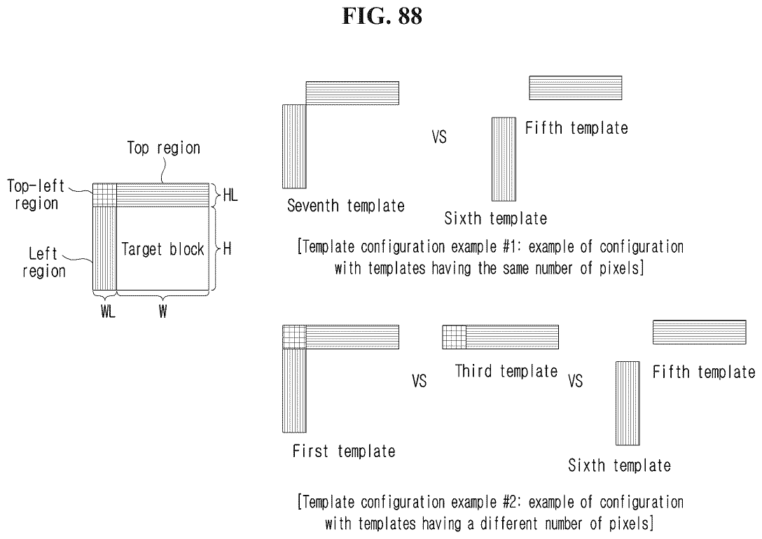

FIGS. 87 and 88 show an example of a template in various forms.

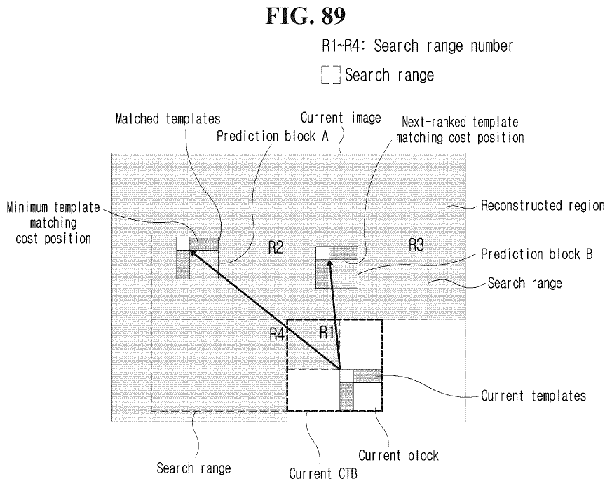

FIG. 89 shows an example in which template matching is performed by using one template.

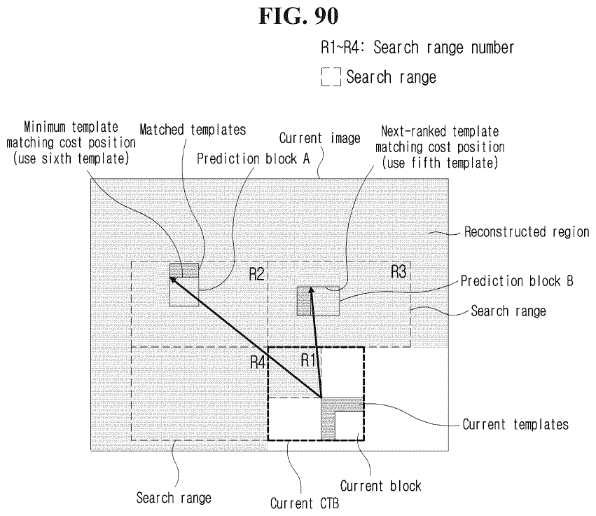

FIG. 90 shows an example in which template matching is performed by using a plurality of templates.

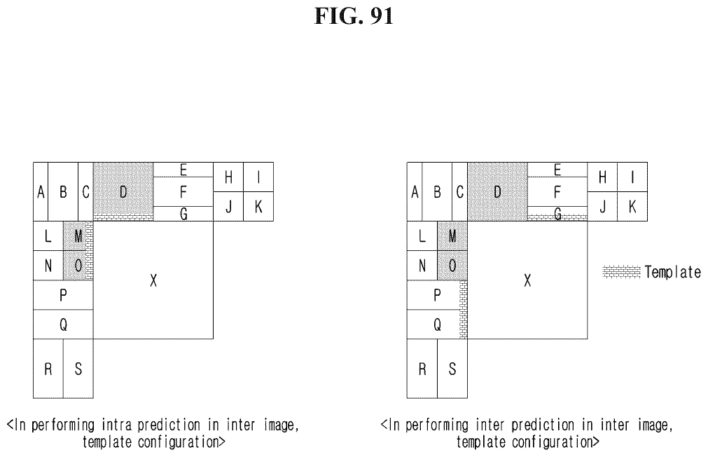

FIG. 91 shows an example in which a template shape is changed according to a prediction mode.
in FIG. 91, blocks D, M and O represent a block encoded by intra prediction.

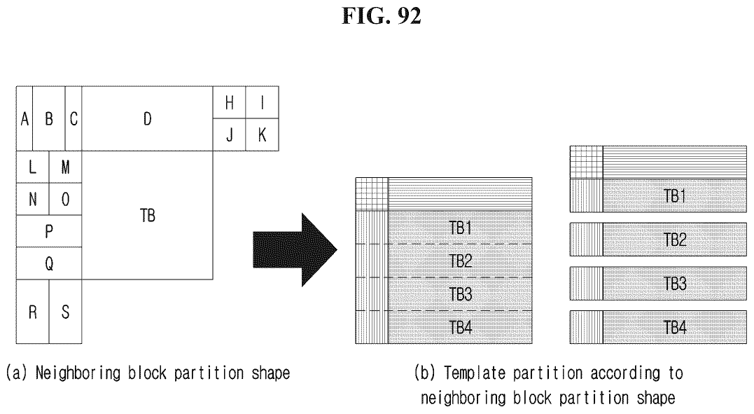

FIG. 92 shows an example in which a template is partitioned according to the partition shape of a neighboring block.

In performing the template matching, template matching may be performed by making a template size and shape different from each other.

In determining the template size and shape, at least one template may be configured by using neighboring pixels.

For example, as in an example shown in FIG. 87, a plurality of templates may be generated by using at least one of a top-left region, a top region and a left region in a predetermined size around a current block (or a target block).

In this case, a first template may generate a template by using a top-left region, a top region and a left region in a predetermined size.

In this case, a second template may generate a template by using a top-left region in a predetermined size.

In this case, a third template may generate a template by using a top-left region and a top region in a predetermined size.

In this case, a fourth template may generate a template by using a top-left region and a left region in a predetermined size.

In this case, a fifth template may generate a template by using a top region in a predetermined size.

In this case, a sixth template may generate a template by using a left region in a predetermined size.

In this case, a seventh template may generate a template by using a top region and a left region in a predetermined size.

Template matching may be performed by using at least one of the templates. In this case, template information used for template matching may be a value preset in an encoder/a decoder or may be a value signaled from an encoder to a decoder.

In determining the size and shape of the template, it may be determined by using encoding/decoding information of a current block or a neighboring block.

In this case, the size and shape of a template may be changed depending on the size of a current block or a neighboring block.

For example, when the size of a current block or a neighboring block is smaller than a threshold, a line or a pixel may be decreased to configure a template or reduce the size of a template.

For example, when the size of a current block or a neighboring block is smaller than a threshold, a line or a pixel may be increased to configure a template or expand the size of a template.

For example, when the size of a current block or a neighboring block is greater than a threshold, a line or a pixel may be decreased to configure a template or reduce the size of a template.

For example, when the size of a current block or a neighboring block is greater than a threshold, a line or a pixel may be increased to configure a template or expand the size of a template.

In determining the block size, it may be determined based on the statistical value of the width and height of a target block.

For example, a block size may be determined as max(width, height), min(width, height) or an average value.

In this case, at least one of the size and/or shape of a template may be configured differently according to the prediction mode of a neighboring block.

As an example, in an example shown in FIG. 91, it is assumed that adjacent blocks D, M and O are encoded/decoded by intra prediction.

For example, when a current block is performing inter prediction, at least one of the reconstructed samples within a block determined by inter prediction may be selected to configure a template.

For example, when a current block is performing inter prediction, at least one of the reconstructed samples within a block determined by intra prediction may be selected to configure a template.

For example, when a current block is performing intra prediction (in an inter picture), at least one of the reconstructed samples within a block determined by inter prediction may be selected to configure a template.

For example, when a current block is performing intra prediction (in an inter picture), at least one of the reconstructed samples within a block determined by intra prediction may be selected to configure a template.

In this case, at least one of the size and/or shape of a template may be configured differently according to the partition information of a block.

For example, as in an example shown in FIG. 92, the size and shape of a template may be different according to the partition shape of a neighboring block.

For example, in performing intra prediction in an inter picture, the size and shape of a template may be different according to the shape of a block that is partitioned in a prediction process.

Example) Here, the partition information of a block may represent at least one of tree structure partition information (e.g., quad-tree, binary tree, ternary tree), prediction unit partition information (e.g., geometric partitioning shape) or transform unit partition information (ISP, sbt, etc.).

In determining at least one of the size and/or shape of the template, a template may be explicitly partitioned and used.

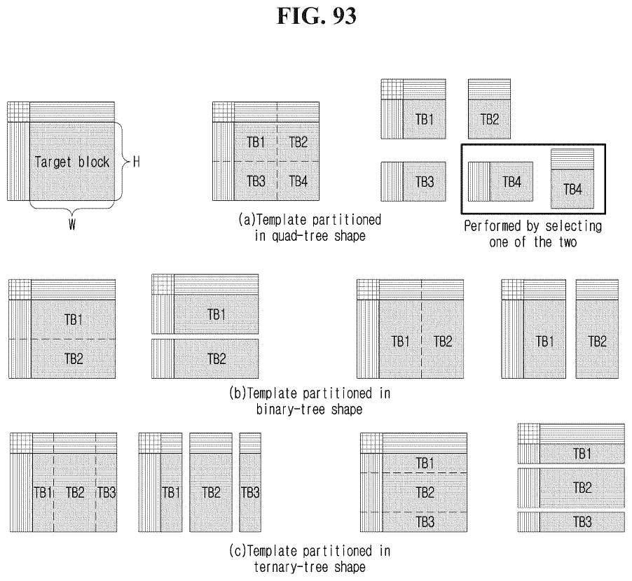

FIG. 93 shows an example in which a template is partitioned.

For example, as in an example shown in FIG. 93, template matching may be performed through partition in a form such as a quad-tree, a binary tree, a ternary tree, geometric partitioning, etc.

For example, template matching may be performed by evenly partitioning the width and height of a template into N parts.

For example, template matching may be performed by partitioning a template in an uneven (asymmetric) form.

In the example, when a template is partitioned, a template matching cost for each partitioned template may be calculated and it may be added to calculate a template matching cost for a target block.

Alternatively, there may be a limit that a partitioned template is not smaller than a predetermined size. When a partitioned template is smaller than a predetermined size, a cost for a corresponding template may not be calculated or a cost may be calculated based on a partitioned template in a predetermined size or greater.

In the example, when there are a plurality of template partition methods for one target block, a template matching cost may be calculated for each template partition method to determine an optimal template partition method.

In the example, the number of lines configuring a template may also be different according to each partition method.

In performing the template matching, template matching and prediction may be performed by using a plurality of templates.

For example, as in configuration example #1 of FIG. 88, a seventh template may be used to perform template matching and generate a prediction block and a fifth template and a sixth template may be used together to perform template matching and generate a prediction block.

In this case, template matching may be performed in at least one position by using a seventh template as in FIG. 89, and template matching may be performed in at least one position by using a fifth template and a sixth template together as in FIG. 90.

In this case, when performing template prediction by using a plurality of templates as in an example of FIG. 88, at least one of a plurality of templates may be selected and determined as a template used for final prediction.

In selecting the final template, it may be determined based on a template cost.

In this case, when a fifth template and a sixth template are used together as in an example shown in FIG. 90, using a fifth template and a sixth template together may be determined as a final template when the sum of the minimum template matching costs calculated at each position is smaller than the minimum template matching cost calculated by using a seventh template.

In this case, when a size between templates is different as in configuration example #2 of FIG. 88, a template cost may be calculated through normalization.

In selecting the final template, it may be determined based on a prediction cost or an encoding cost.

In this case, as in an example shown in FIGS. 89 and 90, a prediction block (or signal) may be derived through template matching based on each template, and a final template may be determined based on a prediction cost (an encoding cost) derived in a prediction and encoding process using this.

In this case, in generating a prediction block through template matching, a new prediction block may be generated by using a plurality of prediction blocks.

For example, as in an example shown in FIG. 89, a prediction block may be derived from at least one pixel position by using one template, and a new prediction block may be generated through the weighted sum of derived prediction blocks (prediction blocks A/B).

For example, as in an example shown in FIG. 90, a prediction block may be derived for each template from at least one pixel position by using a plurality of templates, and a new prediction block may be generated through the weighted sum of derived prediction blocks (prediction blocks A/B).

In generating a prediction block through the weight sum between prediction blocks, a weight may be determined by using encoding/decoding information.

In this case, a prediction block may be generated by using a predefined weight. In this case, multiple weights may be predefined and multiple prediction blocks may be generated by using this.

In this case, a weight may be determined based on a template matching cost calculated through each template. For example, a higher weight may be given to a prediction block with a smaller template matching cost. Alternatively, a weight may be determined according to the ratio of a template matching cost.

In this case, a weight may be configured by considering the position of pixels included in a prediction block and the position of a used template.

For example, as in an example shown in FIG. 90, let's assume that a prediction block is derived by using a fifth template (top) and a sixth template (left). When the size of a prediction block is H×W, a weight for each prediction block may be determined as in Equation 14 below.

$${w}_{A} ( x , y ) = 32 + \frac{32 x}{W} - \frac{32 y}{H} \qquad [ Equation 14 ]$$

$${W}_{L} ( x , y ) = 64 - {w}_{A} ( x , y )$$

In Equation 14, w_{A} represents a prediction block generated by using a top template (a third/fifth template). w_{L} represents a prediction block generated by using a left template (a fourth/sixth template). (x, y) represents a pixel position within a prediction block.

A template cost may be compared with a threshold value to select a template having a template cost smaller than a threshold value. In this case, when there is one template having a template cost smaller than a threshold value, as in an example described above, one prediction block is set as the prediction block of a current block. When there are a plurality of templates having a template cost smaller than a threshold value, as in an example described above, the prediction block of a current block is derived through the weighted sum of a plurality of prediction blocks.

Whether to additionally use a next-ranked template may be determined according to a difference between the template cost of a template with the lowest cost and the template cost of a next-ranked template. As an example, only when the difference is smaller than a threshold value, a next-ranked template may be additionally used to derive the prediction block of a current block.

The template matching and prediction method based on a plurality of templates may be applied to all methods using a template.

For example, for ‘template based intra mode derivation (TIMD)’, matching is not performed by moving the position of a template, but at least one template and prediction block may be generated by using various prediction modes included in a MPM list at a current position.

In ‘the template based intra mode derivation method’, a method for using a template matching method using a plurality of templates may be applied in the same way as in a previous example.

For example, the size and shape of a template may be configured in the same way, and in configuring a template and deriving a prediction block, there is a difference only in that a template matching method in a previous example performs template matching by moving a template position and derives a prediction block, whereas a template based intra mode derivation method performs template matching based on various prediction modes included in a MPM list at a current position and derives a prediction block.

Even when a plurality of templates are used in ‘a template based intra mode derivation method’, it may be performed in the same method as template matching in a previous example, and a final template may also be determined based on a template matching cost or a prediction/encoding cost.

A method for generating a new prediction block by using a plurality of prediction blocks or for determining a weight for generating a new prediction block may also be applied in the same way.

Next, a method for configuring a MPM list through “a template-based intra mode derivation (TIMD) method” and “a decoder-side intra mode derivation (DIMD) method” proposed in the present disclosure is described in detail.

A template-based intra mode derivation (TIMD) method may derive two prediction modes. Among the two prediction modes, the best mode may be an intra prediction mode with the minimum template matching cost, and the secondary mode may be an intra prediction mode with the next-ranked template matching cost.

For decoder-side intra mode derivation (DIMD), a total of six prediction modes may be derived through gradient-based filtering for a template region. Six prediction modes may be the best mode and five candidate modes.

In this specification, a decoder-side intra mode derivation method refers to a method for improving MPM prediction efficiency by adding a prediction mode derived by calculating the gradient of neighboring pixels in intra prediction to a MPM list. In this case, a decoder side also adds a prediction mode derived by calculating the gradient of neighboring pixels when configuring a MPM list.

In this specification, an intra template matching method refers to a method for configuring a template by using neighboring pixels in intra prediction and taking a region most similar to a current template from a reconstructed region in a current image and using it as a prediction block for a current block.

In this specification, a template-based intra mode derivation method refers to a method for generating a template for prediction modes in a MPM list, calculating an error cost (e.g., SAD, SATD) for each prediction mode and deriving a prediction mode based on a calculated error cost.

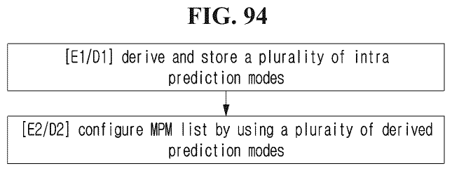

FIG. 94 is a flowchart of a method for configuring a MPM list according to an embodiment of the present disclosure.

Hereinafter, identification sign E represents an operation in an encoder and D represents an operation in a decoder. Hereinafter, each step is described in detail.

[E1/D1] In storing a prediction mode in intra prediction, at least one prediction mode may be stored.

At least one prediction mode derived through DIMD and TIMD may be stored in a current block (or a target block) and used for prediction in a current block or a next block.

For example, the best mode and the secondary mode may be derived through a template-based intra mode derivation (TIMD) method, and a derived prediction mode may be used to configure a MPM list for intra prediction in a current block or a next block.

For example, the best mode and the secondary mode may be derived through a decoder-side intra mode derivation (DIMD) method, and a derived prediction mode may be used to configure a MPM list for intra prediction in a current block or a next block.

An optimal intra prediction mode derived through intra prediction may be stored in a current block (or a target block) and used for intra prediction in a next block.

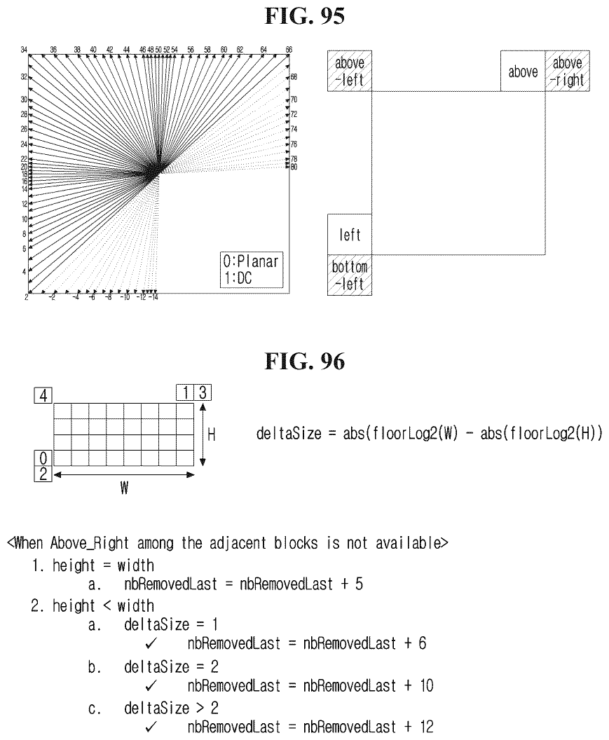

FIG. 95 shows a prediction mode number (index) and adjacent blocks to be referenced in intra prediction.

MPM candidates may be partially reordered.

As an example, let's assume that a prediction mode to be added to a MPM list is “pred_mode_idx”.

Only when pred_mode_idx satisfies a condition in Equation 15 below, it may be added directly to a MPM list, and otherwise, it may be added to a reserved list separately and added to a MPM list later.

$$lower bound < {pred}_{{mode}_{idx}} < upperbound \qquad [ Equation 15 ]$$

$$Lower bound : DC\_IDX ( 2 ) + nbRemovedFirst$$

$$Upper bound : NUM\_LUMA \_MODE ( Number of luma prediction modes : 67 - nbRemovedLast$$

“nbRemovedFirst”, “nbRemovedFirst” for determining the upper bound and lower bound may be adaptively determined according to the width, height ratio or size of a current block.

For example, the size of the width and height may be used to derive deltaSize as in Equation 16 below, and the value of “nbRemovedFirst”, “nbRemovedFirst” may be adaptively determined according to deltaSize.

$$deltaSize = abs ( floor Log 2 ( W ) - abs ( floor Log 2 ( H ) ) \qquad [ Equation 16 ]$$

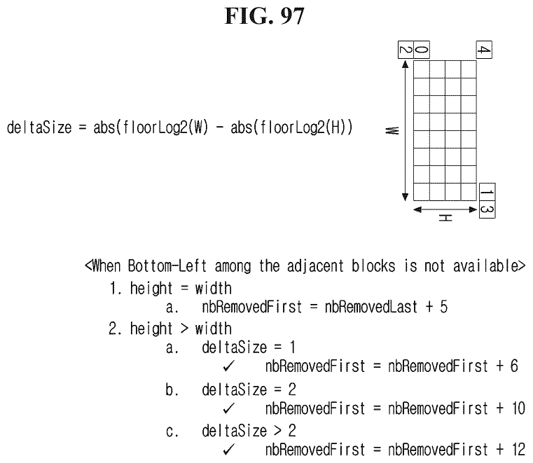

FIGS. 96 and 97 show an example in which the value of nbRemovedFirst is determined differently according to the availability of an adjacent block.

FIG. 96 illustrates a case where a top-right block is unavailable, and FIG. 97 represents an example of a case where a bottom-left block is unavailable.

As below, the value of “nbRemovedFirst”, “nbRemovedFirst” may vary depending on a position where an adjacent block is unavailable.

[E2/D2]A MPM list may be configured by using the derived prediction modes.

New prediction modes may be generated based on the derived prediction modes and added to a MPM list.

In this case, when configuring a MPM list, at least two prediction modes among the top modes in a MPM list may be selected to generate a new prediction mode through a pairwise average method.

For example, when MPM[1]=16, MPM[2]=8 and MPM[3]=4, a new prediction mode generated through a pairwise average method is as follows.
average(MPM[1], MPM[2])=12
average(MPM[1], MPM[3])=10
average(MPM[2], MPM[3])=6

In this case, a new prediction mode may be generated through a pairwise average method by using the best mode derived through TIMD or DIMD and non-best prediction modes.

Among the prediction modes used to generate the new prediction mode, nondirectional prediction modes such as DC or Planar may be excluded.

In configuring a MPM list by using the derived intra prediction mode, the order of adding a prediction mode to a MPM list may be order preset in an encoder/a decoder or the corresponding order may be signaled from an encoder to a decoder.

For example, when an adjacent block is the same as in an example shown in FIG. 95, a prediction mode may be added to a MPM list in the following order.
(STEP 1) PLANAR mode
(STEP 2) Optimal prediction mode (best mode) stored in an adjacent block

In this case, the order may be L(Left)→A(Above)→BL(Bottom Left)→AR(Above Right)→AL(Above Left).
(STEP 3) Prediction mode derived through DIMD in a current block

In this case, among the prediction modes derived through DIMD, the best mode and the secondary mode may be added to a MPM list.
(STEP 4) Prediction mode from −4 to +4 in a prediction mode included in the MPM list

In this case, at least one of the prediction modes included in a MPM list may be selected to add a prediction mode from −4 to +4 to a MPM list.

For example, when a prediction mode number added to the second of a MPM list is 6, a prediction mode added to a MPM list may be {2,3,4,5,7,8,9,10}.
(STEP 5) Add {DC_IDX, VER_IDX, HOR_IDX, VER_IDX −4, VER_IDX+4, 14, 22, 42, 58, 10, 26, 38, 62, 6, 30, 34, 66, 2, 48, 52, 16}

Here, −4 ~+4 refers to adding or subtracting −4, −3, −2, −1, +1, +2, +3, +4 to or from a prediction mode.

In configuring the MPM list, it may be configured by being divided into a Primary MPM list and a Secondary MPM list.

In this case, the maximum list size of each of a primary MPM list and a secondary MPM list may be determined. For example, the maximum size of a primary MPM list may be 6 and the maximum size of a secondary MPM list may be 16.

The size of the primary MPM list and the secondary MPM list may be variable and the number of each list may be a value preset in an encoder/a decoder or a value signaled from an encoder to a decoder.

The type of a prediction mode added to the primary MPM list and the secondary MPM list may be different from each other.

For example, only (STEP 1) PLANAR mode and (STEP 2) Optimal prediction mode (best mode) stored in an adjacent block in the example may be stored in a primary MPM list and the remaining prediction modes may be added to a secondary MPM list.

Whether to use the primary MPM list and the secondary MPM list may be signaled from an encoder to a decoder.

The order of adding the prediction mode of the adjacent block to a MPM list may be different according to the encoding/decoding information of a current block or a neighboring block. (Partial MPM Reordering Technique)

In this case, the order of adding to a MPM list may be different according to the size of the width and height of a current block.
For example) Width>Height: A→L→AR→BL→AL or L→A→AR→AL→BL
For example) Width<Height: L→A→BL→AL→AR or: L→A→AL→BL→AR

In this case, the order of adding to a MPM list may be different according to whether a neighboring block is available (or referenceable).

For example, as in an example shown in FIGS. 96 and 97, when there is an unavailable adjacent block, prediction modes having a direction similar to a direction in which an unavailable adjacent block is positioned may be added to a MPM list after the end of a corresponding step without being added immediately to a MPM list.

For example, when an available adjacent block is added to a MPM list in the order of L(Left)→A(Above)→BL(Bottom Left)→AR(Above Right)→AL(Above Left), if the prediction mode of A(Above) and BL(Bottom Left) does not satisfy a condition in an example shown in FIGS. 96 and 97, the prediction mode of A(Above) and BL(Bottom Left) may be added to a MPM list after adding all prediction modes for the remaining adjacent blocks to a MPM list. In this case, a prediction mode is added to a MPM list in the order of L(Left)→AR(Above Right)→AL(Above Left)→A(Above)→BL(Bottom Left).

In this case, the order of adding to a MPM list may be changed by using the directionality information of a prediction mode.

For example, when the direction of a prediction mode obtained after performing DIMD in a current block is a vertical mode (50), it may be added to a MPM list from the prediction mode of an adjacent block positioned on the top. In this case, it may be determined in the order of A→L→BL→AR→AL or A→AR→AL→L→BL.

A MPM list may be configured by using a Partial MPM reordering technique shown in FIGS. 96 and 97 above.
(STEP 1) PLANAR mode
(STEP 2) Optimal prediction mode (best mode) stored in an adjacent block+Partial MPM reordering technique

In this case, it may be performed in the order of L(Left)→A(Above)→BL(Bottom Left)→AR(Above Right)→AL(Above Left).

In this case, check a condition shown in FIGS. 96 and 97 for each prediction mode of each adjacent block, and when it is not satisfied, add to a reserved list

After adding the best mode for an adjacent block, add a prediction mode in a reserved list
(STEP 3) Prediction mode derived through DIMD in a current block

In this case, among the prediction modes derived through DIMD, the best mode and the secondary mode may be added to a MPM list.
(STEP 4) Prediction mode from −4 to +4 in a prediction mode included in the MPM list

In this case, at least one of the prediction modes included in a MPM list may be selected to add a prediction mode from −4 to +4 to a MPM list.

For example, when a prediction mode number added to the second of a MPM list is 6, a prediction mode added to a MPM list may be {2,3,4,5,7,8,9,10}.
(STEP 5) Add {DC_IDX, VER_IDX, HOR_IDX, VER_IDX −4, VER_IDX+4, 14, 22, 42, 58, 10, 26, 38, 62, 6, 30, 34, 66, 2, 48, 52, 16}

In configuring the MPM list, it may be configured as follows by using modes derived from TIMD and DIMD.

### Example 1)

(STEP 1) PLANAR mode
(STEP 2) Optimal prediction mode (best mode) stored in an adjacent block+Partial MPM reordering technique

In this case, it may be performed in the order of L(Left)→A(Above)→BL(Bottom Left)→AR(Above Right)→AL(Above Left).

In this case, check a condition shown in FIGS. 96 and 97 for each prediction mode of each adjacent block, and when it is not satisfied, add to a reserved list

After adding the best mode for an adjacent block, add a prediction mode in a reserved list
(STEP 3) When the prediction mode of an adjacent block is determined by TIMD/DIMD, add a secondary mode+Partial MPM reordering technique

In this case, it may be performed in the order of L(Left)→A(Above)→BL(Bottom Left)→AR(Above Right)→AL(Above Left).

In this case, check a condition shown in FIGS. 96 and 97 for each prediction mode of each adjacent block, and when it is not satisfied, add to a reserved list

After adding all secondary modes for an adjacent block, add a prediction mode in a reserved list
(STEP 4) Prediction mode derived through DIMD in a current block

In this case, among the prediction modes derived through DIMD, the best mode and the secondary mode may be added to a MPM list.
(STEP 5) Prediction mode from −4 to +4 in a prediction mode included in the MPM list

In this case, at least one of the prediction modes included in a MPM list may be selected to add a prediction mode from −4 to +4 to a MPM list.

For example, when a prediction mode number added to the second of a MPM list is 6, a prediction mode added to a MPM list may be {2,3,4,5,7,8,9,10}.
(STEP 6) Add {DC_IDX, VER_IDX, HOR_IDX, VER_IDX −4, VER_IDX+4, 14, 22, 42, 58, 10, 26, 38, 62, 6, 30, 34, 66, 2, 48, 52, 16}

### Example 2)

(STEP 1) PLANAR mode
(STEP 2) Optimal prediction mode (best mode) stored in an adjacent block

In this case, it may be performed in the order of L(Left)→A(Above)→BL(Bottom Left)→AR(Above Right)→AL(Above Left).

In this case, check a condition shown in FIGS. 96 and 97 for each prediction mode of each adjacent block, and when it is not satisfied, add to a reserved list
(STEP 3) When the prediction mode of an adjacent block is determined by TIMD/DIMD, add a secondary mode

In this case, it may be performed in the order of L(Left)→A(Above)→BL(Bottom Left)→AR(Above Right)→AL(Above Left).

In this case, check a condition shown in FIGS. 96 and 97 for each prediction mode of each adjacent block, and when it is not satisfied, add to a reserved list
(STEP 4) Perform Partial MPM reordering for prediction modes in STEP 2 and STEP 3 above

After performing (STEP 2) and (STEP 3), add a prediction mode added to a reserved list to a MPM list
(STEP 5) Prediction mode derived through DIMD in a current block

In this case, among the prediction modes derived through DIMD, the best mode and the secondary mode may be added to a MPM list.
(STEP 6) Prediction mode from −4 to +4 in a prediction mode included in the MPM list

In this case, at least one of the prediction modes included in a MPM list may be selected to add a prediction mode from −4 to +4 to a MPM list.

For example, when a prediction mode number added to the second of a MPM list is 6, a prediction mode added to a MPM list may be {2,3,4,5,7,8,9,10}.
(STEP 7) Add {DC_IDX, VER_IDX, HOR_IDX, VER_IDX −4, VER_IDX+4, 14, 22, 42, 58, 10, 26, 38, 62, 6, 30, 34, 66, 2, 48, 52, 16}

A difference between Example 1 and Example 2 above is as follows.

Example 1: Best mode of an adjacent block→Prediction mode that does not satisfy a condition shown in FIGS. 96 and 97 among the best modes of an adjacent block→Secondary mode of an adjacent block→Prediction mode that does not satisfy a condition shown in FIGS. 96 and 97 among the secondary modes of an adjacent block

Example 2: Best mode of an adjacent block→Secondary mode of an adjacent block→Prediction mode that does not satisfy a condition shown in FIGS. 96 and 97 among the best modes of an adjacent block→Prediction mode that does not satisfy a condition shown in FIGS. 96 and 97 among the secondary modes of an adjacent block

### Example 3)

(STEP 1) PLANAR mode
(STEP 2) Optimal prediction mode (best mode) stored in an adjacent block+Partial MPM reordering technique

In this case, it may be performed in the order of L(Left)→A(Above)→BL(Bottom Left)→AR(Above Right)→AL(Above Left).

In this case, check a condition shown in FIGS. 96 and 97 for each prediction mode of each adjacent block, and when it is not satisfied, add to a reserved list

After adding the best mode for an adjacent block, add a prediction mode in a reserved list
(STEP 3) Prediction mode derived through DIMD in a current block

In this case, among the prediction modes derived through DIMD, the best mode and the secondary mode may be added to a MPM list.
(STEP 4) When the prediction mode of an adjacent block is determined by TIMD/DIMD, add a secondary mode+Partial MPM reordering technique

In this case, it may be performed in the order of L(Left)→A(Above)→BL(Bottom Left)→AR(Above Right)→AL(Above Left).

In this case, check a condition shown in FIGS. 96 and 97 for each prediction mode of each adjacent block, and when it is not satisfied, add to a reserved list

After adding all secondary modes for an adjacent block, add a prediction mode in a reserved list
(STEP 5) Prediction mode from −4 to +4 in a prediction mode included in the MPM list

In this case, at least one of the prediction modes included in a MPM list may be selected to add a prediction mode from −4 to +4 to a MPM list.

For example, when a prediction mode number added to the second of a MPM list is 6, a prediction mode added to a MPM list may be {2,3,4,5,7,8,9,10}.
(STEP 6) Add {DC_IDX, VER_IDX, HOR_IDX, VER_IDX −4, VER_IDX+4, 14, 22, 42, 58, 10, 26, 38, 62, 6, 30, 34, 66, 2, 48, 52, 16}

### Example 4)

(STEP 1) PLANAR mode
(STEP 2) Optimal prediction mode (best mode) stored in an adjacent block+Partial MPM reordering technique

In this case, it may be performed in the order of L(Left)→A(Above)→BL(Bottom Left)→AR(Above Right)→AL(Above Left).

In this case, check a condition shown in FIGS. 96 and 97 for each prediction mode of each adjacent block, and when it is not satisfied, add to a reserved list

After adding the best mode for an adjacent block, add a prediction mode in a reserved list
(STEP 3) Prediction mode derived through DIMD in a current block

In this case, among the prediction modes derived through DIMD, the best mode and the secondary mode may be added to a MPM list.
(STEP 4) Prediction mode from −4 to +4 in a prediction mode included in the MPM list

In this case, at least one of the prediction modes included in a MPM list may be selected to add a prediction mode from −4 to +4 to a MPM list.

For example, when a prediction mode number added to the second of a MPM list is 6, a prediction mode added to a MPM list may be {2,3,4,5,7,8,9,10}.
(STEP 5) When the prediction mode of an adjacent block is determined by TIMD/DIMD, add a secondary mode+Partial MPM reordering technique

In this case, it may be performed in the order of L(Left)→A(Above)→BL(Bottom Left)→AR(Above Right)→AL(Above Left).

In this case, check a condition shown in FIGS. 96 and 97 for each prediction mode of each adjacent block, and when it is not satisfied, add to a reserved list

After adding all secondary modes for an adjacent block, add a prediction mode in a reserved list
(STEP 6) Add {DC_IDX, VER_IDX, HOR_IDX, VER_IDX −4, VER_IDX+4, 14, 22, 42, 58, 10, 26, 38, 62, 6, 30, 34, 66, 2, 48, 52, 16}

### Example 5)

(STEP 1) PLANAR mode
(STEP 2) Optimal prediction mode (best mode) stored in an adjacent block

In this case, when the prediction mode of an adjacent block is determined by TIMD/DIMD, add a secondary mode immediately after adding the best mode

In this case, it may be performed in the order of L(Left)→A(Above)→BL(Bottom Left)→AR(Above Right)→AL(Above Left).

In this case, check a condition shown in FIGS. 96 and 97 for each prediction mode of each adjacent block, and when it is not satisfied, add to a reserved list

After adding the best mode for an adjacent block, add a prediction mode in a reserved list
(STEP 3) Prediction mode derived through DIMD in a current block

In this case, among the prediction modes derived through DIMD, the best mode and the secondary mode may be added to a MPM list.
(STEP 4) Prediction mode from −4 to +4 in a prediction mode included in the MPM list

In this case, at least one of the prediction modes included in a MPM list may be selected to add a prediction mode from −4 to +4 to a MPM list.

For example, when a prediction mode number added to the second of a MPM list is 6, a prediction mode added to a MPM list may be {2,3,4,5,7,8,9,10}.
(STEP 5) Add {DC_IDX, VER_IDX, HOR_IDX, VER_IDX −4, VER_IDX+4, 14, 22, 42, 58, 10, 26, 38, 62, 6, 30, 34, 66, 2, 48, 52, 16}

In the example, when using a secondary mode derived through TIMD/DIMD, only TIMD or DIMD may be checked to add a secondary mode to a MPM list or both TIMD and DIMD may be checked to add each secondary mode to a MPM list.

In configuring the MPM list, a prediction mode derived through TIMD in a current block may be used to configure the MPM list of a current block.

As in an example below, a prediction mode derived through DIMD in a current block may be added before or after a step for adding a MPM.

Example 1) Add a mode derived through TIMD before adding a prediction mode derived through DIMD in a current block to a MPM list.
(STEP 1) PLANAR mode
(STEP 2) Optimal prediction mode (best mode) stored in an adjacent block+Partial MPM reordering technique

In this case, it may be performed in the order of L(Left)→A(Above)→BL(Bottom Left)→AR(Above Right)→AL(Above Left).

In this case, check a condition shown in FIGS. 96 and 97 for each prediction mode of each adjacent block, and when it is not satisfied, add to a reserved list

After adding the best mode for an adjacent block, add a prediction mode in a reserved list
(STEP 3) Prediction mode derived through TIMD in a current block

In this case, among the prediction modes derived through TIMD, the best mode and the secondary mode may be added to a MPM list.
(STEP 4) Prediction mode derived through DIMD in a current block

In this case, among the prediction modes derived through DIMD, the best mode and the secondary mode may be added to a MPM list.
(STEP 5) Prediction mode from −4 to +4 in a prediction mode included in the MPM list

In this case, at least one of the prediction modes included in a MPM list may be selected to add a prediction mode from −4 to +4 to a MPM list.

For example, when a prediction mode number added to the second of a MPM list is 6, a prediction mode added to a MPM list may be {2,3,4,5,7,8,9,10}.
(STEP 6) Add {DC_IDX, VER_IDX, HOR_IDX, VER_IDX −4, VER_IDX+4, 14, 22, 42, 58, 10, 26, 38, 62, 6, 30, 34, 66, 2, 48, 52, 16}

Example 2) Add a mode derived through TIMD after adding a prediction mode derived through DIMD in a current block to a MPM list.
(STEP 1) PLANAR mode
(STEP 2) Optimal prediction mode (best mode) stored in an adjacent block+Partial MPM reordering technique

In this case, it may be performed in the order of L(Left)→A(Above)→BL(Bottom Left)→AR(Above Right)→AL(Above Left).

In this case, check a condition shown in FIGS. 96 and 97 for each prediction mode of each adjacent block, and when it is not satisfied, add to a reserved list

After adding the best mode for an adjacent block, add a prediction mode in a reserved list
(STEP 3) Prediction mode derived through DIMD in a current block

In this case, among the prediction modes derived through DIMD, the best mode and the secondary mode may be added to a MPM list.
(STEP 4) Prediction mode derived through TIMD in a current block

In this case, among the prediction modes derived through TIMD, the best mode and the secondary mode may be added to a MPM list.
(STEP 5) Prediction mode from −4 to +4 in a prediction mode included in the MPM list

In this case, at least one of the prediction modes included in a MPM list may be selected to add a prediction mode from −4 to +4 to a MPM list.

For example, when a prediction mode number added to the second of a MPM list is 6, a prediction mode added to a MPM list may be {2,3,4,5,7,8,9,10}.
(STEP 6) Add {DC_IDX, VER_IDX, HOR_IDX, VER_IDX −4, VER_IDX+4, 14, 22, 42, 58, 10, 26, 38, 62, 6, 30, 34, 66, 2, 48, 52, 16}

Prediction modes derived other than the derived best mode (secondary, third, etc.) may be added to a primary MPM list or may be added to a secondary MPM list.

In this case, the size of a primary MPM list or a secondary list may be adjusted.

In configuring the MPM list, a list configuration may be different depending on the position of a block where a prediction mode is derived.

In this case, a list may be configured by dividing into “prediction mode derived from a current block” and “prediction mode derived from an adjacent block”.

For example, the prediction modes divided respectively may be added to a primary MPM list or may be added to a secondary MPM list.

For example, in configuring a MPM list, as in Example 1 below, prediction modes derived from a current block may be added before prediction blocks derived from an adjacent block.

In this case, the order of adding modes derived through DIMD and TIMID may be changed.
(STEP 1) PLANAR mode
(STEP 2) Prediction mode derived through DIMD in a current block

In this case, among the prediction modes derived through DIMD, the best mode and the secondary mode may be added to a MPM list.
(STEP 3) Prediction mode derived through TIMD in a current block

In this case, among the prediction modes derived through TIMD, the best mode and the secondary mode may be added to a MPM list.
(STEP 4) Optimal prediction mode (best mode) stored in an adjacent block+Partial MPM reordering technique

In this case, it may be performed in the order of L(Left)→A(Above)→BL(Bottom Left)→AR(Above Right)→AL(Above Left).

In this case, check a condition shown in FIGS. 96 and 97 for each prediction mode of each adjacent block, and when it is not satisfied, add to a reserved list

After adding the best mode for an adjacent block, add a prediction mode in a reserved list
(STEP 5) When the prediction mode of an adjacent block is determined by TIMD/DIMD, add a secondary mode+Partial MPM reordering technique

In this case, it may be performed in the order of L(Left)→A(Above)→BL(Bottom Left)→AR(Above Right)→AL(Above Left).

In this case, check a condition shown in FIGS. 96 and 97 for each prediction mode of each adjacent block, and when it is not satisfied, add to a reserved list

After adding all secondary modes for an adjacent block, add a prediction mode in a reserved list
(STEP 6) Prediction mode from −4 to +4 in a prediction mode included in the MPM list

In this case, at least one of the prediction modes included in a MPM list may be selected to add a prediction mode from −4 to +4 to a MPM list.

For example, when a prediction mode number added to the second of a MPM list is 6, a prediction mode added to a MPM list may be {2,3,4,5,7,8,9,10}.
(STEP 7) Add {DC_IDX, VER_IDX, HOR_IDX, VER_IDX −4, VER_IDX+4, 14, 22, 42, 58, 10, 26, 38, 62, 6, 30, 34, 66, 2, 48, 52, 16}

The embodiments may be performed using the same/corresponding method by the encoding apparatus 1600 and by the decoding apparatus 1700. Also, the image may be encoded/decoded using at least one of the embodiments or at least one combination thereof.

The order of application of the embodiments may be different from each other by the encoding apparatus 1600 and the decoding apparatus 1700, and the order of application of the embodiments may be (at least partially) identical to each other by the encoding apparatus 1600 and the decoding apparatus 1700.

The embodiments may be performed for each of a luma signal and a chroma signal, and may be equally performed for the luma signal and the chroma signal.

The form of a block to which the embodiments are applied may have a square or non-square shape.

Whether at least one of the above-described embodiments is to be applied and/or performed may be determined based on a condition related to the size of a block. In other words, at least one of the above-described embodiments may be applied and/or performed when the condition related to the size of a block is satisfied. The condition includes a minimum block size and a maximum block size. The block may be one of blocks described above in connection with the embodiments and the units described above in connection with the embodiments. The block to which the minimum block size is applied and the block to which the maximum block size is applied may be different from each other.

For example, when the block size is equal to or greater than the minimum block size and/or less than or equal to the maximum block size, the above-described embodiments may be applied and/or performed. When the block size is greater than the minimum block size and/or less than or equal to the maximum block size, the above-described embodiments may be applied and/or performed.

For example, the above-described embodiments may be applied only to the case where the block size is a predefined block size. The predefined block size may be 2×2, 4×4, 8×8, 16×16, 32×32, 64×64, or 128×128. The predefined block size may be (2*SIZE_{X})×(2*SIZE_{Y}). SIZE_{X} may be one of integers of 1 or more. SIZE_{Y} may be one of integers of 1 or more.

For example, the above-described embodiments may be applied only to the case where the block size is equal to or greater than the minimum block size. The above-described embodiments may be applied only to the case where the block size is greater than the minimum block size. The minimum block size may be 2×2, 4×4, 8×8, 16×16, 32×32, 64×64, or 128×128. Alternatively, the minimum block size may be (2*SIZE_{MIN_X})×(2*SIZE_{MIN_Y}). SIZE_{MIN_X} may be one of integers of 1 or more. SIZE_{MIN_Y} may be one of integers of 1 or more.

For example, the above-described embodiments may be applied only to the case where the block size is less than or equal to the maximum block size. The above-described embodiments may be applied only to the case where the block size is less than the maximum block size. The maximum block size may be 2×2, 4×4, 8×8, 16×16, 32×32, 64×64, or 128×128. Alternatively, the maximum block size may be (2*SIZE_{MAX_X})×(2*SIZE_{MAX_Y}). SIZE_{MAX_X} may be one of integers of 1 or more. SIZE_{MAX_Y} may be one of integers of 1 or more.

For example, the above-described embodiments may be applied only to the case where the block size is equal to or greater than the minimum block size and is less than or equal to the maximum block size. The above-described embodiments may be applied only to the case where the block size is greater than the minimum block size and is less than or equal to the maximum block size. The above-described embodiments may be applied only to the case where the block size is equal to or greater than the minimum block size and is less than the maximum block size. The above-described embodiments may be applied only to the case where the block size is greater than the minimum block size and is less than the maximum block size.

In the above-described embodiments, the block size may be a horizontal size (width) or a vertical size (height) of a block. The block size may indicate both the horizontal size and the vertical size of the block. The block size may indicate the area of the block. Each of the area, minimum block size, and maximum block size may be one of integers equal to or greater than 1. In addition, the block size may be the result (or value) of a well-known equation using the horizontal size and the vertical size of the block, or the result (or value) of an equation in embodiments.

Further, in the embodiments, a first embodiment may be applied to a first size, and a second embodiment may be applied to a second size.

The embodiments may be applied depending on a temporal layer. In order to identify a temporal layer to which the embodiments are applicable, a separate identifier may be signaled, and the embodiments may be applied to the temporal layer specified by the corresponding identifier. Here, the identifier may be defined as the lowest (bottom) layer and/or the highest (top) layer to which the embodiments are applicable, and may be defined as being indicating a specific layer to which the embodiments are applied. Further, a fixed temporal layer to which the embodiments are applied may also be defined.

For example, the embodiments may be applied only to the case where the temporal layer of a target image is the lowermost layer. For example, the embodiments may be applied only to the case where the temporal layer identifier of a target image is equal to or greater than 1. For example, the embodiments may be applied only to the case where the temporal layer of a target image is the highest layer.

A slice type or a tile group type to which the embodiments to which the embodiments are applied may be defined, and the embodiments may be applied depending on the corresponding slice type or tile group type.

In the above-described embodiments, it may be construed that, during the application of specific processing to a specific target, assuming that specified conditions may be required and the specific processing is performed under a specific determination, a specific coding parameter may be replaced with an additional coding parameter when a description has been made such that whether the specified conditions are satisfied is determined based on the specific coding parameter, or such that the specific determination is made based on the specific coding parameter. In other words, it may be considered that a coding parameter that influences the specific condition or the specific determination is merely exemplary, and it may be understood that, in addition to the specific coding parameter, a combination of one or more additional coding parameters functions as the specific coding parameter.

In the above-described embodiments, although the methods have been described based on flowcharts as a series of steps or units, the present disclosure is not limited to the sequence of the steps and some steps may be performed in a sequence different from that of the described steps or simultaneously with other steps. Further, those skilled in the art will understand that the steps shown in the flowchart are not exclusive and may further include other steps, or that one or more steps in the flowchart may be deleted without departing from the scope of the disclosure.

The above-described embodiments include examples in various aspects. Although all possible combinations for indicating various aspects cannot be described, those skilled in the art will appreciate that other combinations are possible in addition to explicitly described combinations. Therefore, it should be understood that the present disclosure includes other replacements, changes, and modifications belonging to the scope of the accompanying claims.

The above-described embodiments according to the present disclosure may be implemented as a program that can be executed by various computer means and may be recorded on a computer-readable storage medium. The computer-readable storage medium may include program instructions, data files, and data structures, either solely or in combination. Program instructions recorded on the storage medium may have been specially designed and configured for the present disclosure, or may be known to or available to those who have ordinary knowledge in the field of computer software.

A computer-readable storage medium may include information used in the embodiments of the present disclosure. For example, the computer-readable storage medium may include a bitstream, and the bitstream may contain the information described above in the embodiments of the present disclosure.

A bitstream may include a computer-executable code and/or program. A computer-executable code and/or program may include information described in embodiments and may include syntax elements described in embodiments. In other words, information and syntax elements described in embodiments may be considered as a computer-executable code within a bitstream and may be considered as at least a part of a computer-executable code and/or program expressed in a bitstream. The computer-readable storage medium may include a non-transitory computer-readable medium.

Examples of the computer-readable storage medium include all types of hardware devices specially configured to record and execute program instructions, such as magnetic media, such as a hard disk, a floppy disk, and magnetic tape, optical media, such as compact disk (CD)-ROM and a digital versatile disk (DVD), magneto-optical media, such as a floptical disk, ROM, RAM, and flash memory. Examples of the program instructions include machine code, such as code created by a compiler, and high-level language code executable by a computer using an interpreter. The hardware devices may be configured to operate as one or more software modules in order to perform the operation of the present disclosure, and vice versa.

As described above, although the present disclosure has been described based on specific details such as detailed components and a limited number of embodiments and drawings, those are merely provided for easy understanding of the entire disclosure, the present disclosure is not limited to those embodiments, and those skilled in the art will practice various changes and modifications from the above description.

Accordingly, it should be noted that the spirit of the present embodiments is not limited to the above-described embodiments, and the accompanying claims and equivalents and modifications thereof fall within the scope of the present disclosure.

1. A method of decoding an image, the method comprising:
setting a search range for a template matching for a current block within a current picture;
performing a template matching for the search range to derive a block vector for the current block; and
deriving, based on the block vector, a prediction block of the current block.

2. The method of claim 1, wherein the search range includes a plurality of spatially separated sub-search ranges.

3. The method of claim 2, wherein the search range includes at least one of a first sub-search range at a top position of the current block, a second sub-search range at a left position or a third sub-search range at a top-left position.

4. The method of claim 2, wherein whether a sub-search range is available is determined based on an availability of an adjacent block positioned in a direction toward which the sub-search range faces from the current block.

5. The method of claim 2, wherein based on a block vector of an adjacent block adjacent to the current block, a size of the sub-search ranges is determined.

6. The method of claim 5, wherein a size of a sub-search range including a position spaced apart from a position of the current block by the block vector of the adjacent block is expanded.

7. The method of claim 6, wherein a size of a residual sub-search range not including the position is reduced.

8. The method of claim 1, wherein deriving the block vector includes performing an initial template matching at predefined integer positions set according to a predefined pattern within the search range.

9. The method of claim 8, wherein deriving the block vector includes:
selecting an integer position having a minimum template matching cost among the predefined integer positions,
further performing an additional template matching on ½ pixel positions around a selected integer position,
selecting a ½ pixel position having the minimum template matching cost among the ½ pixel positions, and
further performing the additional template matching on ¼ pixel positions around a selected ½ pixel position.

10. The method of claim 9, wherein a sample value of a sub-pixel position is obtained through an interpolation, and
wherein an interpolation filter used to derive a sample value at the ½ pixel positions is different from an interpolation filter used to derive a sample value at the ¼ pixel positions.

11. The method of claim 1, wherein the prediction block of the current block is obtained based on a weighted sum operation between a first prediction block derived based on a first block vector and a second prediction block derived based on a second block vector.

12. The method of claim 11, wherein the first block vector is derived based on a first template, and the second block vector is derived based on a second template.

13. A method of encoding an image, the method comprising:
setting a search range for a template matching for a current block within a current picture;
performing a template matching for the search range to derive a block vector for the current block; and
based on the block vector, deriving a prediction block of the current block.

14. The method of claim 13, wherein the search range includes a plurality of spatially separated sub-search ranges.

15. The method of claim 14, wherein the search range includes at least one of a first sub-search range at a top position of the current block, a second sub-search range at a left position or a third sub-search range at a top-left position.

16. The method of claim 14, wherein whether a sub-search range is available is determined based on an availability of an adjacent block positioned in a direction toward which the sub-search range faces from the current block.

17. The method of claim 14, wherein based on a block vector of an adjacent block adjacent to the current block, a size of the sub-search ranges is determined.

18. The method of claim 17, wherein a size of a sub-search range including a position spaced apart from a position of the current block by the block vector of the adjacent block is expanded.

19. The method of claim 18, wherein a size of a residual sub-search range not including the position is reduced.

20. A recording medium storing a bitstream generated by an image encoding method, the recording medium comprising:
setting a search range for a template matching for a current block within a current picture;
performing a template matching for the search range to derive a block vector for the current block; and
based on the block vector, deriving a prediction block of the current block.
